(19) United States
(12) Patent Application Publication
(10) Pub. No.: US 2017/0301024 A1
(43) Pub. Date: Oct. 19, 2017

(54) MULTIDIMENSIONAL RISK ANALYSIS

(71) Applicants: Pankaj B. Dalal, South Ozone Park, NY (US); Surbhi P. Dalal, South Ozone Park, NY (US)

(72) Inventors: Pankaj B. Dalal, South Ozone Park, NY (US); Surbhi P. Dalal, South Ozone Park, NY (US)

(21) Appl. No.: 15/641,490

(22) Filed: Jul. 5, 2017

Related U.S. Application Data
(63) Continuation-in-part of application No. 13/066,764, filed on Apr. 23, 2011.
Application No. 13/066,764 is a continuation-in-part of application No. 12/727,195, filed on Mar. 18, 2010, now Pat. No. 8,214,277.
Application No. 12/727,195 is a continuation-in-part of application No. PCT/US2010/002790, filed on Mar. 19, 2010.
(60) Provisional application No. 61/343,120, filed on Apr. 23, 2010.
(60) Provisional application No. 61/276,305, filed on Sep. 9, 2009.
(60) Provisional application No. 61/210,599, filed on Mar. 20, 2009.

(51) Int. Cl. G06Q 40/04; G06T 11/20

(52) U.S. Cl. CPC G06Q 40/04; G06T 11/206

(57) ABSTRACT

Certain embodiments of the present invention relate to dynamically displaying multiple market risk categories for each of at least one time frames in real time, wherein, each of the multiple market risk categories comprises at least one market risk dimension, dynamically assessing within each of the various market risk categories based upon at least one or more of multiple risk dimensions, dynamically designating various aggregate combinations of market risks for each of at least one time frames in real time in response to said dynamically assessing within each of the various market risk categories, and dynamically forecasting possible Bullish Believer or Bearish Believer direction or Neutral Believer direction with an assigned category of risk in response to said dynamically designating the various aggregate combinations of market risks. Certain embodiments of these methods and systems can be applied to the financial markets, such as stocks, commodities, futures, options, foreign currencies, ETFs, ETNs, etc.

### RELATED APPLICATIONS

The present application is a continuation-in-part application of application Ser. No. 13/066,764, filed Apr. 23, 2011, which is related to and claims priority from prior, provisional application Ser. No. 61/343,120, filed Apr. 23, 2010, entitled “Multidimensional Risk Analysis Systems”; and the present application is also a continuation-in-part of application Ser. No. 12/727,195, filed Mar. 18, 2010 entitled “Multidimensional Risk Analysis Systems”; and the present application is also a continuation-in-part of PCT application serial number PCT/US2010/027920, filed Mar. 19, 2010, entitled “Multidimensional Risk Analysis Systems”; and provisional application Ser. No. 61/276,305, filed Sep. 9, 2009; and provisional application No. 61/210,599, filed Mar. 20, 2009; and the present application is also related to the following applications: application Ser. No. 12/189,761, filed Aug. 11, 2008; PCT application serial number PCT/US/2008/072830, filed Aug. 11, 2008; and provisional application Ser. No. 60/954,978, filed Aug. 9, 2007; and U.S. Pat. No. 7,848,995 issued on Dec. 7, 2010; provisional patent application Ser. No. 60/717,962, filed Sep. 16, 2005, and 60/730,121, filed Oct. 24, 2005; and PCT International Application No. PCT/US2006/036281, filed Aug. 16, 2006. The contents of each of these references are incorporated herein by reference and are not admitted to be prior art with respect to the present invention by the mention in this cross-reference section.

### FIELD OF THE INVENTION

Certain embodiments of this disclosure pertain generally to display of financial information.

### BACKGROUND OF THE INVENTION

This disclosure relates to providing methods and a specific purpose computer system, which is an improvement for computer functionality, for improved, dynamic, real time, multidimensional risk recognition, including but not limited to dynamic assessment of various market risk categories and multiple independent risk factors, dynamic designation of various aggregate combinations of market risks, multiple confirmation of risk, dynamic forecasting, dynamic display of multiple market risk categories, and providing multidimensional risk analysis in single or multiple time frames, in market trading.

In trading any market vehicle, over a period of time, technicians and economists seek to identify risks as early as possible. However, early pin-point detection, optimal sequencing, categorization, multidimensional risk recognition, dynamic assessment of market risk, dynamic designation of market risk, multiple confirmation and dynamic forecasting are practically difficult in real-time (as they happen); this leads to delayed entry and exit in market trades. Further, multiple confirmations of risks delay entries and exits in market trades even longer. Methods and a system are desirable to perform the functions described above.

### SUMMARY OF THE INVENTION

Certain aspects of this disclosure describe a multidimensional risk analyzer that can provide for multidimensional, multi-confirmation risk assessment, risk recognition, risk allocation, and risk transfer system with minimum requirements of traditional technical analysis experience in real time for a number and variety of markets. Certain aspects of the multidimensional risk analyzer can limit a number of unnecessary efforts and produces to-the-point efficiency, pinpoint entries with risk recognition and risk designation and limit the cost and effort of learning, trading and also provides a better economical environment for the trading community.

Certain aspects of this disclosure describe a multidimensional risk analyzer that can dynamically display multiple market risk categories for each of at least one time frames in real time, wherein, each of the multiple market risk categories comprises at least one market risk dimension. Some aspects can dynamically assess within each of the various market risk categories based upon at least one or more of multiple risk dimensions. Some aspects can dynamically designate various aggregate combinations of market risks for each of at least one time frames in real time in response to said dynamically assessing within each of the various market risk categories. These can dynamically forecast possible Bullish Believer or Bearish Believer direction or Neutral Believer direction with an assigned category of risk in response to said dynamically designating the various aggregate combinations of market risks.

Certain aspects of the present disclosure relate to dynamic risk recognition of the at least one risk that has been dynamically assessed. Some of these aspects describe confirming at least one risk that has undergone dynamic risk recognition, wherein the dynamically designating various aggregate combinations of market risks is performed at least partially in response to the confirming the at least one risk.

Certain aspects of the present disclosure can dynamically calculate and display a specialized mid pivot of an at least one higher time frame. These can dynamically calculate and display vertical risk components of an at least one lower time frame. Certain of these embodiments can observe, in a real time, the formation of a Halved Hybrid Nozzlelism shape at least partially in response to the relationship between said dynamically calculating and displaying the specialized mid pivot of the at least one higher time frame as taken with respect to said dynamically calculating and displaying the vertical risk components of the at least one lower time frame.

Certain aspects of the present disclosure describe a trading method using a multi-dimensional risk analysis system, comprising dynamically calculating and displaying a precise timing for at least one super belief bullish pinpoint entries and exits, at least one super belief neutral pinpoint entries and exits, or at least one super belief bearish pinpoint entries and exits based on at least one of a various risk dimensions Certain of these can forecasts at least one of a precise targets, forecasts at least one earlier highs and at least one earlier lows, and reduces the number of trading errors, and assesses the developing risks or risk and multi-confirmation or risks, and also forecasts quick recognition combinations of market direction in one or more time frames as they develop.

Certain trading embodiments of the present disclosure display multidimensional financial information contained within multiple market risk categories that could be used to display at least one dynamic forecast of possible Bullish Believer, Neutral Believer, or Bearish Believer direction with an assigned category of risk.

The present invention also relates to a specific purpose computer system, wherein, the computer system must be custom built, equipped with a Risk analyzer, a Risk processor, a Risk assessor, a Risk Designator including internal market moving risk Processor, economic event risk Processor, multiple conditions risk processor, price perception risk Processor, time duration risk processor, trend risk processor, zone range risk processor, family and characteristic risk processor multiple displays, at least three, and multiple memories and servers capable of analyzing data, creating, displaying, and changing shapes, multiple ribbons, patterns, multiple symbols, risk dimensions with numbering, multiple colors, alerts, exploration, with at least one realtime market feed with realtime market data based on stated multidimensional risk analysis system.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows a schematic view, illustrating one embodiment of a multidimensional risk analysis systems;

FIG. 2 shows a schematic view, illustrating another embodiment of the multidimensional risk analysis systems;

FIG. 3 shows one embodiment of a display, showing an illustrative screenshot view which is displaying a Vertical Risk Dimension, as included within certain embodiments of the multidimensional risk analysis systems of FIGS. 1 and 2;

FIG. 4 shows one embodiment of a display, showing an illustrative screenshot view which is displaying a Horizontal Time Risk dimension, as included within certain embodiments of the multidimensional risk analysis systems of FIGS. 1 and 2;

FIG. 5 shows one embodiment of a display, showing an illustrative screenshot view which is displaying a health risk dimension component, as included within certain embodiments of the multidimensional risk analysis systems of FIGS. 1 and 2;

FIG. 6 shows one embodiment of a display, showing an illustrative screenshot view which is displaying a price perception indicator and internal movement indicator, as included within certain embodiments of the multidimensional risk analysis systems of FIGS. 1 and 2;

FIG. 7 shows one embodiment of a display, showing an illustrative screenshot view showing several screenshot sections, which together are displaying all eight risk dimensions, as included within certain embodiments of the multidimensional risk analysis systems of FIGS. 1 and 2;

FIG. 8 shows one embodiment of a display, showing an illustrative screenshot view which is displaying Halved Hybrid Nozzlelism phenomenon and Halved Hybrid Parallelism, as included within certain embodiments of the multidimensional risk analysis systems of FIGS. 1 and 2. The shaded area shown within the red-dotted box is an example of Halved Hybrid Nozzlelism shape that is moving upwards towards the blue line;

FIG. 8A shows one embodiment of a display, showing an illustrative screenshot view which is showing an example of a commercial nozzle that has been cut in half and looks similar to Halved Hybrid Nozzle, as included within certain embodiments of the multidimensional risk analysis systems of FIGS. 1 and 2;

FIG. 9 shows one embodiment of a display, showing an illustrative screenshot view showing several screenshot sections, which together are displaying a Halved Hybrid Nozzlelism phenomenon along with a health risk indicator, as included within certain embodiments of the multidimensional risk analysis systems of FIGS. 1 and 2;

FIG. 10 shows one embodiment of a display, showing an illustrative screenshot view showing several screenshot sections, which together are displaying a colored Candlestick

Spectrum chart showing the bearish effect of Halved Hybrid Nozzlelism along with a health risk indicator, as included within certain embodiments of the multidimensional risk analysis systems of FIGS. 1 and 2;

FIG. 11 shows one embodiment of a display, showing an illustrative screenshot view showing several screenshot sections, displaying a colored Candlestick Spectrum chart showing the bullish effect of Halved Hybrid Nozzlelism along with a health risk indicator, as included within certain embodiments of the multidimensional risk analysis systems of FIGS. 1 and 2;

FIG. 12 shows one embodiment of a display, showing an illustrative screenshot view displaying a colored Candlestick Spectrum chart showing the bullish preparation time, as included within certain embodiments of the multidimensional risk analysis systems of FIGS. 1 and 2;

FIG. 13 shows one embodiment of a display, showing an illustrative screenshot view showing several screenshot sections, displaying a colored Candlestick Spectrum chart showing hybrid confluence along with a health risk indicator, as included within certain embodiments of the multidimensional risk analysis systems of FIGS. 1 and 2;

FIG. 14 shows one embodiment of a display, showing an illustrative screenshot view showing several screenshot sections, displaying a colored Candlestick Spectrum chart showing a closed hybrid zone risk transfer area along with a health risk indicator, as included within certain embodiments of the multidimensional risk analysis systems of FIGS. 1 and 2;

FIG. 15 shows one embodiment of a display, showing an illustrative screenshot view showing several screenshot sections, displaying a colored Candlestick Spectrum chart showing a double open-ended hybrid zone risk transfer area along with health risk indicator as visualized in the shaded area within the blue dotted box, as included within certain embodiments of the multidimensional risk analysis systems of FIGS. 1 and 2;

FIG. 16 shows one embodiment of a display, showing an illustrative screenshot view displaying a colored Candlestick Spectrum chart showing a Bullish Believers Trend Development and Recognition with Hybrid Zone Lines, as included within certain embodiments of the multidimensional risk analysis systems of FIGS. 1 and 2;

FIG. 17 shows one embodiment of a display, showing an illustrative screenshot view displaying a bullish scalp swing setup, as included within certain embodiments of the multidimensional risk analysis systems of FIGS. 1 and 2;

FIG. 18 shows one embodiment of a display, showing an illustrative screenshot view displaying a bearish mega scalp swing setup, as included within certain embodiments of the multidimensional risk analysis systems of FIGS. 1 and 2;

FIG. 19 shows one embodiment of a display, showing a supportive illustrative screenshot view displaying possible positions and exits, with respect to FIG. 18, as included within certain embodiments of the multidimensional risk analysis systems of FIGS. 1 and 2;

FIG. 20 shows one embodiment of a display, showing an illustrative screenshot view displaying a bullish scalp-swing setup based on an open-ended hybrid zone risk transfer area, as included within certain embodiments of the multidimensional risk analysis systems of FIGS. 1 and 2;

FIG. 21 shows one embodiment of a display, showing an illustrative multi-colored legend view displaying scalp-swing components, as ncluded within certain embodiments of the multidimensional risk analysis systems of FIGS. 1 and 2;

FIG. 22 shows one embodiment of a display, showing an illustrative table and graphic representation displaying a sample breakeven analysis for actual percentage equity or margin used, as included within certain embodiments of the multidimensional risk analysis systems of FIGS. 1 and 2;

FIG. 23 shows one embodiment of a display, showing an illustrative risk control table displaying account, capital preservation, trade repair and scalp-swing trading information, as included within certain embodiments of the multidimensional risk analysis systems of FIGS. 1 and 2;

FIG. 24 shows one embodiment of an illustrative control table view that is operationally associated with the table illustrated in FIG. 23, showing an illustrative tabular view displaying quick repair parameters, scalp-swing trading, and broker platform control, as included within certain embodiments of the multidimensional risk analysis systems of FIGS. 1 and 2;

FIG. 25 shows one embodiment of a display, showing an illustrative flow diagram displaying one embodiment of a multidimensional risk analysis method with forecasting capabilities, as performed by certain embodiments of the multidimensional risk analysis systems of FIGS. 1 and 2;

FIG. 26 shows one embodiment of a display, showing an illustrative flow diagram displaying one embodiment of a Halved Hybrid Nozzlelism method with forecasting capabilities, as included within certain embodiments of the multidimensional risk analysis systems of FIGS. 1 and 2;

FIG. 27 shows one embodiment of a display, showing an illustrative flow diagram displaying one embodiment of a scalp-swing or mega scalp-swing method with forecasting capabilities, as included within certain embodiments of the multidimensional risk analysis systems of FIGS. 1 and 2;

FIG. 28 shows one embodiment of a display, showing an illustrative flow diagram displaying one embodiment of a method for using customizable risk control tables, as included within certain embodiments of the multidimensional risk analysis systems of FIGS. 1 and 2; and FIG. 29 shows one embodiment of a display, showing an illustrative flow diagram displaying another embodiment of a multidimensional risk analysis method with forecasting capabilities, as performed by certain embodiments of the multidimensional risk analysis systems of FIGS. 1 and 2.

### DETAILED DESCRIPTION OF THE INVENTION

Certain embodiments of this disclosure relate to providing a system and associated method for improved risk assessment in market trading. More particularly, certain embodiments of this invention relate to providing a specific purpose computer system, which must be a custom built computer system and associated method, for risk assessment from multiple independent risk factors across multiple time frames. Within the financial industry, by trading any market vehicle over a period of time, technicians and economists seek to identify risks as early as possible. However, early pinpoint detection, optimal sequencing, categorization, multi-risk assessment, risk designation, dynamic forecasting, and multi-confirmation of the risks are difficult to detect in real-time (as they happen); this leads to delayed entry, exit, and possibly turns into capital losses in market trades. Further, manual multiple confirmations of risks may delay entries and exits in market trades even further.

A method and/or associated system would be of great use and significance that could reliably identify, assess, recognize, confirm, designate, and forecast risks in real-time, as the risks develop. Further, a system is needed that will identify, confirm, and control the risks in user-desired time frames and at perhaps all stages of a trend, as well as reduce errors associated with trading, by doing portfolio repairs and capital preservation.

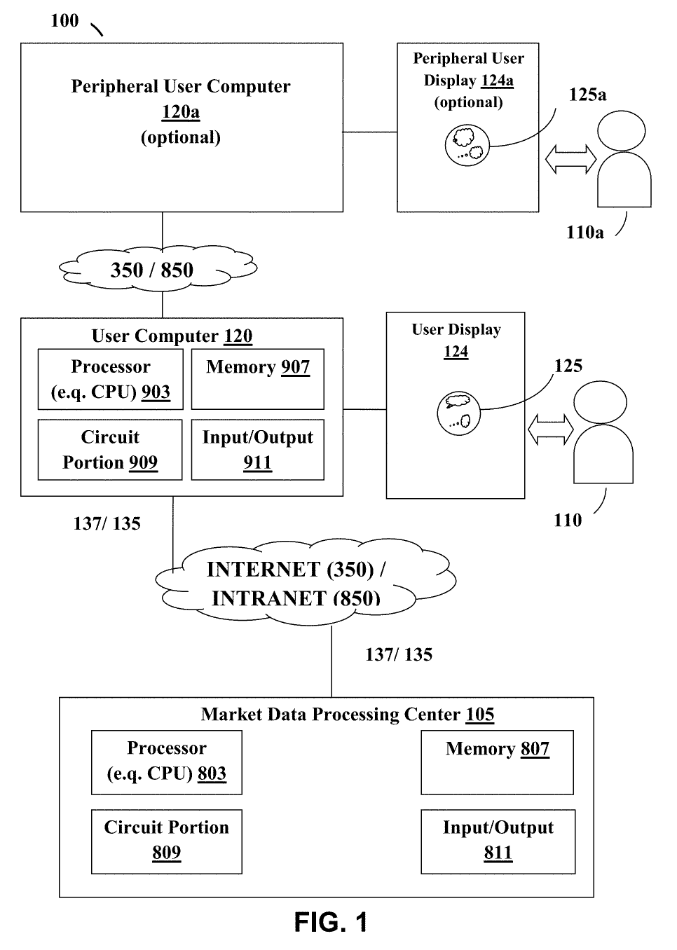

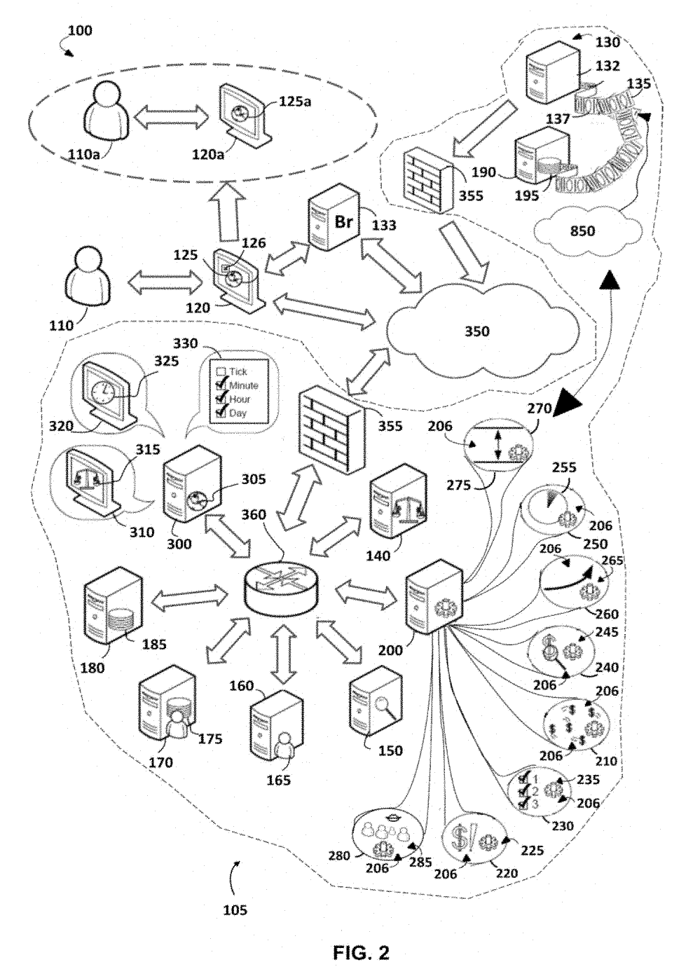

FIGS. 1 and 2 show schematic views, illustrating a number of embodiments of a multidimensional risk analysis systems 100 according to preferred embodiments of the present invention. Certain embodiments of the multidimensional risk analysis systems 100 can be configured to promote what is referred to in this specification as “Bullish Believers”, “Bearish Believers”, or “Neutral Believers”. These terms refer to how a user, or trader, would normally behave provided the information displayed or otherwise received from certain embodiments of the multidimensional risk analysis systems 100. The amount of information, data, colors, shapes, symbols, alphanumeric characters, numbers, etc. that are displayed in certain embodiments of the multidimensional risk analysis systems 100 are considerably more than that of observing traditional trend lines, markets indicators, etc. As such, the additional information is likely to clue a user or trader (whether experienced or not) as to what is likely to be a smart trade, or not. As such, with input as provided by certain embodiments of the multidimensional risk analysis systems 100, certain Bullish Believers are more likely to exhibit “Bullish Believeness”, and thereupon are more likely to make better and smarter decisions based on the provided information. By comparison, with input as provided by certain embodiments of the multidimensional risk analysis systems 100, certain Bearish Believers are more likely to exhibit “Bearish Believeness”, and thereupon are less likely to make poor decisions based on the provided information. By comparison, with input as provided by certain embodiments of the multidimensional risk analysis systems 100, certain Neutral Believers are more likely to exhibit “Neutral Believeness”, and thereupon are less likely to make poor decisions based on the provided information.

Traders with little or considerable experience could likely utilize certain embodiments of the multidimensional risk analysis systems 100 to likely participate to make better or smarter forecasts based on the resulting output. Such unskilled or untrained users could quickly learn to recognize a variety of embodiments of the symbols, shapes, levels, colors, alphabetic or numerical characters, recognizable distinguishable patterns, pinpoint entries and exits, risk recognition as it develops, or other visual and sound effects, etc. that might be expected to develop in real time on graphical user displays, or other displays, of certain embodiments of the multidimensional risk analysis systems 100. As such, skilled or long experienced traders may not necessarily hold the major advantage in success over relative trading neophytes that they are now likely to do. Using certain embodiments of the multidimensional risk analysis systems 100 might allow either skilled or unskilled traders or users to make their trading or financial market decisions with an increased probability of success with fewer traditional technical analysis skills, they too will be more likely to make the right choice to support those financial vehicles that show promise statistically, instead of picking stocks or other financial vehicles based on feel, gambling, or name recognition, etc.

A variety of embodiments of graphical user interfaces that can show the multidimensional risk analysis systems 100 are described with respect to a variety of illustrations and Figures within this disclosure. These illustrations are intended to be illustrative in nature but not limiting in scope, and do not include all potential symbols, colors, shapes, alphanumeric characters, etc. As such, one skilled in the art would well recognize how to provide a variety of similar embodiments of the multidimensional risk analysis systems 100, such as by changing shapes, patterns, colors, symbols, alphanumeric characters, etc., and such appearance but not substantial changes are within the intended scope of the present invention as described according to the present claims, drawings, and specification.

With multidimensional risk analysis systems 100, those financial Market Vehicles that show true promise will likely thereby be supported by increasing purchases and trades, and those that do not will not be as strongly supported. As such, the widespread use of certain embodiments of the multidimensional risk analysis systems 100 will help promote Bullish Believers to promote those financial vehicles that traders or users would be most benefitted by Bullish Believeness. By comparison, the widespread use of certain embodiments of the multidimensional risk analysis systems 100 will help promote Bearish Believers to stay away from those financial vehicles that traders or users would be least benefitted by Bearish Believeness. Additionally, the widespread use of certain embodiments of the multidimensional risk analysis systems 100 will help promote Neutral Believers to display neutral behavior relative to those financial vehicles that traders or users would be mutually benefitted by both bearish and Bullish Believeness. As such, purchasing and selling stocks and other financial vehicles will likely become more based upon real time merit of risk dimensions, where such risk dimensions might be either characterized as good risk dimensions as well as bad risk dimensions.

To recognize and calculate such Bullish Believeness, Neutral Believeness, and/or Bearish Believeness suitably, a number of embodiments of the multidimensional risk analysis systems 100 are now described that can range from operating on relatively complex networks such as the Internet or intranets to operating on much simpler computer systems. Certain embodiments of the multidimensional risk analysis systems 100 can thus be configured as a networked system such as running a number of distinctly interacting computers and processes. By comparison, certain embodiments of the multidimensional risk analysis systems 100 can be configured as a stand-alone computer such as a laptop computer, server, slate, or tablet computer, etc. that can also be running a number of distinct processes. FIGS. 1 and 2, in particular, show a variety of embodiments of network and/or Internet-based methods for obtaining market data 137.

Certain embodiments of multidimensional risk analysis systems 100, as described with respect to FIG. 2, may comprise at least one market-data processing center 105 that operationally includes at least one market-feed database server 190. Market-feed database server 190 preferably comprises at least one market-feed database 195. Market-feed database server 190 preferably receives at least one market data feed 135, from at least one market feed provider 130, preferably by communicating with at least one market feed server 132. In certain instances, market data feed 135 preferably comprises market data 137, relating generally to trade and financial markets. Market data 137 is preferably stored in market-feed database 195. Those skilled will understand that there are other evolving or alternate configurations that may provide market data, such as, for example, direct connection, website extraction, etc.

Certain embodiments of the market data processing center 105 are described with respect to FIG. 1 embodiment, and can include, depending on context, a process provider 803 such as a processor, computer, server, or plurality thereof that can run one or a number of processes. Certain embodiments of the market data processing center 105 can also include a memory 807, a circuit or circuit portion 809, and an input output interface (I/O) 811 that include a bus (not shown). Embodiments of the market data processing center 105 include and/or is a portion of a server, and must include a specific-purpose computer, a microprocessor, a microcontroller, a personal display assistant (PDA), a cellular phone, a wireless communicating device, a hard-wired communication device, and/or any other known suitable type of communications device or phone, computer, and/or controller that are be implemented in hardware, software, electromechanical devices, and/or firmware.

Certain embodiments of the processor 803 can alternately run one or a number of processes depending upon design or users choices, as described with respect to FIG. 1, and can perform the processing and arithmetic operations for certain embodiments of the market data processing center 105. Certain embodiments of the market data processing center 105 can control the signal processing, database querying and response, computational, timing, data transfer, and other processes associated with multidimensional risk analysis systems 100 such as can be adjusted by and/or controlled by certain embodiments of the market data processing center 105.

Certain embodiments of the memory 807 of the market data processing center 105 can include a random-access memory (RAM) and/or read only memory (ROM) that together can store the computer programs, operands, and other parameters that control the operation of certain embodiments of market data processing center 105. The memory 807 can be configurable to contain data, financial information, market feed data, images, visualizations, image information, etc.

that can be obtained, retained, or captured by that particular financial system, as described in this disclosure.

In the embodiment of FIG.1, certain embodiments of the bus can be configurable to provide for digital information transmissions between the processor 803 that can run one or a number of processes, circuits 809, memory 807, I/O 811, to perform the operation of the multidimensional risk analysis systems 100 (which is integrated or removable). In this disclosure, the memory 807 can be configurable as RAM, ROM, flash memory, semiconductor-based memory, of any other type of memory that can be configurable to store data pertaining to the multidimensional risk analysis systems 100. Certain embodiments of the bus can also connect I/O 811 to the portions of certain embodiments of the market data processing center 105 of the multidimensional risk analysis systems 100 that can either receive digital, analog, and/or mixed information from, or transmit digital, analog, and/or mixed information to other portions of the multidimensional risk analysis systems 100, or other systems and/or networking components associated therewith.

Certain embodiments of the market data processing center 105 of the FIGS. 1 and 2 embodiment are configured to communicate via Internet/Intranet, wired-connection, wireless connection, optical media, or any other communication media to provide one way or two way communications to a user computer(s) 120. To provide a user interaction with the market data processing center 105, certain embodiments of the user computer 120, a user display 124, and a user 110, together comprise a variety of embodiments of a client/user interface 125. Different embodiments of the client/user interface 125 can occur directly with the market data processing center 105, or alternately are configured as a peripheral/user/client interface 125a. In this disclosure, the suffix “a” applies to structurally similar or identical components of the peripheral client/user interface 125a as compared to the client/user interface 125. As such, the following descriptions that pertain to computer operations of the client/user interface 125 pertain identically to the peripheral client/user interface 125a. It might be envisioned, for example, that a service provider might utilize their client/user interface 125 to provide requested data, financial information, etc. to the peripheral client/user interface 125a. Certain embodiments of the user computer 120 comprised within the client/user interface 125 are now described.

As described with respect to both FIGS. 1 and 2, there are two users illustrated generally by 110 and 110a that are each associated with their respective user computers 120 and 120a. User 110 is considered a primary user, while user 110a is referred to as a projected or peripheral user. As such, with the proper authorization from the technology providers, the user computer 120 provides the associated information to the user display 124 that is viewed by the user 110. In certain instances, at least some information, data, etc. is controllably projected to the peripheral user computer 120a, which in turn can be displayed via the peripheral user display 124a to the peripheral user 110a. In this manner, a projection interface is established between the user computer 120 and the peripheral user computer 120a that is either direct or via networked connection such as the Internet 350 or Intranet 850 are generally understood in the art.

Certain embodiments of the user computer 120 are described with respect to FIG. 1, and must include a processor 903 such as a central processing unit (CPU), computers, workstations, servers, handhelds, wireless devices, a specific purpose computer/s, or a plurality thereof, that can run one or a number of processes. Certain embodiments of the market user computer 120 also include a memory 907, a circuit or circuit portion 909, and an input output interface (I/O) 911 that also include a bus (not shown).

Certain embodiments of the user computer 120 can include and/or be a portion of a server, a workstation, a mainframe, a specific-purpose computer, a microprocessor, a microcontroller, a personal display assistant (PDA), a cellular phone, a wireless communicating device, a hard-wired communication device, and/or any other known suitable type of communications device or phone, computer, and/or controller that can be implemented in hardware, software, electromechanical devices, and/or firmware. Certain embodiments of the processor 903 that can alternately run one or a number of processes depending upon design or user choices, as described with respect to FIG. 1, can perform the processing and arithmetic operations for certain embodiments of the user computer 120. Certain embodiments of the user computer 120 can control the signal processing, database querying and response, computational, timing, data transfer, and other processes associated with the client/user interface 125.

Certain embodiments of the memory 907 of the user computer 120 can include a random-access memory (RAM) and/or read only memory (ROM) that together can store the computer programs, operands, and other parameters that control the operation of certain embodiments of user computer 120.

The memory 907 can be configurable to contain data, financial information, market feed data, images, visualizations, image information, etc. that can be obtained, retained, or captured by that particular financial system, as described in this disclosure, but can also include other types of data, information, images/programs, such as are typically known to be stored in memories of user computers.

Certain embodiments of the bus can be configurable to provide for digital information transmissions between the processor 903 that can run one or a number of processes, circuits 909, memory 907, I/O 911, to perform the operation of the client/user interface 125 (which is integrated or removable). In this disclosure, the memory 907 of FIG. 1 can be configurable as RAM, ROM, flash memory, semiconductor-based memory, of any other type of memory that can be configurable to store data pertaining to the client/user interface 125. Certain embodiments of the bus can also connect I/O 911 to the portions of certain embodiments of the user computer 120 of the client/user interface 125 that can either receive digital, analog, and/or mixed information from, or transmit digital, analog, and/or mixed information to other portions of the client/user interface 125, or other systems and/or networking components associated therewith.

Because of the complexity of the processor computations associated with the calculations involving the number of multiple risk dimensions and sub categories of various risks, number of symbols, number of colors, and number of alphanumeric characters required per time frame (tick data to any higher time frame), user may require a very powerful or additional processor associated with the processor 903. The complexity and capabilities of the processor 903 should thereby be in similar scope to that provided by the market data processing center 105.

The FIG. 2 embodiment of the multidimensional risk analysis systems 100 is now described in further detail. Certain embodiments of the communication between the client/user interface 125 and the market data processing center 105 can be accomplished via certain embodiments of the market-feed database server 190 in combination with the market feed provider 130 and market feed server 132. This communication at least partially embodies at least one market feed computer process that might be configured to process at least one real time market feed to determine real-time market data; and at least embodying herein processing at least one real-time market feed to determine real-time market data. At least one real time market feed to determine real-time market data preferably is conducted through at least one network, preferably the Internet 350 or intranet 850.

At least one firewall 355 can effect secure communication with Internet 350, preferably to prevent unsanctioned access to market-data processing center 105. Under appropriate circumstances, considering such issues as future technologies, costs, etc., other communication securing methods, such as, for example, encryption, security gateways, etc., may suffice.

Communication within market-data processing center 105 is preferably handled through at least one communications router 360. Upon reading the teachings of this specification, considering such issues as future technologies, cost, etc., other communications devices, such as, for example, direct connections, wireless connections, etc., is used.

Certain embodiments of the market-data processing center 105 preferably comprises at least one programmable market data software, such as, for example, Thomson-Reuters Metastock® Pro (available from Equis.com), E-Signal®, TradeStation®, or Bloomberg®. The multidimensional risk analysis systems 100 is utilized as a plug-in or as an add-on to such programmable market data software, preferably Thomson-Reuters Metastock® Pro software. Such aforementioned financial software companies have given access to strategy creation, indicator building, system test creating, explorers, alerts, or built customized indicators, symbols, experts and they are an integral part of their software with limited or open access for writing logics without learning such computer programming languages such as C++ or Visual Basic, or others. These technologies are available from Thomson-Reuters, E-Signal®, or TradeStation® or similar software companies that would enable one skilled in the art to accomplish the invention without undue burden or efforts to create similar systems The available language from Thomson-Reuters' MetaStock® is called Formula Primer, for TradeStation® it is called EasyLanguage® and for E-Signal® it is called eSignal Formula Script. There is support available and many companies provide help to write any logics or custom indicators, etc. with or without charge, whichever is the company's policy. Market-data processing center 105, as shown in FIG. 2, preferably further comprises at least one risk processor 200, preferably at least one risk assessor 140, preferably at least one risk analyzer 150, and preferably at least one history database server 180.

Certain embodiments of a risk processor 200 (at least embodying herein at least one risk factor computer processor, can be structured and arranged to automatically calculate current values of each of a plurality of market risk factors from such real-time market data; and at least embodying herein automatically calculating current values of each of a plurality of market risk factors from such real-time market data) preferably processes market data 137. This preferably identifies portions of market data 137 related to at least one market risk 206. In discussing “market risk” herein, applicant is generally referring to the particular risks of performing a particular trade at a particular time. Risk analyzer 150, at least partially embodying herein at least one analysis computer processor configured to real-time analyze at least one combination of such market risk factors to quantify at least one market risk.

This at least partially embodies real-time analyzing of at least one combination of such market risk factors to quantify at least one market risk) preferably analyzes the identified portions of market data 137, preferably identifying risk attributes, preferably direction and severity, of market risk 206. Risk processor 200 and risk analyzer 150 preferably both operate in real-time (as, for example, market data 137 is received by market-feed database server), and process and analyze, respectively, preferably in multiple time frames 325. Upon reading the teachings of this specification, those skilled in the art will now appreciate that, under appropriate circumstances, considering such issues as future technologies, costs, resources, etc., other risk attribute identifications may suffice.

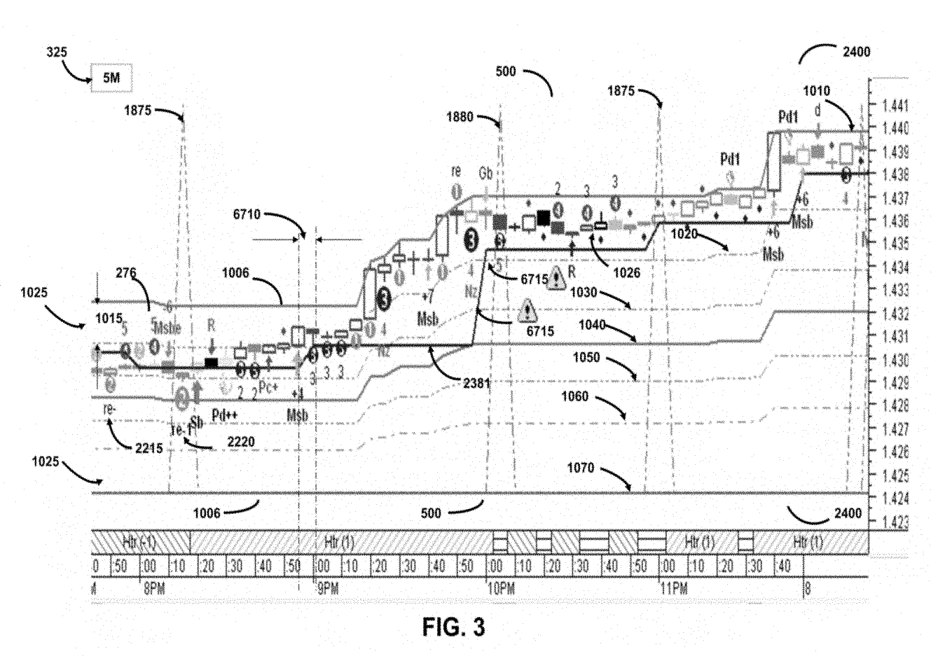

Certain embodiments of the risk assessor 140, at least embodying herein at least one risk assessing computer processor configured to assess relevance of each quantity of a plurality of such at least one market risks to determine when to display at least one risk indicator. This can also assess the relevance of each quantity of a plurality of such at least one market risks to determine when to display at least one risk indicator) preferably creating at least one risk assessment 315, preferably comprising at least one evaluation of at least one risk factor determining whether at least one level of risk is reached, preferably triggering at least one display of the at least one level of risk, preferably comprising at least one indicator 500 (see FIG. 3 through FIG. 24). Certain embodiments of the indicator 500 preferably indicate the identified direction and severity of market risk 206.

Risk assessment 315 of FIG. 2 can preferably comprise indicators 500 from multiple market risks 206, preferably in multiple time-frames 325, at least embodying herein at least one timeframe computer processor configured to calculate each of such plurality of market risk factors relating to each of a plurality of time frames ending at about current real-time; and at least embodying herein calculating each of such plurality of market risk factors relating to each of a plurality of time frames ending at about current real-time. The timing of the indicators 500 preferably end at about current time. Upon reading the teachings of this specification, there might be a variety of embodiments of other risk assessments, such as, for example, market vehicle interrelationship risks, common industry risks, company relationship risks, etc.

Certain embodiments of a history database server 180 preferably comprise at least one history database 185. Such a history database 185 can preferably store results from risk processor 200 and risk analyzer 150. In certain instances, risk assessor 140 preferably accesses history database 185, preferably to include indicators 500, referencing market risks 206 previously identified, in risk assessment 315. Upon reading the teachings of this specification, those skilled in the art will now appreciate that, under appropriate circumstances, considering such issues as future technologies, costs, etc., other data history storage, such as, for example, rotating buffers, flat files, period specific reports, etc., may suffice to provide the at least one history database 185.

Certain embodiments of market-data processing center 105 preferably further comprises at least one user server 160, at least one user database server 170, and at least one user interface server 300. At least one user 110 preferably may utilize user server 160, user database server 170 and user interface server 300 to interact with market-data processing center 105. Certain embodiments of user interface server 300 preferably provides at least one user interface 305 for use by user 110. User interface 305 preferably comprises at least one risk assessment, recognition, confirmation, designation, forecasting or identification display 310, at least one time frame display 320 and at least one display preference interface 330. Display preference interface 330 preferably allows user 110 to set preferences for display of time frames 325 and risk assessments 315.

Within this disclosure, certain embodiments of the risk analyzer 150, as described relative to FIG. 2, have the capabilities of performing such operations as risk analyzing, identifying, recognition, confirmation, designation, or forecasting. As such, the at least one risk analyzing, identifying, recognition, confirmation, designation, or forecasting display 310 displays to a user a displayed image that has undergone such operations as risk analyzing, identifying, recognition, confirmation, designation, or forecasting. In the FIG. 1 embodiment, for example, such risk analyzing, identifying, recognition, confirmation, designation, or forecasting operations can be performed within the market data processing center 105. Those skilled in the art would understand that such risk analyzing, identifying, recognition, confirmation, designation, or forecasting operations can be performed in a variety of stand-alone or networked configurations.

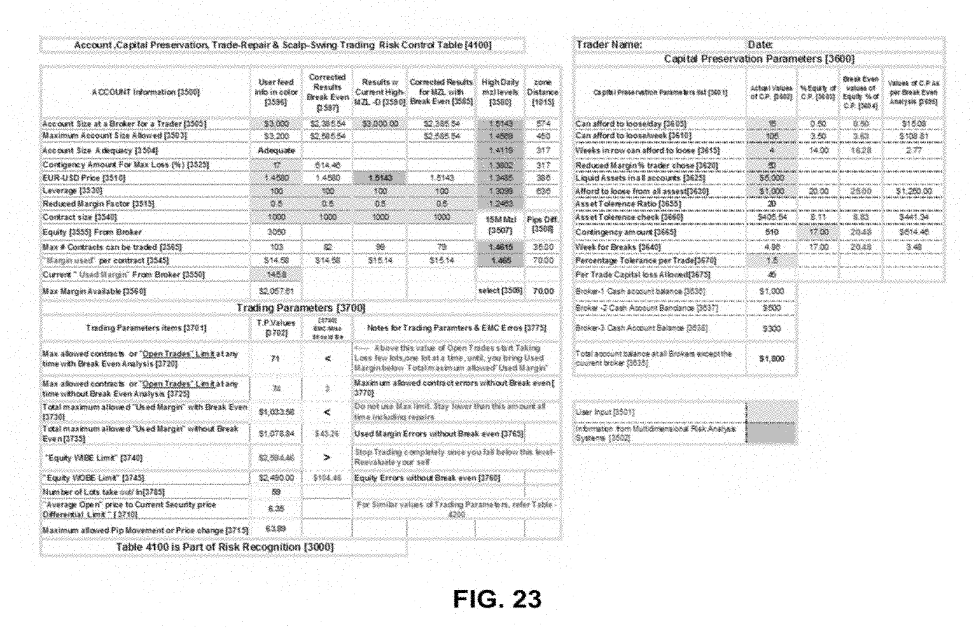

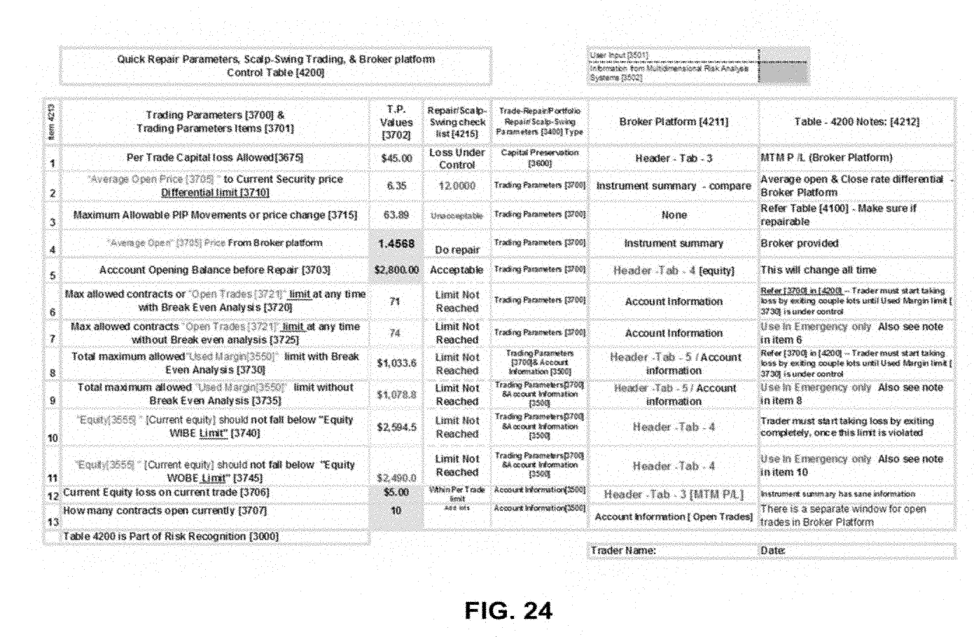

Certain embodiments of user 110 preferably uses at least one user computer 120, preferably having at least one client user interface 125, preferably a web browser, to connect to user interface 305 of FIG. 2. A user or trader uses at least one spreadsheet and/ or database program such as Microsoft Excel® 126, and has an interface with Broker server 133 in order to calculate a risk table 4100 (FIG. 23) and/or 4200 (FIG. 24). Upon reading the teachings of this specification, other software architectures, such as, for example, client server applications, stand-alone applications, etc., are used.

Certain embodiments of one risk assessment, recognition, confirmation, designation, forecasting or identification display 310 (at least embodying herein at least one risk indicator computer display structured and arranged to display such at least one risk indicator; and at least embodying herein displaying such at least one risk indicator) and time frame display 320 preferably display risk assessment 315 and time frames 325, respectively, to user 110. Risk assessment, recognition, confirmation, designation, forecasting or identification display 310 preferably also displays at least some of the results from risk processor 200 (at least embodying herein at least one risk factor computer display can be structured and arranged to display at least some of such current values of such plurality of market risk factors; and at least embodying herein displaying at least some of such current values of such plurality of market risk factors).

Certain embodiments of the risk assessment, recognition, confirmation, designation, forecasting or identification display 310 and at least one time frame display 320 are preferably combined for comparison by user 110. There might be a variety of embodiments of processed data distribution methods, such as might use email alerts, outbound data feeds, instant messages, text messages, etc.

Certain embodiments of user server 160 preferably controls authentication to market-data processing center 105 preferably using at least one user account 165. User 110, having user account 165, may login to market-data processing center 105, using at least one username and password combination, through user server 160. Upon reading the teachings of this specification, those skilled in the art will now appreciate that, under appropriate circumstances, considering such issues as cost, future technologies, etc., other authentication methods, such as may use key-code, file authenticators, etc.

Certain embodiments of user database server 170 may comprise at least one user database 175. User database 175 preferably stores information for user account 165, including the preferences set by user 110 with display preference interface 330. There might be a variety of embodiments of other data storage methods, such as, for example, flat files, client-side storage, etc.

Certain embodiments of risk processor 200 preferably comprises at least one internal market moving risk processor 210, at least one economic event risk processor 220, at least one multiple conditions risk processor 230, at least one price perception risk processor 240, at least one time duration risk processor 250, at least one trend risk processor 260, at least one zone range risk processor 270 and. at least one family and characteristic risk processor 280.

User may select a combination of at least some of the described risk processors; alternately preferably, each other combination of at least some of the described risk processors. There are a variety of embodiments of risk processors, such as, for example, economic event risk processors, news-feed risk processors, industry-family risk processors, company-family risk processors, etc. Those skilled in the art will now appreciate that, under appropriate circumstances, considering such issues as future market influences, future technologies, available data, etc.

In use, certain embodiments of multidimensional risk analysis systems 100 can provide, in risk assessment 315 of FIG. 2, a representation of the travel of current market vehicle prices while demonstrating various market risks 206 in a multi-dimensional risk spectrum. Risk assessment 315 also preferably presents multiple confirmations of market risks 206, preferably in multiple time frames 325. Certain embodiments of the market data processing center 105, each market risk 206 has preferably no direct dependence on other market risks 206; while ideally this non-dependence is complete, market risks 206 may have indirect influences on one another. Movement of any market vehicle can be independently subject to various risk dimensions (market risks 206) that the applicant categorizes in eight major dimensions (eight market risks 206), namely: Vertical Risk Dimension (zone range risk 275 or Hybrid zone range risk 276); Horizontal Time Risk (time duration risk 255); Trend Health Risk 265; Dynamic Sectional Price Risk (price perception risk 245); Sudden Market Spot Change Risk (internal market moving risk 215); Special Conditional Risk (multiple conditions risk 235); Fundamental Risk (economic event risk 225) and family and characteristic risk 285.

Certain embodiments of zone range risk processor 270, at least herein embodies wherein said at least one risk factor computer processor comprises at least one bounded range risk computer processor structured and arranged to automatically calculate current values of at least one historic value range boundary risk factor. Certain embodiments of zone range risk processor 270 can at least partially embody herein wherein such step of automatically calculates current values of each of a plurality of market risk factors comprises the step of automatically calculating current values of at least one historic value range boundary risk factor that can preferably processes zone range risk 275 and/or Hybrid dynamic zone risk 276.

Certain embodiments of time duration risk processor 250 (at least herein embodying wherein said at least one risk factor computer processor comprises at least one time-duration risk computer processor configured to automatically calculate current values of at least one time-duration risk factor; and at least herein embodying wherein such step of automatically calculating current values of each of a plurality of market risk factors comprises the step of automatically calculating current values of at least one time-duration risk factor) preferably processes time duration risk 255.

Certain embodiments of trend risk processor 260 at least herein embodying wherein said at least one risk factor computer processor comprises at least one Trend Health Risk computer processor configured to automatically calculate current values of at least one Trend Health Risk factor. This at least partially herein embodies wherein such step of automatically calculating current values of each of a plurality of market risk factors comprises the step of automatically calculating current values of at least one Trend Health Risk factor that can preferably at least partially process Trend Health Risks 265.

Certain embodiments of price perception risk processor 240 at least herein embodying wherein said at least one risk factor computer processor comprises at least one price-perception risk computer processor structured and arranged to automatically calculate current values of at least one price-perception risk factor; and at least herein embodying wherein such step of automatically calculating current values of each of a plurality of market risk factors comprises the step of automatically calculating current values of at least one price-perception risk factor, and also thereby preferably processes price perception risk 245.

Certain embodiments of the risk processor 200 preferably independently process each market risk 206. Consequently, internal market moving risk processor 210 (at least herein embodying wherein said at least one risk factor computer processor comprises at least one internal-market-movement risk computer processor structured and arranged to automatically calculate current values of at least one internal-market-movement risk factor; and at least herein embodying wherein such step of automatically calculating current values of each of a plurality of market risk factors comprises the step of automatically calculating current values of at least one internal-market-movement risk factor) preferably processes internal market moving risk 215.

Certain embodiments of multiple conditions risk processor 230 (at least herein embodying wherein said at least one risk factor computer processor comprises at least one multiple-conditions risk computer processor structured and arranged to automatically calculate current values of at least one multiple condition risk factor; and at least herein embodying wherein such step of automatically calculating current values of each of a plurality of market risk factors comprises the step of automatically calculating current values of at least one multiple condition risk factor) preferably processes multiple conditions risk 235.

Certain embodiments of economic event risk processor 220 (at least herein embodying wherein said at least one risk factor computer processor comprises economic-event risk computer processor structured and arranged to automatically calculate current values of at least one economic-event risk factor; and at least herein embodying wherein such step of automatically calculating current values of each of a plurality of market risk factors comprises the step of automatically calculating current values of at least one economic-event risk factor) preferably processes economic event risk 225. Certain embodiments of family and characteristic risk processor 280 (at least herein embodying wherein said at least one risk factor computer processor comprises at least one family and characteristic risk computer processor configured to automatically calculate current values of at least one family and characteristic risk factor. Certain embodiments of the family and characteristic risk processor 280 can at least partially herein embody wherein such step of automatically calculating current values of each of a plurality of market risk factors comprises the step of automatically calculating current values of at least one family and characteristic risk factor such as to preferably processes family and characteristic risk 285.

FIG. 3 shows one embodiment of a display, showing an illustrative screenshot view which is displaying a Vertical Risk Dimension, as included within certain embodiments of the multidimensional risk analysis systems 100 of FIGS. 1 and 2. In the Hybrid Vertical Risk Dimension, hybrid zone range risk 276, indicators 500 preferably comprise at least two Dynamic Zone Lines 1006, preferably at least seven Dynamic Zone Lines 1006 based on a lower time frame 325, for example 5 minutes, and at least one dynamically calculated mid pivot line 2381 (Blue Line or FXTA mid pivot or any user desired pivot type) of a higher time frame 325, for example 60 minutes, which is scheduled to change over predetermined size of higher time frame 325, for example 60 minutes, as illustrated within FIG. 3.

As such, this indicator comprises of at least seven Dynamic Zone Lines 1006, based on a lower time frame 325, such as 5 minutes, and at least one dynamically calculated mid pivot line 2381 of a higher time frame 325, for example 60 minutes, which is scheduled to change over predetermined size of higher time frame 325, for example 60 minutes, which is referred to as Hybrid Dynamic Zone Lines (8)—59—L 1006.

Upon reading the teachings of this specification, those skilled in the art will now appreciate that, under appropriate circumstances, considering such issues as cost, market dynamics, future statistical methods, etc. Other dynamic zone line quantities are used, such as, for example, nine, twelve, twenty, and other dynamically changing pivot lines such as daily, weekly, monthly etc. Vertical distances (illustrated by distance 1015) between any two zone lines 1006 preferably comprises at least one risk zone 1025. However, one risk zone 1025 comprises of at least one Blue Line 2381, which is referred to as hybrid dynamic risk zone 1026. It is further understood that such vertical distances have dynamic distances and may not always be equal to the values of the other zones. Dynamic Zone Lines are adaptive, horizontal, flexible lines that may dynamically travel, dynamically travel independently of one another and have forecasting capabilities, allowing the possible indication of a possible change within the near future.

In Hybrid Dynamic Zone Lines (8)—59—L, eight Hybrid Dynamic Zone Lines 1006 are created with the use of seven zone lines (1010, 1020, 1030, 1040, 1050, 1060, and 1070), comprising of higher high values and lower low values over a period of time for any market vehicle and is interjected with one specially designed dynamically changing, over a designated period, Blue Line 2381.

These interjections are designated as hybrid dynamic zone levels. Thereupon, such concept of hybrid dynamic risk zones 1026 tend to reduce reliance upon the traditional use of pivots and Fibonacci levels and their limitations in trading. In addition, Hybrid Dynamic Zone Lines 1006 tend to reduce the use of such two indicators separately and produces a better dynamic tool for traders or users. It is understood that there has been great confusion for traders or users as to selecting which highs or lows in applying Fib levels and applicant's herein described embodiment eliminates that confusion. Applicant's embodiment preferably permits designing Hybrid Dynamic Zone Lines 1006 using different time periods which are provided to indicate higher high values and lower low values. In this exemplary, as such illustrated, is the possible travel of current prices through various Hybrid Dynamic Zone Lines (8)—59—S, for shorter duration, or Hybrid dynamic zones 1026, along with Applicant's dynamic multi-colored candle collection and various dimensional risks, which creates a multi-dimensional risk spectrum 2400. It is further understood that Hybrid Dynamic Zone Lines 1006 are designed for medium duration designated with hybrid zone lines (9)—D—M (“9” Indicates: seven zone lines and two Blue Lines), which is based on daily and weekly Blue Line 2381 and the combination of seven zone lines; alternately a long-term duration is designed by hybrid zone lines (10)—D—L (“10” indicates: seven zone lines and three Blue Lines) , which is based on daily, weekly and monthly, Blue Line 2381 and the combination of seven zone lines. It is also understood that a super long duration is designated by hybrid zone lines (10)—W—SL , which is based on weekly, monthly and yearly Blue Line 2381 with the combination of seven zone lines, as per choice of user. Separate indicators 500 are preferably designed for each type of choice. In certain configurations, Hybrid Dynamic Zone Lines 1006 preferably comprises zone line 1010, zone line 1020, zone line 1030, zone line 1040, zone line 1050, zone line 1060, zone line 1070 and Blue Line 2381, preferably determined in a statistical manner, preferably by applying a Fibonacci analysis and pivot levels. In consideration of traditional financial or market factors such as Fibonacci (Fib) levels, pivot levels or combination of both or some specialty levels, it is possible by mathematical formula, to derive Hybrid Dynamic Zone Lines 1006. In other words, the new methodology for Dimension #1 (zone range risk 275 or hybrid zone range risk 276) is flexible and adaptable to existing methods for a smooth transition in future.

Upon reading the teachings of this specification, those skilled in the art will now appreciate that, under appropriate Circumstances other quantities of Dynamic Zone Lines may suffice, considering such issues as desired accuracy, future technologies, cost, etc.

In certain configurations, a market vehicle comprises hybrid zone range risk 276 which may follow an upward or downward movement, when compared to a reference point, over a period of time. Preferably, hybrid zone range risk 276 moves dynamically as market conditions change and is divided into multiple zones by Hybrid Dynamic Zone Lines 1006, depending upon the accuracy required. Hybrid zone range risk 276 preferably is contained between an upper zone line 1010 and a lower zone line 1070. Hybrid zone range risk 276 thereby preferably is dynamically adjusted, most likely indicating that market conditions are likely to change. With respect to the illustrative display in FIG. 3, it is evident that in hybrid risk zone 1026, due to the Blue Line 2381 and its scheduled event of showing the dynamic change at every 60 minute, using Hybrid zone lines (8)—59—L (1006), at approximately 8:55 pm, the Blue Line was observed to be shifting to the upside constituting an upward movement of market vehicle prices above zone line 1020. Blue Line 2381 partially contributes to the risk of Bearish Believers when zone lines 1020 and 1030 remain parallel during such process. Showing the dynamic changes occurring during the preselected time frame period, as for example 60 minutes, in Blue Line 2381, within the last segment of lower time frame period of Hybrid Dynamic Zone Lines 1006 at the completion of preselected time period of Blue Line 2381 is referred to as Scheduled Event of Blue Line 6710. As such, it may repeat itself at the end of preselected time period of Blue Line 2381 and contributes to the dynamic risks in trading.

In certain instances, formation of multiple scheduled events of Blue Line 6710 and continuous scheduled intersection 6715 with zone lines 1006, in one direction, constitutes steps in shape, which further serves as an indication of trend development. Multiple intersections of the Blue Line 6715 with multiple zone lines 1006 serves as a confirmation of a previously strong trend.

In certain other instances, hybrid zone range risk 276 preferably identifies the risk associated with any market vehicle, by determining its location between its highest recent position and its lowest position, preferably over designated periods, preferably in a dynamic motion. Hybrid zone range risk 276 preferably is subdivided into two or more major dynamic zones lines 1006, as shown, for recent activities. Upon reading the teachings of this specification, those skilled in the art will now appreciate that, under appropriate circumstances, considering such issues as forecastive beliefs, cost, etc., other zone lines, such as, for example, higher zone lines, lower zone lines, subdividing zone lines, etc.

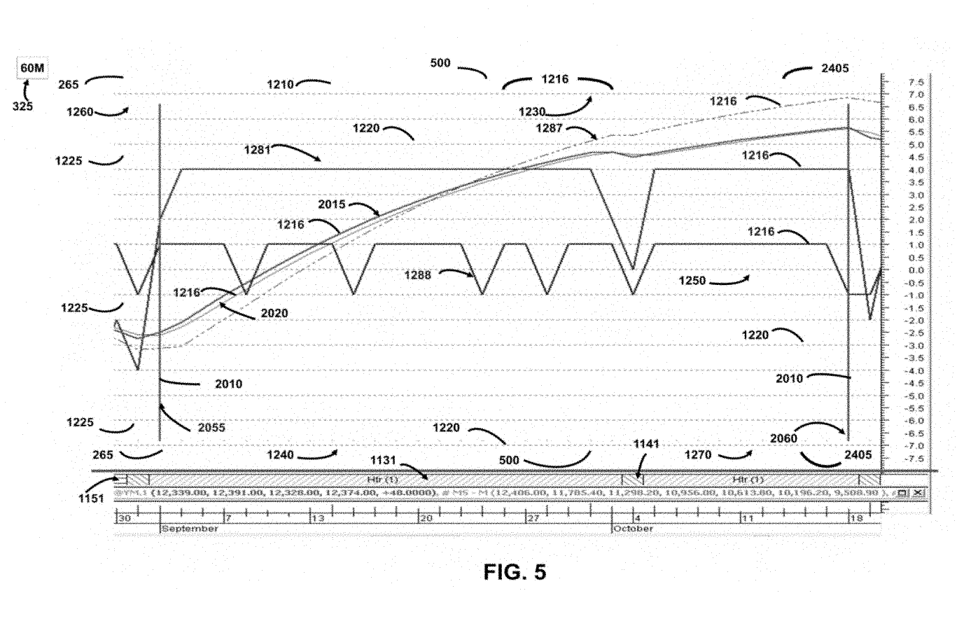

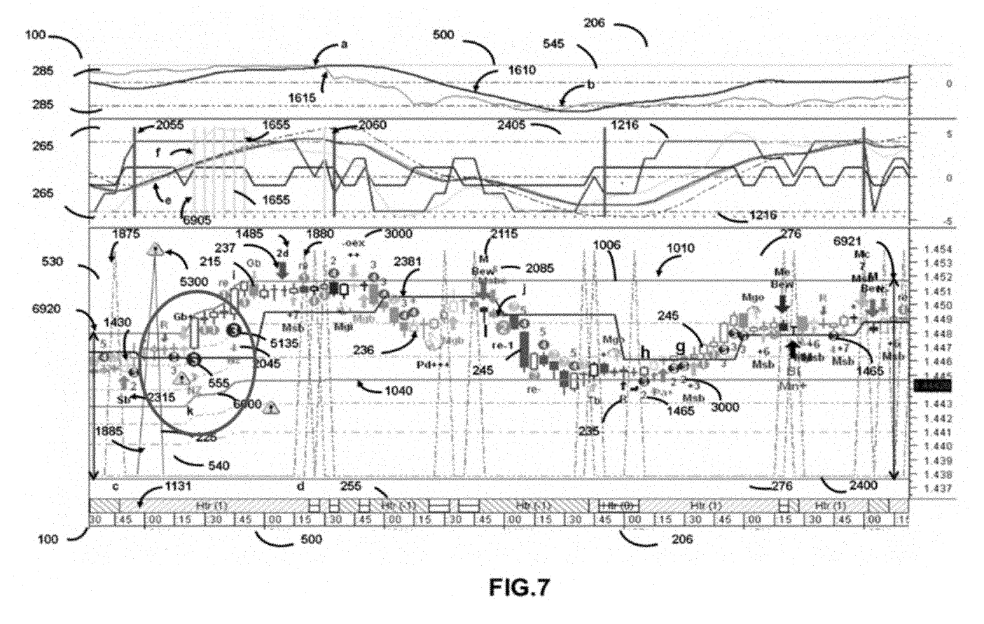

In certain instance, hybrid zone range risk 275 or dynamic zone range risk 276 areas comprise of either a dotted or solid triangle shaped object, of user choice, which can be externally injected, and is referred to as a spike in trading, for either a Bullish Believer's entries, Bearish Believer entries, or Neutral Believers entries, based on modified health indicator 1216. With respect to FIG. 3, certain embodiments are designed for bear entry spike 1880, which are understood as Spikes that depend on multiple market risks or are directional Spikes, based on forward looking intersection of Bearish Believers directional indicator component 2020 (FIG. 5) and Bullish Believers directional indicator component 2015 (FIG. 5) of health window 2405 (FIG. 7) to create such shape. There are certain types of bearish entry Spikes, which include, but are not limiting scope to, pre-entry Spikes for bears using multiple market risks, bear entry spike (directional), and entry Spikes for bears using multiple market risks. Certain embodiments are designed for bullish entry spike 1875, which can be understood as Spikes that depend on multiple market risks or are directional Spikes, based on forward looking intersection of Bullish Believers directional indicator component 2015 and Bearish Believers directional indicator component 2020 of health window to create such shape by using Thomson-Reuters Metastock® Pro software, E-Signal®, TradeStation®, or similar financial software. There are certain types of bullish entry Spikes, which include, but not limiting scope to, pre-entry Spikes for bulls using multiple market risks, bull entry spike (directional), and entry Spikes for bulls using multiple market risks.

In certain additional instances, the dynamic changes on any zone line 1006 indicates possible changes in the near future, which may further serve as an indication of lower prices or higher prices for a market vehicle, depending upon the direction of the change. It is understood that a key indication is that one of either uppermost zone line 1010 or lowermost zone line 1070 must be steady and other zone lines vary to higher levels or lower levels compared to previous zone levels. After initial movement of the seven zone lines in one direction, while one of either uppermost or lowermost zone levels remain steady, one of the uppermost or lowermost zone lines may start moving and at one time, all seven levels will move in one direction and establish either new higher or new lower prices in the market. In many cases, zone lines 1006 make a trough formation first, before making such new higher prices or new lower prices compared to previous periods under consideration. The smaller the period selection, the more such events occur.

Due to dynamic nature of market, in certain instances, these zones levels 1006 or distances 1015 is dynamically adjusted as changes occur, without the traditional limitations of Fib levels or pivot levels. In addition, zone lines 1006 preferably move independent of one another, showing true levels of risk areas from one to another. It is not necessary to have a constant distance between all zone levels. More zone lines 1006 may preferably be added by changing designated periods, preferably the mixing zones 1025 or 1026 to see earlier changes in market than even a fixed period for all zones 1025 or 1026, helping a user and/or trader with upcoming changes in a market vehicle prices, including directional changes.

In this manner, multiple factors are dynamically displayed in certain instances, to assist in forecasting future market direction. Additionally, several calculations of zone lines 1006 preferably is mixed to find an average zone level price, alternately preferably is combined to derive additional zone lines 1006. An algorithm is also used, preferably to bring the values of zone lines 1006 from other time frames 325, preferably superimposing other zone lines 1006 from other time frames 325, preferably to create an effect of multiple time frame zone lines for efficient trading.

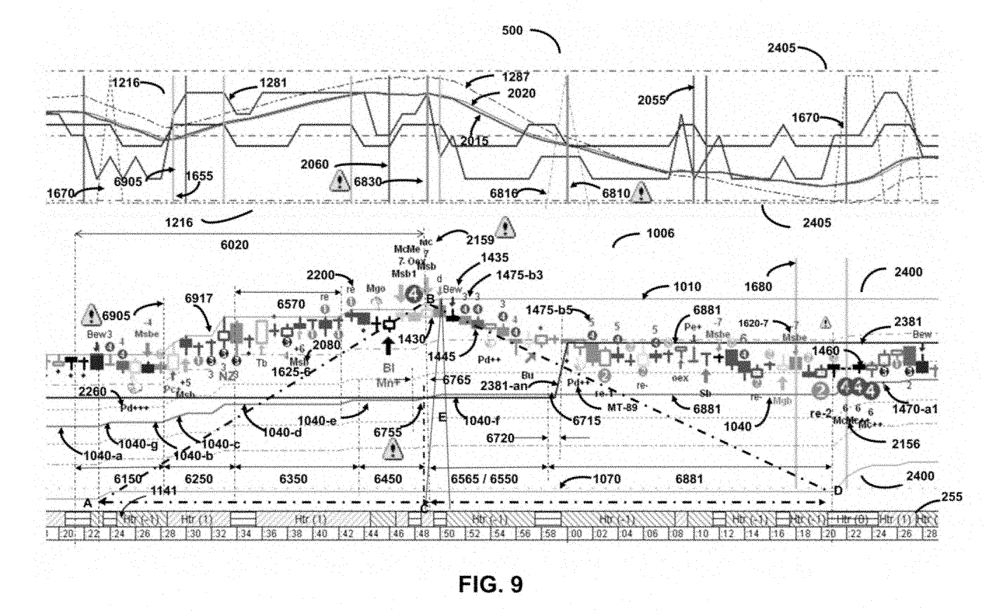

A trader or user understands that Blue Continuation Spikes 1670 (FIG. 9) occur due to the dynamic changes within a market over a period of time. As such changes are adapted by different Zone Lines such as 1020, 1030, 1040, 1050, 1060, and 1070, with the exception of 1010, a new series of shifting points are created within all zone lines with the exception for 1010, to adapt to such recent market conditions. The comparison of the diminution of the immense value of the eminent value over a period of time detracting the nether value of the squat value over a period of time and the aggregation with the nether values of the squat value over a period of time, helps to find the shifting points of Zone Lines with the exception of 1010 under the shifting to reflect the dynamic changes. A trader or user may refer to FIG. 9 for some examples of Blue Continuation Spike 1670.

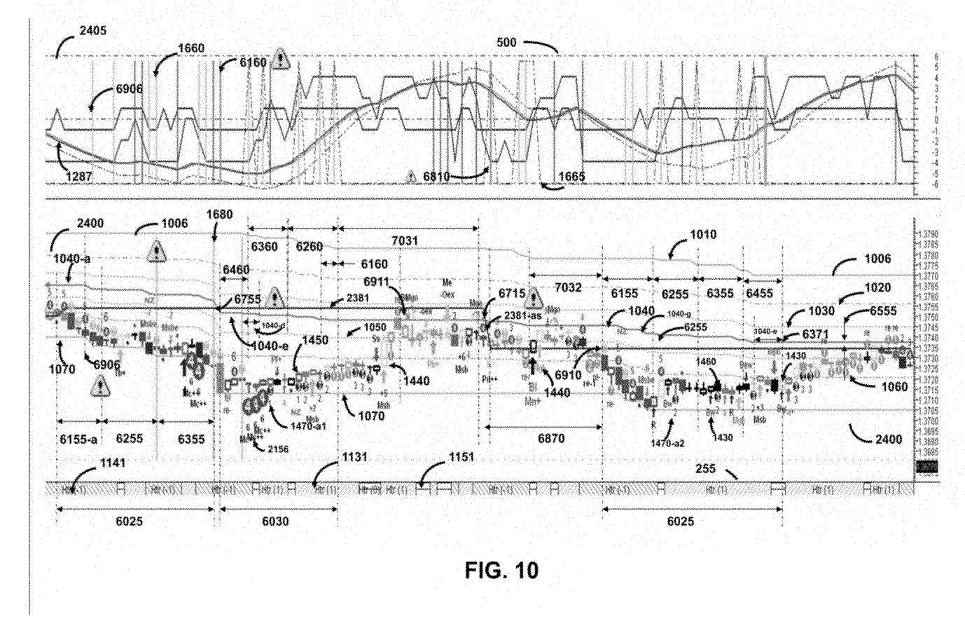

A trader or user understands that Black Transition Spike 1665 (FIG. 10), is considered a neutral spike, which occurs due to the dynamic changes within the market over a period of time. As such changes are adapted by different Zone Lines such as 1010, 1020, 1030, 1040, 1050, and 1060, with the exception of 1070, a new series of shifting points gets created within all zone lines with the exception of 1070, to adapt to such recent market conditions. The comparison of the diminution of the immense value of the eminent value over a period of time detracting the nether value of the squat value over a period of time and the aggregation with the nether values of the squat value over a period of time, helps find the shifting points of Zone Lines with the exception of 1070 under the shifting to reflect the dynamic changes.

A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

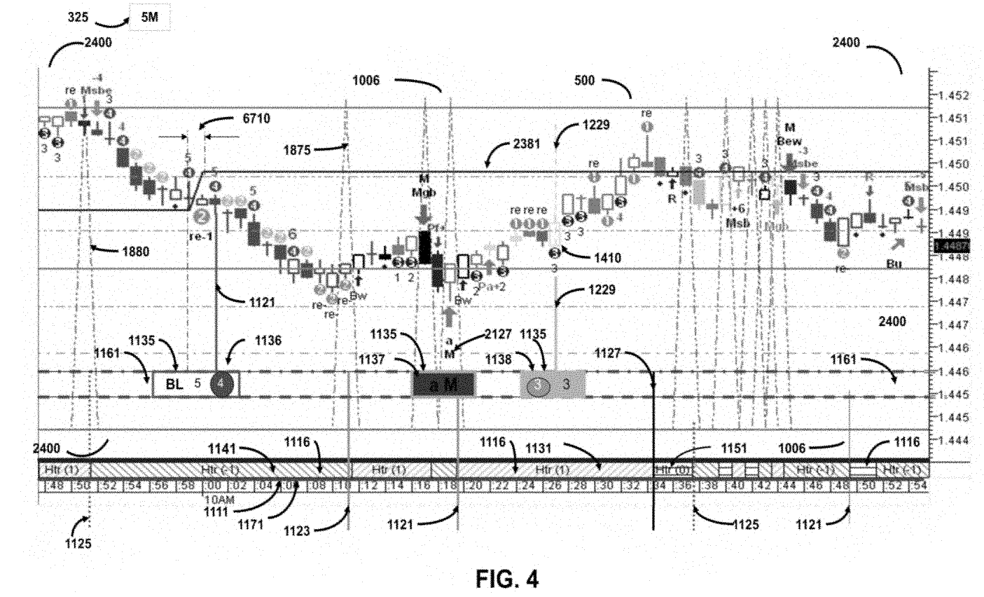

FIG. 4 shows one embodiment of a display, showing an illustrative screenshot view which is displaying a Horizontal Time Risk dimension 255 (FIG. 2), as included within certain embodiments of the multidimensional risk analysis systems 100 of FIGS. 1 and 2. In the Horizontal Time Risk dimension (time duration risk 255), indicators 500 preferably comprise at least one modified time spectrum ribbon 1111. In certain instances, modified time spectrum ribbon 1111 preferably comprise at least one modified time spectrum segment 1116, preferably at least one modified bullish time spectrum segment 1131, comprising a concentration of Bullish Believers, alternately preferably at least one modified bearish time spectrum segment 1141, comprising a concentration of Bearish Believers, and alternately preferably at least one modified neutral time spectrum segment 1151, comprising the exchange between Bullish Believers to Bearish Believers or vice versa, as shown. Upon reading the teachings of this specification, those skilled in the art will now appreciate that, under appropriate circumstances, considering such issues as user preference, cost, etc., others. There might be a variety of embodiments of time spectrum segments, such as, for example, partial bull time spectrum segments, partial bear time spectrum segments, etc. In certain embodiments, a distinct ribbon, and/or an indicator portion of an existing ribbon, or any indicator corresponding to market risks 205 (FIG. 2), or any portion thereof, can have its appearance, color, texture, shading, lining, etc., altered to indicate to a user a noteworthy event or minor event of user choices, which is used by the user and/or trader to assist in making financially related decisions.

In certain instances within trading, a trader or user preferably finds a confined location and a time spectrum, as indicated through modified time spectrum segment 1116, which is modified based on modified health risk indicator 1216 (FIG. 5) which may reduce time errors, in any time frame 325 (as shown with 5 minutes), in real time, where there is a maximum possibility of either Bullish Believers stepping desire or Bearish Believers stepping desire and there is possible mix of desire for Bullish Believers or Bearish Believers stepping/no stepping desire. There is a Horizontal Time Risk dimension (time duration risk 255) associated in trading during the formation of a time spectrum, preferably with indicators 500 comprising modified bullish time spectrum segment 1131, modified bearish time spectrum segment 1141 and modified neutral time spectrum segment 1151, preferably indicating Bullish Believers desire, Bearish Believers desire, or a possible mix of desire for bullish or bearish situations, respectively. The longer the time spectrum segment forms, the greater the risk for any type of desire.

In certain other instances, time duration risk 255 preferably is represented by multiple modified time spectrum ribbons 1111. At least one modified fixed time spectrum ribbon 1171 preferably represents time duration risk 255 of a time frame 325, currently displayed. Additionally, at least one modified floating time spectrum ribbon 1161 is preferably used to represent at least one hybrid of time duration risk from other time frames 325 (at least embodying herein at least one time-frame computer display structured and arranged to display, relating to each of such plurality of time frames, at least some of such current values of such plurality of market risk factors; and at least embodying herein displaying, relating to each of such plurality of time frames, at least some of such current values of such plurality of market risk factors), alternately preferably from previous time frames 325. It is understood that a modified floating time spectrum ribbon 1161 is considered an event based ribbon.

Modified fixed time spectrum ribbon 1171 comprises at least one flashing segment 1135, preferably colored, which delivers messages for corresponding candle or bar color, symbols and its colors around candle or bar, identify Hybrid Dynamic Zone Lines 1006 or any user selected items of multidimensional risk systems 100. FIG. 4 provides an illustrative display of three types of flashing segments 1135, such as flashing segment 1136, flashing segment 1137 and flashing segment 1138. Flashing segment 1136 indicates a Scheduled Event of Blue Line 6710 occurring, which can be messaged as “BL” and few minutes later, message “5 4” can be displayed stating number five risk and the market vehicle forecasting further low prices. Modified time risk hybrid line 1229 can preferably comprise a vertical line drawn thru a candle or a bar which aids the user to recognize the risk in Bearish Believers favor forecasting further low prices based on “5 4” flashing segment 1137 indicates, type M scalp swing set up 2127 is forming indicated “a M”, the color indicates the type of price sectional risk named type “a”. Green spike 1875 further confirms Bullish Believers entry, thereupon confirming the multi-confirmation of multiple risk dimensions and pin point entries with easy application of colors, symbols , numbers and alphabets.

In certain alternate instances, modified fixed time spectrum ribbon 1171 preferably comprises at least one modified time risk line 1121. Each modified time risk line 1121 preferably comprises a modified time risk bullish line 1123, alternately preferably a modified time risk bearish line 1125, alternately preferably a modified time risk neutral line 1127, or alternately preferably a modified time risk hybrid line 1229. Though not illustrated, modified time risk line 1121 preferably comprises at least one indicator color for distinguishing between modified time risk bullish line 1123, modified time risk bearish line 1125, modified time risk neutral line 1127, and a modified time risk hybrid line 1229.

For a bullish Horizontal Time Risk, modified time risk bullish line 1123 usually comprises a vertical line preferably drawn before the beginning of a bullish Horizontal Time Risk actual time frame either candle or bar, as shown. Modified time risk bullish line 1123 can preferably be followed by either modified bearish time spectrum segment 1141 or modified neutral time spectrum segment 1151.

Fora bearish Horizontal Time Risk, modified time risk bearish line 1125 can comprise a vertical line preferably drawn before the beginning of a bearish Horizontal Time Risk actual time frame either candle or bar, as shown. Modified time risk bearish line 1125 can be followed by either Modified bullish time spectrum segment 1131 or Modified neutral time spectrum segment 1151.

For a modified neutral Horizontal Time Risk, modified time risk neutral line 1127 can comprise of a modified vertical line preferably drawn before the beginning of a modified neutral Horizontal Time Risk actual time frame either candle or bar, as illustrated. Modified time risk neutral line 1127 can be followed by either modified bullish time spectrum segment 1131 or modified bearish time spectrum segment 1141.

In certain instances, modified time risk hybrid line 1229 preferably comprises a vertical line drawn through a candle or a bar, when a sudden event occurs in the market, due to dimension risk #5 (internal market moving risk 215), in modified floating time spectrum ribbon 1161, as shown. Indicators 500 for time duration risk 255 preferably pinpoint at least one location, when real increasing Bullish Believers stepping desire, real increasing Bearish Believers stepping desire or mix stepping/no stepping desires exist in the market, along with multiple confirmations represented by colored candles or bars representations. Flashing segment 1138 delivers a possible message of “3 3” inside turquoise colored segment with modified time risk line 1229 connecting to sudden market risk bullish candle 1410 with “3” forecasting further high prices of market vehicle with risk designation number 3. Modified time risk hybrid line 1229 preferably comprises a vertical line drawn through a candle or a bar which aids the user in recognizing the risk in Bearish Believers favor forecasting further low prices based on “5 4”.

In certain instances, as shown in FIG. 4, by “a M” (bullish Dk yellow candle—type a (M) 2127) , an algorithm preferably is created using confirmed swing locations in either direction in trading, comparing higher stepping desire values with previous higher stepping desire values, comparing lower stepping desire values with previous stepping lower desire values, the number of bars since these events have occurred, the highest values of stepping swings, and the lowest values of stepping swings. Upon reading the teachings of this specification, those skilled in the art will now appreciate that, under appropriate circumstances, considering such issues as cost, user reference, etc., other indicators, such as, for example, PSSTOCH, moving averages, lag less averages, directional indicators, money flow, CCI, etc., may be injected.

FIG. 5 shows one embodiment of a display, showing an illustrative screenshot view which is displaying a health risk dimension component, included within certain embodiments of the multidimensional risk analysis systems 100 of FIGS. 1 and 2. Trend Health Risk 265 (FIG. 7) preferably uses indicators 500, preferably comprising at least one oscillating risk indicator 1210, preferably representing a dynamic oscillating risk assessment of a trend movement of upward, downward or sideways in trading of any market vehicle. Oscillating risk indicator 1210, within a preferably created, preferably adjustable boundary (Boundary Lines 1220) preferably locates a risk tolerance at any given time, in any time frame 325 for any Market Vehicles. This concept allows checking health of risk in the market on a variable adjustable scale.

Certain embodiments of oscillating risk indicator 1210 preferably comprises at least two Boundary Lines 1220, preferably at least eleven Boundary Lines 1220. Oscillating risk indicator 1210 preferably further comprises at least one oscillating risk indicator component 1216, preferably at least five oscillating risk indicator components 1216 and at least an optional two directional line Indicator component 2010, comprise of one Bullish Believers directional line Indicator component 2055 and one Bearish Believers directional line component 2060.

Certain embodiments of health risk directional indicator components 2010 for modified health risk indicator 1216 are based on debasing conventional progressing mean of prices and still keeping the integrity of all health risk components 1215 of previously submitted design to produce real dynamic, adaptive, true, much reliable direction either for Bullish Believers or for Bearish Believers. Two components herein referred to as Bullish Believers directional indicator component 2015 and Bearish Believers directional indicator component 2020, are integral part of modified health risk indicator components 1216.

One of the two optional directional line indicator component 2010 comprises of one Bullish Believers directional line Indicator component 2055, based on dynamic strength risk indicator 1287 and its mean values over a specified period and give priority to strength risk indicator 1287 over values mean values of dynamic strength risk indicator 1287. A trader or user uses more than one indicators of his/her choice and use delay free or lag less types of options to produce types of results wanted for accuracy. Bullish Believers directional line indicator component 2055 is late in nature, but provides general Bullish Believers confirmed direction.

Another of the two optional directional line indicator component 2010 comprises of one Bearish Believers directional line indicator component 2060 , based on dynamic strength risk indicator 1287 and its mean values over a specified period and give priority to strength risk indicator 1287 over values mean values of dynamic strength risk indicator 1287 One uses more than one indicators of his/her choices and use delay free or lag less types of options to produce types of results wanted for accuracy. Bullish Believers directional line indicator component 2055 is late in nature, but provides general Bullish Believers confirmed direction. In certain instances, Boundary Lines 1220 comprises an uppermost boundary line 1230, a lowermost boundary line 1240 and core Boundary Lines 1250 of the dynamic oscillating risk. The values vary, depending upon the risk associated with a particular market vehicle. Typically, the approximate values observed are between −7 to +7 for Boundary Lines 1220 for various types of Market Vehicles. Boundary Lines 1220 preferably define at least one risk area 1225.

The values of Boundary Lines 1220 from +6 and exceeding +6 can, in certain configurations, represent uppermost risk areas for Bullish Believers and lowermost risk areas for Bearish Believers (risk areas 1260), when any of seven health risk indicator components 1216 are taken into consideration individually or combined. The values of Boundary Lines 1220 from −6 and less than −6 preferably represent corresponding uppermost risk areas for Bearish Believers and lowermost risk areas for Bullish Believers (risk areas 1270). Oscillating risk indicator 1210 in risk areas 1260 preferably can indicate a near peak risk for Bullish Believers and entry points for Bearish Believers. Likewise, oscillating risk indicator 1210 in risk areas 1270 preferably can indicate a near trough risk for Bearish Believers and entry points for Bullish Believers. In certain instances, oscillating risk indicator 1210 is displayed for multiple time frames 325, preferably in real time. Boundary line 1220 values preferably vary depending upon market conditions, type of market vehicle, and preferably is plotted on vertical scale in a horizontal line format, as shown. Upon reading the teachings of this specification, those skilled in the art will now appreciate that, under appropriate circumstances, considering such issues as user preference, cost, desired accuracy, etc., other quantities of Boundary Lines may suffice.

A trader or user skilled in the art understands that the health risk indicator 1216 allow a trader or user to determine the internal health of any particular market vehicle with the possible use of the various health risk indicator components. In certain instances, modified health risk indicator component 1216 can preferably comprise at least one modified positive/negative-indicator count 1281. Positive/negative-indicator count 1281 may preferably comprise a non-zero integer value. Modified positive/negative-indicator count 1281 preferably comprises at least one summation of counts of modified positive and/or negative indicators. Such modified positive and/or negative indicators 1281 preferably include traditional indicators, of trader or user choice, such as Percentage price Oscillator, percentage Volume Oscillator, Relative Strength Index, Stoch RSI, William % R, Difference of Two EMAs, open, close, High, or low values and its comparisons over a selected period of time, price health relative to past movements, rate at which Market vehicle prices are changing, alternately preferably modified indicators, alternately preferably specialty indicators, alternately preferably proprietary indicators or any numbers of Indicators as per a trader or user's choice. A trader or user balances the selected Indicators, at least one summation of counts, for speed, in either traditional or proprietary Indicators, by making them slower, making a few of them faster than others or mixing and matching the speed, periods, and/or price change differentials.

Modified positive/negative-indicator count 1281 is slower than positive/negative-indicator count, which was submitted in previous design and requires less periods of selected time frame 325. Each indicator increases count of modified positive/negative-indicator count 1281 by one, when positive, or decreases count of modified positive/negative-indicator count 1281 by one, when negative. Count of modified positive/negative-indicator count 1281 preferably comprises a maximum value equal to the number of indicators used and a minimum value equal to the number of indicators used in the negative. When modified positive/negative-indicator count 1281 drops below zero, it is considered that the health risk for a bullish direction is very high. When modified positive/negative indicator count 1281 has a value equal to the minimum, it is considered that the market vehicle health risk for a bearish outlook is very good. Likewise, once Modified positive/negative-indicator count 1281 increases above zero value, it is considered that the health risk is very high for a bearish outlook for a market vehicle. Also, when Modified positive/negative-indicator count 1281 has a value equal to the maximum, it is considered that the market vehicle health risk for a bullish outlook is very good. A further health risk indicator component 1216 preferably comprises at least one modified dynamic strength risk indicator 1287. Modified dynamic strength risk indicator 1287 preferably is designed similar to dynamic strength risk indicator 1286 in previous design of health risk indicator component, except preferably for lesser periods for the rate at which the market vehicle prices (open, high, low or close) are changing based on Bullish Believeness or Bearish Believeness. The independency preferably helps to avoid further lag errors in traditional or custom indictors used, as well as, earlier or later travel to extreme oscillating risk boundaries. Values of modified dynamic strength risk indicator 1287 preferably vary between about +7 and about −7, but may also vary from market vehicle to market vehicle depending upon behavioral patterns at the time of its life span.

Another health risk indicator component 1216 preferably comprises at least one internal health risk indicator 1288. Values of internal health risk indicator 1288 preferably vary between about +1 and about −1. If values of internal health risk indicator 1288 are about +1 and stays about +1, it preferably is an indication of a health risk that is likely to stay bullish. If values of internal health risk indicator 1288 fall from about +1 and stays below zero and reach to about −1 and then stays at a steady value of about −1, then values of internal health risk indicator 1288 are weak and preferably indicates the health risk for Bullish Believer has deteriorated and is confirmed. Likewise, if values of internal health risk indicator 1288 are about −1 and stays about −1, it preferably is an indication of a health risk that is likely to stay bearish. If values of internal health risk indicator 1288 rise from about −1 and stays above zero and reach to about +1 and then stays at a steady value of about +1, then values of internal health risk indicator 1288 are strong and preferably indicates the health risk for Bearish Believer has deteriorated and is confirmed. Internal health risk indicator 1288 may preferably be designed based on stepping desire values mixed with three different types of trend calculations. Another modified health risk indicator component 1216, preferably comprises at least one Bullish Believers directional indicator component 2015. A trader or user preferably selects the number of indicators, preferably comprising traditional indicators, alternately preferably proprietary indicators, alternately preferably custom indicators, as desired, but keeping the basis of design of health risk directional indicator 2010 applicable to modified health risk indicator 1216. A trader or user may additionally preferably select the polarity, and modify such selected indicators for time delays errors. Further, Bullish Believers directional indicator component 2015 preferably is customized to oscillate between and beyond a boundary, alternately preferably between boundaries to preferably measure the underlying strength. An extreme value of beyond or equal to about −6, using at least four indicators, preferably indicates possible extreme risk for bullish earlier entries and preferably indicates very high risk health for Bearish Believers. An extreme value of beyond or equal to about 6, using at least four indicators, preferably indicates possible extreme risk for bearish earlier entries and preferably indicates very high risk health for Bullish Believers.

Yet another modified health risk indicator component 1216 preferably comprises at least one Bearish Believers directional indicator component 2020. Bearish Believers directional indicator component 2020 is preferably designed to oscillate between the maximum and minimum polarity values indicated in modified positive/negative-indicator count 1281. Bearish Believers directional Indicator component 2020 preferably comprises at least one algorithm written based on a set of traditional indicator methods, but derived from basis of design of health risk directional indicator 2010 applicable to modified health risk indicator 1216. In normal market conditions, the value of Bearish Believers directional Indicator component 2020 varies between about 4 and about −4. Any values greater than about 4, up to the maximum, indicate an extreme health risk issue for Bullish Believers entries, indicating possible reversals from a Bullish Believers to a Bearish Believers direction or profit takings. Any values less than about −4, down to the minimum, indicate an extreme health risk issue for Bearish Believers entries, indicating possible reversals from a bearish to a bullish direction or profit takings.

Two components are referred to as Bullish Believers directional indicator component 2015 and Bearish Believers directional indicator component 2020, Modified Health risk indicator components 1216, preferably have an inherent nature of synchronization with each other either preferably partially or, alternately preferably fully, when desired and adjusted by a trader or user.

Bullish Believers directional indicator component 2015 and Bearish Believers directional indicator component 2020, when synchronized and staying together in upward direction, preferably indicate a strong possibility of continuity of upward trend. In addition, when Bullish Believers directional indicator component 2015, Bearish Believers directional indicator component 2020 and modified dynamic strength risk indicator 1287 are synchronized together in an upward direction, it preferably indicates an even stronger upward strength possibility for bullish belief, until Modified dynamic strength risk indicator 1287 reaches a maximum.

The relation of Bearish Believers directional indicator component 2020, Bullish Believers directional indicator component 2015 and modified dynamic strength risk indicator 1287 for bearish belief exactly mirror bullish belief, as stated earlier. Once the polarity of modified positive/negative-indicator count 1281 and internal health risk indicator 1288 are equal, synchronization preferably occurs. If the polarity is positive for modified positive/negative-indicator count 1281 and internal health risk indicator 1288, then it preferably indicates a smooth strong bullish flow for believers. If the polarity is negative for modified positive/negative-indicator count 1281 and internal health risk indicator 1288, then it indicates a smooth strong bearish flow for believers.

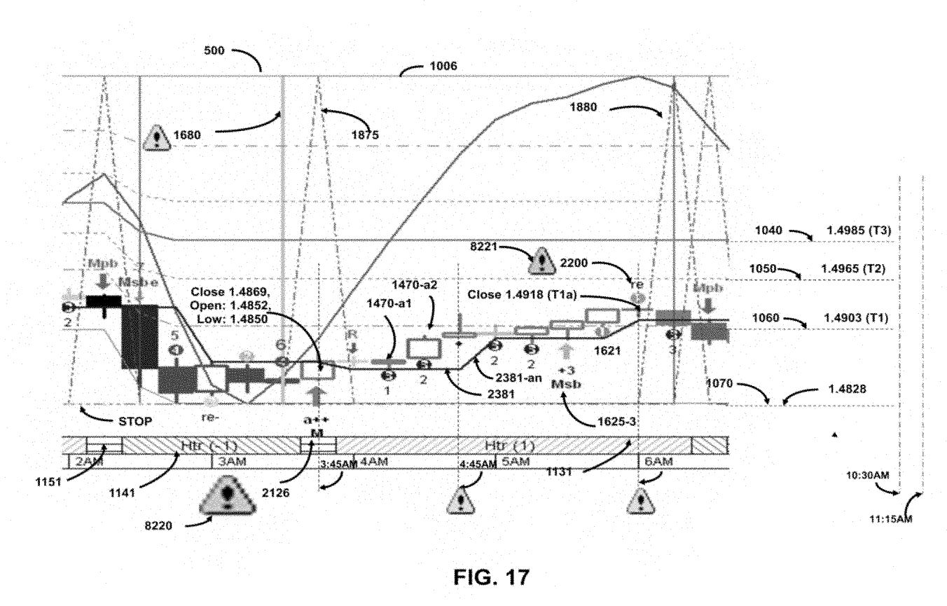

A trader or user understands, with respect to pin point reversals named as, Super Bullish Belief Contra+Re 2200 (FIG. 17), that when the Trend Health 2405 of a market vehicle ora security looks optimistic for the Bullish Believers, it internally is becoming offset by the development of its own weakness and may create a controversy to the Trend Health 2405 and to the Modified Bullish Time Segment 1131, and may possibly create a reversal of prices and possibly of the trend. A trader or user can refer to FIGS. 10, 11, 14, and 17 for some examples of Super Bullish Belief Contra+Re 2200.

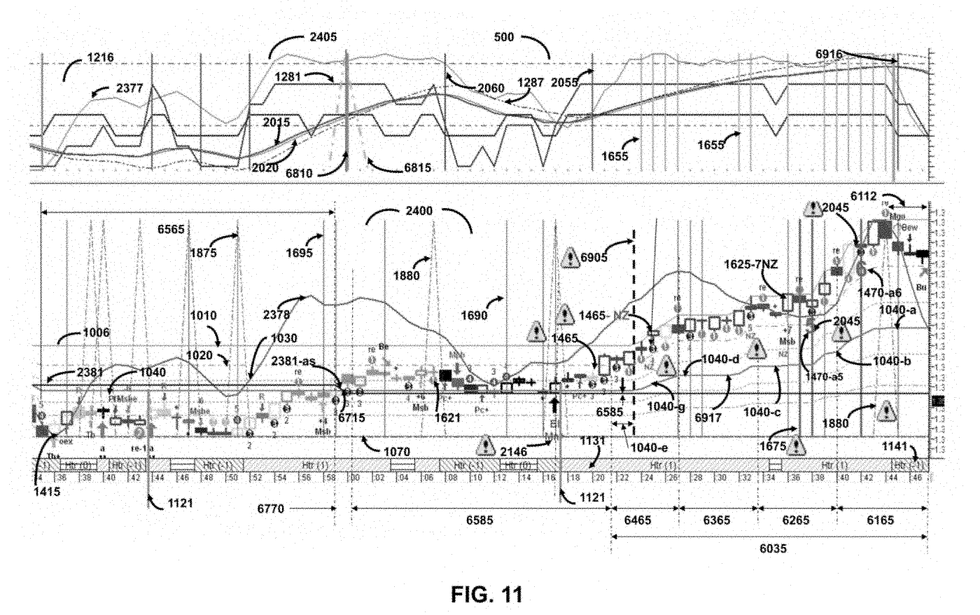

A trader or user understands that, with respect to pin point reversals named as, Super Bullish Belief Contra+RE1 (not illustrated), when the Trend Health 2405 of a market vehicle or security looks optimistic for the Bullish Believers, it internally is becoming offset by the development of Bear Entry Spike 1880 (FIG. 3) and Bear Spot Risk line 1695 (FIG. 11) and creates a controversy to the trend health 2405 and to the Modified Bullish Time Segment 1131 and may possibly create a reversal of the prices and possibly of the trend.

A trader or user understands, with respect to pin point reversals named as, Super Bullish Belief Contra+RE2, that when the Trend Health 2405 of a market vehicle or security looks optimistic for the Bullish Believers, it internally is becoming offset by the development of Bear Entry Spike 1880 (FIG. 3) and Bear Spot Risk line 1695 (FIG. 11) along with additional Bearish Risk Recognition factors from the User's Manual and creates a controversy to the trend health 2405 and to the modified bullish time segment 1131 and may possibly create a reversal of the prices and possibly of the trend. This can be more powerful than Super Bullish Belief Contra+RE1 2200 (FIG. 17).

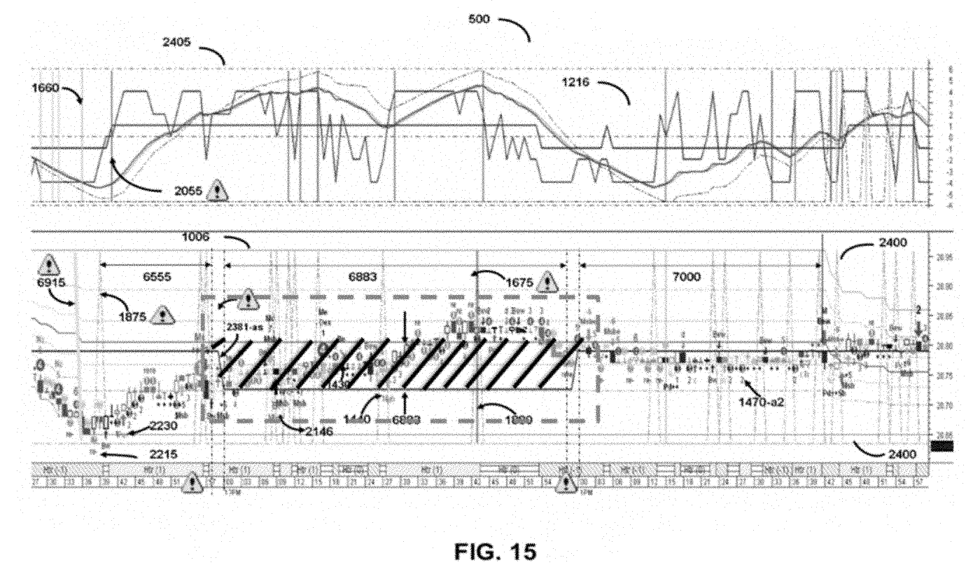

A trader or user understands that, with respect to pin point reversals named as Super Bearish Belief Contra−RE-2215 (FIG. 3), when the Trend Health 2405 of a market vehicle or security appears optimistic for the Bearish Believers, it internally is becoming offset by the development of its own weakness and creates a controversy to the Trend Health 2405 and to the Modified Bearish Time Segment 1141 and creates a reversal of the prices and possibly of the trend. A trader or user refers to FIG. 15 for some examples of Super Bearish Belief Contra−Re-2215. A trader or user understands that, with respect to pin point reversals named as Super Bearish Belief Contra−RE-1 2220 (FIG. 3), when the Trend Health 2405 of a market vehicle or security appears optimistic to the Bearish Believers, it internally is becoming offset by the development of Bull Entry Spike 1875 (FIG. 3) and Bull Spot Risk line 1690 (FIG. 11) and creates a controversy to the trend health 2405 and to the Modified Bearish Time Segment 1141 and creates a reversal of the prices and of the trend. A trader or user refers to FIGS. 11, 12 and 14 for some examples of Super Bearish Belief Contra−Re-1 2220.

A trader or user understands that, with respect to pin point reversals named as Super Bearish Belief Contra−RE-2, when the Trend Health 2405 of a market vehicle or security appears optimistic for the Bearish Believers, it internally is becoming offset by the development of Bull Entry Spike 1875 (FIG. 3) and Bull Spot Risk Line 1690 (FIG. 11) and creates a controversy to the Trend Health 2405 and to the Modified Bearish Time Segment 1141 and creates a reversal of the prices and of the trend. This is more powerful than Super Bearish Belief Contra−Re-1 2220. A trader or user understands that a “Bullish Believer Condition” develops in trading when the various components of Trend Health Risk 265 (FIG. 5), such as but not limiting scope to, internal health risk indicator 1288 (FIG. 5) and modified positive/negative indicator 1281 (FIG. 5) are aligned above zero Boundary Lines 1250 (FIG. 5) with modified bullish time segment 1131 (FIG. 5) and price perception risk 245 (FIG. 7), which are preferably for sections “a”, “b” or “c”. As such for trading a market vehicle in any time frame that comprises of tick to yearly or any combination of time frames.

A trader or user understands that a “Bearish Believer Condition” develops in trading when the various components of Trend Health Risk 265 (FIG. 5), such as, but not limiting scope to, internal health risk indicator 1288 (FIG. 5) and modified positive/negative indicator 1281 (FIG. 5) are aligned below zero Boundary Lines 1250 (FIG. 5) with modified bearish time segment 1141 (FIG. 5) and price perception risk 245 (FIG. 7), which are preferably for sections “d”, “e” or “f”. As such for trading a market vehicle in any time frame that comprises of tick to yearly or any combination of time frames.

A trader or user understands that a “Neutral Believer Condition” develops in trading when the various components of Trend Health Risk 265 (FIG. 5), such as, but not limiting scope to, internal health risk indicator 1288 (FIG. 5) and modified positive/negative indicator 1281 (FIG. 5) are both aligned at the zero Boundary Lines 1250 at the same time or either one of them (FIG. 5) with modified neutral time segment 1151 (FIG. 5) and price perception risk 245 (FIG. 7), which are preferably for section “d”, As such for trading a market vehicle in any time frame that comprises of tick to yearly or any combination of time frames.

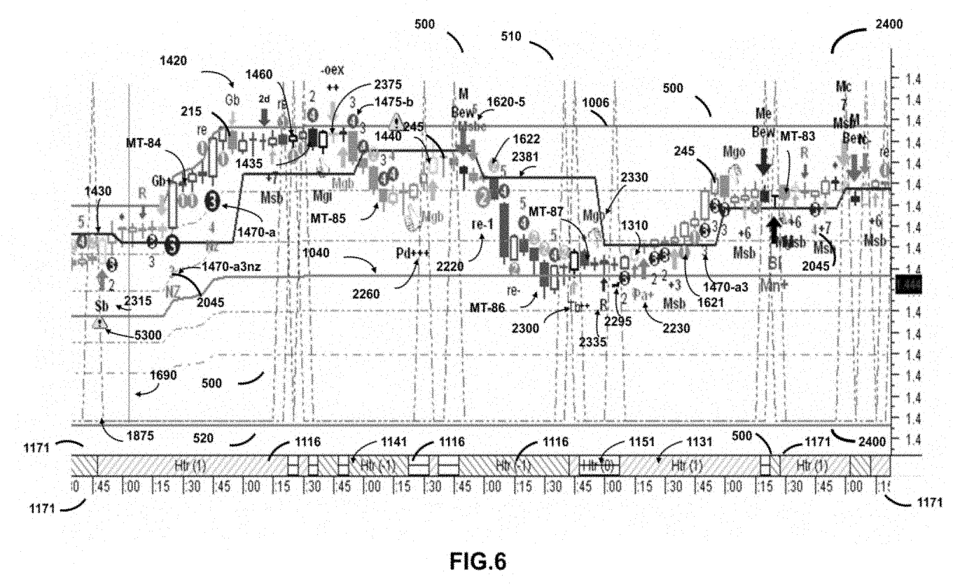

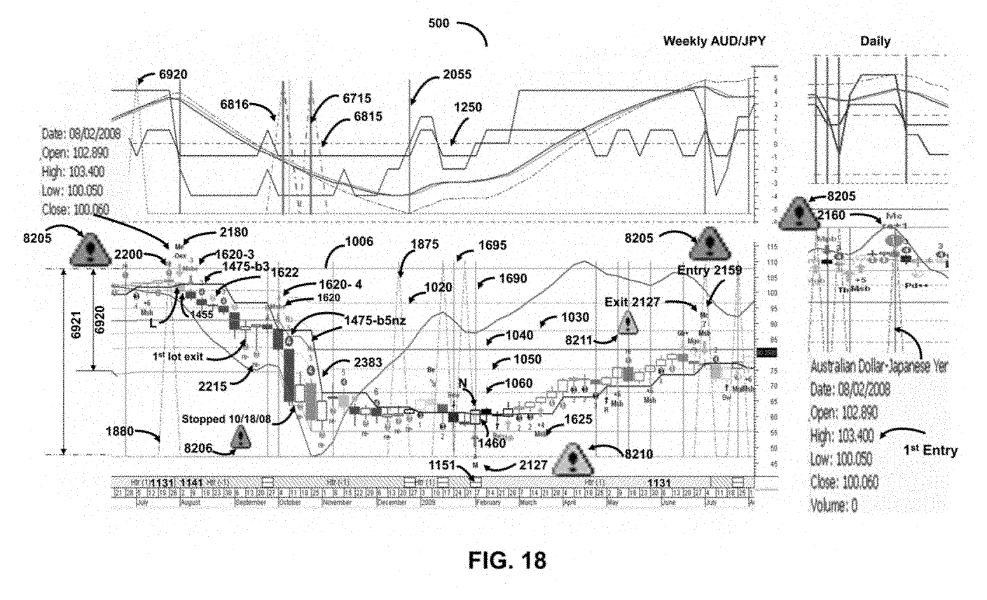

A trader or user understands that a “Super Bullish Believer Entry” 1621 (FIG. 6) condition develops in trading when the various components of Trend Health Risk 265 (FIG. 7) such as internal health risk indicator 1288 (FIG. 5) and modified positive/negative indicator 1281 (FIG. 5) have aligned above the zero boundary line 1250 (FIG. 5) with modified bullish time segment 1131 (FIG. 5) and price perception risk 245 (FIG. 7), which are preferably for sections “a”, “b”, or “c”, but only as such when both modified positive/negative indicator 1281 (FIG. 5) and boundary line 1220 (FIG. 5) remain horizontal. A trader or user understands that “Super Bearish Believer Entry” 1622 (FIG. 18) condition develops in trading when the various components of Trend Health Risk 265 (FIG. 5) such as internal health risk indicator 1288 (FIG. 5) and modified positive/negative indicator 1281 (FIG. 5) have aligned below the zero Boundary Lines 1250 (FIG. 5) with modified bearish time segment 1141 (FIG. 5) and price perception risk 245 (FIG. 7), which are preferably for sections “d”, “e”, or “f”, but only as such when both modified positive/negative indicator 1281 (FIG. 5) and Boundary Lines 1220 (FIG. 5) remain horizontal.

A trader or user understands that “Super Belief Neutral Pinpoint Entries (For Bullish Believers)” (FIG. 18) condition develops in trading when the various components of Trend Health Risk 265 (FIG. 5) such as internal health risk indicator 1288 (FIG. 5) and modified positive/negative indicator 1281 (FIG. 5) are approaching the zero Boundary Lines 1250 (FIG. 18) from more negative to less negative within a short period of time, achieve a value of zero at the same time or within a very short period of time, and then become more positive. A trader or user further understands that such events are illustrated within either a modified neutral time segment 1151 (FIG. 18) or by two time segments side by side, such as modified bearish time segment 1141 next to modified bullish time segment 1131. A black neutral candle 1460 or subsequent black candles/bars over a period of time, are observed during such events and price perception risk 245 (FIG. 18) which are preferably for sections “a”, “b”, or “c” are at the zero boundary line 1250 (FIG, 18). Such Super Belief Neutral Pinpoint Entries (For Bullish Believers) are observed with, for example, bullish DK yellow candle type a(M) 2127 (FIG. 18), wherein “a” is the price perception risk defined with a black colored candle to indicate an exchange from Bearish Believers to Bullish Believers within the specified candle/bar under observation, hereby referred to as point “N”, and thereupon is considered a Super Belief Neutral Pinpoint Entries (For Bullish Believers).

A trader or user understands that “Super Belief Neutral Pinpoint Entries (For Bearish Believers)” (FIG. 18) condition develops in trading when the various components of Trend Health Risk 265 (FIG. 5) such as internal health risk indicator 1288 (FIG. 5) and modified positive/negative indicator 1281 (FIG. 5) are approaching the zero Boundary Lines 1250 (FIG. 18) from more positive to less positive within a short period of time, achieve a value of zero at the same time or within a very short period of time, and then become more negative. A trader or user further understands that such events are illustrated within either a modified neutral time segment or by two time segments side by side, such as modified bullish time segment 1131 next to modified bearish time segment 1141. A black neutral candle (overlaid by a tan colored candle 1455 for illustrative purposes), is observed during such events and price perception risk 245 (FIG. 18) which are preferably for sections “e”, or “f” are at the zero boundary line 1250 (FIG, 18). Such Super Belief Neutral Pinpoint Entries (For Bearish Believers) are observed with, for example, tan bearish entry-(Me) 2180 (FIG. 18), wherein “f” is the price perception risk defined within the tan bearish candle and “-oex” serves as an indication that there is an extended previous bullish condition with a tan colored candle to indicate an exchange from Bullish Believers to Bearish Believers within the specified candle/bar under observation, hereby referred to as point “L”, and thereupon is considered a Super Belief Neutral Pinpoint Entries (For Bearish Believers).

A trader or user understands that the term “Believeness” is defined as when a majority of traders or users trading a particular market vehicle believe that they are either be going in the long (bullish), short (bearish) or are neutral about the market vehicle and as such are classified as “Bullish Believeness”, “Bearish Believeness” or “Neutral Believeness”.

A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading.

Upon reading the teachings of this specification, those skilled in the art will now appreciate that, under appropriate circumstances, considering such issues as market vehicle cost, etc., other health risk components suffice.

FIG. 6 shows one embodiment of a display, showing an illustrative screenshot view which is displaying a price perception indicator 510 and internal movement indicator 520, which is included within certain embodiments of the multidimensional risk analysis systems 100 of FIGS. 1 and 2. Price perception risk 245 preferably comprises a perception of prices of a market vehicle. Price perception risk 245 preferably uses price perception indicators 510. Internal market moving risk 215 preferably is displayed through internal movement indicator 520 (enhanced), which preferably show such conditions as they occur, alternately preferably to warn a trader or user well in advance of conditions happening, preferably working as a forecasting tools for future decision making in trading.

For the various bars, tags, indicators, etc., as illustrated in FIG. 6 are tended to be illustrative in nature, and not limiting in scope. The selection of the various colors, shapes, textures, symbols, numbers, sounds, alerts, an explorer, etc., are a design choice.

With certain instances of price perception risk 245, the perception of prices in the market preferably is categorized into at least one sectional category of risk, preferably at least six sectional categories of risk, attributed to bullish, bearish and/or mixed prices, preferably using at least one analysis tool comprising algorithms, alternately preferably indicators either custom or traditional, or alternately preferably oscillators, preferably where the primary factors are either open, low, high or close prices in the dynamic motion against time. Price perception risk 245 preferably is directly proportional to time, vertical movement of prices and repeating events. Price movements follows a Dynamic Sectional Price Risk path, preferably following at least one sequence of sections. Any deviation from such at least one sequence in sections preferably indicates sudden market changes, either adding more risk in trading or reducing risk in trading.

The price perception is categorized based on its distance from a particular analysis tool. At least one bullish level preferably represents bullish belief above analysis tool and at least one bearish level preferably represents bearish belief below analysis tool. For descriptive purposes, such at least one bullish level is designated as section “a”, section “b” or section “c”; likewise such at least one bearish level is designated as section “d”, section “e” or section “f”.

For design purposes, section “a” as illustrated in FIG. 6 for example purposes with bullish Dk yellow candle type—a 1310, comprises the furthest lowest price perception for a Bullish Believer from a selected analysis tool; section “b” as illustrated in FIG. 6 for example purposes with bullish bright green candle type—b MT-83, may comprise the reasonable price perceptions accepted by the Bullish Believer for a market vehicle from a selected analysis tool for a selected time period, and section “c” as illustrated in FIG. 6 for example purposes with bullish green candle type—c MT-84 may comprise the furthest highest price perception by a Bullish Believer, for a market vehicle, over a selected time period. Price perception risk 245 for Bullish Believer preferably falls in to section “a”, section “b”, or section “c”. For ideal market behavior, the sequence must follow section “a”, then section “b”, then section “c” for a Bullish Believer, making a bullish sequence, or it indicates some disruption on sequential bullish sentiment.

Section “d” as illustrated in FIG. 6 for example purposes with Purple (C) Candle—type d MT-85, preferably comprises the furthest highest price perception below a selected analysis tool 1321 for a Bullish Believer, section “e” as illustrated in FIG. 6 for example purposes with Bearish Brown (C) Candle—Type e MT-86 comprises the nearest highest price perception values for a Bullish Believer for a market vehicle below a selected analysis tool, for a selected time period, and section “f” as illustrated in FIG. 6 for example purposes with Bearish Red Candle—type f MT-87, comprises the furthest lowest price perception values for a Bullish Believer, for a market vehicle below a selected analysis tool, over a selected time period. Price perception risk 245 for Bearish Believer preferably falls in to section “d”, section “e”, or section “f”. For ideal market behavior, the sequence must follow section “d”, then section “e”, then section “f” for a Bearish Believer, making a bearish sequence, or it indicates some disruption on sequential bearish sentiment.

When a mix occurs of highest perception of prices and second lower perception of prices, prices are magnetized towards the current values of a selected analysis tool, and prices may enter section “d” then returns to section “c” and repeats up to about 27 times, before prices are completely attracted to current value of a selected analysis tool.

In section “e”, as illustrated in FIG. 6 for example purposes with Bearish Brown (C) Candle—Type e MT-86, trader's perceptions are reasonably priced for taking risk to sell the market vehicle, as it is losing value suddenly. The trader's second perception would logically be that, he will lose more value of market vehicle, if he holds them longer. A Bullish Believer reacts to sell its own inventory, plus any other opportunist's inventory, who make a similar decision based on such observation established in section “e”.

The time duration of section “e” is shorter in most cases and does not often happen in general bullish belief for market vehicle, but happens, if some bad news or other factors in market exists and is used for taking profit.

In section “f”, as illustrated in FIG. 6 for example purposes with Bearish Red Candle—type f MT-87, trader's perceptions are reasonably priced for eliminating risk by holding the market vehicle, as it loses value suddenly. The trader's second perception would logically be that he will lose the value of market vehicle further and financial damage would be beyond normal if he holds them any longer. The reaction of a Bullish Believer is to sell his own inventory, plus other opportunist's inventory, who make similar decision based on such observation of success established in section “f”. The time duration of section “f” is shorter in most cases and does not often happen in general bullish belief for market vehicle, but happens if some bad news or some other factors in market does exist and by losing faith in the market vehicle.

In certain instances, perception indicators 510 can preferably differentiate between sections, and preferably indicate confirmations. Perception indicators 510 preferably use colors for differentiation, so for illustrative purposes have been labeled on FIG. 6. Confirmations in perception indicators 510 preferably are indicated through the use of “+” signs. Perception indicators 510 preferably also utilize arrows to differentiate directionality.

Definitions of meaning of section labeling in examples shown in FIG. 6:

“Bullish Dk Yellow Candle Type a” (indicator label 1310): There are no catalysts and the market vehicle is in section “a”.

“Bullish Dk Yellow Candle Type a+” (indicator label 2230): There is one catalyst and the market vehicle is in section “a”; this means a trader or user should take a risk to go long, as there is a very low risk and is double confirmed.

“Purple (C) Candle—Type d +++” (indicator label 2260): There are three catalysts and the market vehicle is in section “d”; this means a trader or user should take a risk to go long, as there is a very low risk, a big “thumbs up” symbol, and is quadruple confirmed, and understood as a pin point entry for Bullish Believers. An ordinary trader or user with minimal skills understands how to recognize colors and symbols such as “Pd+++” and independently trade without having too much knowledge of technical skill in trading.

Upon reading the teachings of this specification, those skilled in the art will now appreciate that, under appropriate circumstances, considering such issues as clarity, cost, user preference, etc., other perception indicators, such as, for example, stars, numbers, letters, symbols, alerts, etc., suffice. Price perception risk 245 preferably is represented in real time using the following type of formula:

“Purple (C) Candle—Type d +++” where the purple color indicates that the current prices are in Dynamic Sectional Price Risk “d” (price perception risk 245). Type d indicates that the values of price perception risk 245 are in category “d” for either a Bullish Believer or a Bearish Believer on a current bar, and there are three additional catalyst confirmations in support of price perception risk 245 and the risk to go bullish is very low, if such symbol is located underneath the current candle/bar, as there is a triple confirmation for bullish belief; the risk to go bearish is very low, if such symbol is located on top of the current candle/bar, as there is a triple confirmation for bearish belief. FIG. 6 illustrates a Bullish Believer Condition.

A trader or user understands that, with respect to Risk Designators Numbers 2045, for all Price Perception Indicators 510, there are either a single risk or a multiple of risks that exist within trading. On a scale of 1 to 7, these numbers are used to designate risk, where “1” illustrates lowest risk and “7” illustrates the highest risk. These Risk Designators 2045 are used along with Earlier Highs 1470-a, Earlier Lows 1475-b, Super Bullish Believer Entries 1621, Super Bearish Believer Entries 1622, Super Neutral Believer Entries, Super Belief Bull Pin Point Entries categories or Super Belief Neutral Pin Point Entries or Super Belief Bear Pin Point Entries categories. It is further understood that such risk designators are produced by Risk Assessor 140 (FIG. 2) and displayed by risk assessment, recognition, confirmation, designation, forecasting or identification display 310 (FIG. 2). It is well known by those skilled in the computer/electronic/processor arts that computer and processor systems often perform more than one function. For example, a processor-based device performs multiple functions such as a Risk Assessor 140, Risk Designators 2045, etc. In brief, specific purpose computers are not structured to perform one function, operation, or process, as is generally known in the art. A trader or user refers to FIG. 11 for some examples of Risk Designators 2045. A trader or user understands that with respect to Risk Balancers, when Price Perception Indicators 510 along with Earlier Lows 1475-b or Earlier Highs 1470-a are designated by a Risk Designator Number 2045 with higher risk designations, such as for example Earlier Highs +3.6 1470-a6 (FIG. 11), and there is an existence of divider vertical warning lines, also known as Bull Spot Risk Lines 1690 or Turquoise PH Lines 1655 (FIG. 7), the severity of the risk designator, such as “6” which is reduced and a trader or user uses these events as a reason to remain within a position and produce a profitable trade.

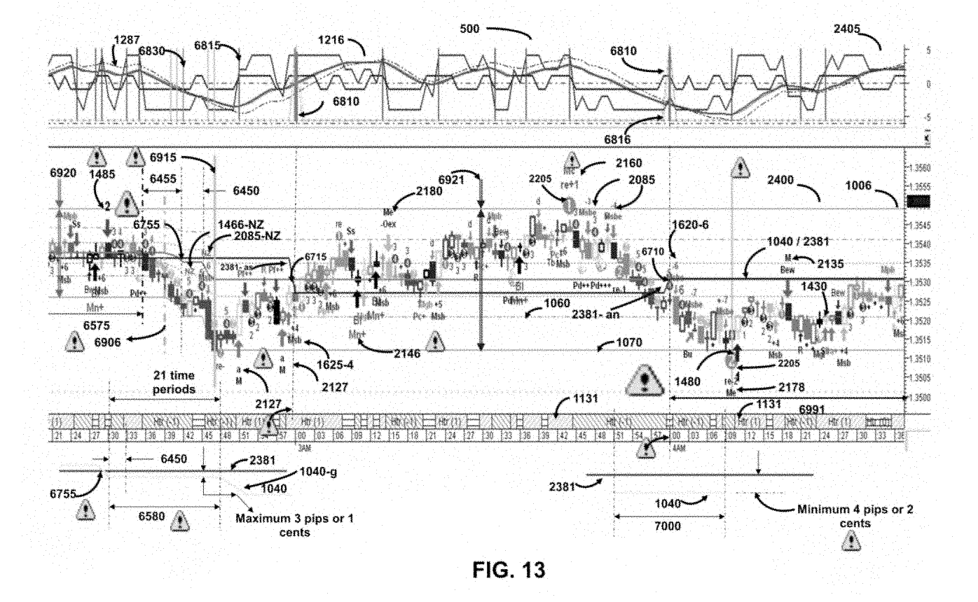

With respect to FIG. 6, such price perception indicators 510 further is enhanced with the use of circles, umbers, arrows, symbols and audio/visual alerts, either on top or underneath a candle or bar in order to recognize, but not limiting scope to, dynamic sectional risk transition candle/symbol, forecasting possible highs without risk assessments, forecasting possible lows without risk assessments, forecasting earlier highs with risk assessments 1465 (FIG. 7), forecasting earlier highs with risk assessments for Halved Hybrid Nozzlelism, forecasting earlier highs without risk assessments, forecasting earlier lows with risk assessments, forecasting earlier lows with risk assessments for Halved Hybrid Nozzlelism, forecasting earlier lows without risk assessments, super bullish pin point entries without risk assessments, super bearish pin point entries without risk assessments, super belief bull pin point entries categories with risk assessments , super belief bull pin point entries categories with risk assessment for Halved Hybrid Nozzlelism, super belief bull pin point entries categories without risk assessment , super belief bear pin point entries categories with risk assessment 2085 (FIG. 7), super belief bear pin point entries categories with risk assessment for Halved Hybrid Nozzlelism 2085-NZ (FIG. 13), super belief bear pin point entries categories without risk assessment, super belief pin point Reversals for Bulls to bears, super belief pin point Reversals for Bears to bulls, special market conditions for bullish entries, special market conditions for bearish entries, Reversals for Bulls, Reversals for Bears, further possible pre-high, and further possible pre-low, although a trader or user may refer to the users manual for additional examples. All of the examples aforementioned are programmed by a highly skilled individual in the art.

Within FIG. 6, dynamic sectional risk transition candle/symbol are illustrated, for example purposes, with transition bull 2295. Additional examples of dynamic sectional risk transition candle/symbol are selected by a trader or user. Formation of such symbols occur when sectional “d” candles allow for the continuation of bullish sectional price risk candles (“a”, “b”, or “c”). Such bullish sectional price risk candles are seen after “d” candles, in a smooth market trend development and is further understood that such transition occurs from sectional price “d” to “c” or sectional price “d” to “b”. A trader or user skilled in the art understands that a transitional bull 2295, as thus illustrated within FIG. 6, is the transition of sectional price “f” to “a”.

Although not illustrated within FIG. 6, it is understood that forecasting possible highs without risk assessments and/or forecasting possible lows without risk assessments is selected by a trader or user skilled in the art in order to further enhance such price perception indicators 510. There are no risk numbers associated within such categories of forecasting possible highs without risk assessments and/or forecasting possible lows without risk assessments but rather a symbol is used to indicate a possible high or low in the future.

A trader or user understands that forecasting earlier highs with risk assessments, is illustrated within FIG. 6, for example purposes, with earlier highs +3.3 1470-a3. Additional examples of forecasting earlier highs with risk assessments are selected by a trader or user. As such, forecasting earlier highs with risk assessments serves as an indication that there is an uptrend and the formation of earlier highs. Risk numbers are associated with such symbols, which allow a trader to pin point the risk that are associated with a candle/bar. Such risk numbers further allows a trader or user to understand how risky it is to take a bullish or bearish position. A trader or user understands that as the risk increases on a modified health risk 1216 (FIG. 5) on a scale of +1 to +6, it is understood as a higher risk involved in taking a bullish position. As illustrated within FIG. 6, a trader or user identifies the color of the candle/bar, which as such is seen as Dynamic Sectional Price Risk “a”, along with the symbol of a circled “3” which indicates forecasting an earlier high along with risk “3” out of a scale of +1 to +6. This eliminates a lengthy technical analysis and an ordinary trader or user instantly identifies various risks on a visual observation, which can be taken advantage of. Forecasting earlier lows with risk assessments and forecasting earlier lows without risk assessments and its various examples are selected by a trader or user.

A trader or user understands that forecasting earlier highs with risk assessments for Halved Hybrid Nozzlelism, are illustrated within FIG. 6, for example purposes, with earlier highs +3.3 for Halved Hybrid Nozzlelism 1470-a3nz. Additional examples of forecasting earlier highs with risk assessments for Halved Hybrid Nozzlelism are selected by a trader or user. As such, forecasting earlier highs with risk assessments for Halved Hybrid Nozzlelism serves as an indication that there is an uptrend and the possible formation of earlier highs. Risk numbers are associated with such symbols, which allows a trader to pin point the risk that are associated with a candle/bar. Such risk numbers further allows a trader or user to understand how risky it is to take a bullish or bearish position. A trader or user understands that as the risk increases on a modified health risk 1216 (FIG. 5) scale of +1 to +6, it is understood as a higher risk involved in taking a bullish position and as such may occur during the formation of Halved Hybrid Nozzlelism. As illustrated within FIG. 6, a trader or user identifies the color of the candle/bar, which as such is seen as Dynamic Sectional Price Risk “c”, along with the symbol of a circled “3” indicates a forecasting an earlier high 1470-a, along with risk “3” out of a scale of +1 to +6 and along with the symbol “NZ” to illustrate the occurrence of such during the phenomenon of Halved Hybrid Nozzlelism, which serves as a further indication of a strong movement for the Bullish Believers and is used as a sign for a trader or user to stay within a trade. This eliminiates a lengthy technical analysis and an ordinary trader or user instantly identifies various risks on a visual observation, which can be taken advantage of. Forecasting earlier lows with risk assessments for Halved Hybrid Nozzlelism and its various examples are selected by a trader or user.

A trader or user understands that super bullish pin point entries without risk assessments, are illustrated within FIG. 6, for example purposes, with super bullish belief entry 1621. As such, super bullish pin point entries without risk assessments serve as an indication of a strong bullish pin point entry. As illustrated within FIG. 6, a trader or user identifies the color of the candle/bar, which is seen as Dynamic Sectional Price Risk “a”, along with a circled “1” indicates a super bullish belief entry. This eliminates a lengthy technical analysis and an ordinary trader or user instantly identifies various risks on a visual observation, which can be taken advantage of. Super bearish pin point entries without risk assessments are selected by a trader or user.

A trader or user understands that super belief bear pin point entries categories with risk assessment 2085, are illustrated within FIG. 6, for example purposes, with super belief bear pin point en-5* 1620-5. As such, super belief bear pin point entries categories with risk assessment 2085 (FIG. 7) serve as an indication of bearish belief pin point entries. There are risk numbers associated with these symbols, which allows a trader or user to pin point the risk associated in a candle/bar. Risk numbers are associated with such symbols, which allows a trader or user to understand how risky it is to take a bearish position. A trader or user understands that as the risk increases on a modified health risk 1216 (FIG. 5) scale of −1 to −7, it is understood as a higher risk involved in taking a bearish position. As illustrated within FIG. 6, a trader or user identifies the color of the candle/bar, which is seen as Dynamic Sectional Price Risk “d”, along with risk “3” out of a scale of −1 to −7. This eliminates a lengthy technical analysis and an ordinary trader or user instantly identifies various risks on a visual observation, which can be taken advantage of. Super belief bull pin point entries categories with risk assessments, super belief bill pin point entries categories without risk assessment, super belief bear pin point entries categories without risk assessment and its various examples. Super belief bull pin point entries categories with risk assessment for Halved Hybrid Nozzlelism and super belief bear pin point entries categories with risk assessment for Halved Hybrid Nozzlelism and its various examples, in which super belief bull/bear pin point entries categories with risk assessment illustrates the occurrence of such during the phenomenon of Halved Hybrid Nozzlelism are selected by a trader or user.

A trader or user understands that super belief pin point Reversals for Bears to bulls, are illustrated within FIG. 6, for example purposes, with super bearish belief contra-re-1 2220. As such, super belief pin point Reversals for Bears to bulls, in which there is alignment of the horizontal and health risk which further reverses a bearish to bullish trend. As illustrated within FIG. 6, a trader or user identifies the color of the candle/bar, which is seen as Dynamic Sectional Price Risk “d”, along with super bearish belief contra-re-1 2220, which is seen with an orange circled 2 with the words “re-1”, which serves as a pinpoint reversal of a bearish to bullish trend. However, it is observed that such example failed to reverse the trend, which a trader or user understands was due to the newly added Hybrid Dynamic Zone Lines 1006, component Blue Line 2381 of the current design. The market vehicle was not able to close above the Blue Line 2381, which are observed as the Bullish Believers not being able to overcome Bearish Believers. A trader or user should keep a visual eye on the previous sectional risk or setup an alert for as desired. Dynamic sectional price “d” serves as an indication that the market can go in either direction. This eliminates a lengthy technical analysis and an ordinary trader or user instantly identifies various risks on a visual observation, which can be taken advantage of. Super belief pin point Reversals for Bulls to bears and its various examples are selected by a trader or user.

A trader or user understands that Reversals for Bulls, are illustrated within FIG. 6, for example purposes, with bull reversal 2335. As such, Reversals for Bulls are reversal signals in which a bearish trend becomes a bullish trend due to the alignment of multiple risk changes and confirmations. It is understood by a trader or user that reversal of such trends may not occur even with the appearance of such and other factors should be taken into consideration, such as, for example, the dynamic hybrid zone lines 1006. There are certain types of Reversals for Bulls, which include, but not limiting scope to, bull reversal, Bottom Bull small or big, bear bottom, and excess bear to bull belief. As illustrated within FIG. 6, a trader or user identifies the color of the candle/bar, which is Dynamic Sectional Price Risk “f”, along with bull reversal 2335, which is seen with a blue colored “R”. Although there was a Dynamic Sectional Price Risk “f”, it is observed that in such example the trend shortly thereafter did reverse, which is confirmed with the appearance of a transition bull 2295, the failure to break zone line 1040, as well as other indicators, which allows the Bullish Believers to overcome the Bearish Believers. This eliminates a lengthy technical analysis and an ordinary trader or user instantly identifies various risks on a visual observation, which are taken advantage of. Reversals for Bears and its various examples are selected by a trader or user. Though not illustrated within FIG. 6, a trader or user further selects possible pre-high and further possible pre-low, which a trader or user understands as a forecast of pre-high or pre-low within the possible future. A trader or user selects an alert for all the aforementioned examples for price perception risk 245 and its components.

FIG. 6 also shows an exemplary screenshot view, illustrating at least one internal movement indicator 520 (enhanced), according to certain embodiments of FIGS. 1 and 2. Regardless, where the prices are, whether they are trending or not, or going sideways, there are risks associated with sudden market conditions changes, which are located in any time frame, by inventing proper tools. In order to identify them, in real-time, in a particular time frame, during any trend development, consolidation, retracement, they preferably need to be separated and highlighted or given special symbol. In addition, there are spots, where a well-established trend looks great from outside on normal bar, candles, or line charts, but internally, the conditions are deteriorating, but they are not obvious by looking at traditional methods or charts. So due to their sudden occurrence, it either costs the trader or causes missed opportunities.

In FIG. 6, for example purposes, a turquoise bullish candle can have additional market conditions to make them more efficient, such as the turquoise bullish candle ++ 2300 as shown. A plus sign [+] indicates one modification, a double plus [++] shows two modifications to normal types. The risk to go bullish is low, if such symbol is located underneath the current candle/bar, as there is a triple confirmation for Bullish Believers.

For illustrative purposes, the following labels have been used in the drawings to distinguish differently colored bars:

Turquoise Bullish Candle ++: (Tb++) (indicator 2300)

Golden Bearish Candle: (GB) (indicator 1420)

Yellow Bull Warning Candle: (indicator 1430)

Indigo Bear Warning Candle (indicator 1435)

Gray (C) Bullish Candle Gray Bull: (Mgb) (indicator 1440):

It is observed that there are two risk conditions occurring at the same time, yellow bull warning candle and “Mgb” 1440, but the first priority is yellow bull warning candle for the trader or user to identify warnings that it may give control to Bullish Believers.

Tan Bearish Candle ++ (indicator 2375)

Black Neutral Candle (indicator 1460)

Special Buy (indicator 2315);

When a market vehicle has been sold or bought for a long time or a short time, some traders believe that it is time to step into the trade or do a trial/small test trade, even though prices were previously going against what they want to do. Alternately, institutions may make decisions that the Market Vehicles are reasonably priced to take a small amount of risk, or alternately, the institution's research department starts believing that, a particular market vehicle has a near term or medium term or long term potential in the direction research indicates, then the institution may try to test the market with the prices agreed in the research. In some cases, a technical department also comes up with some recommendations, based on their analysis in one or multiple timer periods. Internal movement indicator 520 preferably shows events of internal movement of market, where an outside trading community has the least amount of warning. Yellow Bull Warning Candle (indicator 1430) and Indigo Bear Warning Candle (indicator 1435), in certain instances, indicate such warnings of a trend change, from Bearish Believer to Bullish Believer with respect to yellow bull warning candles and Bullish Believer to Bullish Believer with respect to indigo bear warning candles. Bull belief warning serves as an indication of a confirmation of the trend change from Bearish Believers to Bullish Believers. Bear belief warning serves as an indication of a confirmation of the trend change from Bullish Believers to Bearish Believers.

Typically after formation of Yellow Bull Warning Candle 1430, in many cases, many traders start observing some directional movement in a specific time frame or alternately in several time frames, indicating a directional bullish movement has started taking place and a flow of orders starts coming in. Gray (C) Bullish Candle (indicator 1440) conditions are formed before, after, or together with the Yellow Bull Warning Candle 1430, which preferably is a low risk entry for the bullish direction, as the bullish belief gets converted into a bullish direction at first evidence. However, the enhanced design provides a Bull Entry Spike 1875 ahead of these warnings due to enhanced design of modified health indicator 1216 (FIG. 5) and modified time spectrum segment 1116, which provides a trader or user an even earlier warning to enter a trade and await a Bullish Directional Line 2055 (FIG. 5) in the modified health.

Typically after formation of bear belief warning, in many cases, many traders start observing some directional movement in a specific time frame or alternately in several time frames, indicating a directional bullish movement has started taking place and a flow of orders starts coming in. Pink (C) Bearish Candle (indicator 1445; refer to FIG. 9) conditions are formed, which preferably is a low risk entry for bearish direction, as the bearish belief gets converted in to a bearish direction at first evidence.

Powder Blue (C) Bullish Candle (indicator 1450; refer to FIG. 10), is a special bullish market condition risk earlier entry, and Tan Bearish Candle ++ (indicator 2375), is a special bearish market condition risk earlier entry, are preferably created using various components of price perception risk 245, preferably providing better entries for Bullish Believers or Bearish Believers and per the location of those components. At least one indicator is used to find an extended location with no time delays factors. Using internal market moving risk 215 preferably reduces risk for the entry for Bullish Believers or Bearish Believers.

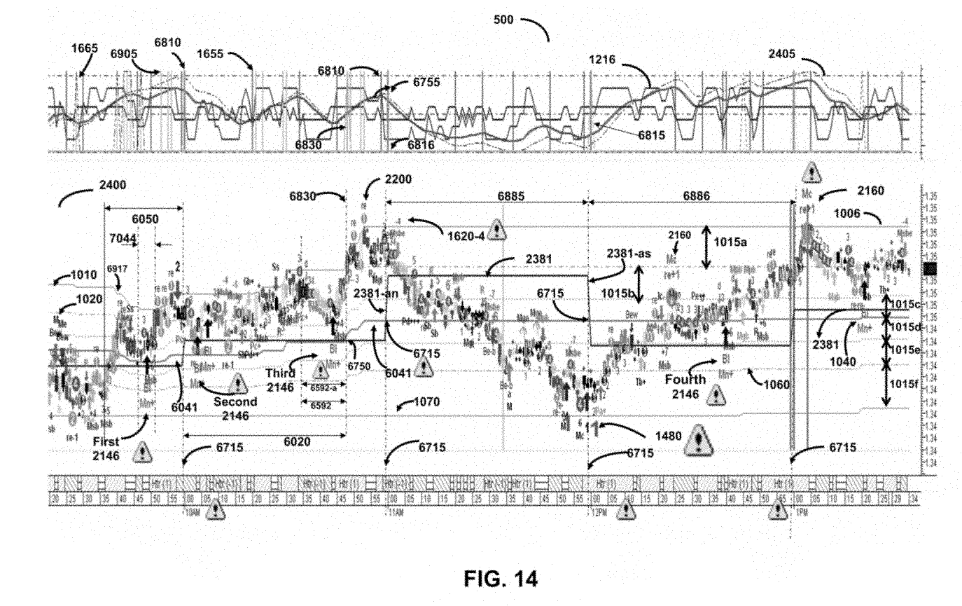

Internal market moving risk 215 preferably comprises multi-dimensional bull entry (indicator 1480 ; refer to FIG. 14) and multi-dimensional bear entry (indicator 1485; refer to FIG. 13), which preferably is based on multiple confirmations of multiple dimensions as per user selection in a design; this may preferably give user 110 an entry based on a risk assessed by risk assessor 140 (FIG. 2) overall based on many factors, not only on one particular component of a selected dimension or a single dimension. Internal market moving risk 215 preferably additionally indicates when there is an equilibrium between Bullish Believers and Bearish Believers in a particular time frame, at a peculiar level or range of levels, using one or more dimensions, by utilizing a Black Neutral Candle (indicator 1460), which preferably indicates that the direction can go either way. Black Neutral Candle (indicator 1460) preferably shows an area of equilibrium, with a pinpoint neutral candle/bar location timing. This typically indicates the exchange between Bullish Believers and Bearish Believers, creating a trading range until either Bullish Believers or Bearish Believers takes control of the direction. The combination of a black neutral candle1460 and a modified neutral time spectrum segment 1151 may be considered to comprise the highest concentration of Neutral Believers. Typically, the previous direction is reversed after the formation of either one or several Black Neutral Candles 1460. This can pinpoint the locations of such events and enhance trading as well as reduces the risk in trading.

Using the components of multiple dimensions, as discussed in this application, earlier highs (indicator 1470-a) and earlier lows (indicator 1475-b), are preferably designated as “risk conditions are met” for extensions from that point. This helps a trader to stay within a trade and expect to meet higher or lower zone lines or breaking such zone lines.

FIG. 7 shows one embodiment of a display, showing an illustrative screenshot view showing several screenshot sections, which together are displaying all eight risk dimensions 206, as is included within certain embodiments of the multidimensional risk analysis systems 100 of FIGS. 1 and 2. In FIG. 7, multi-dimensional, confirmations are shown along with risk recognition, risk designation, risk assessment, formation of nozzlelism, by using multiple dimensions, hybrid zone range risk 276, time duration risk 255, Trend Health Risk 265, price perception risk 245, internal market moving risk 215, multiple conditions risk 235, economic event risk 225) together, a trader or user preferably receives real-time multi-dimensional confirmations, comprising multiple sources of market vehicle influences. Within this figure, the symbol 3NZ shows the type of risk is 3 during the nozzle formation and the step up of zone line 1040 (as shown by 6000) is the Nozzlelism formation. The circled blue “3” and the “3NZ” underneath shows the breakout of the security to a new level due to Nozzlelism formation with multi-confirmation 555. Halved Hybrid Nozzlelism 6000 is forming, Hybrid Zone Level 1010 has shifted to the upside and the symbol “3NZ” under green candle with “3” underneath forming. “In Nozzlelism, the market vehicle is directed towards an upwards breakout direction by the dynamic movement of zone levels (1010). The brown circle in this figure is drawn around the Nozzlelism area.

At least one multi-dimensional indication, as shown in FIG. 7, shows a combination of indicator label, internal movement indicator 520 and modified fixed time spectrum ribbon 1171; each are strong indications for Bullish Believers, and together provide multidimensional confirmation. Multi-dimensional indications are preferably applied to time frame charts starting from ticks to multiple-minute charts. Variables, such as last value, highest sum, and time frame location compared to bigger time frame, specific values of market vehicle on a specific selected time frame, values when specific conditions met cumulative values, absolute values for cumulative specific conditions, combinations of cumulative values, and values at specific combinations and other user choice of conditions, are used. Multiple conditions risk 235 preferably comprises an automatic sequencing and confirmation of multiple conditions, which may derive special meaning and indications for trading, in real-time. Indicators 530 for multiple conditions risk 235 preferably take out the time consuming process of manual handling of special conditions and special conditional sequences. Some of these special conditions can be designed by using the various methods of analysis of market risks 206, as detailed within the teachings of this specification, using traditional indicators, patterns, oscillators, etc., to preferably develop Special Conditional Risk indicators.

There are many events in trading, which occur due to the satisfaction of several conditions at the same time or series of conditions met on a sequential basis. Traders look at them happening, confirm it manually and then make an informal decision to trade; the manual process of confirming is insufficient in trading quickly and sequencing them manually is a difficult and time consuming process.

Multidimensional risk analysis systems 100 reduces these difficulties and time consumption process. FIG. 7 illustrates one example of multiple conditions risk 235, such as the combination of Turquoise Bullish Candle ++ with Earlier Lows −4.4 and modified bullish time segment, hereby referenced with 236. The Bearish Believers were under control during the previous price perception sectional risk type “d”. Due to the visual verification of conflicts between multiple risks 236, a trader or user is alerted that there are conflicts between various risks and sudden changes in the market direction may occur. Such sudden market changes are identified with sudden market spot risks 215. Due to the simple recognition of colors and symbols, an ordinary trader or user with very minimal training benefits from the multidimensional risk analysis systems 100 without exerting much effort into technical analysis and such trader or user has the ability to make quick decisions in trading. FIG. 7 also illustrates another example of multiple conditions risk 235, as such seen as the combination of Multidimensional Bear and price perception sectional risk type “c”, hereby referenced with 237. Price perception sectional risk type “c” is within the illustrative display of a 5 minute chart. Due to “2d” of a higher time frame, where “d” stands for Daily and “2” stands for Multidimensional Bear conflicting with price perception sectional risk type “c”, it can be evident that the Bearish Believers eventually took control over the Bullish Believers as illustrated with the price movement from zone line 1010 to zone line 1040. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

A highly skilled trader or user in the art is able to program such multiple conditions risk events such as 236 and 237, in a single or combination of time frames. An ordinary trader or user only requires learning to recognize colors, symbols and numbers without calculating or having to put together multiple risks to arrive with the same conclusion.

There are many types of fundamental economical risk (economic event risk 225) identified over the period of time preferably comprising interest rate risk, employment data risk, current accounts risks, payroll reports, trade balance, manufacturing numbers, PPI, CPI, home sales, GDP prices, construction spending, earning reports, inventories, and durable goods. FIG. 7 illustrates one example of an economic event risk 225, as seen with an economic risk indicator 540, referred to as Economical Single Event Spike 1885. A trader or user skilled in the art understands that economical event Spikes indicates economical events that are occurring within a market vehicle.

Economic event risk 225 preferably addresses erratic movement in the market from related to the fundamental economical risks as they occur. As illustrated within FIG. 7, before the news, the prices were in a squeezing area of the zone lines 6920. The economical event was represented by Economical Single Event Spike 1885, which indicates a risk for the Bearish Believers or Bullish Believers and alerts 5300 the trader or user, while he/she was busy trading and pay attention without going onto the Internet and searching what time the news are coming. The Economical Single Event Spike 1885 allowed the trader or user to be pro-active in the market and allowed for more possible conservative behavior. Due to this alert, the trader or user who was on the bearish side, may have avoided the financial damage due to Expansion of Zone Lines 6921, Similar Spikes are created for single or multiple events. A trader or user preferably has automatic notification on the software, preferably by alert, preferably at the time of it happens or alternately preferably pre-program and shown during normal trading. Additionally, economical event of the past referably is plotted by having it programmed as an indicator and superimposing it to the price charts or, alternately preferably by making a separate fundamental health risk dimension.

Upon reading the teachings of this specification, those skilled in the art will now appreciate that, under appropriate circumstances, considering such issues as future economic reports, costs, etc., other fundamental economic risks, such as, for example, price rank, group rank, P/E Ratio, debt/equity ratio, date of earning, earning growth, projected earnings, earning estimate, growth ratio, rank of earning, accumulation and distributions, cash flow and its growth, insider trading, dividend, outstanding number of shares, dividend yields, may suffice. Economic event risk 225 preferably is represented in real time using the following type of formula:

7−[GDP-1]/[PPI-1] US 1/30/09 830 AMEST−Htr(1)D(3)

where 7 is indicating that the current prices (either open, close, high, low—user choice) are in economic event risk 225, GDP indicates that there is GDP economical number due at 8:30 AM EST for USA on Jan. 30, 2009, PPI producer price Index for USA will be announced at 8:30 AM EST on Jan. 30, 2009, Htr(1)D indicates that the current dimensional spectrum is bullish on a daily chart for last three days. FIG. 7 shows an illustration of a screenshot view, illustrating family and characteristic indicators 545, according to certain embodiments of FIGS. 1 and 2.

In certain instances of family and characteristic risk 285, there is a risk in a market vehicle due to the class or family that it belongs into. There are more hidden risks within a market vehicle due to the characteristics that each market vehicle might have or due to the characteristics that a few members within a family of Market Vehicles might have. Each market vehicle either follows a same set of Indexes or are effected by other markets or factors differently. A particular family and characteristic risk processor 280 (FIG. 2) and an index are created for a particular market vehicle in order to assess the risk and possible directional movement based upon the complex factors within real time trading. This can not only be based upon the industry these Market Vehicles might be in, but also upon its family and its characteristics.

For example purposes, a trader or user may look at the stocks Merck and Pfizer, both of which are categorized into one family, the Drug Industry. If Pfizer received good or bad news, the entire family of stocks might become effected.

FIG. 7 illustrates two examples of the family and characteristic indicators 545 by Inner Market Family Risk Index 1610 and Inner Market Family Risk Composite Index 1615. With respect to Inner Market Family Risk Index 1610, one needs to find the closest family members in behavior out of all of the family members and the common factors and indexes they may follow and compare them to others. A trader or user uses either all components of the Horizontal Time Risk 255 or one or more components and a highly skilled trader creates an algorithm combining the peculiarities and the common indexes that become effected and also with the other factors that may affect some family members. Such index oscillates between a scale of −5 to +5. Such scale values may vary depending upon the selection of the time frame. FIG. 7 illustrates a 5 minute chart. When the index is near +5, the index can create Bearish Believers concentration whereas a −5 can create a Bullish Believers concentration. Inner Market Family Risk Composite Index 1615 is similar in nature to Inner Market Family Index 1610 with the exception that the algorithm is modified for the exclusion of any component within Trend Health Risk 265. Such index oscillates approximately between 250 to 450, of which the range depends upon the selection of the time frame. FIG. 7 illustrates a 5 minute chart. As illustrated within FIG. 7, before the point labeled “a”, the Inner Market Family Risk Composite Index 1615 remained almost flat. However, Inner Market Family Index 1610 started rising way before the Economic Event Spike 1885 was scheduled, which provides Bullish Believers an extra advantage that there might be a bullish trend development in the near future. The results were evident about this forecast until point “a” and the Inner Market Family Risk Composite Index 1615 started losing value, which gave Bullish Believers a heads-up that they may lose the control and this is evident by the current example between points “a” and “b”. After point “b” the Inner Market Family Index 1610 once again started increasing in value, which lead into further bullish trend development. Both indexes together provide a possible direction and entry/exit system. A highly skilled trader may program such indexes using multiple factors, such as components of modified health indicator 1216 and current values of family members.

FIG. 7 illustrates a screenshot view of a combination of the risk dimensions (market risks 206) that the applicant categorizes in eight major dimensions (eight market risks 206), namely: Vertical Risk Dimension (Hybrid zone range risk 276); Horizontal Time Risk (time duration risk 255); Trend Health Risk 265; Dynamic Sectional Price Risk (price perception risk 245); Sudden Market Spot Change Risk (internal market moving risk 215); Special Conditional Risk (multiple conditions risk 235); Fundamental Risk (economic event risk 225) and family and characteristic risk 285. It also indicates a portion of multidimensional risk analysis systems 100, which comprises, multi-confirmation 555, multi-risk assessment 1465, risk recognition 3000, risk designation or assignment 2045, dynamically forecasting, pin point entries 2085, display of Halved Hybrid Nozzlelism 6000, Scalp-Swing Method Set Ups or Special Multi Low Risk Opportunity Set Ups 2115.

An ordinary trader or user uses multidimensional risk analysis systems 100 in a simplistic manner with the use of colored candles, symbols, numbers, arrows, alerts, and minimal use of technical analysis. The trader or user takes advantage of all of the features or can utilize portions of it, to benefit in trading, without the need for extensive training.

As illustrated within FIG. 7, there are certain instances, if a trader or user is bullish, and does not have extensive knowledge about the market, they are taught to recognize three components for a possible entry, such as a green ribbon 1131 location “c”, a green spike 1875 and a green vertical line 2055 and that a exit of such trade is at the end of the green ribbon 1131 location “d”. With the simple recognition of such three components, the trader or user is able to trade within the market. In another instance, such trader or user is taught to recognize a yellow candle 1430, “Sb” symbol 2315, and a green spike 1875 and can enter the trade and exit at the appearance of a red spike 1880. In certain instances, a trader or user is taught to enter at the appearance of the green vertical line 2055 and exit at the appearance of the red vertical line 2060.

As illustrated within FIG. 7, if a trader or user want to only use a multi-confirmation 555 to enter, he/she selects an entry to go bullish such with 555 by recognizing a symbol which consists of a blue circled “3”, a pink colored risk of “+3” and a pink colored “NZ” and a green colored candle (price perception risk section type “c”) and observing a green ribbon 1131. A trader or user also uses an alert, which notifies such trader or user of the multi-confirmation 555 event and he/she may enter. As illustrated within FIG. 7, if a trader or user would like to know whether he/she can stay within a trade or not, such as for example if a trader is in a trade at point “e”, he/she may use green vertical line 2055 in window 265 and verify the green ribbon 1131, which confirms the bullish direction and he/she can stay within a trade. At point “f”, a trader or user might question as to whether the market will continue further up or not. By recognizing the turquoise line 1655, which serves as a forecasting tool, which is dynamically forecasting, for possible further higher prices, a trader or user stays in a trade and exits by recognizing the risk of Multidimensional Bear 1485 or the appearance of a red vertical line 2060 or a red spike 1880. A trader or user uses a blue circled “3” as a forecasting tool which is dynamically forecasting, to stay within a trade.

As illustrated within FIG. 7, a trader or user determines what the risk is at point “g” on a scale of 1 to 6 (1 being lowest, 6 being highest) for a bullish direction. By observing a “2” underneath the candle/bar, such trader or user can recognize the risk 3000, the trader or user understands that it is a less riskier trade in the bullish direction.

As illustrated within FIG. 7, a trader or user observes a red colored candle at point “h” and feels that he/she should take a bearish position. However, with recognition of a blue circled “3” with a risk of “+2”, the trader or user had a multi-risk assessment 1465 and with the confirmation of a green ribbon 1131 and a green spike 1875 previously, he/she decides to go in a long direction. As illustrated within FIG. 7, a trader or user, at point “i”, would like to know what is the designated risk 2045 in a Halved Hybrid Nozzlelism shape in that particular time frame. By using the designation number, as seen by a pink colored “4”, on a scale of 1 to 6. Number 4 indicates that the market vehicle has moved enough a possible pullback may occur in the near future. As illustrated within FIG. 7, a trader or user, at point “j”, realized he/she was late and missed the “MBew” short entry and would like to determine if he/she can still enter into a trade without any extensive knowledge. By observing the orange colored “5, MSBE”, he/she can make a quick decision to enter into a short trade. MSBE stands for super belief bear pin point entries with a risk of −5 on a scale of −1 to −7. It can be observed that the market vehicle went down so by simply using pin point entries 2085, a trader or user can focus on trading rather than on lengthy technical analysis.

As illustrated within FIG. 7, a trader or user, at point “k”, was in a short position, and an alert appeared for the formation of Halved Hybrid Nozzlelism 6000. By teaching an ordinary trader or user the symbol of “NZ” underneath the candle/bar, along with an alert, he/she exits the short trade and avoid capital losses. Also, at the same token, the little knowledge about Halved Hybrid Nozzlelism shape, in this illustration, if he/she took a long position, he/she could have a successful trade. The breakouts were confirmed by recognizing the symbol “NZ”.

As illustrated within FIG. 7, a trader or user was a scalper, and a point “I”, he/she wanted to do scalping in the market vehicle to earn a small profit, but due to the simple recognition for scalp-swing setup symbol 2115, he/she stayed longer into the trade, until zone line 1040, and was benefitted more.

As illustrated within FIG. 7, at point “e”, a trader or user was long in a position. He/she would like to determine what is occurring in the entire family of similar categories. By simply comparing the Blue Line 1610 to the red vertical line 2060 in the heath window 265, he/she can determine the answer without having to conduct a complicated analysis of all of the family members.

### Halved Hybrid Nozzlelism

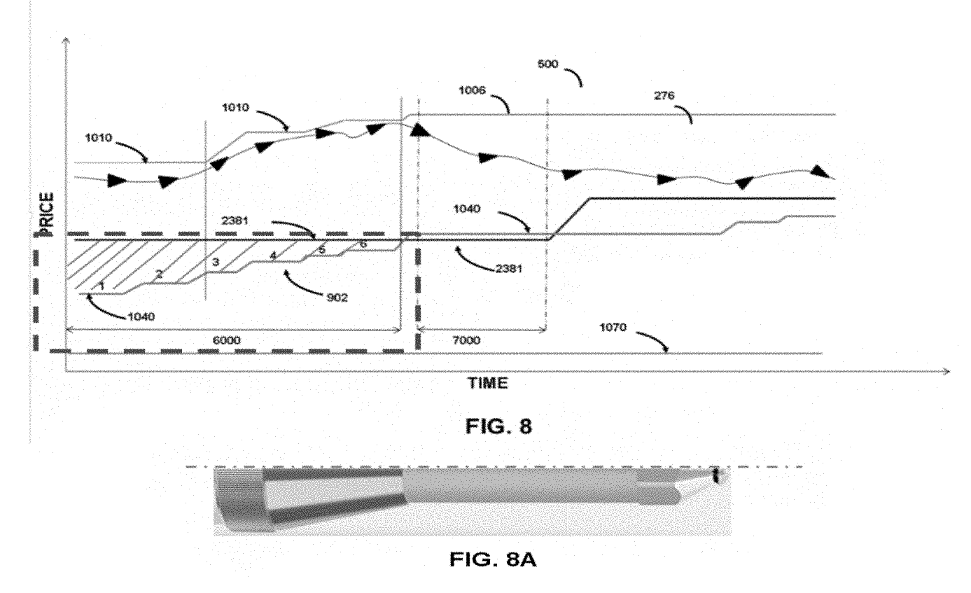

Within this disclosure, the term “Halved Hybrid Nozzlelism” 6000 (FIG. 8) is utilized not to describe a physical nozzle, but to instead illustrate a general shape (that may appear to be that of a nozzle cut in half) or pattern of a variety of indicator combinations, which is utilized to help an ordinary skilled user or trader without extensive as when the mid zone line 1040 and blue line 2381 combine. Visually this can be seen in the shape of a nozzle that is cut in half and zone line 1040 is seen in the shape of “stairs” in which those stairs (zone line 1040) are moving upwards or downwards toward blue line 2381 or moving upwards or downwards away from blue line 2381. The shaded area shown within the red-dotted box is an example of Halved Hybrid Nozzlelism shape. This visual pattern helps indicate trading clues such as training to understand important events occurring within financial markets such as market trend changes, breakouts, retracements, new highs, new lows, directional forecastings, reversals, pullbacks, and many other such trading clues. FIG. 8A is a picture of a commercial nozzle that has been cut in half and looks similar to the Halved Hybrid Nozzlelism. Also, the various types and shapes of Halved Hybrid Nozzlelism tend to indicate and show the accumulation of Bullish Believers or Bearish Believers or the exchange between Bullish Believers and Bearish Believers. Due to increasing demand of Bullish Believers conditions, Neutral believers conditions, and Bearish believers conditions, the prices of any market vehicle, at one point, breaks either upper zone level 1010 or lower zone level 1070 in any time frames, which may constitute either new highs, new lows for either intraday or on daily basis or for a particular time frame on zone levels 1006 basis. In such cases, the rest of zone levels 1020, 1030, 1040, 1050 and 1060 (FIG. 3) follow either upper zone level 1010 or lower zone level 1070. The phenomenon of the formation of Halved Hybrid Nozzlelism shape theory is referred to as “Halved Hybrid Nozzlelism”. “Halved Hybrid Nozzlelism shape” is defined as a two-dimensional line diagram that combines the combination of two indicators/elements, zone line 1040 and blue line 2381. This shape can be formed with the mid zone line, components of the Hybrid Dynamic zone lines of a Lower time frame combined with an Interjected Specialized mid pivot of a Higher time frame.

When comparing the relative positions of mid zone level 1040 with respect to a Blue Line 2381 (FXTA Mid Pivot or any user desired pivot type), an area having a similar appearance as halved the nozzle shape, is formed either above or below the Blue Line 2381, or on left or right side of the end of the tip of the halved nozzle shape. These areas in trading are referred to in this disclosure as “Halved Hybrid Nozzlelism” 6000, which tends to follow a repeating pattern in trading and provides many trading clues, such as: forecasting of direction, forecasting of pullbacks, forecasting retracements, forecasting new or extended trends, reversals, break outs, new trends, etc. Indicators, Alerts and explorers can be designed for all parts of this concept as illustrated by these independently repeating patterns, in part or full.

FIG. 8 shows one embodiment of a display, showing an illustrative screenshot view which is displaying Halved Hybrid Nozzlelism 6000 phenomenon and Halved Hybrid Parallelism 7000, which is included within certain embodiments of the multidimensional risk analysis systems of FIGS. 1 and 2. It also describes an illustrative display of one type of Halved Hybrid Nozzlelism 6000. As such, a person having ordinary skills is able to recognize, with minimal training based on visualization of a variety of illustrative Halved Hybrid Nozzlelism 6000 shapes, as described subsequently, such as may develop in real time based on dynamic changes in the market. For instance, FIG. 8 illustrates a display of dynamically moving interjected specialized mid pivot (also known as mid Blue Line 2381) of a higher time frame based on real time calculations, and illustrates a display of dynamically moving one of the vertical risk components 276 of a lower time frame based on real time calculations of mid zone level 1040. The interjection of specialized mid pivot 2381 of a higher time frame compared to zone levels 1010 and 1040took place between hybrid dynamic zone level 1010 and 1040 in the formation of Halved Hybrid Nozzle and to create Nozzelism where the step up of zone level 1040 creates the Lower Left Halved Hybrid Nozzlelism, which is evident in the shaded area in FIG. 8. A trader or user skilled in the art must use Blue Line 2381 in order to create Halved Hybrid Nozzlelism.

Certain embodiments of the multidimensional risk analysis systems 100, as described above with respect to FIGS. 1 and 2, can be configured to perform the above calculation. Thereupon, the user interface 125 (FIG. 2) will project such a display the formation of Halved Hybrid Nozzlelism 6000 which is observed, as illustrated in real time in FIG. 8. This Halved Hybrid Nozzlelism 6000 is based at least partially in response to the relationship between said dynamically calculating and displaying interjected specialized mid pivot of a higher time frame as taken with respect to said dynamically calculating and displaying vertical risk components of a lower time frame.

In FIG. 8, as the shape of Halved Hybrid Nozzlelism 6000 develops over the period of time in trading (in this case, converging), by observing upward steps 1 and 2, which are initial Components of Halved Hybrid Nozzlelism 6000, an ordinary skilled trader would be led to believe the amount of Bullish Believers are dominating compared to the amount of Bearish Believers. This shape would likely result in a breakout in such a market vehicle, and also likely result in establishing new higher prices of Market Vehicles.

As Halved Hybrid Nozzlelism 6000 further converges into additional upward steps 3, 4, 5 and 6, it becomes evident to market observers considering FIG. 8 that new higher market trend prices have been established. Observe the resulting upward trend direction as indicated and displayed by new upper zone levels 1010 that have been established in real time based on an illustrative dynamic change in the market.

The process of the formation of Halved Hybrid Nozzle Shape uses components of zone line 1040 and interjected specialized mid pivot blue line 2381 and is known as “Halved Hybrid Nozzlelism”. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. A variety of embodiments of Halved Hybrid Nozzlelism are used. Upon read the teachings of this specification, those skilled in the art will now appreciate that, under appropriate circumstances, the concepts behind Halved Hybrid Nozzlelism.

### Components of Halved Hybrid Nozzlelism

FIG. 9 shows one embodiment of a display, showing an illustrative screenshot view showing several screenshot sections, which together are displaying a Halved Hybrid Nozzlelism phenomenon along with a health risk indicator 1216, which is included within certain embodiments of the multidimensional risk analysis systems of FIGS. 1 and 2. It also illustrates one embodiment of certain illustrative Components of Halved Hybrid Nozzlelism. There are a number of, for example, five, more, or fewer components for various embodiments of Halved Hybrid Nozzlelism. For illustrative purposes to show the various components, we are selecting one particular type of Halved Hybrid Nozzelism in FIG. 9, which is called “Lower Left Halved Hybrid Nozzlelism (also known as Lower Left Step Up Halved Hybrid Nozzlelism) 6020”.

As shown in FIG. 9, one component of Halved Hybrid Nozzlelism is Blue Line 2381. For the Halved Hybrid Nozzlelism concept to work, the selected time frame for the mid zone line 1040 must be lower than the time frame selected from the Blue Line 2381 (FXTA mid pivot or any user desired pivot type). A user may see a similar formation of Halved Hybrid Nozzlelism with the use of various other zone lines 1006 as taken in combination of such zone lines 1006. As also shown in FIG. 9, another component of certain embodiments of Halved Hybrid Nozzlelism is the mid Zone Line 1040. The middle zone line is used for Lower Left Halved Hybrid Nozzlelism (also known as Lower Left Step Up Halved Hybrid Nozzlelism) 6020.

Zone Line 1040 is broken up into several components, such as referenced within this disclosure as 1040-a, 1040-b, 1040-c, 1040-d, 1040-e, 1040-f, and 1040-g. Within FIG. 9, zone line 1040 is observed to be moving upwards towards blue line 2381. Each step up of zone line 1040 is broken into the 1040-a, 1040-b, 1040-c, 1040-d, 1040-e towards blue line 2381. This move shows the Lower Left Halved Hybrid Nozzlelism 6020. Below, are a variety of sections, that are taken together such that each may contribute to form Halved Hybrid Nozzlelism. Consider the following illustrative examples of a variety of sections partially contributing to form a variety of Components of

### Halved Hybrid Nozzlelism:

An illustrative halved convergence section 6150 are formed with components 1040-a, 1040-b, Blue Line 2381 and 1040-g.
An illustrative Annularization section 6250 is formed using components 1040-c, Blue Line 2381, and 1040-g.
An illustrative Halved Hybrid Nozzlelism Parallelism section 6350 is formed using components 1040-d, Blue Line 2381, and 1040-g.
An illustrative Halved Hybrid Nozzlelism tipping section 6450 is formed using components 1040-e and Blue Line 2381, and 1040-g.
An illustrative Post Halved Hybrid Nozzlelism confluence section 6565/6550 is formed using components 1040-f, Blue Line 2381, and 1040-g.

A trader or user should be aware that component 1040-g at least partially forms a transition between the various components of zone line 1040. Such a component 1040-g is responsible for the shifting of the zone lines 1005 and connects the various components of the zone line 1040.

A trader or user understands, with respect to Time Projection for Zone Shifting 6975, this indicator is designed to approximately calculate the next shifting Zone Lines 1005, either fully or partially and is based on the current movement and further based upon the current shifting locations. With basis upon the Unscheduled Intersection Of Zone Line 6755 with Blue Line 2381 with reference to either the upper or lower most zone, and further referencing the peaks and trough points of the upper and lower most zone lines, and with the application of the knowledge of symmetric triangles, a trader or user calculates the time cycles of the next shifting. As illustrated within FIG. 9, “A” represents the shifting of the lowermost zone line, “B” represent the peak of the uppermost zone line, “E” represents the Unscheduled Intersection Of Zone Line 6755, “C” represents the reference point created based upon “B” and E. “A”, “B”, and “C” to make a triangle. Between “A” and “C”, it is observed that there is a time duration of 27 [49−22=27] so within approximately the next 30 minutes, (27×10% contingency for errors), the actual shifting of the lower zone line “D” was done after 31 minutes. A trader or user predicts the time cycles for the zone lines using simple mathematics.

Upon reading the teachings of this specification, those skilled in the art will now appreciate that, under appropriate circumstances, the descriptions of the Components of Halved Hybrid Nozzlelism, may suffice.

### Types of Halved Hybrid Nozzlelism

FIG. 9 shows one embodiment of a Lower Left Halved Hybrid Nozzlelism 6020 (also known as lower left step up Halved Hybrid Nozzlelism) which is utilized by certain embodiments of multidimensional risk analysis systems. This phenomenon would likely occur in a Bullish Believer's area. The area between the start of lower left Halved Hybrid Nozzlelism Convergence 6150 to the end of lower left Halved Hybrid Nozzle Tipping 6450 is thereby called Lower Left Halved Hybrid Nozzlelism 6020. At the start of Lower Left Halved Hybrid Nozzlelism Convergence 6150, if Market vehicle prices are above Blue Line 2381 after the formation of first component 1040-a for lower left Halved Convergence 6150 forms, as a part of Lower left Halved Hybrid Nozzlelism 6020 and after formation of 6905, new higher prices for a market vehicle prices may commence due to increasing demand of Bullish Believers. Until all zone lines 1006 have stabilized, extended bullish trend is established, resulting in break outs, and creating intraday new highs.

For lower left Halved Hybrid Nozzlelism 6020 to exist, the corresponding components are lower left Halved Hybrid Nozzlelism Convergence 6150, lower left Halved Hybrid Nozzlelism Annularization (convergence) 6250, lower left Halved Nozzlelism Hybrid Parallelism 6350, and lower left Halved Hybrid Nozzle Tipping 6450. In certain instances, lower left Halved Nozzlelism Hybrid Parallelism 6350 and lower left Halved Hybrid Nozzle Tipping 6450 do not exist due to the sudden intersection of zone line 1040 with Blue Line 2381 or due to the merging of zone line 1040 with Blue Line 2381. If all four components, lower left Halved Hybrid Nozzlelism 6020 (the components are lower left Halved Hybrid Nozzlelism Convergence 6150), lower left Halved Hybrid Nozzlelism Annularization (convergence) 6250, lower left Halved Nozzlelism Hybrid Parallelism 6350, and lower left Halved Hybrid Nozzle Tipping 6450, do not develop, then a skilled trader or user recognizes that there would likely be a pullback just after formation of completed parts. In certain instances, Halved Convergence 6150 may control the bearish direction of the trend. Modified bearish time segment 1141 would likely be bearish during most of the time during Lower Left Halved Hybrid Nozzlelism 6020.

FIG. 10 shows one embodiment of a display, showing an illustrative screenshot view showing several screenshot sections, which together are displaying a colored Candlestick Spectrum chart showing the bearish effect of Halved Hybrid Nozzlelism along with a health risk indicator 1216, which is included within certain embodiments of the multidimensional risk analysis systems 100 of FIGS. 1 and 2. It also shows one illustrative embodiment of an Upper Left Halved Hybrid Nozzlelism (also called Upper left Step Down Halved Hybrid Nozzlelism) 6025, such as may occur to provide a Bearish Believers' area. The area between the start of upper left Halved Hybrid Nozzlelism Convergence 6155 to the end of upper left Halved Hybrid Nozzle Tipping 6455 is called Upper Left Halved Hybrid Nozzlelism. Usually, at the start of Upper Left Halved Hybrid Nozzlelism Convergence 6155, if Market vehicle prices are below Blue Line 2381, after the formation of first component 1040-a for upper left Halved Convergence 6155-a tends to form.

As a partial result of upper left Halved Hybrid Nozzlelism 6025 and after formation of Warning Spot for First Gold PL Line (Bull to Bear) 6906, new lower prices for a market vehicle prices start due to increasing demand of Bearish believers, until all zone lines 1006 have stabilized thereby extending bearish trends. Subsequently, break down likely occurs and intraday new lows are likely created. On the left side of FIG. 10, illustrated are aspects for upper left Halved Hybrid Nozzlelism 6025, upper left Halved Hybrid Nozzlelism Convergence 6155-a, upper left Halved Hybrid Nozzlelism Annularization (convergence) 6255, upper left Halved Nozzlelism Hybrid Parallelism 6355, upper left Halved Hybrid Nozzle Tipping 6455.

In FIG. 10, certain embodiments of aspects including upper left Halved Nozzlelism Hybrid Parallelism 6355 as well as the upper left Halved Hybrid Nozzle Tipping 6455 were eliminated due to Unscheduled Intersection of zone line 6755 for left hand side example. Halved Convergence 6155-a dictates the bearish direction of trend. Modified bearish time segment 1141 is bearish most time during formation of Upper Left Halved Hybrid Nozzlelism 6025.

FIG. 10 shows certain embodiments of Lower Right Halved Hybrid Nozzlelism (also called lower Right Step Down Halved Hybrid Nozzlelism) 6030, which occurs to provide a preliminary Bullish trend. The area between the start of lower right Halved Hybrid Nozzle Tipping 6460 and end of lower right Halved Hybrid Nozzlelism Divergence 6160, is called Lower right Halved Hybrid Nozzlelism. Usually, at the start of Lower Left Halved Hybrid Nozzle Tipping if Market vehicle prices are below Blue Line 2381 and zone line 1040, after the formation of last component 1040-e for lower right Halved Hybrid Nozzle Tipping, area 6460 forms due to formation of unscheduled intersection of zone line 6755 as a part of lower right Halved Hybrid Nozzlelism 6030. After the formation of Warning Spot For First Gold PL Line (Bull To Bear) 6906, new higher prices for a market vehicle prices likely results due to increasing demand of Bullish Believers after all zone lines 1006 stabilized, and thereupon preliminary bullish trends are established, short covering does takes place, higher prices establish temporarily from lowest levels of 1070, and test of nearest zone levels 1060, 1050, 1040 or sometimes Blue Line 2381 takes place. Certain embodiments of lower right Halved Hybrid Nozzlelism 6030 are Lower Right Halved Hybrid Nozzle Tipping 6460, Lower Right Halved Nozzle Hybrid Parallelism 6360, Lower Right Halved Hybrid Nozzlelism Annularization (Divergence) 6260, and Lower Right Halved Hybrid Nozzlelism Divergence 6160. Halved Hybrid Nozzle Divergence 6160 controls the Preliminary Bullish direction of the trend. Modified bullish time segment 1131 is bullish most of the time during lower right Halved Hybrid Nozzlelism 6030. Within FIG. 10, zone line 1040 is observed to be moving downwards away from blue line 2381. Each step down of zone line 1040 is broken into the 1040-e, 1040-d, 1040-c, 1040-b, 1040-a away from blue line 2381. This move shows the Lower Left Halved Hybrid Nozzlelism 6020.

FIG. 10 illustrates a Nozzlelism to Hybrid Parallelism Transformation Point 6371. Such configuration occurs after the formation of halved hybrid nozzle, zone line 1040 fails to intersect Blue Line 2381, which causes it to form Hybrid Parallelism. A trader or user skilled in the art understands that if Hybrid Parallelism forms after this point, it becomes an attraction to those levels for zone line 1040 as well as Blue Line 2381, and within the Hybrid Parallelism phase. A trader or user skilled in the art is aware that such configuration serves as a forecasting tool and causes a breakout from this point. This provides the first evidence of pinpointing the area before the breakouts within the financial market for any market vehicle.

FIG. 11 shows one embodiment of a display, showing an illustrative screenshot view showing several screenshot sections, displaying a colored Candlestick Spectrum chart showing the bullish effect of Halved Hybrid Nozzlelism along with a health risk indicator 1216, which is included within certain embodiments of the multidimensional risk analysis systems 100 of FIGS. 1 and 2. It also shows certain embodiments of Upper Right Halved Hybrid Nozzlelism (also known as Upper Right Step Up Halved Hybrid Nozzlelism) 6035, which occurs during a strong break out in a bullish trend. The area between the start of upper right Halved Hybrid Nozzle Tipping 6465 and end of upper right Halved Hybrid Nozzlelism Divergence 6165 is referred to as Upper right Halved Hybrid Nozzlelism. Usually, at the start of Upper Right Pre Halved Hybrid Nozzlelism Confluence 6585, if Market vehicle prices are above Blue Line 2381 and zone line 1040, after the formation of last component 1040-e for Upper right Halved Hybrid Nozzle Tipping area 6465 forms, due to formation of Upper right Pre Nozzlelism Hybrid Confluence 6585 after scheduled intersection of Blue Line 6715, as a part of Upper right Halved Hybrid Nozzlelism 6035.

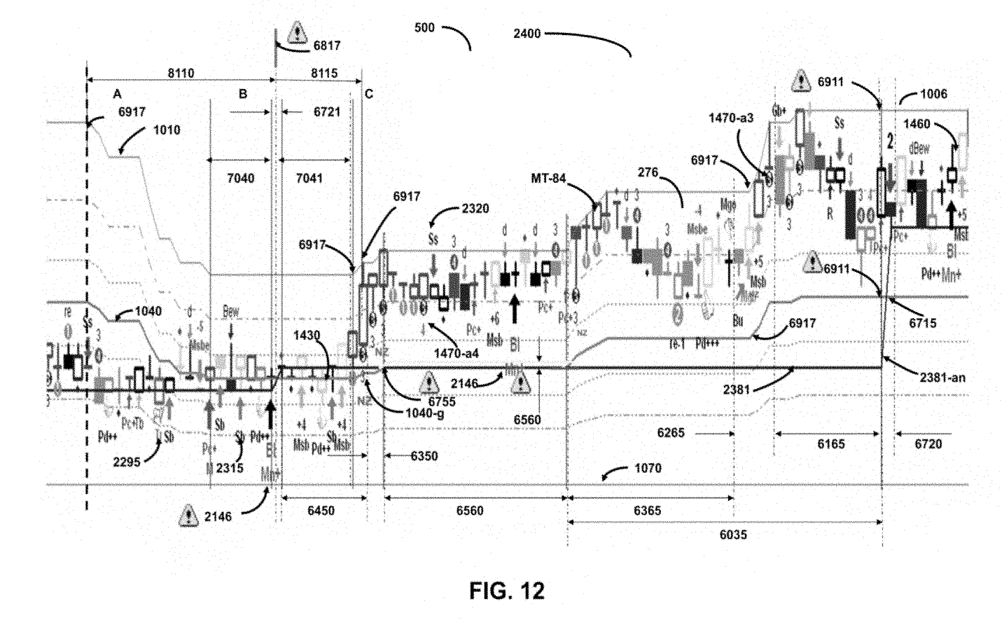

After formation of Warning Spot for First Turquoise PH Line (Bear to Bull) 6905, new higher prices for a market vehicle prices start due to increasing demand of Bullish Believers, all zone lines 1006 tend to start shifting to higher levels and extended bullish trend may establish. Nearest upper zone level 1010 in the current time frame establishes new levels as different parts of upper right Halved Hybrid Nozzlelism 6035 forms, until all zone levels 1006 stabilized. Usually, the stabilization comes when upper zone level equalize the values to nearest zone level 1010, 1020, 1030, 1040 etc. in bigger time frames higher than the current one. Certain embodiments of parts for upper right Halved Hybrid Nozzlelism 6035 are Upper Right Halved Hybrid Nozzle Tipping 6465, Upper Right Halved Nozzle Hybrid Parallelism 6365, Upper Right Halved Hybrid Nozzlelism Annularization (Divergence) 6265, and Upper Right Halved Hybrid Nozzlelism Divergence 6165. If Upper right Pre Nozzlelism Hybrid Confluence 6585 does not exists, an Unscheduled Intersection of zone line 6755 (FIG. 12) takes place, before formation of Upper Halved Hybrid Nozzle Tip 6585. Though not illustrated, it is understood by those skilled in the art that there are other types of Halved Hybrid Nozzlelism which occurs during trading. One example is referred to as Partial Halved Hybrid Nozzlelism. Due to Scheduled Intersection of Blue Line 6715 for either Blue Line angle north 2381-an (FIG. 14) or Blue Line angle south 2381-as, all components of Hybrid Halved Hybrid Nozzlelism do not get completed and may form Partial Halved Hybrid Nozzlelism, which helps during pullback for Bullish Believers or Bearish Believers depending upon the locations of Blue Line angle north 2381-an or Blue Line angle south 2381-as.

FIG. 14 shows one embodiment of a display, showing an illustrative screenshot view showing several screenshot sections, displaying a colored Candlestick Spectrum chart showing a closed hybrid zone risk transfer area along with a health risk indicator 1216, which is included within certain embodiments of the multidimensional risk analysis systems 100 of FIGS. 1 and 2. It also shows one embodiment of Partial Halved Hybrid Upper Nozzlelism 6041. This exemplary illustrative partial Halved Hybrid upper Nozzlelism 6041 was disturbed by scheduled Intersection of Blue Line 2381-an and had caused the prices of Market vehicle to come down to Blue Line level, after the scheduled Intersection 6715 was completed.

FIG. 14 shows one embodiment of Double Upper Halved Hybrid Nozzlelism 6050, which typically occurs in a bullish trend for an ordinary skilled trader to consider entrance into a low risk scalp-swing entry area. For example, when upper left Halved Hybrid Nozzlelism 6025 is connected to Upper Right Halved Hybrid Nozzlelism 6035 by Prep-Pre Double Bullish Trend Hybrid Parallelism 7044 and zone line 1040 remains higher than Blue Line 2381, a Double Upper Halved Hybrid Nozzlelism 6050 is created. This type of Halved Hybrid Nozzlelism is used to create a short term trading opportunity for Bullish Believers, after a down trend, which was reversed by evidence of Sectional Price risk type b and Market vehicle managing to bring prices above Blue Line 2381in lower zone lines such as 1070 or 1060.

FIG. 15 provides an illustrative display of Halved Hybrid Nozzlelism Shifting End Spike/Vertical Line (Bear To Bull) 6915. Such configuration occurs when all zone lines 1006 stop shifting to the downside and remain horizontal for Halved Hybrid Nozzlelism.

Though not illustrated, it is understood by those skilled in the art that there are other type of Halved Hybrid Nozzlelism, which occur during trading. One example is referred to as Double Lower

Halved Hybrid Nozzlelism, which typically occur in a bearish trend for an ordinary skilled trader to consider entrance into a lower risk scalp-swing entry area. When lower left Halved Hybrid Nozzlelism 6025 (FIG. 10) is connected to lower Right Halved Hybrid Nozzlelism 6035 (FIGS. 11 and 12) by Prep-Pre Double Bearish Trend Hybrid Parallelism and zone line 1040 remains lower than Blue Line 2381, a Double Lower Halved Hybrid Nozzlelism is created. This type of Halved Hybrid Nozzlelism is used for creating a short term trading opportunity for Bearish Believers, after an uptrend, which was reversed by evidence of Sectional Price risk type f and Market vehicle managing to bring prices below Blue Line 2381in Upper zone lines such as 1010 or 1020. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. With respect to FIG. 7, for example, a trader or user skilled in the art isi aware of Warning Spot For First Turquoise PH Line (Bear To Bull) 6905. Such configuration occurs where the post, where Halved Hybrid Nozzlelism Convergence ends and where halved Annularization starts. This is referred to as a “break out” or the making of new highs for lower left Halved Hybrid Nozzlelism Convergence and upper right Halved Hybrid Nozzlelism Divergence (“PH” indicates possible higher prices of a market vehicle 1655).

Upon reading the teachings of this specification, those skilled in the art will now appreciate that, under appropriate circumstances, the various types and examples of Halved Hybrid Nozzlelism Annularization for convergence, may suffice.

### Halved Hybrid Nozzlelism Convergence/Divergence

It would be understood by those skilled in the art that such formation of Halved Hybrid Nozzlelism Convergence/divergence requires two zone line components; 1040-a and 1040-b. FIGS. 9 and/or 10 represents one embodiment of the multidimensional risk analysis systems 100 of FIGS. 1 and 2, with four types of Halved Hybrid Nozzlelism Convergence/divergence: Lower Left Halved Hybrid Nozzlelism Convergence 6150, Upper Left Halved Hybrid Nozzlelism Convergence 6155, Lower Right Halved Hybrid Nozzlelism Divergence 6160, and Upper Right Halved Hybrid Nozzlelism Divergence 6165. The variations of convergence and divergences within Halved Hybrid Nozzlelism mechanism contribute to trend development for a short or long term duration. Upon reading the teachings of this specification, those skilled in the art will now appreciate that, under appropriate circumstances, the concepts behind Halved Hybrid Nozzlelism Convergence/divergence, may suffice.

### Halved Hybrid Nozzlelism Convergence

Though it is not illustrated, it is understood by a trader or user skilled in the art that Halved Hybrid Nozzlelism Convergence is part of the upper or lower left side of Halved Hybrid Nozzlelism, in which where the prices flow into this area first and then travel towards Halved Hybrid Nozzle Annularization or Halved Hybrid Nozzle Tipping area, which is for bullish or Bearish Believers. The result of a halved hybrid convergence formation pushes prices away from convergence area and creates a bullish trend for lower left halved side and a bearish trend for upper halved side in the Halved Hybrid Nozzlelism. A trader or user is aware that halved convergence may create an expansion of a current direction. The phenomenon of halved hybrid convergence occurs on left side of an unscheduled intersection of zone line. Upon reading the teachings of this specification, those skilled in the art will now appreciate that there is a variety of embodiments of Halved Hybrid Nozzlelism Convergence.

### Types of Halved Hybrid Nozzlelism Convergence

FIG. 9 illustrates one embodiment of the various types of Halved Hybrid Nozzlelism Convergence, referred to as lower left Halved Hybrid Nozzlelism Convergence 6150, which occurs during a buildup of a pre-bullish breakout. The area between the beginning of the first shifting of the zone lines including the area for at least three previous time frames before shifting and up to the formation of turquoise PH Line 6905 or the beginning of Annularization of lower left Halved Hybrid Nozzlelism is called convergence area for lower left Halved Hybrid Nozzlelism. Initially, all zone lines 1006 remain horizontal and then all zone lines start to shift upwards with the exception of the upper most zone line 1010 up to a breakout point for the upper most level 6905 or with the formation of a warning spot for the first turquoise PH Line 6905. In certain instances, Bearish Believers are overpowered by Bullish Believers with the progression of Horizontal Time Risk 255 until turquoise PH Line 6905 occurs. In such an area, Bullish Believers continue to build up their position at upper zone line 1010, despite the possibility of some Bearish Believers demand.

A trader or user skilled in the art is aware of various indicators that indicate a sign of controversy, such as yellow bar 1430, dynamic price risk type d, and Bew 1435 or other various bearish risk recognition factors. A trader or user skilled in the art is aware of various indicators that indicate a sign of a possible breakout of the higher zone line 1010 for newer intraday highs or new highs, such as with such as Yellow Bull Warning Candle 1430, Purple (C) Candle—Type d++ MT-89, Purple (C) Candle—Type d+++ 2260 or other various bullish risk recognition factors. Such indicators are evident of warnings that are located within an area of convergence and where consolidation at a resistance might have taken place.

FIG. 10 illustrates one embodiment of the various types of Halved Hybrid Nozzlelism Convergence, referred to as upper left Halved Hybrid Nozzlelism Convergence 6155, which occurs during the early stages of Bearish Believeness or during the buildup of a pre-bearish breakdown. The area between the beginning of the first shifting of zone lines including the area for at least three previous time frames before shifting and up to the formation of Gold PH Line 6906 or the beginning of upper left halved Annularization of Nozzlelism is called convergence area for upper Halved Hybrid Nozzlelism.

Initially, all zone lines 1006 remain horizontal and then all zone lines start shifting downwards with the exception of the upper most zone line 1010 up to a point of break down for the lower most level 1070 or formation of a warning spot for first gold PH Line 6906. In certain instances, Bullish Believers are overpowered by Bearish Believers with the progression of Horizontal Time Risk 255 until gold PH Line 6906 occurs. In such an area, Bearish Believers continue to build up their position at and below Blue Line 2381, despite the possibility of some Bullish Believers demand.

A trader or user skilled in the art is aware of various indicators that indicate a sign of a possible breakdown from the lower zone level 1070 to newer intraday lows or new lows, such as with dynamic price sectional risk type e, or type f, forecasting earlier lows with risk assessments or with some other various bearish risk recognition factors. Such indicators are evident of warnings within an area of convergence and where consolidation at the zone line 1070 support might take place before a possible further breakdown. A trader or user is aware that Market Vehicles prices remain below Blue Line 2381.

Upon reading the teachings of this specification, those skilled in the art will now appreciate that, under appropriate circumstances, the various types and examples of Halved Hybrid Nozzlelism Convergence, may suffice.

### Halved Hybrid Nozzlelism Divergence

Though it is not illustrated, it is understood by a trader or user skilled in the art that Halved

Hybrid Nozzlelism Divergence 6110, which is part of the upper or lower left side of Halved Hybrid Nozzlelism, in which where the prices may flow into this area last and it travels from Halved Hybrid Nozzle Annularization/Halved Hybrid Nozzle Hybrid Parallelism area, which is for either for a bullish or Bearish Believers.

The result of stabilization of all zone lines 1005, after a long duration of Horizontal Time Risk 255, start from Halved Hybrid Nozzle Tipping area, which push prices away from the upper most zone line 1010 or the lower most zone line 1070 within this area and creates a Bearish Believers controlled area for the upper right halved side and a Bullish Believers controlled area for the lower halved side in Halved Hybrid Nozzlelism. A trader or user is aware that halved divergence creates a sign of exhaustion of the current trend. The phenomenon of halved divergence occurs on the right side on an unscheduled intersection of zone line 6755. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. A variety of embodiments of Halved Hybrid Nozzlelism Divergence are intended to be applied.

Upon reading the teachings of this specification, those skilled in the art will now appreciate that, under appropriate circumstances, the concepts behind Halved Hybrid Nozzlelism Divergence, may suffice.

### Types of Halved Hybrid Nozzlelism Divergence

FIG. 10 illustrates one embodiment of the various types of Halved Hybrid Nozzlelism Divergence, referred to as lower right Halved Hybrid Nozzlelism Divergence 6160, which occurs during the transition of bearish to bullish, during a bear flag or during the pre-transfer area for bullish to bearish.

Within this area, Bullish Believers continue to build up their position at and below zone line 1040, despite some Bearish Believer's occasional demand. A trader or user skilled in the art is aware of various indicators that indicate a sign of a possible higher high prices from the lower zone level 1070 to a next zone level 1060 or 1050, such as with dynamic price sectional risk types a or b, Super Belief Bull Pin Point En+1**, Super Belief Bull Pin Point En+2* or other various bullish risk recognition factors. Such indicators are evident of warnings within an area of divergence and where zone lines 1006 have stabilized and where support might take place before a further upside takes place. It is evident that sectional price risk type b occurs often, which leads to the testing of zone line 1040 and sometimes even to Blue Line 2381 from the lowest zone level 1070, which is also evident of pinpoint time and price location of the formation of a bear flag within trading, giving an allocation from a highest risk to lowest risk area.

FIG. 11 illustrates one embodiment of the various types of Halved Hybrid Nozzlelism Divergence, referred to as upper right Halved Hybrid Nozzlelism Divergence 6165, which occurs during the pre-bearish break down exhaustion area 6112. The area between end of Halved Hybrid Nozzle Annularization 6265 (within the right side) and between either at least three time frames after the stabilization of all zone lines 1005 or within the scheduled intersection of Blue Line 6715 (to the upside), in upper right Halved Hybrid Nozzlelism is called Upper right halved Divergence area 6165. The Bullish Believers experience exhaustion due to the possible over-expansion of all zone levels 1005 with the exception of the lower most zone level 1070. In certain instances, prices pullback to the nearest zone level 1020 or 1030 around the time of formation of Risk Transition Time Area for Scheduled Intersection of Blue Line 6720 (FIG, 9) or during the Scheduled intersection of Blue Line 2381. Upon reading the teachings of this specification, those skilled in the art will now appreciate that, under appropriate circumstances, the various types and examples of Halved Hybrid Nozzlelism Divergence, may suffice.

### Halved Hybrid Nozzlelism Annularization

Though it is not illustrated, it is understood by a trader or user skilled in the art that Halved Hybrid Nozzlelism Annularization, is an intermediary portion of the Halved Hybrid Nozzlelism formation, which occurs between Halved Hybrid Nozzlelism parallelism and Halved Hybrid Nozzle Tipping area and halved convergence or halved divergence area. A user or trader is aware that the formation of left Halved Hybrid Nozzlelism for convergence occurs on the upper or lower left side of the intersection of zone line 6755 (FIGS. 9, 10, 12, 13 and 14), while the formation of right Halved Hybrid Nozzlelism occurs on the upper or lower right side of the intersection of Blue Line 6755. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

Upon reading the teachings of this specification, those skilled in the art will now appreciate that, under appropriate circumstances, the concepts behind Halved Hybrid Nozzlelism Annularization, may suffice.

### Halved Hybrid Nozzlelism Annularization for Convergence

Though not illustrated, a trader or user skilled in the art understands that the function of the Halved Hybrid Nozzlelism Annularization for convergence, is for the expansion of the trend to a new limit on either an intraday, daily, other time frame basis, or to reach a nearest zone level in the higher time frames. Such a process creates new highs or new lows. A variety of embodiments of Halved Hybrid Nozzlelism Annularization for convergence are within the scope of the present disclosure

### Types of Halved Hybrid Nozzlelism Annularization (Convergence)

FIG. 9 illustrates one embodiment of the various types of Halved Hybrid Nozzlelism Annularization for convergence, referred to as lower left Halved Hybrid Nozzlelism Annularization (convergence) 6250. Such configuration occurs after the formation of Warning Spot For First Turquoise PH Line (Bear To Bull) 6905, or a breakout of zone line 1010, and due to the possibility of extraordinary demand of numerous Bullish Believers, additional bullish risk recognition factors and/or Dynamic Sectional Price Risk types b or c takes place until the occurrence of lower left Halved Hybrid Nozzlelism Hybrid Parallelism 6350. A trader or user skilled in the art expect higher prices within a market vehicle within the Halved Hybrid Nozzlelism Annularization (convergence) 6250 area. In certain instances, zone line 1040 intersects with Blue Line 2381 to the upper side at the end of the portion and forms nozzlelism in the upper right part of Halved Hybrid Nozzlelism as an unscheduled event of a zone line 6755.

FIG. 10 illustrates one embodiment of the various types of Halved Hybrid Nozzlelism Annularization for convergence, referred to as upper left Halved Hybrid Nozzlelism Annularization (convergence) 6255, and serves as an indication of the further expansion of a bearish trend. Such configuration occurs after the formation of Warning Spot for First Gold PL Line (Bull to Bear) 6906, or a breakdown of zone line 1070, and due to the possibility of extraordinary demand of numerous Bearish Believers, additional bearish risk recognition factors 3010 and/or Dynamic Sectional Price Risk 245 types e or f may take place until the occurrence of upper Halved Hybrid Nozzlelism parallelism 6355. A trader or user skilled in the art is aware that zone line components such as 1040-b and 1040-g and horizontal Blue Line 2381 are required. Such configuration leads into the formation of Halved Hybrid Nozzlelism parallelism and the possibility of further new levels of zone line 1070. A trader or user is alerted by all important events as illustrated by a yellow triangle or any trader or user desired colors or triangles. All important events have alerts that are selected by a trader or user can have alerts may be and are sent via electronic mail, PDA's, or by audio/visual alert on chart during trading. Upon reading the teachings of this specification, those skilled in the art will now appreciate that, under appropriate circumstances, the various types and examples of Halved Hybrid Nozzlelism Annularization for convergence, may suffice.

### Halved Hybrid Nozzlelism Annularization for Divergence

Though not illustrated, a trader or user skilled in the art understands that the function of the Halved Hybrid Nozzlelism Annularization for divergence is for the release of pressure that occurs from either the bullish or Bearish Believers in a previous trend and helps stop further losses in trading. During such formation, zone lines 1006 become stabilized and the transformation of one type of believers to the other type of believers occurs.

Upon reading the teachings of this specification, those skilled in the art will now appreciate that, under appropriate circumstances, the concepts behind Halved Hybrid Nozzlelism Annularization for divergence, may suffice.

### Types of Halved Hybrid Nozzlelism Annularization (Divergence)

FIG. 10 illustrates one embodiment of the various types of Halved Hybrid Nozzlelism Annularization for divergence, referred to as lower right Halved Hybrid Nozzlelism Annularization (divergence) 6260. After the formation of Lower Right Halved Hybrid Nozzle Tipping 6460, a stabilized zone line 1070 occurs and the demand for Bearish Believers diminishes and Scalp-Swing set ups such as earlier lows −4.6(Mc)++ 2156, earlier lows −4.6(Mc)+, or earlier lows −4.6(Mc) and/or bullish risk recognition factors such as Dynamic Sectional Price Risk type a, Earlier Highs +3.1 1470-a1, or Earlier Highs +3.2 1470-a2 takes place until the formation of lower right Halved Hybrid Nozzlelism Divergence 6160. A trader or user expects slightly higher prices or a small possible consolidation of a market vehicle, which leads to higher prices for the next phase of lower right Halved Hybrid Nozzlelism Divergence 6160.

With respect to FIG. 10, for example, a trader or user skilled in the art is aware of Warning Spot For First Gold PL Line (Bull To Bear) 6906. Such configuration occur where the post, where Halved Hybrid Nozzlelism Divergence end and where halved Annularization starts. This is referred to as a “breakdown” or the making of new lows for upper left Halved Hybrid Nozzlelism Convergence and lower right Halved Hybrid Nozzlelism Divergence (“PL” indicates possible lower prices of a market vehicle 1660).

FIG. 11 illustrates one embodiment of the various types of Halved Hybrid Nozzlelism Annularization for divergence, referred to as Upper Right Halved Hybrid Nozzlelism Annularization (Divergence) 6265. After the formation of upper right Halved Hybrid Nozzlelism parallelism 6365, due to the increasing demand from Bullish Believers, all zone lines with the exception of the lowest zone line 1070 shift to the upside, and help forms at least two zone line components 1040-c and 1040-g, wherein as 1040-c is parallel to the Blue Line 2381. A trader or user skilled in the art expects turquoise PH lines 1655 within the health risk indicator 1215/ modified health risk indicator 1216 area and also expects some pink ext bear warning lines 1675 and/or higher risk symbols such as “4” or “5”. A trader or user is alerted by all important events as illustrated by a yellow triangle or any trader or user desired color or shapes. All important events have alerts that are selected by a trader or user can have alerts may be and are sent via electronic mail, PDA's, or by audio/visual alert on chart during trading.

Upon reading the teachings of this specification, those skilled in the art will now appreciate that, under appropriate circumstances, the various types and examples of Halved Hybrid Nozzlelism Annularization for divergence, may suffice.

### Halved Nozzle Hybrid Parallelism

FIG. 8 describes an illustrative display of one type of halved nozzle Hybrid Parallelism. As such, a person having ordinary skills is able to recognize, with minimal training based on visualization of a variety of illustrative halved nozzle Hybrid Parallelism shapes, as described subsequently, which develops in real time based on dynamic changes in the market. For instance, FIG. 8 illustrates a display of dynamically moving interjected specialized mid pivot (also known as mid Blue Line 2381) of a higher time frame based on real time calculations, and illustrates a display of dynamically moving one of the vertical risk components 276 of a lower time frame based on real time calculations of mid zone level 1040.

Certain embodiments of the multidimensional risk analysis systems 100, as described above with respect to FIGS. 1 and 2, is configured to perform the above calculation. Thereupon, the user interface 125 (FIGS. 1 and 2) will project such a display the formation of halved nozzle Hybrid Parallelism 7000 which is observed, as illustrated in real time in FIG. 8. This halved nozzle Hybrid Parallelism 7000 is based at least partially in response to the relationship between said dynamically calculating and displaying specialized interjected mid pivot of a higher time frame as taken with respect to said dynamically calculating and displaying vertical risk components of a lower time frame, but both components remain parallel.

In FIG. 8, halved nozzle Hybrid Parallelism 7000 shape develops over the period of time in trading, FIG. 8 illustrates one embodiment of halved nozzle Hybrid Parallelism 7000, which serves as an indication of a bullish to bearish trend change and profit taking by the Bullish Believers and as a sign of retracement for the bulls. Such configuration occurs during the post and pre formation of Halved Hybrid Nozzlelism 6000, and after or before the intersection with Blue Line 2381. It is observed that market vehicle prices lost its value due to the lack of Bullish Believers and taking profits and the empowerment of Bearish Believers.

Generally, a trader or user skilled in the art understands that halved hybrid nozzle parallelism occurs after the formation of a tipping area on either the upper right or lower right side of the Halved Hybrid Nozzlelism and after the formation of lower or upper left halved Annularization portion of the Halved Hybrid Nozzlelism. Such configuration is comprised of zone line component 1040-d (FIGS. 9, 10, and 11) and requires 1040-g (FIGS. 9, 11, 12, and 13) to connect the other component. A trader or user skilled in the art understands that the distance between Blue Line 2381 and zone line 1040 is approximately 4 pips for currencies (FIG. 13) and is approximately two cents for stocks/ETFs or any other market vehicle (FIG. 13) (being provided for reference purposes only).

It is further understood that both lines should be parallel. Upon reading the teachings of this specification, those skilled in the art will now appreciate that there are a variety of embodiments of halved nozzle Hybrid Parallelism.

### Types of Halved Nozzle Hybrid Parallelism

FIG. 9 illustrates one embodiment of the various types of halved nozzle Hybrid Parallelism, referred to as lower left halved nozzle Hybrid Parallelism 6350. Within such area, the Bullish Believers still are in control. However, the possibility of risk designators such as “4” or “5” are observed and the possibility of a higher Msb 2080 such as 6 or 7 are observed, which states to a trader or user skilled in the art that there is higher risk which becomes evident by the Hybrid Parallelism of Blue Line 2381 and zone line 1040 within a very short distance, which is approximately 5 pips for currencies and is approximately fifty cents for stocks or other Market Vehicles. It becomes evident that at the end of Hybrid Parallelism, the Bullish Believers become exhausted within such area. A trader or user is aware of bearish risk recognition factors, such as Super Bullish Belief Contra+Re 2200, Super Bullish Belief Contra+Re1 (not illustrated), and/or Super Bullish Belief Contra+Re2 (not illustrated). FIG. 10 illustrates one embodiment of the various types of halved nozzle Hybrid Parallelism, referred to as upper left halved nozzle Hybrid Parallelism 6355. After the formation of Nozzlelism to Hybrid Parallelism Transformation Point 6371, both zone line 1040 and Blue Line 2381 stay parallel to one another for a period of time until either the occurrence of a Scheduled Event of Blue Line or shifting of zone lines 1006. A trader or user is aware that zone line 1040 is higher than Blue Line 2381 and such distance is approximately 5-7 pips for currencies and 50 cents for stocks or other Market Vehicles. The phenomenon of Hybrid Parallelism is used as a forecasting tool and causes zone line 1040 and Blue Line 2381 to attract Bullish Believers into testing these levels. A trader or user skilled in the art is aware of dynamic price risk types a orb, BW 1430, yellow bar 1430, and/or other bullish risk recognition factors, which support forecasting. A trader or user is also aware that zone lines 1006 are parallel during this configuration.

FIG. 10 illustrates one embodiment of the various types of halved nozzle Hybrid Parallelism, referred to as lower right halved nozzle Hybrid Parallelism, which serve as an indication of the transformation from bearish to bullish trend. Lower right halved nozzle Hybrid Parallelism occurs if after the formation of lower right Halved Hybrid Nozzle Tipping 6460, zone line 1040 continues to expand with Horizontal Time Risk 255, provided that the lowest zone line 1070 remain parallel to Blue Line 2381 and whereas component 1040-d is parallel to Blue Line 2381 and has a visible distance from the Blue Line and comprise of at least one component of 1040-g. A trader or user skilled in the art is aware of factors such as Black Neutral Candle (also known as Neutral Bar) 1460, earlier lows −4.6(Mc)++2156, Earlier Highs +3.1 1470-a1, Powder Blue (C) Bullish Candle 1450 and/or other bullish risk recognition factors for the divergence of flow through the body of halved hybrid nozzle towards right lower Annularization 6260.

FIG. 11 illustrates one embodiment of the various types of halved nozzle Hybrid Parallelism, referred to as upper right halved nozzle Hybrid Parallelism 6365. This configuration occurs between the upper right Halved Hybrid Nozzle Tipping 6465 and the upper right halved Annularization 6255, where in as at least two components 1040-d and 1040-g exists. 1040-d is parallel to Blue Line 2381, and has a visible distance from Blue Line 2381. A trader or user is aware that there is a strong hold in the market vehicle prices due to the outperformance to the Bearish Believers by the Bullish Believers. In certain instances, super bullish belief entries 1621 are created regardless of the possibility of higher risk designators such as “4” or “5”. A trader or user is further aware that the existence of turquoise PH lines 1655 serves as an indication of a further expansion of the uppermost zone lines, which includes zone line 1040 should zone line 1070 stay horizontal. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. Upon reading the teachings of this specification, those skilled in the art will now appreciate that there are a variety of other types and examples of halved nozzle Hybrid Parallelism.

### Halved Hybrid Nozzle Tipping

Though not illustrated, a trader or user skilled in the art understands that the front Hybrid Parallelism portion, which is in variable length on a Horizontal Time Risk from one to several number of the same time frame and connects at least two Components of Halved Hybrid Nozzlelism, such as 1040-e (FIGS. 9, 10, and 11) and 1040-g (FIGS. 9, 10, 11, 12, and 13) are referred to as nozzle tipping area. The end of the tip starts with an unscheduled intersection of zone line 1040 or with the pre-nozzlelism hybrid confluence and the other end is connected to halved nozzle Hybrid Parallelism. A trader or user skilled in the art is aware that zone lines 1006 should remain parallel to Blue Line 2381 during the formation of 1040-e. This configuration serves as an indication of a low risk area for an upcoming trend. Upon reading the teachings of this specification, those skilled in the art will now appreciate that there are a variety of embodiments of Halved Hybrid Nozzle Tipping.

### Types of Halved Hybrid Nozzle Tipping

FIG. 9 illustrates one embodiment of the various types of Halved Hybrid Nozzle Tipping, referred to as lower left Halved Hybrid Nozzle Tipping 6450. After the formation of lower halved nozzlelism Hybrid Parallelism 6350, a trader or user skilled in the art understands that if zone line 1040 has not penetrated Blue Line 2381, it stays parallel to Blue Line 2381, but at a very minute visible distance, thus creating Halved Hybrid Nozzle Tipping shape over several times frames over an extended Horizontal Time Risk 255, since the formation of the scheduled or unscheduled risk transition line. In certain instances, during the tipping formation, Bullish Believers may become exhausted within this area. A trader or user skilled in the art is aware of various factors such as Super Bullish Belief Contra+Re 2200, Super Bullish Belief Contra+Re1 (not illustrated), Super Bullish Belief Contra+Re2 (not illustrated), Black Neutral Candle (Neutral Bar) 1460, Magic: Out 2330 (FIG. 6), and/or other bearish risk recognition factors.

A trader or user is further aware that a formal pullback takes place before the end of halved hybrid nozzle tip, which serves as an indication as a sign of weakness from the Bullish Believers, which is evident by factors, but not limiting in scope, such as Black Neutral Candle (Neutral Bar) 1460 (FIGS. 6, 9, and 10) or Super Bullish Belief Contra+Re 2200 (FIGS. 9, 17, and 18). It is further noted that halved tipping ends with the intersection of zone line 1040 to Blue Line 2381. FIG. 10 illustrates one embodiment of the various types of Halved Hybrid Nozzle Tipping, referred to as upper left Halved Hybrid Nozzle Tipping 6455. Such configuration occurs after the formation of Upper Left Halved Nozzlelism Hybrid Parallelism 6355, where Bullish Believers have taken control from the Bearish Believers, which is evidenced by modified bullish time segment 1131. Due to the possibility of an increasing demand from Bullish Believers, a nozzle shape occurs within three to four time periods, instead of zone line 1040 intersecting with blue 2381. This forms a first evidence of transformation to hybrid confluence, which occurs at the end of the nozzle. A trader or user skilled in the art is aware of factors such as Yellow Bull Warning Candle 1430, Gray (C) Bullish Candle 1440, Black Neutral Candle 1460, and/or other bullish risk recognition factors.

FIG. 10 illustrates one embodiment of the various types of Halved Hybrid Nozzle Tipping, referred to as lower right Halved Hybrid Nozzle Tipping 6460, which serves as an indication of the Bearish Believers' last action. Such configuration occurs after the unscheduled intersection of zone line 6755, which further leads to zone line component 1040-e making a confluence with Blue Line 2381 and has component 1040-g on the lower right side of 6755. A trader or user skilled in the art is aware that lower zone line 1070 stays horizontal to blue 2381. This area serves as the first evidence of the stabilization of market prices after a selloff, which brings the attraction of Bullish Believers. A trader or user skilled in the art is aware that the possibility of Lower Right Halved Nozzle Hybrid Parallelism 6360 forms.

FIG. 11 shows one embodiment of the various types of Halved Hybrid Nozzle Tipping, referred to as upper right Halved Hybrid Nozzle Tipping 6465, which serves as an indication of a bullish trend to a more bullish trend and the possibility of a first breakout point. After the formation of upper right halved pre-nozzle hybrid confluence 6585, most of the zone lines remain parallel until the possible shifting point 6917 becomes established for upper zone line 1010. After such shifting point, component 1040-g occurs. Such configuration of upper right Halved Hybrid Nozzle Tipping occurs when there are three time period distances from upper right halved hybrid confluence 6585 up until the possible formation of Upper Right Pre Halved Hybrid Nozzlelism Confluence 6585, with the inclusion of 1040-e.

A trader or user skilled in the art is aware that such area of this configuration helps Bullish Believers build up their position and to further buildup more positions which leads to the creation of shifting point 6917 for zone line 1040. It should further be aware that Warning Spot for First Turquoise PH Line 6905 serves as a warning sign of Turquoise PH Line 1655 and that commitment from Bullish Believer is possible even if there is the possibility of higher risk numbers such as “3” or “4”. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. Upon reading the teachings of this specification, those skilled in the art will now appreciate that there are a variety of types and examples of Halved Hybrid Nozzle Tipping.

Forecasting Earlier Highs and Earlier Lows for Halved Hybrid Nozzlelism with Risk Assessment

Though not illustrated, a trader or user skilled in the art understands that in trading, one can forecast with the use of risk assessment during the formation of Halved Hybrid Nozzlelism. It is understood that as Halved Hybrid Nozzlelism process takes place, during the shifting of zone line 1010 or 1070, there are designation of numbers such as, but not limiting in scope, “1NZ”, “2NZ”, “3NZ”, “4NZ”, “5NZ” or “6NZ”, which are referred to as risk designators of Halved Hybrid Nozzlelism. A trader or user skilled in the art further categorizes such risks as per his/her choice. Such risk designations helps a trader or user to forecast earlier highs or lows with risk assessments during the formation of Halved Hybrid Nozzlelism.

A trader or user skilled in the art understands that since Halved Hybrid Nozzlelism has the inheritance of additional support from the bullish or Bearish Believers, taking the upper risk designators for Halved Hybrid Nozzlelism, such as 3NZ, 4NZ or 5NZ, are safer entries compared to the risk designators 2045 (FIGS. 6, 7 and 11), such as “3”, “4”, “5”, or “6”.

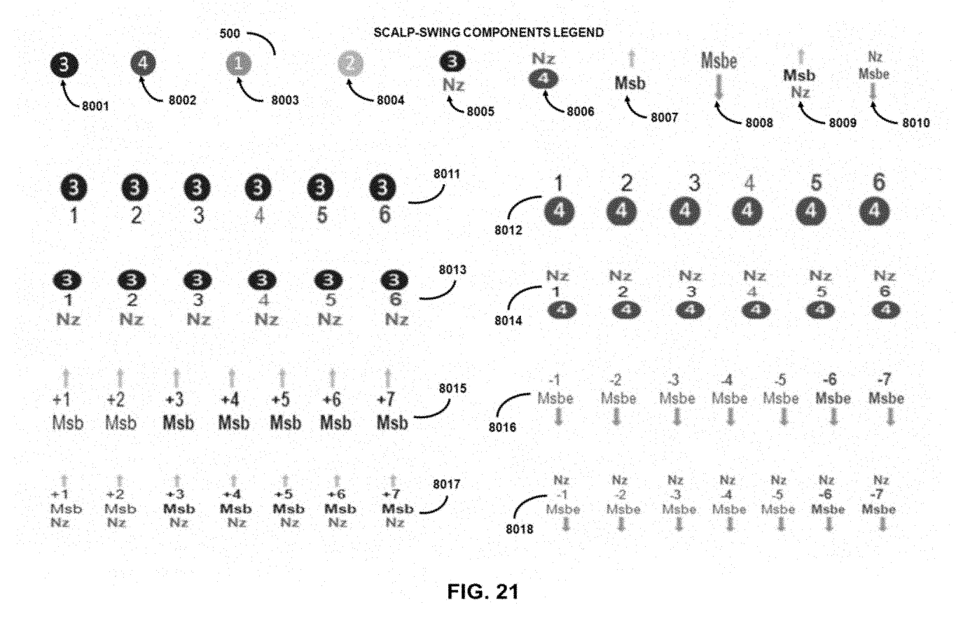

FIG. 21 illustrates one embodiment of forecasting earlier highs and earlier lows for Halved Hybrid Nozzlelism with risk assessment, which is referred to as forecasting earlier highs with risk assessment for Halved Hybrid Nozzlelism 8013. A trader or user skilled in the art understands that as the Halved Hybrid Nozzlelism process takes places, during the shifting of zone 1010, designation of risk designators for Halved Hybrid Nozzlelism, such as, but not limiting in scope, “1NZ”, “2NZ”, “3NZ”, “4NZ”, “5NZ” or “6NZ” take place if risk designators such as, but not limiting in scope, “1”, “2”, “3”, “4”, “5”, or “6” are available. With respect to FIG. 21, it is further understood that the design is the same as forecasting earlier highs with risk assessments 8011, with exception to the Halved Hybrid Nozzlelism process. A trader or user skilled in the art understands that such risk designators further categorizes as per a trader or users choice. Reference to the Users Manual is given attention to for various categories of forecasting earlier high details.

FIG. 21 illustrates one embodiment of forecasting earlier highs and earlier lows for Halved Hybrid Nozzlelism with risk assessment, which can be referred to as forecasting earlier lows with risk assessment for Halved Hybrid Nozzlelism 8014. A trader or user skilled in the art should understand that as the possibility of the Halved Hybrid Nozzlelism process takes places, during the possible shifting of zone 1070, designation of risk designators for Halved Hybrid Nozzlelism such as, but not limiting in scope, “1NZ”, “2NZ”, “3NZ”, “4NZ”, “5NZ” or “6NZ” might take place if risk designators 2045 such as, but not limiting in scope, “1”, “2”, “3”, “4”, “5”, or “6” are available. A trader or user skilled in the art should understand that such risk designators are further categorized as per a trader or users choice. Reference to the Users Manual should be given attention to for various categories of forecasting earlier low details. With respect to FIG. 21. it is further understood that the design is the same as forecasting earlier low with risk assessments 8012, with exception to the Halved Hybrid Nozzlelism process. Upon reading the teachings of this specification, those skilled in the art will now appreciate that, under appropriate circumstances, there are a variety of types and examples behind forecasting earlier highs and earlier lows for Halved Hybrid Nozzlelism with risk assessment.

Super Belief Bull/Bear Pin Point Entries with Risk Assessment for Halved Hybrid Nozzlelism

Though not illustrated, a trader or user skilled in the art understands due to the additional support from bullish or Bearish Believers in the Halved Hybrid Nozzlelism process, one can, so long as the shifting of zone lines do not stop, use super belief bear pin point entries categories with risk assessment or MSBE or higher risk designators such as, but not limiting in scope, “4NZ”, “5NZ”, or “6NZ instead of risk designators such as, but not limiting in scope, “4”, “5”, or “6”. A trader or user skilled in the art understands that the same logic applies to super belief bear pin point entries categories with risk assessment or MSB.

FIG. 21 illustrates one embodiment of super belief bull/bear pin point entries with risk assessment for Halved Hybrid Nozzlelism, which is referred to as super belief bull pin point entries with risk assessment for Halved Hybrid Nozzlelism 8017. A trader or user skilled in the art understands that as Halved Hybrid Nozzlelism process takes place, during the shifting of zone line 1010, designation of risk designators designation of risk designators for Halved Hybrid Nozzlelism such as, but not limiting in scope, “1NZ”, “2NZ”, “3NZ”, “4NZ”, “5NZ”, “6NZ” or “7NZ” take place if risk designators such as, but not limiting in scope, “1”, “2”, “3”, “4”, “5”, “6”, or “7” are available. A trader or user skilled in the art understands that such risk designators are further categorized as per a trader or users choice. Reference to the Users Manual is given attention to for various categories of super belief bull pin point entries with risk assessment for Halved Hybrid Nozzlelism details. With respect to FIG. 21, it is further understood that the design is the same as Super Belief Bull Pin Point Entries Categories w/Risk Assessment 8015, with exception to the Halved Hybrid Nozzlelism process.

FIG. 21 illustrates one embodiment of super belief bull/bear pin point entries with risk assessment for Halved Hybrid Nozzlelism, which is referred to as super belief bear pin point entries with risk assessment for Halved Hybrid Nozzlelism 8018. Though not illustrated, a trader or user skilled in the art understands that as Halved Hybrid Nozzlelism 6000 process takes place, during the shifting of zone line 1070, designation of risk designators designation of risk designators for Halved Hybrid Nozzlelism such as, but not limiting in scope, “1NZ”, “2NZ”, “3NZ”, “4NZ”, “5NZ”, “6NZ” or “7NZ” take place if risk designators such as, but not limiting in scope, “1”, “2”, “3”, “4”, “5”, “6”, or “7” are available. A trader or user skilled in the art understands that such risk designators are further categorized as per a trader or user's choice. Reference to the Users Manual is given attention to for various categories of super belief bear pin point entries with risk assessment for Halved Hybrid Nozzlelism details. With respect to FIG. 21, it is further understood that the design is the same as Super Belief Bear Pin Point Entries Categories w/Risk Assessment 8016, with exception to the Halved Hybrid Nozzlelism process. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading can have alerts may be and are sent via electronic mail, PDA's, or by audio/visual alert on chart during trading. Upon reading the teachings of this specification, those skilled in the art will now appreciate that there are various types and examples of super belief bull/bear pin point entries with risk assessment for Halved Hybrid Nozzlelism.

Scalp Swing Trading with Halved Hybrid Nozzlelism

Within this disclosure, the term “Scalp-Swing” is utilized to demonstrate a unique trading style, which is utilized to help an ordinary skilled trader to understand important events such as market trend change, breakouts, retracements, new highs, new lows, directional prediction, reversals, pullbacks, and many other trading clues. Though not illustrated, a trader or user skilled in the art understands that due to the discovery of Halved Hybrid Nozzlelism, its stated details and its components, the use of Scalp-Swing Trading has brought accuracy in trading to new levels. A trader or user trades with various types of Halved Hybrid Nozzlelism and can trade any market vehicle in any time frame with high levels of efficient trading. A trader or user uses forecasting earlier highs and earlier lows for Halved Hybrid Nozzlelism with risk assessment and/or, but not limiting in scope, super belief bull/bear pin point entries with risk assessment for Halved Hybrid Nozzlelism for the refinement of Scalp-Swing.

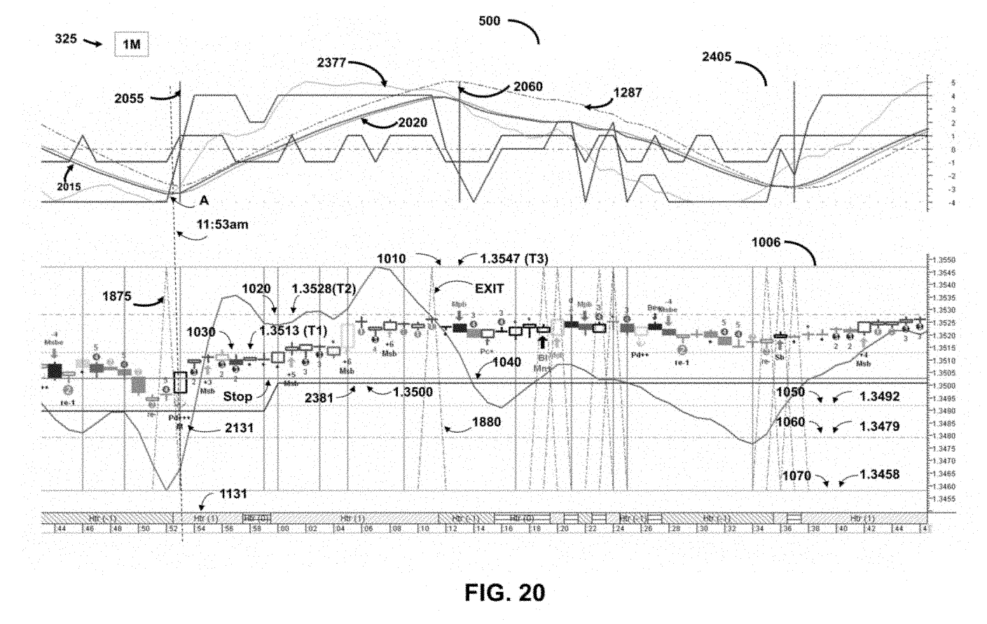

A trader or user is aware that Scalp-Swing trading is applied to various types or shapes of Halved Hybrid Nozzlelism but for example purposes, only one example is provided herein. FIG. 11 illustrates one embodiment of Scalp-Swing trading with Halved Hybrid Nozzlelism, referred to as scalp-swing trading with upper right Halved Hybrid Nozzlelism. A trader or user looks for a scalp-swing setup for bullish symbols such as, but not limiting in scope, Bullish Dk Yellow Candle—Type a ++ (M) 2126 (FIG. 17), Bullish Dk Yellow Candle—Type a (M) 2127 (FIG. 18), Bullish Bright Green Candle—Type b (M) (not illustrated), Bullish Green Candle—Type c + (M) Pc+ (not illustrated), Purple (C) Candle—Type d +++ (M) Pd 2131 (FIG. 20), Turquoise Bullish Candle + (M) (not illustrated), Gray (C) Bullish Candle (M) (not illustrated), Black Neutral Candle (Mn+) 2146 (FIGS. 11, 13, 14, and 15) Powder Blue (C) Bullish Entry(Me)+Oex (not illustrated), or SuperBearishBeliefContra-Re-2(Me) (FIG. 13).

Within FIG. 11, it can be seen that Black Neutral Candle (Mn+) 2146 occurred. A trader or user uses the beginning of modified bullish time segment 1131 and the formation of green spike 1875 to enter a trade.

Upon further evaluation of such entry, a trader or user puts a tight stop after the formation of the first pink line 1675 and trail until the stabilization of zone lines 1006. Another exit is with the appearance of red spike 1880 or modified bearish time segment 1141. Within such listed entry and exit, as portrayed in FIG. 11, it took approximately 29 minutes for such a trade to take place and created an 80 pip move from 1.3570 to 1.3650. A trader or user uses a vertical direction green line 2055 as another entry point. The use of the modified dynamic strength risk indicator 1287 with values exceeding +6 may be used as a warning sign for the use of tightening stops and trail them. An aggressive trader can add additional lots or positions at each turquoise PH line 1655 for the first seven to nine/ten line appearances or until the third pink line 1675.

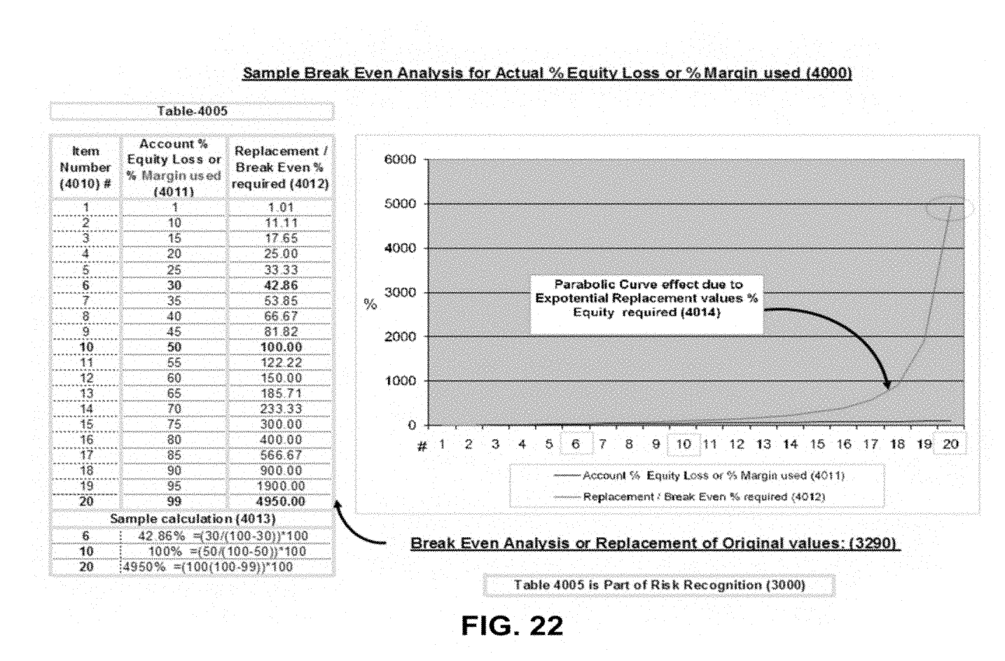

Typically, with reference to FIG. 11, a series of turquoise PH lines 1655 takes place, which start at, but not limiting in scope, Warning Spot For First Turquoise PH Line (Bear To Bull) 6905, during upper right halved nozzle Hybrid Parallelism 6365, during upper right Halved Hybrid Nozzlelism Annularization (divergence) 6265, and during upper right Halved Hybrid Nozzlelism Divergence 6165. The appearance such lines forms in a total of approximately 12 to 14 counts for a very powerful trend, up to 9 for a medium breakout, up to 5 for a normal breakout, and sometimes a scattered of one or two to match upper time frame levels. Indicators such as earlier highs +3.4 1470-a4, earlier highs +3.5 1470-a5, or earlier highs +3.6 1470-a6, despite the use of higher risk warnings such as “4” or “5” help predict higher prices and in helping to make intraday highs or new highs until the stabilization of zone levels 1006 and the establishment of modified bearish time segment 1141. The formation of a first few pink extended bear warning lines 1675 in upper right halved Annularization 6265 serve as an indication of an upcoming exhaustion in the upper right halved hybrid nozzle divergence 6155 (FIG, 10). Halved hybrid nozzle divergence 6165 controls the completion of an extended bullish trend and forms exhaustion as shown with pink extended bear warning lines 1675. Modified bullish time segment 1131 is mostly bullish during upper right Halved Hybrid Nozzlelism (upper right step up Halved Hybrid Nozzlelism) 6035. FIG. 22 shows one embodiment of a display, showing an illustrative table and graphic representation displaying a sample breakeven analysis for actual percentage equity or margin used, as is included within certain embodiments of the multidimensional risk analysis systems 100 of FIGS. 1 and 2. A trader or user uses tables 4100 (FIG. 23), 4200 (FIG. 24), and/or 4005 (FIG. 22) for proper risk evaluation, risk control, capital preservation, trade repair/portfolio repairs for using scalp-swing setups. Those skilled in the art will now appreciate that there are a variety of concepts and examples behind scalp-swing trading with Halved Hybrid Nozzlelism and its various applications.

### Confluence in Hybrid Dynamic Zone Lines and Halved Hybrid Nozzlelism

Certain embodiments of the multidimensional risk analysis systems 100, as described above with respect to FIGS. 1 and 2, are configured, though not illustrated, with Hybrid Dynamic Zone Lines 1006 to create confluence. Hybrid confluence comprises two major components. One embodiment of hybrid confluence is referred to as Hybrid Dynamic Zone Lines 1006, which serves as vertical risk. As mentioned in Provisional Application Ser. Nos. 61/210,599 and 61/343,120 as part of vertical risk, such line is characterized as dynamic, flexible, adaptive and creates a vertical distance amongst them. A trader or user skilled in the art is aware that there are seven zone lines, and that when combined with FXTA Pivot lines (Blue Line or any user desired pivot type), form hybrid zone lines 1006. Another embodiment of hybrid confluence is referred to as FXTA Pivots lines (Blue Line or any user desired pivot type). Several lines, although not limiting in scope, is used in combination with zone lines 1006: Blue Line (FXTA—30 Minute Mid Pivot), Blue Line (FXTA—60 Minute Mid Pivot) 2381 (FIGS. 3, 4, 6, 7, 8, 9, 10, 11, 12, 13, 14, 16, etc) , FXTA Daily Mid Pivot, FXTA Weekly Mid Pivot, FXTA Monthly Mid Pivot, or FXTA Yearly Mid Pivot. A trader or user skilled in the art is aware that other pivot lines is used instead of a Mid-Pivot; and the use of Blue Line 2381 and zone line 1040 are used to provide convenience. The phenomenon of the formation of hybrid confluence shape into the theory of “Halved Hybrid Nozzlelism” is referred to as “Hybrid Confluence”.

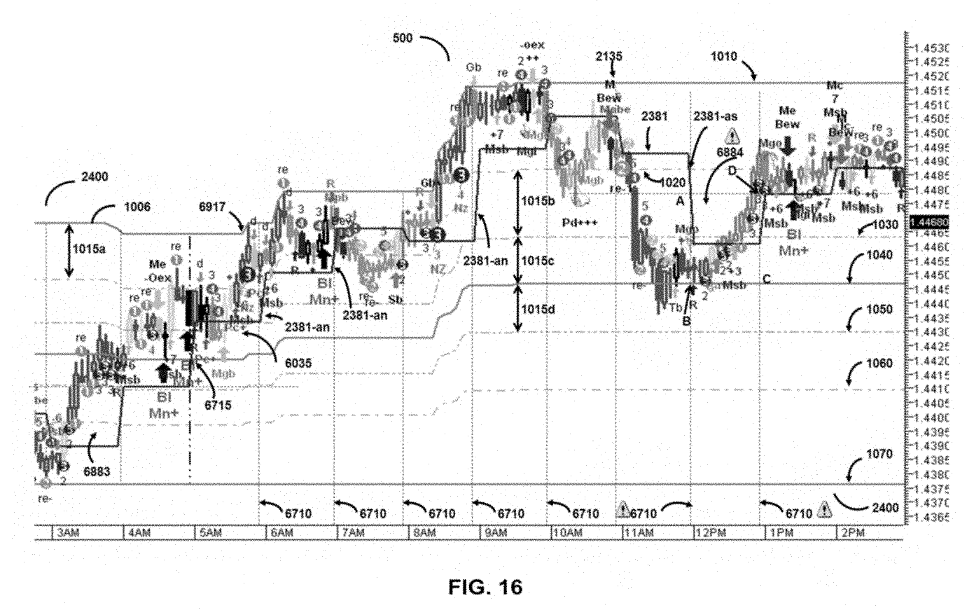

A trader or user skilled in the art is aware that during its formation, Blue Line 2381 and zone line 1040 stay parallel with very close visible distance on a chart, with an approximate maximum of 3 pips for currencies and approximately one cent for stock and/or other Market Vehicles. A trader or user is further aware that over a period of time, this ends with either a scheduled event of the Blue Line 6710 (FIG. 16) or an unscheduled event of the zone line, or it converts into Halved Hybrid Nozzlelism 6000 (FIG. 8) or Hybrid Parallelism 7000 (FIG. 8). The formation of such confluence attracts the Bullish Believers into taking profits, and if such Bullish Believers are within the upper zones or lower zones, the Bullish Believers accumulates their positions within a market vehicle. The opposite is applicable to Bearish Believers. A trader or user is further aware that confluence expands more in vertical distance, it converts itself into Hybrid Parallelism 7000 (FIG. 8). A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. Those skilled in the art will now appreciate that, under appropriate circumstances, there are a variety of concepts behind confluence in Hybrid Dynamic Zone Lines and Halved Hybrid Nozzlelism.

### Pre and Post Halved Hybrid Nozzlelism Confluence

Though not illustrated, a trader or user skilled in the art understands that when hybrid confluence occurs before the formation of the various types of Halved Hybrid Nozzlelism, it is referred to as pre-Halved Hybrid Nozzlelism confluence and when hybrid confluence occurs after the formation of the various types of Halved Hybrid Nozzlelism, it is referred to as post-Halved Hybrid Nozzlelism confluence. There is a variety of embodiments of post Halved Hybrid Nozzlelism confluence.

### Types of Post-Halved Hybrid Nozzlelism Confluence

FIG. 9 illustrates one embodiment of post-halved hybrid confluence, herein referred to as lower left post Halved Hybrid Nozzlelism confluence 6550, which serves as an indication of a bullish to bearish trend change and profit taking by the Bullish Believers and as a sign of retracement for the bulls. Such configuration occurs after the completion of lower halved nozzlelism tipping area 6450, when zone line 1040 intersects with Blue Line 2381, and after the completion of risk transition time area for unscheduled intersection of zone line 6765, it travels to the upper right after the intersection and forms a Hybrid Parallelism that goes from left to right. It is observed that market vehicle prices loses its value due to the lack of Bullish Believers and taking profits and the empowerment of Bearish Believers. A trader or user skilled in the art is aware of factors such as Indigo Bear Warning Candle 1435, Dynamic Sectional Price Risk types e orf and/or other bearish risk recognition factors. Such configuration is also referred to upper right post-Halved Hybrid Nozzlelism confluence.

FIGS. 10 and 15 illustrate one embodiment of post-halved hybrid confluence, herein referred to as upper left post Halved Hybrid Nozzlelism confluence, which serves as first evidence of a preliminary development of a bullish trend. Such configuration occurs when Hybrid Parallelism forms after the failing of zone line 1040 to create an unscheduled intersection of zone line with Blue Line 6755, but thus creating Nozzlelism to Hybrid Parallelism Transformation Point 6371. A trader or user skilled in the art is aware that such a confluence attracts Bullish Believers to test either Blue Line 2381 or zone line 1040 from the lower zone levels 1060 and 1070 and thus create a bullish trend within a market. To serve as a confirmation to a trader or user, factors such as Yellow Bull Warning Candle 1430, dynamic price risk type b, Gray (C) Bullish Candle 1440, and/or other bullish recognition factors. A trader or user is further aware that if prices manage to stay above zone line 1040, it serves as a confirmation that Bullish Believers have taken control of the trend and that all of the Bearish Believers have become defeated.

FIG. 12 shows one embodiment of a display, showing an illustrative screenshot view displaying a colored Candlestick Spectrum chart showing the bullish preparation time, as is included within certain embodiments of the multidimensional risk analysis systems 100 of FIGS. 1 and 2. It also illustrates one embodiment of post-halved hybrid confluence, referred to as lower right post Halved Hybrid Nozzlelism confluence 6560, which serves as an indication of a pinpoint bullish consolidation area.

Such configuration occurs after the formation of Halved Hybrid Nozzlelism tipping 6350, if zone line 1040 intersects Blue Line and remains at a very close visible distance and parallel to the Blue Line, or is close to merging, and up until all zone lines except the lower most zone line 1070 possibly shift to the upside, the parallel distance between unscheduled intersection of zone line 6755 and shifting point 6917. A trader or user skilled in the art is aware that this is a Bullish Believers controlled or breathing area, in which prices are around the upper most zone 1010 area. It is further understood that consolidation occurs with the evidence of Black Neutral Candle 1460, bullish green candle—type c MT-84, with earlier highs +3.3 1470-a3, earlier highs +3.4 1470-a4, and/or other indicators.

FIG. 9 illustrate one embodiment of post-halved hybrid confluence, referred to as upper right post-Halved Hybrid Nozzlelism confluence 6565, which serves as an indication of bullish to bearish trend change and profit taking by the Bullish Believers and sign of retracement for the bulls. Such configuration occurs after the completion of lower halved nozzlelism tipping area 6450, when zone line 1040 intersects with Blue Line 2381 after the completion of risk transition time area for unscheduled intersection of zone line 6765, it travels to the upper right after the intersection and forms Hybrid Parallelism that goes from left to right. It is observed that market vehicle prices can lose its value due to the lack of Bullish Believers and taking profits and the empowerment of Bearish Believers. A trader or user skilled in the art is aware of factors such as Indigo Bear Warning Candle 1435, Dynamic Sectional Price Risk types d, e, or f, and/or other bearish risk recognition factors. Such configuration is also referred to lower left post-Halved Hybrid Nozzlelism confluence 6550. There are a variety of examples and embodiments of post-Halved Hybrid Nozzlelism confluence. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

Upon reading the teachings of this specification, those skilled in the art will now appreciate that,under appropriate circumstances, the various types and examples of post-Halved Hybrid Nozzlelism confluence, may suffice.

### Types of Pre-Halved Hybrid Nozzlelism Confluence

FIG. 9 illustrates one embodiment of pre-halved hybrid confluence, herein referred to as lower left pre-Halved Hybrid Nozzlelism confluence 6570. After the formation of the lower halved Annularization portion of Halved Hybrid Nozzlelism, all of the zone lines 1006 remain stabilized and horizontal to each other with zone line 1040 and remain at a very close visible distance, approximately 5 pips in currencies and approximately fifty cents for stocks/ETFs and/or other Market Vehicles, for a number of periods of a particular user desired time frame along with the prolonged Horizontal Time Risk 255. Such configuration is determined by the distance between the end of lower left Halved Hybrid Nozzlelism Annularization (convergence) 6250 until a new shifting point 6917 on the upper zone line 1010 possibly forms. A trader or user skilled in the art is aware that Bullish Believers are in control of this area, and remain close to the upper zone line 1010, and perhaps ready to move higher upon formation of 1040-g of the Halved Hybrid Nozzlelism.

FIG. 13 shows one embodiment of a display, showing an illustrative screenshot view showing several screenshot sections, displaying a colored Candlestick Spectrum chart showing hybrid confluence along with a health risk indicator 1216, as is included within certain embodiments of the multidimensional risk analysis systems 100 of FIGS. 1 and 2. It also illustrates one embodiment of pre-halved hybrid confluence, herein referred to as upper left pre-Halved Hybrid Nozzlelism confluence 6575. Such configuration occurs after the unscheduled intersection of zone line to Blue Line 6755 or scheduled intersection of Blue Line to zone line 6715, and if the zone line stays above the Blue Line, keeping a very close visible distance and the formation of Hybrid Parallelism. This configuration remains until the formation of upper left Halved Hybrid Nozzle Tipping area 6455. A trader or user skilled in the art understands that typically all of the zone lines 1006 may squeeze during such an event. There may be mixed signals occurring from bullish recognition factors and bearish recognition factors. It is further understood that multi-confirmation signs such as Multi Dimensional Bear 1485 serves as a sign that the trend direction most likely is bearish.

FIG. 13 shows one embodiment of pre-halved hybrid confluence, referred to as lower right pre-Halved Hybrid Nozzlelism confluence 6580. Such configuration occurs after the unscheduled intersection of zone lines 6755, if the zone line component for the lower right Halved Hybrid Nozzlelism tipping area 6450 is extended over a number of times frames, usually more than three time periods, up until the formation of halved hybrid nozzle Hybrid Parallelism 6360 (FIG.10). Halved Hybrid Nozzle Hybrid Parallelism 6360, as further illustrated within FIG. 10 is understood as follows: a trader or user skilled in the art is aware that Blue Line 2381 has higher values than zone line 1040. Such area is supported by a stabilized zone line 1070, which constitutes Bullish Believers relief and generates short covering for the Bearish Believers, in which prices move to the upper zone lines such as, but not limiting to, 1060 or 1050. A trader or user skilled in the art is aware of factors such as earlier lows −4.6(Mc)++ 2156, yellow bull warning candle, Powder Blue (C) Bullish Candle 1450, and/or other bullish recognition factors. The possibility of more duration of the Horizontal Time Risk 255 assures consolidation within the market and testing of the upper zone levels.

FIG. 13 illustrates a phenomenon of Expansion of Zone Lines 6921. After the Squeezing of Zone Lines 6920, at one point or another the unscheduled intersection of zone line 6755 occurs, due to the increased volatility and creates a shifting point either in the upward or downward direction, provided that one of the zone levels 1006, either 1010 or 1070 remain stable, which creates the Expansion of Zone Lines in either the upward or downward direction. As displayed within the left, the Squeezing of Zone Lines 6920 occurred, then the unscheduled intersection of zone lines 6755 created a downward movement for all the zone lines, with the exception of the upper most zone line 1010 and Halved Hybrid Nozzlelism Shifting End Spike/Vertical Line (Bear To Bull) allowed for stabilization. A trader or user skilled in the art is aware that the first expansion confirmation point and subsequent expansion points of zone lines are spotted by using, but not limiting scope to, Warning Spot For First Gold PL Line (Bull To Bear) 6906, then within FIG. 14 gold PL line 1660, and Shifting Point of Zone Lines 6917 for any bearish outlook and any warning sign for the first turquoise PH line 6905, Shifting Point of Zone Lines 6917 and subsequent black transition spike 1665. Though not illustrated, a trader or user skilled in the art understands Trend Development and Recognition with Hybrid Zone Lines. This is applicable to Hybrid Dynamic Zone Lines, Hybrid Parallelism, hybrid zone risk transfer areas, hybrid confluence, and Halved Hybrid Nozzlelism. Many scalp-swing trade setups from the Users Manual, favorable bullish recognition factors and/or bearish recognition factors are used for the enhancement of scalp-swing trading opportunities to conduct mega-scalp swing using trend development.

FIG. 11 shows one embodiment of pre-halved hybrid confluence, referred to as upper right pre-Halved Hybrid Nozzlelism confluence, which serves as an indication of a pre-bullish move area and first evidence of a pinpoint area of accumulation of Bullish Believers before a big upward move. Such configuration occurs after a scheduled intersection of Blue Line 6715 to the zone line 1040, if a Hybrid Parallelism is formed between the Blue Line 2381 and zone line 1040 with a very minute visible distance. Such configuration lasts up until a scalp-swing setup 2146, a formation of modified bullish time segment 1131 or a bullish direction 2055 is formed or until the upper right Halved Hybrid Nozzle Tipping point 6465 is formed. A trader or user skilled in the art understands that indicators such as, but not limiting in scope to, black neutral candle (Mn+) 2146, upper right Halved Hybrid Nozzle Tipping 6465 or health directional line -bullish 2055, serves as an entry point for a huge upcoming surge in prices. It is further understood that prices have to stay above zone line 1040 and Blue Line 2381 in order to qualify for a further bigger upward move and breakouts. There are various types and examples of pre-Halved Hybrid Nozzlelism confluence.

Upon reading the teachings of this specification, those skilled in the art will now appreciate that, under appropriate circumstances, the various types and examples of pre-Halved Hybrid Nozzlelism confluence, may suffice.

Misc. Types of Hybrid Confluences

Though not illustrated, there are several embodiments of the types of hybrid confluence. Such confluences are created due to either the shifting or non-shifting of zone lines 1006. Typically, during a less volatile period, zone line 1040 comes very close in distance to the Blue Line and almost merges with one another.

FIG. 13 shows one embodiment of the misc. types of hybrid confluence, referred to as confluence zero after Hybrid Parallelism between two scheduled events of Blue Line. Such arrangement occurs when on the second scheduled event 6710 of the Blue Line fails to intersect zone line 1040, but rather becomes the same value of zone line 1040, and keeps such same value, either the Scheduled Event of Blue Line 6710 or Unscheduled Event of Zone Line 6755 takes place. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading. There are various miscellaneous types and examples of hybrid confluence.

### Scalp-Swing Using Confluence

Though not illustrated, a trader or user skilled in the art uses Scheduled Risk Transition Spike/Line Bear Continue 6816 (FIGS. 9, 13, 14, and 18) or Super Belief Bear Pin Point En-6* 1620-6 (FIG. 13) and scalps up to lower zone line 1060 or 1070, with the use of multiple lots/positions and using risk tables 4100 (FIG. 23) /4200 (FIG. 24) and produces quicker results than the normal swing trading style. The use of scalp-swing setup Super Bearish Belief Contra-Re-2(Me) 2178 or Multi

Dimensional Bull 1480 with the addition of multiple lots/positions and with the targets of zone lines 1060, 1050, 1040 or Blue Line 2381 and the adding of such lots upon the appearance of indicators such as, but not limiting scope to, every Yellow Bull Warning Candle 1430 (FIG. 6, 7, 9, 10, 13, or 15) or MSB with risk recognition indicators of “1”, “2”, “3”, or “4” produces better results than normal swing trading. A trader or user skilled in the art becomes aware that amount of time spent and money possibly earned, along with low risk, as hybrid confluence provides for lower risk entries and attraction to their hybrid confluence levels, which keeps stops below zone line 1070. There are a variety of concepts behind Scalp-Swing using confluence.

Upon reading the teachings of this specification, those skilled in the art will now appreciate that, under appropriate circumstances, the concepts behind Scalp-Swing using confluence, may suffice.

### Confluence Zero After Hybrid Nozzlelism Tipping Area

As shown in FIG. 14, such arrangement occurs when hybrid nozzlelism tipping area has both zone line 1040 and Blue Line 2381 within close or zero distance of one another. A trader or user skilled in the art understands that as trading progresses, either an unscheduled event of the zone line 6755 or scheduled event of the Blue Line 6710 occurs after such arrangement. FIG. 14 shows one embodiment of the confluence zero after hybrid nozzlelism tipping area 6592, referred to as scalp-swing with confluence zero after hybrid nozzlelism tipping area 6592a. Due to the confluence of confluence zero after hybrid nozzlelism tipping area 6592, the previous higher prices become attracted to both the Blue Line 2381 and zone line 1040. A trader or user skilled in the art uses Black Neutral Candle (Mn+) 2146 (following the third symbol on such figure), a bullish scalp-swing entry is taken with stops below zone line 1040 and Blue Line 2381. A trader or user uses multiple lots and uses tables 4100 (FIG. 23)/4200 (FIG. 24), along with risk control methods and expect at least a target of zone level 1030 and then 1020 and further 1040. A trader or user further, at the shifting point 6917 or at Turquoise PH Line 1655, trails the market vehicle until is stopped out or take profits at various indicator such as, Super Bullish Belief Contra+Re 2200, Super Bullish Belief Contra+Re1 (not illustrated), Super Bullish Belief Contra+Re2 (not illustrated) or other bearish risk recognition factors. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading. Upon reading the teachings of this specification, there are a variety of concepts and applications of confluence zero after hybrid nozzlelism tipping area.

### Hybrid Parallelism

Within this disclosure, the term “Hybrid Parallelism” is utilized to illustrate a general shape or pattern of a variety of indicator combinations, which is utilized to help an ordinary skilled trader to understand important events such as market trend change, breakouts, retracements, new highs, new lows, directional prediction, reversals, pullbacks, and many other trading clues. Also, the various types and shapes of Hybrid Parallelism tends to indicate and show the accumulation of Bullish Believers or Bearish Believers or the exchange of Bullish Believers and Bearish Believers. The phenomenon of the formation of Hybrid Parallelism shape into the theory of “Halved Hybrid Nozzlelism” is referred to as “Hybrid Parallelism”.

FIG. 13 illustrates one embodiment of Hybrid Parallelism. Within such concept, when the middle zone line 1040 approaches Blue Line 2381 within an approximate 4 pips for currencies or within an approximate two cents for stocks/ETFs or other Market Vehicles, and when both zone line 1040 and Blue Line 2381 appear parallel to each other, it is referred to as the development of zone level Hybrid Parallelism. Due to the Blue Line being a member of a separate family when made in comparison to zone line 1040, this therefore is called Hybrid Parallelism 7000. Typically, Hybrid Parallelism provides a trader or a user a warning sign that something may occur to the current direction of a trade. This turns into Halved Hybrid Nozzlelism or its different types or hybrid confluence or its different types, and as such gets effected by scheduled events of Blue Line 2381 and produces various trading events and forecasting such as, but not limiting scope to, forecasting earlier highs with risk assessments 8011 (FIG. 21)/forecasting earlier highs with risk assessments for Halved Hybrid Nozzlelism 8013 (FIG. 21) or forecasting earlier lows with risk assessments 8012 (FIG. 21)/ forecasting earlier lows with risk assessments for Halved Hybrid Nozzlelism 8014 (FIG. 21), various pin point entries such as, but not limiting scope to, super belief bull pin point entries categories w/risk assessment 8015 (FIG. 21)/super belief bull pin point entries categories w/risk assessment for Halved Hybrid Nozzlelism 8017 (FIG. 21) or super belief bear pin point entries categories w/risk assessment 8016 (FIG. 21)/super belief bear pin point entries categories w/risk assessment for Halved Hybrid Nozzlelism 8018 (FIG. 21), or scalp-swing trading or scalp-swing trading with Halved Hybrid Nozzlelism, as well as others. From such figure, a trader or user understands the definition of this concept. There are a variety of embodiments and concepts of Hybrid Parallelism.

### Types of Hybrid Parallelism

There are certain embodiments of Hybrid Parallelism that exist in trading and a trader or user uses the various types as a forecasting tool. FIG. 10 illustrates one embodiment of Hybrid Parallelism, herein referred to as bullish Hybrid Parallelism for lower right Halved Hybrid Nozzlelism 7031. Such configuration forms at the end of lower right Halved Hybrid Nozzlelism Divergence 6160 until either the formation of scheduled intersection of Blue Line 6715 with Blue Line angle south 2381-as or the closing/opening expansion at the particular point of intersection. A trader or user skilled in the art is aware that Blue Line 2381 is greater than zone line 1040 within such area and the Bullish Believers are attracted to levels of Blue Line 2381 or zone line 1040.

FIG. 10 illustrates one embodiment of Hybrid Parallelism, herein referred to as bearish Hybrid Parallelism for upper left Halved Hybrid Nozzlelism 7032. Such arrangement forms after the scheduled intersection of Blue Line 6715 with Blue Line angle south 2381-as, once all zone lines 1006 have stabilized. A trader or user skilled in the art understands that such configuration is comprised of the area between the point of stabilization of all zone levels 1005 and the beginning of Upper Left Halved Hybrid Nozzlelism (Upper Left Step Down Halved Hybrid Nozzlelism) 6025. As Ilustrated within FIG. 10, prices flow from the scheduled intersection of Blue Line 6715 to upper left Halved Hybrid Nozzlelism Convergence 6155 and gets transferred into bearish direction as the prices was not able to exceed zone level 1040. A trader or user skilled in the art is aware that Blue Line 2381 is lower than zone line 1040 within such area and that Bearish Believers is in control below levels of Blue Line 2381 and zone line 1040.

FIG. 12 illustrates one embodiment of Hybrid Parallelism, hereby referred to as prep-bullish trend Hybrid Parallelism 7040. A trader or user skilled in the art is aware that if all zone lines 1006 start shifting downwards at the same time, with the exception of 1070, and if zone line 1040 has a higher value than Blue Line 2381 and the occurrence of Hybrid Parallelism does not take place shortly thereafter, a new bullish trend develops within the near future, after the formation of upper left Halved Hybrid Nozzlelism (upper left step down Halved Hybrid Nozzlelism) 6025. Such configuration occurs when the Blue Line 2381 is between zone lines 1070 and 1060 or near zone line 1060, and onstitutes a bullish trend in the near future, so long as the prices stays above Blue Line 2381. A trader or user skilled in the art understands that the Blue Line 2381 has a Blue Line angle-north 2381-an effect after this formation. A trader or user skilled in the art further understands that factors such as, but not limiting in scope, transition bull 2295, Special Buy 2315, and/or other bullish risk recognition factors, serves as an indication of such configuration.

FIG. 12 illustrates one embodiment of Hybrid Parallelism, referred to as pre-bullish trend Hybrid Parallelism 7041. Such configuration occurs after the formation of risk transition time area for scheduled intersection of Blue Line and Hybrid Parallelism 6721, if all zone lines 1006 stop shifting downwards, instead remaining parallel at the same time and if zone line 1040 has a lower value than Blue Line 2381 and pre-Hybrid Parallelism has not yet occurred, a new bullish trend immediately develops. A trader or user skilled in the art enters the bullish direction during the length of pre-bullish Hybrid Parallelism, considering the use of factors such as, but not limiting in scope, yellow bull warning candle 1430, turquoise bullish candle +(not illustrated), Special Buy 2315, and/or other bullish risk recognition factors. A trader or user skilled in the art understands that after reference to risk tables 4100 (FIGS. 23) and 4200 (FIG. 24), scalp-swing setups such as, but not limiting in scope, black neutral candle (Mn+) 2146, provides a low risk bullish entry.

Though not illustrated, one embodiment of Hybrid Parallelism, is hereby referred to as prep-bearish trend Hybrid Parallelism. A trader or user skilled in the art is aware that if all zone lines 1006 start shifting upwards at the same time, with the exception of 1010, and if zone line 1040 has a lower value than Blue Line 2381 and the occurrence of Hybrid Parallelism does not take place shortly thereafter, a new bearish trend develops within the near future, after the formation of lower right Halved Hybrid Nozzlelism (lower right step down Halved Hybrid Nozzlelism) 6030 (FIG. 10). Such configuration may occur when the Blue Line 2381 is between zone lines 1010 and 1020, as such constitutes a bearish trend in the near future, so long as the prices stay below Blue Line 2381. A trader or user skilled in the art understands that the Blue Line 2381 has a Blue Line angle-south 2381-as effect after this formation. A trader or user skilled in the art further understands that factors such as, but not limiting in scope, transition bear, special sell 2320, and/or other bearish risk recognition factors serves as an indication of such configuration.

Though not illustrated, one embodiment of Hybrid Parallelism, is referred to as pre-bearish trend Hybrid Parallelism. Such configuration occurs after the formation of risk transition time area for scheduled intersection of Blue Line and Hybrid Parallelism 6721 (FIG. 12), if all zone lines 1006 stop shifting upwards, instead remaining parallel at the same time and if zone line 1040 has a higher value than Blue Line 2381 and pre-Hybrid Parallelism has not occurred first, a new bearish trend immediately develops. A trader or user skilled in the art enters the bearish direction during the length of pre-bearish Hybrid Parallelism, considering the use of factors such as, but not limiting in scope, indigo bear warning candle 1435 (FIGS. 6 and 9), golden bearish candle 1420 (FIG. 6), special sell 2320 (FIG. 12) and/or other bearish risk recognition factors.

FIG. 12 illustrates a Shifting Point of Zone Lines 6917. Such configuration is the point where the zone lines start to shift, due to dynamic, adaptive changes within the market, due to changing market vertical risk 276.

FIG. 13 illustrates a Squeezing of Zone Lines 6920. A trader or user skilled in the art understands that over a period of time, when the market has very low volatility, the distance between all zone lines start to get smaller and smaller, thus creating a situation where modified health risk indicator 1287 cannot reach the Boundary Lines. It is further understood by a trader or user skilled in the art that the reduced distance between all zone lines is referred to as squeezing and it creates breakouts or breakdowns.

FIG. 14 illustrates one embodiment of Hybrid Parallelism, referred to as prep-pre double bullish trend Hybrid Parallelism 7044, and as such serves as an indication of an early, extremely bullish scalp-swing setup area. A trader or user skilled in the art understands that such configuration has a pre-requisite, which as such, is of zone line 1040 having greater value than Blue Line 2381 at all time, it has the forming of an upper left Halved Hybrid Nozzlelism on the left side and has upper right Halved Hybrid Nozzlelism forming on the right side, of which is before the scheduled intersection of Blue Line 2381. A trader or user skilled in the art further understands that zone level 1010 has a lower value on the right side of the prep-pre double bullish trend Hybrid Parallelism 7044 and has a higher value on the left side of pre-bearish trend Hybrid Parallelism, which serves as a confirmation of an upcoming bullish trend and further serves as a forecasting tool for the second or third black neutral candle (Mn+) 2146.

Though not illustrated, one embodiment of Hybrid Parallelism, is referred to as prep-pre double bearish trend Hybrid Parallelism, as such serves as an indication of an early, extremely bearish scalp-swing setup area. A trader or user skilled in the art understands that such configuration has a pre-requisite, which as such, is of zone line 1040 having lesser value than Blue Line 2381 at all time, it has the forming of lower right Halved Hybrid Nozzlelism on the right side and has lower left Halved Hybrid Nozzlelism forming on the left side, of which is before the scheduled intersection of Blue Line 2381. A trader or user skilled in the art further understands that zone level 1010 has a higher value on the left side of prep-pre double bearish trend Hybrid Parallelism and has a lower value than the right side of prep-pre double bearish trend Hybrid Parallelism, which serves as a confirmation of an upcoming bearish trend and further serves as a forecasting tool for bearish scalp-swing setups.

FIG. 14 illustrates one embodiment of Hybrid Parallelism, referred to as Hybrid Parallelism for Bullish Believers 7046. Such configuration occurs when the Blue Line 2381 is below the gray line and is in the lower zones such as in zones 1015d, 1015e, or 1015f, and if all zone lines are stabilized. A trader or user skilled in the art understands that prices reach those levels over or around the Scheduled Event of Blue Line if there is no unscheduled events of zone line 1040.

Though not illustrated, one embodiment of Hybrid Parallelism, is referred to as Hybrid Parallelism for Bearish Believers. Such configuration occurs when the Blue Line 2381 is above the gray line and is in the upper zones such as 1015a (FIG. 14), 1015b (FIG. 14), or 1015c (FIG. 14), and if all zone lines are stabilized. A trader or user skilled in the art understands that prices reach those levels over or around the Scheduled Event of Blue Line if there is no unscheduled events of zone line 1040. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading. A variety of embodiments of Hybrid Parallelism may exist within this disclosure.

Upon reading the teachings of this specification, those skilled in the art will now appreciate that, under appropriate circumstances, the various types and examples of Hybrid Parallelism, may suffice.

### Risk Transition Due to Scheduled and Unscheduled Events

A trader or user skilled in the art understands that within the history of trading, there has been a desire to determine where the actual risk is being transferred from Bullish Believers to Bearish Believers or vice versa or as to finding a point of continuation of the same risk with pinpoint accuracy, using the scheduled events of Blue Line and unscheduled events of zone lines.

Though not illustrated, one embodiment of risk transition due to scheduled and unscheduled events, is referred to as scheduled events of Blue Line. The calculation for the Blue Line is based on the use of pre-selected time frames. It is as such that the Mid-Pivot line occurs on a scheduled time basis. For example purposes, if a trader or user were to take the 60 minute FXTA Pivot, the mid-pivot line would occur every 60 minutes and the use of a Daily FXTA Pivot would cause occurrence every 24 hours (or any user desired pivot type). A trader or user skilled in the art therefore understands that the crossing of Blue Line 2381 with zone line 1040 or other zone lines, occurs on a scheduled time and are thereupon called scheduled events of Blue Line. A trader or user understands that scheduled events of Blue Line also occur without the crossing of the Blue Line with zone lines. The Blue Line either goes vertically up, referred to as Blue Line angle-north 2381-an, or vertically down, referred to as Blue Line angle-south 2381-as, both of which occur at some angle. A trader or user skilled in the art understands that Blue Line angle-north 2381-an or Blue Line angle-south 2381-as intersects either number of zone lines, 1020, 1030, 1040, 1050, 1060, or confluences with such zone lines at any scheduled events of Blue Line. Such configurations allow to help create, but not limiting scope to, hybrid confluence, Hybrid Parallelism, Halved Hybrid Nozzlelism, scheduled upper hybrid zone risk transfer area open ended, or scheduled upper close ended hybrid zone risk transfer area.

FIG. 10 provides an illustrative display of one embodiment of risk transition due to scheduled and unscheduled events, referred to as scheduled intersection of Blue Line 6715. A trader or user skilled in the art understands that a scheduled intersection occurs when the there is a crossing of Blue Line 2381 to zone line 1040 as per the scheduled events of Blue Line. Such intersection also occurs with the other zone lines 1006. Such intersection also occurs due to the vertical shifting of Blue Line 2381 on a scheduled time and then crossing either zone line 1040 or the other zone lines 1006. Such configuration occurs on a pre-scheduled basis during trading, before or after or at the same time during the unscheduled events of zone line. Within this illustrative display, Blue Line 2381 is illustrated as Blue Line angle south 2381-as.

Though not illustrated, one embodiment of risk transition due to scheduled and unscheduled events is referred to as unscheduled events of zone lines. A trader or user skilled in the art understands that zone lines 1006 are adaptive, dynamic, flexible, can incorporate changes within the market over a selected period of time and has no scheduled time for its occurrence. It is further understood that zone line 1040, along with other zones, shifts up or down at any time within any market vehicle under review for a particular time frame.

FIGS. 10 and 12 provide illustrative displays of one embodiment of risk transition due to scheduled and unscheduled events, referred to as unscheduled intersection of zone line 6755. Such configuration occurs when there is a crossing of zone line 1040 to Blue Line 2381, as per the unscheduled events of zone lines. A trader or user skilled in the art understands that such intersection can also happen for the other zone lines 1006 and that this occurs at any time during trading, before or after or at the same time during the scheduled events of Blue Line 6715. A trader or user skilled in the art further understands that such intersection occurs due to the vertical shifting of zone line 1040 and then the crossing to Blue Line 2381.

Though not illustrated, one embodiment of risk transition due to scheduled and unscheduled events, referred to as risk transition time area for scheduled intersection of Blue Line 6720. Such configuration is a risk transition formation area over a period of time, usually from 1 to 3 time frames, where the Blue Line 2381 crosses zone line 1040 or the other zone lines 1006.

FIG. 11 illustrates one embodiment of risk transition due to scheduled and unscheduled events, referred to as risk transition time area for scheduled intersection of Blue Line after Hybrid Parallelism 6770. Such configuration is the area, where the Blue Line angle south 2381-as crosses zone line 1040, on a scheduled time basis (within this illustration, every hour within 1 to 3 time frames), and as such where risk is transferred from Bearish Believers to Bullish Believers and due to the exhaustion of the Bearish Believers or due to the empowerment of Bullish Believers. Within this illustration, a trader or user observes that market vehicle prices move upward around this area. A trader or user skilled in the art looks for factors such as, but not limiting in scope to, turquoise bullish candle, turquoise bullish candle + 1415, turquoise bullish candle ++, catalyst turquoise bullish candle, dynamic price risk types a or b before risk transition time area for scheduled intersection of Blue Line after Hybrid Parallelism 6770, modified bullish time segment 1131, earlier highs +3.1, or earlier highs +3.2. A trader or user is aware of Risk transition line [scheduled and unscheduled] as a confirmation within the modified health indicator window 1216.

FIG. 12 represents one embodiment of risk transition due to scheduled and unscheduled events, which is referred to as risk transition time area for scheduled intersection of Blue Line and Hybrid Parallelism 6721. Such configuration is a risk transition area, which is over a time duration of about 1 to 3 time frames, that is formed between pre-bullish Hybrid Parallelism 7040 and post-bullish Hybrid Parallelism 7041. A trader or user skilled in the art understands that such area occurs only in the scheduled events of Blue Line 6715 and its intersection with zone line 1040.

FIG. 9 illustrates one embodiment of risk transition due to scheduled and unscheduled events, referred to as risk transition time area for unscheduled intersection of the 1040 zone line 1040 6765, which occurs after lower left Halved Hybrid Nozzle Tipping 6450. Such configuration is the area where the zone line 1040 crosses the Blue Line 2381, over an approximate time frame of 1 to 3, of which the risk is transferred from Bullish Believers to Bearish Believers and due to exhaustion of the existing Bullish Believers or due to the empowerment of the Bearish Believers.

A trader or user skilled in the art is aware of factor such as, but not limiting scope to, tan bearish candle, tan bearish candle, tan bearish candle ++, tan bearish entry—type c (M1), tan bearish entry—type d(M)—oex, indigo bear warning candle (M), pink (C) bearish candle (M), Top Bear—small or big (Mn−), super belief bull pinpoint en+7* (Mc), or super bullish belief contra+re1 (Mc). A variety of embodiments of risk transition due to scheduled and unscheduled events occurs.

### Risk Transition Lines

Within this disclosure, “risk transition lines” is understood as an indication of a change within the current trend of a market vehicle or that there is a continuation of the market vehicle trend. Risk transition lines is further described as the creation of a vertical line within the modified trend health window, every time there is a scheduled intersection of the Blue Line or an unscheduled intersection of the mid zone line within the Candlestick Spectrum window. A trader or user skilled in the art understands that there is at least twelve categories of risk transition lines that exist in trading and they occur due to the shifting of zone lines 1006, due to the scheduled events of Blue Line and the unscheduled events of zone lines. A trader or user skilled in the art uses the location relation between zone line 1040 and Blue Line 2381 to create forecasts of the direction in conjunction with the use of health risk directional indicator-bearish and the health risk directional indicator-bullish. Typically, risk transition lines occur after the formation of the directional line-bear, which serve as an indication within approximately five to seven time frames, that the bearish trend changes to either first consolidation and then a bullish trend. Typically, risk transition lines also occurs after the formation of the directional line-bull, which serves as an indication within approximately five to seven time frames, that the bullish trend changes to either first consolidation and then a bearish trend. Risk transition lines are located within the modified trend health window, which is shown with a light purple color (r:128g:128, b:255), which a trader or user further uses the Users Manual for such risk transition lines for bullish and Bearish Believers.

Though not illustrated, one embodiment of risk transition lines, is referred to as scheduled risk transition line, as such is created in the Trend Health Risk or modified trend health window or within the spectrum of colored candlesticks, with the occurrence of scheduled intersection of Blue Line. Though not illustrated, one embodiment of risk transition lines, is referred to as unscheduled risk transition line, as such is created in Trend Health Risk or modified trend health window or within the spectrum of colored candlesticks, with the occurrence of unscheduled intersection of zone lines.

Though not illustrated, one embodiment of risk transition lines is referred to as scheduled risk transition spike/line bull continue, which serves as an indication of a bullish to more bullish trend. A trader or user skilled in the art understands that such Spikes occurs when zone line 1040 on a scheduled time remains horizontal and Blue Line decreases its value, and its level falls underneath zone line 1040, and a Hybrid Parallelism is created. A trader or user skilled in the art is aware that the scheduled intersection of Blue Line is created for the continuation of the previous bullish trend. Such a spike helps continue the previous bullish direction. The previous bullish risk has been transformed into more bullish risk. It is further aware to a trader or user skilled in the art that a pullback at zone line allows for the reduction of risk and provides a low risk opportunity to Bullish Believers. Scheduled risk transition spike/line bull continue to be used for scalp-swing.

Though not illustrated, one embodiment of risk transition lines is referred to as scheduled risk transition spike/line bear continue, which serves as an indication of a bearish to a more bearish trend. A trader or user skilled in the art understands that such Spikes occurs when zone line on a scheduled time remains horizontal and Blue Line increases its value, and its level rises above zone line 1040, and a Hybrid Parallelism is created. A trader or user skilled in the art is aware that the scheduled intersection of Blue Line is created in order for the continuation of the previous bearish trend. Such a spike helps continue the previous bearish direction. The previous bearish risk has been transformed into a more bearish risk. It is further aware to a trader or user skilled in the art that a pullback at Blue Line allows for the reduction of risk and provides a low risk opportunity to Bearish Believers. Scheduled risk transition spike/line bear continue is used for scalp-swing.

FIG. 12 illustrates one embodiment of risk transition lines, referred to as scheduled risk transition spike/line prep to pre bull 6817, which serves as an indication of a slightly bullish trend to a more bullish trend. Such configuration occurs when prep-bullish trend Hybrid Parallelism 7040 and pre-bullish trend Hybrid Parallelism 7041 are created side by side at the scheduled intersection of Blue Line angle-north 2381-an, of which a risk transition takes place and is shown by a vertical line/spike. Within this configuration, a trader or user skilled in the art understands that the previous Bearish Believers risk is transformed into Bullish Believers risk. Though not illustrated, one embodiment of risk transition lines, is referred to as scheduled risk transition spike/line prep to pre bear, which serves as an indication of a slightly bearish trend to a more bearish trend. Such configuration occurs when prep-bearish trend Hybrid Parallelism and pre-bearish trend Hybrid Parallelism are created side by side at the scheduled intersection of Blue Line angle-south, of which a risk transition takes place and is shown by a vertical line/spike. A trader or user understands that Prep Bull or Transition time is that in which, within the dynamic movement of zone lines, the time differential between the start point of shifting of at least zone line, preferably of the uppermost zone line to the downside, is referred to as the Squeezing of Zone Lines, and at the same time with the scheduled intersection of the Blue Line with the Blue Line angle north, so long as there is no shifting of the lower most zone line. FIG. 12 represents one embodiment of the multidimensional risk analysis systems 100, which provide an illustrative display of Prep Bull or Transition Time 8110, which took place between points “A” and “B”. At such time, it is observed that Bullish Believers were prepared to hold their current position or adding additional positions whereas the Bearish Believers either close their current positions or follow what the Bullish Believers do. It is further observed that symbols such as, but not limiting scope to, “Sb”, yellow bar/candle, Pd++, neutral bar/candle, and transitional bull are signs of Transition Time. A trader or user understands that Pre Bull or Transition Time 8115 is that in which, within the dynamic movement of zone lines 1006, the time ifferential between the time at which the scheduled intersection of Blue Line 6917 with Blue Line angle north 2381-an and at least the first or second starting point for the shifting of at least one zone line to the upside, preferably the upper most zone line 1010 to the upside, is referred to as the Expansion of Zone Lines 6921, and so long as there is no shifting of the lower most zone line 1070. FIG. 12 provides an illustrative display of Pre Bull or Transition Time 8115, which took place between points “B” and C. At such time, it is observed that the Bullish Believers were prepared to hold their current position or add additional positions whereas the Bearish Believers either close their current positions or follow what the Bullish Believers do. It is further observed that symbols such as, but not limiting scope to, MSB, Pd++, yellow bar/candle, turquoise bar/candle, and bullish setups such as BL Mn+, are signs of Transition Time.

Though not illustrated, it is understood by a trader or user that Prep Bear or Transition Time and Pre Bear Transition Time is understood as the opposite of Prep Bull or Transition Time and Pre Bull Transition Time, respectively. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

Within this configuration, a trader or user skilled in the art understands that the previous Bullish Believers risk transformed into Bearish Believers risk. Those skilled in the art will now appreciate that there are a variety of alternative aspects of risk transitions lines.

### Hybrid Zone Risk Transfer Areas

A trader or user skilled in the art understands that such area is the area in which there is an exchange between Bullish Believers and Bearish Believers, of which is either one end open area (either on the left or right on the upper or bottom side) or is closed on both sides of the Blue Line. Those skilled in the art will appreciate alternate hybrid zone risk transfer area configurations.

### Types of Hybrid Zone Risk Transfer Areas

FIG. 9 provides an illustrative display of one embodiment of the types of hybrid zone risk transfer areas, referred to as hybrid zone scheduled risk transfer areas. Such configuration occurs after the scheduled events of Blue Line 2381 and the formation of risk transition time area for scheduled intersection of Blue Line 6720, the distance between zone line 1040 and Blue Line 2381 increases substantially, which is supported by the intersection of the Blue Line (upper or lower) to at least one of the zone lines 1010, 1020, 1030, 1040, 1050, 1060 or 1070, and of which there is an area forming until the zone lines 1006 shift again. Such configuration is on the left or right side of Blue Line angle-north 2381-an or Blue Line angle south. A trader or user skilled in the art is made aware that if the Blue Line is above zone line 1040, it is referred to as an upper area while the Blue Line 2381 being below zone line 1040 is referred to as a lower area. After the formation of risk transition time area for scheduled intersection of Blue Line 6720, the value of a market vehicle remains within this area until the zone lines have shifted once again. A trader or user skilled in the art is further aware that there is conflict between the Bullish Believers and Bearish Believers within this area, which is evidenced by the generation of mixed signals such as, but not limiting scope to, bearish risk recognition factors and bullish risk recognition factors. It is observed that if prices remain below zone line 1040, the trend moves to the downside. It is also observed that if prices remain above Blue Line 2381, there would be a resumption of the bullish trend. A trader or user defines the leaving of market vehicle prices from the risk transfer area as falling out of the risk transfer area.

FIG. 9 illustrates one embodiment of the hybrid zone scheduled risk transfer areas, which is referred to as scheduled upper right hybrid zone one open ended (r) transfer area 6881, which serves as an indication of a bearish trend. Such configuration is on the upper and right side of the Blue Line angle-north 2381-an. The formation of upper right post Halved Hybrid Nozzlelism confluence 6565, the prices of a market vehicle loses its value; prices bounce between Blue Line 2381 and zone line 1040 within this area. A trader or user skilled in the art is aware that the formation of scheduled intersection of Blue Line 6715 and Blue Line angle-north on the left side is mandatory and that the open end at the completion of this area allows for future trend on either side. The resumption of an uptrend in the near future, after leaving this area, occurs with the appearance of factors such as, but not limiting scope to, earlier lows −4.6(Mc)++ 2156, earlier lows −4.6(Mc)+, earlier lows −4.6(Mc), super bearish belief contra—re-2, yellow extended bull warning line 1680 and/or other bullish risk recognition factors. FIG. 15 shows one embodiment of a display, showing an illustrative screenshot view showing several screenshot sections, displaying a colored Candlestick Spectrum chart showing a double open-ended hybrid zone risk transfer area, which consists of an open end on the left hand and right hand side, along with health risk indicator 1216, which is visualized in the shaded area within the blue dotted box, as is included within certain embodiments of the multidimensional risk analysis systems 100 of FIGS. 1 and 2. It also illustrates one embodiment of the various types of hybrid zone scheduled risk transfer areas, which is referred to as scheduled lower hybrid zone risk transfer area-open ended 6883. With respect to FIG. 15, a continuous sell off in the market led to zone levels 1006, with the exception of upper zone level 1010, to shift to the lower side and for Blue Line 2381 to also lower itself over a period of time. It is observed that such zone lines once again become stabilized and the lowest zone line 1070 has also become stable, which has allowed for the Bearish Believers to close their positions and for some Bullish Believers to commence participation into the market, which is evident by certain factors, but not limiting in scope to, Dynamic Sectional Price Risk type a, earlier highs +3.1, earlier highs +3.2 1470-a2, etc. The occurrence of Scheduled Event of Blue Line, the intersection of Blue Line or the intersection of zone line 1010 may not take place. A trader or user skilled in the art understands that this forms an open end for previously formed Hybrid Parallelism. It is further observed that Blue Line 2381 forms Blue Line angle-south 2381-as; zone line 1040 and Blue Line 2381 forms Hybrid Parallelism, which is separated by at least one zone line 1060 or 1050, until the occurrence of another Scheduled Event of Blue Line or Unscheduled Event of Zone Line. A trader or user skilled in the art understands that if Unscheduled Event of Zone Line does not occur until and including consecutive Scheduled Event of Blue Line there is an open area between zone line 1040 and Blue Line 2381 converts into either hybrid confluence or Hybrid Parallelism. It is further understood that if market vehicle prices manage to remain between zone line 1040 and Blue Line 2381, after the first Scheduled Event of Blue Line 6710 and manages to remain above 1040, a new bullish trend develops. However, it is considered that at the second Scheduled Event of Blue Line, if there happens to be no intersection of Blue Line, it ends for the time being as either hybrid confluence or Hybrid Parallelism. A trader or user skilled in the art should implement a trading strategy, possibly trading from Blue Line 2381 to zone line 1040. If prices fail to progress to the zone lines higher than 1040, the risk is transferred back to the bears within the risk transfer area, causing a wick formation to occur within the candle, due to the Scheduled Event of Blue Line. A trader or user skilled in the art would further understand that zone line 1040 works as a line in the sand or as the territory between the Bullish Believers and Bearish Believers, and the falling out of Blue Line 2381, allows control in the Bearish Believers' hands.

FIG. 15 represents one embodiment of the multidimensional risk analysis systems 100. A trader or user skilled in the art applies scalp-swing for open ended transfer area. As illustrated within FIG. 15, Scheduled Event of Blue Line, at the end of upper left post Halved Hybrid

Nozzlelism confluence 6555 and it its open ended, causes left post Halved Hybrid Nozzlelism confluence 6555 to turn into a scheduled lower hybrid zone risk transfer open end 6883. This serves as an entry point for scalping at Blue Line angle-south 2381-as, so long as the prices remain above Blue Line 2381. A trader or user skilled in the art sets a potential for at least zone line 1040 and this turns into scalp-swing trading, should prices stay above zone line 1040 and move to upper zone levels. A trader or user designs an alert for when the right open end of scheduled lower hybrid zone risk transfer area-open ended 6883 along with upper left post Halved Hybrid Nozzlelism confluence 6555 and on scheduled time, and checking the scheduled lower hybrid zone risk transfer area-open ended 6883 provides a trading opportunity, if there are setups in place such as, but not limiting in scope to, black neutral candle (Mn+) 2146. A trader or user uses Halved Hybrid Nozzlelism Shifting End SpikeNertical Line (Bear To Bull) 6915 and either, but not limiting in scope to, bull entry spike 1875 or health directional line—bullish (directional bull) 2055 as an entry; uses, but not limiting in scope to, bullish dk yellow candle—type a+ 2230 or yellow bull warning candle (bull belief warning) 1430 as an entry during the process of upper left post Halved Hybrid Nozzlelism confluence 6555 as a scalp-swing trader and exits at, but not limiting scope to, pink ext bear warning line 1675 or bear entry spike 1880.

FIG. 16 shows one embodiment of a display, showing an illustrative screenshot view displaying a colored Candlestick Spectrum chart showing a Bullish Believers Trend Development and Recognition with Hybrid Zone Lines, as is included within certain embodiments of the multidimensional risk analysis systems 100 of FIGS. 1 and 2. It illustrates a Bullish Believers Trend Development and Recognition with Hybrid Zone Lines. After the occurrence of scheduled lower hybrid zone risk transfer area-open ended 6883, a scheduled intersection of Blue Line 6715 to the upside of zone line 1040 occurs, preferably in zone area 1015c, if there are a number of occurrences of scheduled events of Blue Line 6710, without any unscheduled intersection of zone line 6755, a Bullish Believers trend development takes place so long as there are a series of Blue Line angle north 2381-an forming and this starts slowing down once the Scheduled Event of Blue Line 2381-as starts occurring. A trader or user skilled in the art understands that at the first formation of unscheduled intersection of zone line 1040, the trend reverses. Shifting of the upper zone line 1010 at shifting point 6917 and the formation of upper right Halved Hybrid Nozzlelism 6035 shape, indicates further expansion of the bullish trend. Typically, the shifting of all zone lines over a period of time to the upside, with the exception of 1010, provides an indication of an upcoming weakness within the trend. Within trend development, it is typical for the Blue Line 2381 to be higher than zone line 1040. It is further understood that market vehicle prices stay above zone line 1040 for a general bullish direction. FIG. 16 also illustrates one embodiment of at least one type of hybrid zone scheduled risk transfer areas, which is referred to as scheduled upper hybrid zone risk transfer area-open ended 6884. A trader or user skilled in the art observes that such configuration is similar to scheduled lower hybrid zone risk transfer area-open ended 6883, however in this configuration, the Scheduled Event of Blue Line 6710 takes place within the upper zones 1015a, 1015b, or 1015c. As illustrated within FIG. 16, the scheduled upper hybrid zone risk transfer area-open ended 6884 occurs between points “A”, “B”, “C” and D. Typically, market vehicle prices from zones 1015a or 1015b comes down to zone line 1040 and creates either profit taking opportunities or scalp-swing opportunities 2112, as illustrated in FIG. 16 with Indigo Bear Warning Candle (M) 2135, for the Bearish Believers and uses targets of zone lines 1020, 1030, or 1040 with stops at either the Blue Line 2381 or zone line 1050. Due to the recognition of scheduled upper hybrid zone risk transfer area-open ended 6884, a trader or user benefits by closing bearish positions and takes positions in a bullish direction, recognizing bullish indicators above Blue Line 2381 in the transfer area. An alert is setup for this configuration.

Though not illustrated, a trader or user skilled in the art understands Bearish Believers Trend Development and Recognition with Hybrid Zone Lines. After the scheduled intersection of Blue Line, to the downside of the mid zone line, preferably in zone area 1015d, if there are a number of occurrences of scheduled events of Blue Line, without any unscheduled intersection of zone line, a bearish trend development takes place so long as there are a series of Blue Line angle south forming and this starts slowing down once the Scheduled Event of Blue Line angle south starts occurring. A trader or user skilled in the art understands that the first formation of unscheduled intersection of the mid zone line, the trend reverses. Shifting of the lower zone line at shifting point and the formation of Halved Hybrid Nozzlelism shape, indicates further expansion of the bearish trend. Typically, the shifting of all zone lines over a period of time to the downside, with the exception of 1070, provides an indication of upcoming weakness in the trend. Within trend development, it is typical for the Blue Line to be lower than the mid zone lin. It is further understood that market vehicle prices stay below the mid zone line for a general bearish direction.

FIG. 14 illustrates one embodiment of the various types of hybrid zone scheduled risk transfer areas, which is referred to as scheduled upper close ended hybrid zone risk transfer area 6885, which serves as an indication from a bullish to bearish trend. A trader or user skilled in the art understands that such configuration has a pre-requisite for the Bullish Believers' risk to Bearish Believers' risk, which as such, the Blue Line 2381 is greater in value than zone line 1040, of which both lines is parallel to one another within this entire area, covered by two scheduled intersections of Blue Line 6715, one left for Blue Line angle north 2381-an and one right for Blue Line angle south 2381-as. A trader or user skilled in the art is aware that the location of Blue Line 2381 is in zones 1015a or 1015b. It is further understood that after the unscheduled intersection of zone line 6755 and the formation of unscheduled risk transition line 6830 and scheduled intersection of Blue Line 6715, Bullish Believers lose the appetite for more demand and the devaluation of prices is possible and creates a scalp-swing bearish trading opportunity. A trader or user skilled in the art may observes for some scalp-swing setups or uses, but not limiting scope to, MSBE types of super bearish belief entries, if setups are not available.

FIG. 14 illustrates one embodiment of the various types of hybrid zone scheduled risk transfer areas, referred to as scheduled lower close ended hybrid zone risk transfer area 6886, which serves as an indication from a bearish to bullish trend. A trader or user skilled in the art understands that such configuration has a pre-requisite for the Bearish Believers' risk to Bullish Believers' risk, which as such, the Blue Line 2381 is lesser in value than zone line 1040, of which both lines are parallel to one another in this entire area, covered by two intersections of Blue Line 6715, one left for Blue Line angle south 2381-as and one right for Blue Line angle north 2381-an. A trader or user skilled in the art is aware that the location of Blue Line 2381 is in zones 1015e or 1015f. It is further understood that after the scheduled intersection of Blue Line 6715 and the formation of scheduled risk transition spike/line bull continue 6815, Bearish Believers lose the appetite for more demand and the prices increases and creates a scalp-swing bullish trading opportunity. A trader or user skilled in the art observes from some scalp-swing setups or uses, but not limiting scope to, MSB types of super bullish belief entries, if setups are not available. A trader or user further uses multi dimensional bull (multi dimensional bull entry) 1480 or earlier lows−4.6(Mc)++. Multidimensional Bull entry 1480 is a Bullish Believers' entry and has an alert, as illustrated, and is further considered as a bull entry special market condition. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading. There is a variety of embodiments of hybrid zone risk transfer areas.

### Scalp Swing Trading

Within this disclosure, the term “scalp-swing trading” is utilized to describe unique combination of the swing trading with scalp trading, designed especially to produce more efficient, more accurate, unique risk distributed, less riskier, pinpointed, precise targets, better timed, click and go methods and quick result oriented trading methods compared to both traditional individual scalping and swing trading methods. As such, scalp-swing trading illustrates a shape or pattern of a variety of indicator combinations, which is utilized to help an ordinary skilled user or trader without extensive training to understand important events occurring within financial markets such as market trend changes, breakouts, retracements, new highs, new lows, directional forecastings, reversals, pullbacks, and many other such trading clues.

A trader or user skilled in the art understands that traditional scalping is a trading style in which a trader or user looks to collect possible profits on their positions within very small price changes within the Market Vehicles or securities. Typically, such exit occurs after a trade has been entered into and appears profitable. A trader places anywhere between 10 to a couple hundred trades within a single day, with the belief that being able to capture small moves within a market vehicle is easier than capturing larger moves. The apparent main goal of a trader is to get into and out of a trade with a small amount of profit within a short period of time, and with the apparent belief that small profits easily compound into larger gains if a strict exit strategy is followed in order to prevent large losses. A trader or user who implements such a strategy may be referred to as a scalper.

A trader or user skilled in the art understands that traditional swing trading is a trading style in which a trader or user attempts to capture gains within a market vehicle by holding such market vehicle for a period of a day to four days. It is further understood that swing is the fluctuation of the value of the market vehicle or any particular asset, liability or account over a short period of time, therefore referred to as short term trading. Such particular trading styles are used by at-home and day traders. Such traders use technical analysis to perform swing trading. These traders have no concern as to the fundamentals but rather focuses on price trends and patterns for their trading and engage into short term trading strategies. A trader or user skilled in the art understands that swing trading is subject to large draw downs. The risks involved within swing trading are much higher than scalping, but lower than long-term trading. Such traders forecast the changes in the prices of a market vehicle or security based upon the oscillations between its prices being bid up by optimism and alternately being bid down by pessimism over a period of one to four days.

Scalp-Swing trading uses proprietary tools such as, but not limiting scope to, earlier highs, earlier lows, with assigned risk recognition numbers, super belief bull, super belief bear entries, super belief bull pin point entries and/or super belief bear pin point entries with assigned risk recognition numbers, etc. A trader or user skilled in the art understands that Dynamic Zone Lines assist with entries and exits with scalp-swing setups.

Certain embodiments of the multidimensional risk analysis systems 100, as described with respect to FIGS. 1 and 2, are configured to perform the above and thereupon, user interface 125 (FIG. 2) can project such a display of scalp-swing trading. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. There are a variety of embodiments of scalp-swing trading as compared to traditional swing and scalp trading.

### Advantages of Scalp-Swing

A trader or user skilled in the art understands that scalp-swing trading has advantages over both traditional scalp trading and traditional swing trading. Scalp-swing trading allows for more accuracy of entries and exits, with lesser draw downs. It is further observed that scalp-swing trading allows for the significant reduction of trading risk, as during every time period or ticker, a trader or user is informed about the various risks that are associated within the market as well as the health of the security or market vehicle.

In certain instances, entries and exits typically is two to five time frames earlier than traditional methods due to the pin pointing of risks as well as entries and exits. Thereupon, this allows for the reduction of errors made in entries and exits and reduces the risks involved in trading, which therefore provide help to a trader or user with their capital preservation. Reducing a trader or users losses, that would not have occurred using traditional swing and scalp methods, would allow a trader or user more flexibility in using their capital efficiently. Obtaining predetermined targets from dynamic-adaptive zone lines of any market vehicle within any user selected time frame and the ability to get such targets well in advanced and have them self-adjust according to the dynamic changes within the market, reduces or eliminates the labor involved in finding such adaptive-dynamic real time accurate real investment grade bullish or bearish belief's supports and resistances, of which are institutional grade rather than those used within traditional methods. As such, it helps a trader or user set more realistic and achievable goals and still adapt the dynamic changes after entries and exits. It is observed that scalp-swing trading allows for less time spent in trading, when trying to achieve the same results as on traditional swing and traditional scalp trading, with the use of horizontal time duration risk.

A trader or user skilled in the art uses various forecasting tools with risk designations such as, but not limiting scope to, earlier highs, earlier lows, with assigned risk recognition numbers, super belief bull, super belief bear entries, super belief bull pin point entries and/or super belief bear pin point entries with assigned risk recognition numbers, to produce more accurate and better trading results within a shorter amount of time in comparison to traditional scalp or traditional swing methods. Traditional swing trading time frame is proven wrong with the use of scalp-swing trading. Scalp-swing trading allows the trader, user or investor less market exposure and quicker results, due to reducing the amount of time involved in trading to produce similar results as traditional swing and traditional scalp trading. For example purposes, when applying scalp-swing to Forex markets, it helps the trader or user experience a reduction in the overnight interest charges as the amount of time spent in a particular trade is less.

Upon reading the teachings of this specification, those skilled in the art will now appreciate that, under appropriate circumstances, the advantages of scalp-swing in comparison to traditional swing and traditional scalp trading along with the reduction in risk and time involved, may suffice.

### Major Components of Scalp-Swing Method

FIG. 21 shows one embodiment of a display, showing an illustrative multi-colored legend view displaying scalp-swing components, as is included within certain embodiments of the multidimensional risk analysis systems 100 of FIGS. 1 and 2. FIG. 21 represents certain embodiments of the major components of scalp-swing method, which include earlier highs 8001 and earlier lows 8002. A trader or user skilled in the art forecasts earlier highs with risk assessments 8011 and forecast earlier lows with risk assessments 8012. It is understood that this is a forecasting of either the bullish or bearish direction of a security with possible lower risk. A trader or user categorizes per their choice, such risk assessment numbers, in forecasting earlier highs with +1 to +6 and earlier lows with −1 to −6. Earlier highs and earlier lows self-adjust to the variations unusual of internal risk and serves as a forecasting tool.

A trader or user skilled in the art uses the components modified health risk indicator 1216 (FIG. 5) individually or in combination of a few in order to develop earlier possible highs 8001 and earlier possible lows 8002. For a trader or user to develop an algorithm for earlier highs 8001, such trader or user uses the following indicators, which are provided for example purposes and are not limiting in scope: health risk directional indicator—bullish 2015 (FIG. 5), health risk directional indictor—bearish 2020 (FIG. 5), and Boundary Lines 1220, 1230, 1240, 1250 (FIG. 5). Thereupon, with such listed indicators for example purposes, a trader or user uses the relation of health risk directional indicator—bullish 2015 in comparison to health risk directional indictor—bearish 2020, the relation of health risk directional indictor—bullish 2015 with its previous values and relation of health risk directional indictor—bearish 2020 with its previous values. A trader or user also uses the relation of health risk directional indictor—bullish 2015 and health risk directional indictor—bearish 2020 in comparison to Boundary Lines 1220, upper most Boundary Lines 1230, lower most Boundary Lines 1240, and core Boundary Lines 1250, or any other user defined values is used to further categorize the assigned risk recognition numbers, including but not limiting the scope of, +1 to +6, −1 to −6, or other risk designators as per the trader or users choice.

Within the multidimensional risk analysis systems 100, FIG. 21 includes earlier highs categories, which is classified with 8011. Certain embodiments of earlier highs 8011 are categorized in the following manner, or is classified according to a trader or users choice: earlier highs +3.1 1470-a1 (FIGS. 9 and 13); earlier highs +3.2 1470-a2 (FIGS. 11, 13, and 14); earlier highs +3.3 1470-a3 (FIGS. 10, 11, and 13); earlier highs +3.4 1470-a4 (FIG. 11); earlier highs +3.5; and, earlier highs +3.6. Earlier highs are used as a forecasting tool.

Within the multidimensional risk analysis systems 100, FIG. 21 includes earlier lows categories, which are classified with 8012.Certain embodiments of earlier lows categories 8012 are categorized in the following manner, or are classified according to a trader or users choice: earlier lows −3.1; earlier lows −3.2 1475-b2 (FIG. 14); earlier lows −3.3 1475-b3 (FIGS. 9, 12, and 13); earlier lows −3.4 1475-b4 (FIGS. 13 and 14); earlier lows −3.5 1475-b5 (FIGS. 9, 11, 13, and 14); and, earlier lows −3.6 1475-b6 (FIG. 13). Earlier lows are used as a forecasting tool.

Within the multidimensional risk analysis systems 100, FIG. 21 includes certain embodiments of the major components of scalp-swing method, which include magic super belief bull pin point entries 8007 and magic super belief bear pin point entries 8008. A trader or user skilled in the art understands that magic super belief bull pin point entries 8007 and magic super belief bear pin point entries 8008 are referred to as the readiness a trader or user receives with pin point entries. It is classified into seven categories of risk recognition number for either the Bullish Believers +1 to +7 or Bearish Believers −1 to −7. Within the multidimensional risk analysis systems 100, pin point bullish moves have been designated with 8007 and pin point bearish moves have been designated with 8008 and as such are used as a forecasting tool.

Within the multidimensional risk analysis systems 100, FIG. 21 includes super belief bull pin point entries categories with risk assessment, which are classified with 8015. Certain embodiments of super belief bull pin point entries categories with risk assessment are categorized in the following manner, or are classified according to a trader or users choice: super belief bull pin point en+1*; super belief bull pin point en+2* 1625-2 (FIG. 10); super belief bull pin point en+3* 1625-3 (FIG. 10); super belief bull pin point en+4* 1625-4 (FIGS. 11, 12, 13 and 14); super belief bull pin point en+5* 1625-5 (FIGS. 10, 13, and 14); super belief bull pin point en+6* 1625-6 (FIGS. 9, 12, and 13); and, super belief bull pin point en+7* 16257 (FIG. 14). Super belief bear pin point entries categories with risk assessment, are classified with the following retrospect as seen in Scalp-Swing Components Legend, FIG. 21 with 8016. Certain embodiments of super belief bear pin point entries categories with risk assessment are categorized in the following manner, or are classified according to a trader or user's choice: super belief bear pin point en-1*; super belief bear pin point en-2*; super belief bear pin point en-3* 1620-3 (FIG. 13); super belief bear pin point en-4* 1620-4 (FIGS. 13 and 14); super belief bear pin point en-5* 1620-5; super belief bear pin point en-6* 1620-6 (FIGS. 10, 11, and 13); and, super belief bear pin point en-7* 1620-7 (FIGS. 9, 10, 13 and 14). FIG. 14 illustrates a super belief bear pin point en-4* 1620-4, which is considered a Bearish Believers' entry and has a yellow triangle alert, as illustrated, which is used as a forecasting tool.

Within the multidimensional risk analysis systems 100, certain embodiments of the major components of scalp-swing method, with respect to FIG. 21, include super belief bull entries 8003 and super belief bear entries 8004. A trader or user skilled in the art understands that magic super belief bull entries 8003 and magic super belief bear entries 8004 are used in the absence of risk recognition number 2045. With respect to super bullish belief entry 8003 a trader or user skilled in the art uses FIGS. 10, 11 and 13 for reference purposes while with respect to super bearish belief entry 8004, a trader or user skilled in the art uses FIGS. 10, 13, and 14 for reference purposes. Super belief bull entries and super belief bear entries are used as a forecasting tool.

Within the multidimensional risk analysis systems 100, FIG. 21 includes certain embodiments of the major components of scalp-swing method, includes forecasting earlier highs with risk assessments for Halved Hybrid Nozzlelism 8013 and forecasting earlier lows with risk assessments for Halved Hybrid Nozzlelism 8014. A trader or user skilled in the art understands that this is used for the forecasting of either the bullish or bearish direction of a market vehicle or security with low risk with applications to the phenomenon of Halved Hybrid Nozzlelism. A trader or user categorizes according to their choice, such risk assessment numbers, in forecasting earlier highs with +1 to +6 and earlier lows with −1 to −6. Within the multidimensional risk analysis systems 100, earlier highs has been designated with 8005 and earlier lows has been designated with 8006 for Halved Hybrid Nozzlelism. Earlier highs 8005 and earlier lows 8006 for Halved Hybrid Nozzlelism self-adjust to the variations unusual of internal risk and as such is used as a forecasting tool.

Within the multidimensional risk analysis systems 100, FIG. 21 allows a trader or user skilled in the art to understand that forecasting earlier highs with risk assessments for Halved Hybrid Nozzlelism 8013 are applicable to Bullish Believers. Such configuration occurs during the Halved Hybrid Nozzlelism process and during the shifting of the upper most zone line, risk designators becomes available such as, but not limiting in scope, “1”, “2”, “3”, “4”, “5” or “6”, such as which are designated into the risk designators for Halved Hybrid Nozzlelism such as, but not limiting scope to, “1NZ”, “2NZ”, “3NZ”, “4NZ”, “5NZ” or “6NZ” or other such numbers as per a trader or user's choice if he/she further categorizes the risk. A trader or user skilled in the art refers to the Users Manual for the various categories of forecasting earlier high details. A trader or user skilled in the art further understands that such configuration have the same design as forecasting earlier highs with risk assessments 8011 but is also combined with Halved Hybrid Nozzlelism 8013 and as such is used as a forecasting tool.

Within the multidimensional risk analysis systems 100, FIG. 21 allows a trader or user skilled in the art to understand that forecasting earlier lows with risk assessments for Halved Hybrid Nozzlelism 8012 are applicable to Bearish Believers. Such configuration occurs during the Halved Hybrid Nozzlelism process and during the shifting of the lower most zone line, risk designators become available such as, but not limiting in scope, “1”, “2”, “3”, “4”, “5” or “6”, such as which are designated into the risk designators for Halved Hybrid Nozzlelism such as, but not limiting scope to, “1NZ”, “2NZ”, “3NZ”, “4NZ”, “5NZ” or “6NZ” or other such numbers as per a trader or user's choice if he/she furthers categorized the risk. A trader or user skilled in the art refers to the Users Manual for the various categories of forecasting earlier lows details. A trader or user skilled in the art further understands that such configuration has the same design as forecasting earlier lows with risk assessments 8012 but is also combined with Halved Hybrid Nozzlelism 8014 and as such is used as a forecasting tool.

Within the multidimensional risk analysis systems 100, FIG. 21 includes forecasting earlier highs with risk assessments for Halved Hybrid Nozzlelism, which are classified with 8013. Certain embodiments of forecasting earlier highs with risk assessments for Halved Hybrid Nozzlelism 8013 are categorized in the following manner, or are classified according to a trader or users choice: magic trader earlier highs +3.1 for Halved Hybrid Nozzlelism 1470-a1nz (FIG. 10); magic trader earlier highs +3.2 for Halved Hybrid Nozzlelism; magic trader earlier highs +3.3 for Halved Hybrid Nozzlelism 1470-a3nz (FIGS. 9 and 13); magic trader earlier highs +3.4 for Halved Hybrid Nozzlelism 1470-a4nz (FIG. 11); magic trader earlier highs +3.5 for Halved Hybrid Nozzlelism 1470-a5nz (FIG. 11); and, magic trader earlier highs +3.6 for Halved Hybrid Nozzlelism. Forecasting earlier lows with risk assessments for Halved Hybrid Nozzlelism 8012, are classified with 8014. Certain embodiments of forecasting earlier lows with risk assessments for Halved Hybrid Nozzlelism 8012 are categorized in the following manner, or are classified according to a trader or users choice: magic trader earlier lows −3.1 for Halved Hybrid Nozzlelism; magic trader earlier lows −3.2 for Halved Hybrid Nozzlelism; magic trader earlier lows −3.3 for Halved Hybrid Nozzlelism; magic trader earlier lows −3.4 for Halved Hybrid Nozzlelism; magic trader earlier lows −3.5 for Halved Hybrid Nozzlelism 1475-b5nz (FIGS. 10 and 13); and, magic trader earlier lows −3.6 for Halved Hybrid Nozzlelism and as such are used as a forecasting tool.

Within the multidimensional risk analysis systems 100, FIG. 21 contains certain embodiments of the major components of scalp-swing method, which include super belief bull pin point entries categories with risk assessment for Halved Hybrid Nozzlelism 8017 and super belief bear pin point entries categories with risk assessments for Halved Hybrid Nozzlelism 8018. A trader or user skilled in the art understands that, 8008 is used for super belief bear pin point entries(“Msb”) 8007 is used for super belief bull pin point entries. A trader or user skilled in the art understands that super belief bull pin point entries for Halved Hybrid Nozzlelism 8017 and super belief bear pin point entries for Halved Hybrid Nozzlelism 8018 allows a trader to obtain pin point entries for either super belief bear pin point entries (“Msbe”) 8008 or super belief bullish pin point entries 8007. A trader or user skilled in the art understands that super belief bull pin point entries for Halved Hybrid Nozzlelism 8017 and super belief bear pin point entries for Halved Hybrid Nozzlelism 8018 are classified into seven categories of risk recognition numbers, for either the Bullish Believers +1 to +7 or Bearish Believers −1 to −7 and are applicable to Halved Hybrid Nozzlelism. Within the multidimensional risk analysis systems 100, pinpoint bullish move for Halved Hybrid Nozzlelism has been designated with 8009 and pinpoint bearish move for Halved Hybrid Nozzlelism has been designated with 8010. As such, this is applicable to Halved Hybrid Nozzlelism and as such is used as a forecasting tool.

Within the multidimensional risk analysis systems 100, FIG. 21 allows a trader or user skilled in the art to understand that super belief bull pin point entries for Halved Hybrid Nozzlelism 8017 are applicable to Bullish Believers. Such configuration occurs during the Halved Hybrid Nozzlelism process and during the shifting of the upper most zone line; risk designators become available such as, but not limiting in scope, “1”, “2”, “3”, “4”, “5” “6”, or “7”, such as which are designated into the risk designators for Halved Hybrid Nozzlelism such as, but not limiting scope to, “1NZ”, “2NZ”, “3NZ”, “4NZ”, “5NZ”, “6NZ”, or “7NZ” or other such numbers as per a trader or users choice if he/she further categorizes the risk. A trader or user skilled in the art refers to the Users Manual for the various categories of super belief bull pin point entries with risk assessment for Halved Hybrid Nozzlelism. A trader or user skilled in the art further understands that such configuration has the same design as super belief bull pin point entries categories w/risk assessment 8015 but is also combined with Halved Hybrid Nozzlelism and is used as a forecasting tool.

Within the multidimensional risk analysis systems 100, FIG. 21 allows a trader or user skilled in the art to understand that super belief bear pin point entries for Halved Hybrid Nozzlelism 8018 are applicable to Bearish Believers. Such configuration occurs during the possible Halved Hybrid Nozzlelism process and during the shifting of the lower most zone line, risk designators becomes available such as, but not limiting in scope, “1”, “2”, “3”, “4”, “5” “6”, or “7”, such as which are designated into the risk designators for Halved Hybrid Nozzlelism such as, but not limiting scope to, “1NZ”, “2NZ”, “3NZ”, “4NZ”, “5NZ”, “6NZ”, or “7NZ” or other such numbers as per a trader or user's choice if he/she further categorizes the risk. A trader or user skilled in the art refers to the User's Manual for the various categories of super belief bear pin point entries with risk assessment for Halved Hybrid Nozzlelism. A trader or user skilled in the art further understands that such configuration has the same design as super belief bear pin point entries categories w/risk assessment 8016 but is also combined with Halved Hybrid Nozzlelism and as such is used as a forecasting tool.

Within the multidimensional risk analysis systems 100, FIG. 21 illustrates super belief bull pin point entries categories with risk assessment for Halved Hybrid Nozzlelism 8017. Certain embodiments of super belief bull pin point entries categories with risk assessment for Halved Hybrid Nozzlelism 8017 are categorized in the following manner, or are classified according to a trader or user's choice: super belief bull pin point en+1* for Halved Hybrid Nozzlelism; super belief bull pin point en+2* for Halved Hybrid Nozzlelism; super belief bull pin point en+3* for Halved Hybrid Nozzlelism; super belief bull pin point en+4* for Halved Hybrid Nozzlelism; super belief bull pin point en+5* for Halved Hybrid Nozzlelism; super belief bull pin point en+6* for Halved Hybrid Nozzlelism; and, super belief bull pin point en+7* for Halved Hybrid Nozzlelism 1625-7nz (FIG .11) and all of which are used as a forecasting tool.

Within the multidimensional risk analysis systems 100, FIG. 21 illustrates super belief bear pin point entries categories with risk assessment for Halved Hybrid Nozzlelism 8018. Certain embodiments of Super belief bear pin point entries categories with risk assessment for Halved Hybrid Nozzlelism 8018 are categorized in the following manner, or are classified according to a trader or user's choice: super belief bear pin point en-1* for Halved Hybrid Nozzlelism; super belief bear pin point en-2* for Halved Hybrid Nozzlelism; super belief bear pin point en-3* for Halved Hybrid Nozzlelism; super belief bear pin point en-4* for Halved Hybrid Nozzlelism; super belief bear pin point en-5* for Halved Hybrid Nozzlelism; super belief bear pin point en-6* for Halved Hybrid Nozzlelism 1620-6nz (FIG. 13); and, super belief bear pin point en-7* for Halved Hybrid Nozzlelism 1620-7nz (FIG. 10) and all of which are used as a forecasting tool. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading.

Upon reading the teachings of this specification, those skilled in the art will now appreciate that, under appropriate circumstances, the various components, examples and concepts of scalp-swing, may suffice.

### Scalp-Swing Method Setups or Special Multi-Low Risk Opportunity Setups

Certain embodiments of the multidimensional risk analysis systems 100, as described with respect to FIGS. 1 and 2, are configured to perform scalp-swing method setups or special multi-low risk opportunity setups and thereupon, user interface 125 (FIG. 2) can project such a display of scalp-swing method setups or special multi-low risk opportunity setups.

It is understood by a trader or user skilled in the art that scalp-swing method setups and special multi-low risk opportunity setups are considered unique in design and provide low risk entries and exits and are available for any time frame. When such are applied to 1 minute, it provides scalp-swing opportunities, allowing for drawdowns to be very close to none. When such are applied to 15 minutes, it provides entries for the 60 minutes and/or daily time frames, and drawdowns are significantly smaller than those drawdowns within traditional methods, and are used in conjunction with the 1 minute to allow for possible minimal drawdowns close to zero. When such are applied to 60 minutes, it provides entries for the daily time frame, and drawdowns are smaller in comparison to traditional methods, and are used in conjunction with 15 minutes and 1 minute to produce minimal to close to zero drawdowns.

A trader or user skilled in the art is aware that this is available for including, but not limiting scope to, all dynamic-adaptive sectional price perception risk dimensions indicators types a, b, c, d, e, f, and its deviations, various types of Sudden Market Spot Change Risk (internal market moving risk) 215 (FIG. 6), special conditions and for all risk dimensions (also known as market risks) 206 (FIG. 7). It further aware that use of higher time frames for setups such as the use of daily, weekly, 60 minute, 15 minute, and 1 minute produce mega scalp-swing and larger results. It is understood that any combination of time frames is applicable to this method and it produces better pin point results.

A trader or user skilled in the art may refers to the Halved Hybrid Nozzlelism section for including, but not limiting scope to, scalp-swing trading with upper right Halved Hybrid Nozzlelism, scalp-swing trading with Halved Hybrid Nozzlelism, prep-pre double bullish trend Hybrid Parallelism 7044 (FIG. 14), prep-pre double bearish trend Hybrid Parallelism 7045 (FIG. 14), confluence zero after Hybrid Parallelism between two scheduled events of Blue Line, confluence zero after hybrid nozzlelism tipping area 6592 (FIG. 14), scheduled risk transition spike/line bull continue 6815 (FIG. 18), scheduled risk transition spike/line bear continue 6816 (FIGS. 9, 13, 14, and 18), scheduled lower hybrid zone transfer area, scheduled upper close ended hybrid zone risk transfer area 6885 (FIG. 14), scheduled lower close ended hybrid zone risk transfer area 6886 (FIG. 14), double upper Halved Hybrid Nozzlelism 6050 (FIG. 14), double lower Halved Hybrid Nozzlelism, and lower right Halved Hybrid Nozzlelism Annularization (divergence) 6260 (FIG. 10). There are a variety of concepts and applications of scalp-swing and special multi-low risk opportunity setups.

### Mega Scalp-Swing

A trader or user skilled in the art refers to scalp-swing trading and special multi-low risk opportunity setups for details on scalp-swing trading. It is understood by a trader or user skilled in the art that there are several setup types such as, but not limiting scope to, scalp-swing method set ups types M, scalp-swing method set ups types Mn ,scalp-swing method set ups types Mc and scalp-swing method set ups types Me which are used to produce large results for either the Bullish Believers or Bearish Believers over a period of time, with the least amount of risk and maintenance.

Once a setup is identified, such as, but not limiting scope to, earlier lows −4.6(Mc)++ 2156 (FIG. 9), earlier lows −4.6(Mc)+ 2157 (not illustrated), super belief bull pinpoint en+7* (Mc) 2159 (FIG. 9), earlier lows −4.1 tan (Me)-oex (not illustrated), powder blue (C) bullish entry(Me)+oex (not illustrated), or tan bearish entry-(Me) 2180 (FIG. 13), a trader or user skilled in the art uses alerts or manually, on larger time frames such as daily, weekly, monthly, etc and use smaller time frames such as 60 minutes, 15 minutes or 1 minute to identify scalp-swing method set ups or special multi ow risk opportunity set ups, which are used to refine entries in the direction of one of the possible setups aforementioned in this paragraph. A trader or user skilled in the art understands that Dynamic Zone Lines assist with entries and exits with mega scalp-swing setups. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

A trader or user skilled in the art understands that there are a variety of mega scalp-swing setups and that it is referred to as the use of entering scalp-swing on a lower time frame but following the scalp-swing setups of a bigger time frame allows for large results within any market vehicle such as, but not limiting scope to, stocks, commodities, ETFs, options, derivatives, ETCs, or Forex.

### Examples of Mega Scalp-Swing

A trader or user skilled in the art is aware that there are numerous types and examples that are provided with mega scalp-swing. However, within this disclosure, two examples are considered. FIG. 18 shows one embodiment of a display, showing an illustrative screenshot view displaying a bearish mega scalp swing setup, as is included within certain embodiments of the multidimensional risk analysis systems 100 of FIGS. 1 and 2.

It also provides one illustrative display of mega scalp-swing short entry setup, tan bearish entry-(Me) 2180, which is considered as special multi low risk bearish opportunity setups. A trader or user skilled in the art understands that Me +/−Oex is considered to be a special multi-low risk opportunity setup. “Me” is defined as magic trader entry, while the “Oex” is defined as extended movement and either has a “+” or “−” before it. Thereupon, a “+Oex” serves as an indication that there is an extended previous bearish condition within the market, while a “−Oex” serves as an indication that there is an extended previous bullish condition within the market. It is further understood that such setups are considered special since they have unique conditions within the market and that there are several low risk factors that are taking place at such particular time. A trader or user skilled in the art takes a setup position with Me+/−Oex and such setups produce big results in trading.

Typically, an Me+Oex precedes super belief bullish pin point entries 1625, whereas an Me−Oex precedes super belief bear pin point entries 1620. It is observed that forecasting earlier highs with risk assessments are combined with +Oex and forecasting earlier lows with risk assessments are combined with −Oex. It is understood that a large red colored alert symbol 8205 represents a Bearish Mega Scalp-Swing setup entry alert whereas a small red colored alert symbol 8206 represents a Bearish Mega Scalp-Swing setup exit. It is understood that a large green colored alert symbol 8210 represents a Bullish Mega Scalp-Swing setup entry alert whereas a small green colored alert symbol 8211 represents a Bullish Mega Scalp-Swing setup exit.

Certain embodiments of the multidimensional risk analysis systems 100, as described with respect to FIGS. 1 and 2, are configured, in respect with various risk processors 200 (FIG. 2), to allow a trader to utilize a risk management procedure. A trader or user skilled in the art uses risk tables 4005 (FIG. 22), 4100 (FIGS. 23), and 4200 (FIG. 24) to decide how many maximum allowed contracts with breakeven analysis 3720 (FIG. 23), maximum allowed used margin with breakeven analysis 3730 (FIG. 23) and the current equity WIBE limit 3740 (FIG. 23), with the incorporation of EMC errors elimination technique in capital preservation.

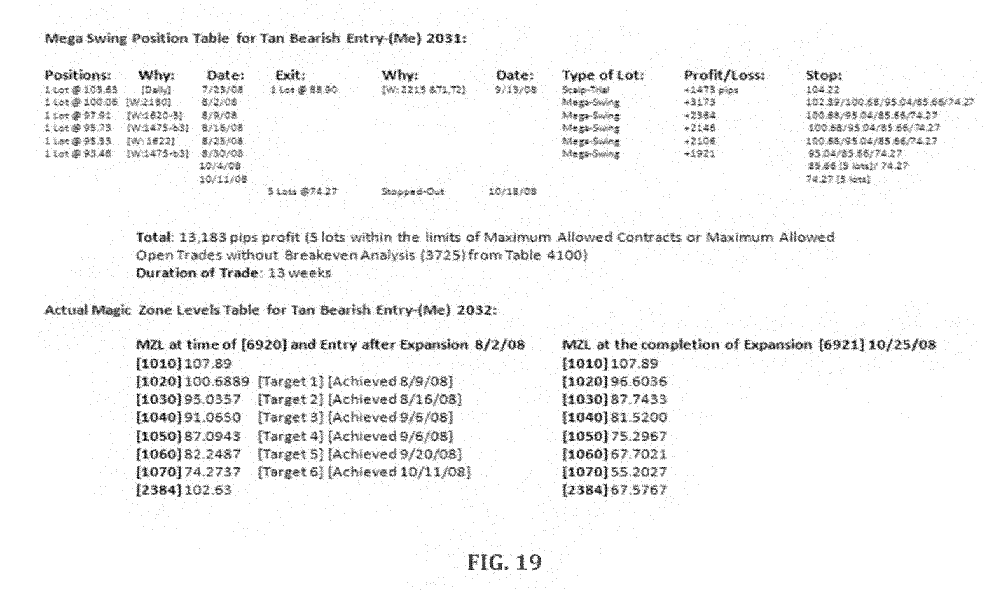

FIG. 19 shows one embodiment of a display, showing a supportive illustrative screenshot view displaying positions and exits, with respect to FIG. 18, as included within certain embodiments of the multidimensional risk analysis systems 100 of FIGS. 1 and 2. It also provides a supportive illustrative display of FIG. 18, in which a trader or user enters into a trade with an alert for the following indicators, but not limiting scope to, on the daily time frame: bear magic entry spike 1880, super bearish belief contra—re-1 2200, and/or super bullish belief contra+re1 (Mc) 2160. A trader or user enters mega scalp-swing setup, tan bearish entry-(Me) 2180, with or without the use of an alert, at a close price of 103.63 of the selected market vehicle to trade 3510 (FIG. 23), with a contract size 3540 (FIG. 23) of one lot, taking into consideration various factors such as, but not limiting scope to, a reduced margin factor user selection from what broker offers 3515 (FIG. 23), a margin used per contract 3545 (FIG. 23), a contingency amount for max loss for a particular account 3525 (FIG. 23), a corrected results for breakeven analysis for zone levels used 3585 (FIG. 23), a per trade capital loss allowed 3675 (FIG. 23), a maximum allowable pip movements or price change 3715 (FIG. 23), and a pip difference between two nearest zone lines 3508 (FIG. 23).

FIG. 18 is further analyzed in conjunction with FIG. 19 to understand a trade a trader or user takes using mega scalp-swing setup, tan bearish entry-(Me) 2180. An alert for super bullish belief contra+re 2200 is seen within the AUD/JPY weekly chart and has also appeared within the explorer on Jul. 26, 2008. It is observed that on Jul. 19, 2008, the left leg portion of bear entry spike 1880 started to form. Within the daily chart, a trader or user skilled in the art, observes on 7/23/08, a setup, super bullish belief contra+re1 (Mc) 2160 along with several indicators such as, bear entry spike 1880 and bear spot risk line 1695, occurred. A trader or user adds a test scalp lot at this time, at the close of 103.63 based upon a 60 minute and 5 minute entry, placing a stop at 104.22, which a trader or user observes as the open price. It is further observed that the bear entry spike 1880 was completed on Ayg. 2, 2008; within the week of Jul. 26, 2008, a modified bearish time segment 1141 is observed and the Squeezing of Zone Lines 6920 is visualized on the left. Thus far, it is observed by a trader or user that there is a shorting opportunity but there was no setup signal. On the week of Aug. 2, 2008, the setup tan bearish entry-(Me) 2180 is observed. The high of 103.40 did not take out the stop of 104.22 that the trader or user had placed. At the end of such week, around the close of the market of 4:00 pm, a trader or user adds another lot and can refer FIG. 19 for subsequent details and results of such trade.

FIG. 18 provides an illustrative display of another mega scalp-swing long entry setup, bullish DK yellow candle—type a (M) 2127, which is considered as special multi low risk bullish opportunity setups 2116. Certain embodiments of the multidimensional risk analysis systems 100, as described with respect to FIGS. 1 and 2, are configured, in respect with various risk processors 200 (FIG. 2), to allow a trader to utilize a risk management procedure. A trader or user skilled in the art uses risk tables 4005 (FIG. 22), 4100 (FIGS. 23), and 4200 (FIG. 24) to decide how many maximum allowed contracts with breakeven analysis 3720 (FIG. 23), maximum allowed used margin with breakeven analysis 3730 (FIG. 23) and the current equity WIBE limit 3740 (FIG. 23), with the incorporation of EMC errors elimination technique in capital preservation.

A trader or user skilled in the art, referring to FIG. 18, observes on the AUD/JPY weekly chart that on the week of Feb. 7, 2009, a bullish DK yellow candle—type a (M) 2127 setup had taken place. At the open of Feb. 14, 2009, a modified bullish time segment 1131 is observed, and therefore the trader or user takes a long entry at the close price of 60.33. A trader then exits out of such trade at the appearance of a setup, super belief bull pinpoint en+7* (Mc) 2159 at the close price of 76.52 on Jul. 4, 2009. The conclusion of such trade is that the trader or user approximately earns 1619 pips profit for one lot within the limits of maximum allowed contracts or maximum allowed open trades without breakeven analysis 3725 from table 4200 (FIG. 24) for a duration of approximately 21 weeks.

A trader or user skilled in the art concludes from such above examples that it can be relatively simple to trade with mega scalp-swing setups, as such is able to easily identify entries and exits, reducing time involved in a trade, pinpoint the accuracy of an entry or exit, risk assessment and risk recognition at every stage, the ability to receive pre-determined targets that is achievable and the ability of such being user friendly. Many configurations of mega scalp-swing occurs within the scope of the present disclosure.

### Multi-Confirmation Risk Assessment and Trading System Scalp-Swing Setup Table

A trader or user skilled in the art understands that the multi-confirmation risk assessment and trading system scalp-swing setup table, as seen in the Users Manual, (also known as scalp-swing setups table) provides all scalp-swing method setups, the various symbols for such setups, the various colors for scalp-swing setups, the various bullish symbols for scalp-swing setups, the various neutral symbols for scalp-swing setups, the various bearish symbols for scalp-swing setups, the color-coding for scalp-swing setups and the reference numbers that are associated with such scalp-swing setups. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. A variety of configurations of the scalp-swing setups table and its various components occurs.

### Types of Scalp-Swing Method Setups

Certain embodiments of the multidimensional risk analysis systems 100, as described with respect to FIGS. 1 and 2, are configured, in order to determine the numerous types of scalp-swing setups. A trader or user skilled in the art determines that such setups are based upon multiple risk recognition and confirmation. A trader or user does not have to worry about the lining up of multiple indicators, about the short bullish or bearish risk recognition factors or the aligning the combination of eight major types of risk dimensions 206 (FIG. 2). Thereupon, it is understood that such setups are classified into four major categories.

One embodiment of the various types of scalp-swing setups is referred to as scalp-swing methods setup type M. As such, these setups are based on, but not limiting scope to, all price risks and spot risks and typically involves the color of candles/bars, Spikes, vertical lines, spot risk lines and warnings. A trader or user skilled in the art uses one mathematical function such as sum, subtraction, multiplication and division to create such scalp-swing setups. There are certain types of scalp-swing type M setups, which includes, but not limiting scope to, bullish DK yellow candle type a++(M), bullish DK yellow candle type a (M), bullish bright green candle type b (M), bullish green candle type c+ (M) Pc+, tan bearish entry type c (M1), purple (C) candle type d+++(M) Pd, tan bearish entry type d (M)−oex, turquoise bullish candle+(M), gray (C) bullish candle (M), indigo bear warning candle (M), and pink (C) bearish candle (M).

Within the multidimensional risk analysis systems 100, with respect to FIG. 17, a trader or user skilled in the art understands that one such scalp-swing type M setup is referred to as bullish Dk yellow candle—type a++ (M) 2126, which is concluded from the combination of: bullish dk yellow candle—type a, Blue Line 2381, and bull entry spike 1875. Another scalp-swing type M setup is referred to as bullish Dk yellow candle—type a (M) 2127, which is derived from the combination of: bullish dk yellow candle—type a, bull entry spike 1875 and bull spot risk line 1690, as such is illustrated in FIGS. 11, 13, 14 and 18. Yet another scalp-swing type M setup is referred to as bullish bright green candle—type b (M), which is concluded through the combination of bullish bright green candle—type b MT-83 (FIG. 6), bull entry spike, and bull spot risk line. Yet another scalp-swing type M setup is referred to as bullish green candle—type c+(M) Pc+, which is derived from the combination of bullish green candle type c+, Blue Line, bull spot risk line, and bull entry spike. A further scalp-swing type M setup is referred to as tan bearish entry—type c (M1), which results from the combination of tan bearish entry, bear entry spike, and directional line bear . Another scalp-swing type M setup is referred to as purple (C) candle—type d +++ (M) Pd, which arrived from the combination of purple candle—type d+++, yellow bull warning candle and bull entry spike. A trader or user recognizes another scalp-swing type M setup which is referred to as tan bearish entry—type d (M)−oex, which can be designed through a possible combination of purple (C) candle type d, bear entry spike, and is referred to as tan bearish entry—type c (M1), which results from the combination of tan bearish entry. A trader or user recognizes another scalp-swing type M setup which is referred to as turquoise bullish candle + (M), which is concluded from the combination of turquoise bullish candle +, yellow ext bull warning line and bull entry spike. Yet another scalp-swing type M setup is referred to as gray (C) bullish candle (M), which is designed through the combination of yellow bull warning candle, gray (C) bullish, and bull entry spike. A trader or user recognizes another scalp-swing type M setup which is referred to as indigo bear warning candle (M), which is concluded from the combination of indigo bear warning candle, pink (C) bearish candle, and bear entry spike. A trader or user recognizes a final scalp-swing type M setup which is referred to as pink (C) bearish candle (M) which is derived from the combination of pink (C) bearish candle, black neutral candle (also known as neutral bar), and bear entry spike.

One embodiment of the various types of scalp-swing setups is referred to as scalp-swing methods setup type Mn. As such, these setups involve black neutral candle and bullish/bearish entry Spikes and also in the modified neutral time segment. Within such, it is observed that the risk is balanced from the previous trend and the first test run takes place in either the bullish or bearish direction, as such a trader refers to the User Manual for directional reference. There are certain types of scalp-swing type Mn setups, which include, but not limiting scope to, black neutral candle (Mn+) and Top Bear small or big (Mn−).

A trader or user skilled in the art understands that one such scalp-swing type Mn setup is referred to as black neutral candle (Mn+) 2146, which is concluded from the combination of: black neutral candle 1460, bull entry spike 1875 and Blue Line 2381, as such is illustrated in FIGS. 11, 13 and 14. Another scalp-swing type Mn setup is referred to as Top Bear—small or big (Mn−), which is derived from the combination of black neutral candle, Top Bear—small or big and bear entry spike. One embodiment of the various types of scalp-swing setups is referred to as scalp-swing methods setup type Mc. As such, these setups are created when the sudden previous direction has changed but the previous direction risk recognition factors, such as favorable bullish risk recognition factors, favorable bearish risk recognition factors, and favorable neutral risk recognition factors, are still in effect or the previous Horizontal Time Risk is still in effect. Typically, such direction is recognized by the directional entry Spikes, bull entry spike or bear entry spike. There are certain types of scalp-swing type Mc setups, which include, but not limiting scope to, earlier lows 4.6 (Mc)++, earlier lows −4.6 (Mc)+, earlier lows 4.6 (Mc), super bullish bull pin point en+7*(Mc), super bullish belief contra+re1, bullish DK yellow candle type a+(Mc) Mgo, bullish DK yellow candle type a (Mc) Mgo, and bullish green candle type C (Mc) Mgo.

A trader or user skilled in the art understands that one such scalp-swing type Mc setup 2155 is referred to as earlier lows −4.6 (Mc)++, which is created from the combination of earlier lows −4.6, bull entry spike and bull spot risk line. Another such scalp-swing type Mc setup is referred to as earlier lows −4.6 (Mc)+, which are concluded from the combination of earlier lows −4.6, bull entry spike, and bull spot risk line. Another such scalp-swing type Mc setup is referred to as earlier lows −4.6 (Mc), which is derived from the combination of earlier lows −4.6, bull entry spike, and bull spot risk line. Another such scalp-swing type Mc setup is referred to as super belief bull pin point en+7* (Mc), which is concluded from the combination of Super Bullish Believer Entry, dynamic strength risk indicator and bear entry spike. An entry for super belief bull pin point en+7* (Mc) 2159 is illustrated in FIG. 18.

Another such scalp-swing type Mc setup is referred to as super bullish belief contra+re1 (Mc) 2160, which is created by the combination of super bullish belief contra+re1 (also known as super bullish belief en-R) 2205 and modified bullish time segment 1131 or bear spot risk line and bear entry spike, as such is illustrated in FIGS. 13 and 14. Yet another scalp-swing type Mc setup is referred to as bullish Dk yellow candle—type a+(Mc) Mgo, which arrived from the combination of bullish Dk yellow candle—type a, bear spot risk line and bear entry spike. Yet another scalp-swing type Mc setup is referred to as bullish Dk yellow candle—type a (Mc) Mgo, which arrived from the combination of bullish Dk yellow candle—type a, bear spot risk line, bear entry spike and magic: out. Another scalp-swing type Mc setup is referred to as bullish green candle—type c (Mc) Mgo, which is derived from the combination of bullish green candle type c (also known as MSDPR-C), strength risk indicator or upper values of Boundary Lines, bear entry spike and magic: out.

One embodiment of the various types of scalp-swing setups is referred to as scalp-swing methods setup type Me. As such, these setups are based upon earlier highs, earlier lows, super belief contra or warning candles and directional entry Spikes, bull entry spike or bear entry spike. There are certain types of scalp-swing type Me setups, which include, but not limiting scope to, earlier lows −4.1 tan (Me)−Oex, powder blue (C) bullish entry(Me)+Oex, super bearish belief contra—re-2(Me), bear belief warning candle (Me) and tan bearish entry—(Me).

A trader or user skilled in the art understands that one such scalp-swing type Me setup is referred to as earlier lows −4.1 tan (Me)−Oex, which is created from the combination of earlier lows −4.6, and tan bearish candle ++, and bear entry spike 1880 or directional line-bear. Another scalp-swing type Me setup is referred to as powder blue (C) bullish entry (Me)+Oex, which is derived from the combination of powder blue (C) bullish candle and bull entry spike or directional line-bull. Another scalp-swing type Me setup 2175 is referred to as super bearish belief contra—re-2 (Me) 2178, which is created from the combination of super bullish belief contra+rel (also known as super bullish belief en-r) 2205 and modified bullish time segment 1131 or bear spot risk line and bear entry spike, as such is illustrated in FIG. 13.

Yet another scalp-swing type Me setup is referred to as bear belief warning candle (Me), which arrived from the combination of indigo bear warning candle and bear entry spike. Another scalp-swing type Me setup is referred to as tan bearish entry (Me) 2180, which is created from the combination of tan bearish candle 1455 and bear entry spike 1880 or directional line-bear, as illustrated with FIG. 18. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. Various types and concepts behind scalp-swing setups occurs.

### Trading Examples Using Scalp-Swing

A trader or user skilled in the art is aware that there are numerous types and examples that are provided with scalp-swing trading. However, within this disclosure, three examples are considered.

FIG. 17 shows one embodiment of a display, showing an illustrative screenshot view displaying a bullish scalp swing setup, as included within certain embodiments of the multidimensional risk analysis systems 100 of FIGS. 1 and 2. It also provides one illustrative display of a scalp-swing setup, bullish Dk yellow candle—type a ++ (M) 2126, which is a multi low risk opportunity setup. Certain embodiments of the multidimensional risk analysis systems 100, as described with respect to FIGS. 1 and 2, are configured, in respect with various risk processors 200 (FIG. 22), to allow a trader to utilize a risk management procedure. A trader or user skilled in the art uses risk tables 4005 (FIG. 22), 4100 (FIGS. 23), and 4200 (FIG. 24) to decide how many maximum allowed contracts with breakeven analysis 3720 (FIG. 23), maximum allowed used margin with breakeven analysis 3730 (FIG. 23) and the current equity WIBE limit 3740 (FIG. 23), with the incorporation of EMC errors elimination technique in capital preservation.

With respect to FIG. 17, a trader or user skilled in the art enters into a trade with the alert 8220, for yellow ext bull warning line 1680 and enters scalp-swing setup, bullish Dk yellow candle—type a ++ (M) 2126, with or without the use of an alert, at the close price of 1.4869 of the selected market vehicle to trade 3510 (FIG. 23), with a contract size 3540 (FIG. 23) of one lot, taking into consideration various factors such as, but not limiting scope to, a reduced margin factor user selection from what broker offers 3515 (FIG. 23), a margin used per contract 3545 (FIG. 23), a contingency amount for max loss for a particular account 3525 (FIG. 23), a corrected results for breakeven analysis for zone levels used 3585 (FIG. 23), a per trade capital loss allowed 3675 (FIG. 23), a maximum allowable pip movements or price change 3715 (FIG. 23), and a pip difference between two nearest zone lines 3508 (FIG. 23).

With respect to FIG. 17, a trader or user skilled in the art understands the following zone levels are available:
Zone Line 1040 (T3)—1.498511 Exit here may allow for (1.4985−1.4869)=116 pips potential profit (prices reached zone line 1040 at 11:15 am); Zone Line 1050 (T2)—1.4965 ∥ Exit here may allow for (1.4965−1.4869)=96 pips potential profit (prices reached zone line 1050 at 10:30 am); Zone Line 1060—1.4903 ∥ Exit here may allow for (1.4903−1.4869)=34 pips potential profit; Zone Line 1070−1.4828 ∥ A trader or user puts an initial stop here.

It is possible to take such trade in another aspect, with reference to FIG. 17. A trader or user enters such trade as a scalper, with the anticipation of a few pips at the close of 3:45 am on Nov. 27, 2009 at the close price of 1.4869 with one lot. At 4:15 am on Nov. 27, 2009, a trader or user observes earlier highs +3.1 1470-a1, and as it is a forecasting of earlier highs with a risk assessment of 1, such trader or user adds another lot at the close price of 1.4870, with a potential target of zone line 1060 (T1). Such trader or user adds an additional lot at the first appearance of earlier highs +3.2 1470-a2, at the close price of 1.4890, as it is considered a low risk for forecasting earlier highs.

Then, yet another lot is added by the trader or user at 5:00 am at the second appearance of earlier highs +3.2 1470-a2, at the close price of 1.4894, as it is still considered to be a low risk for forecasting earlier highs. Yet another lot is added at the third appearance of earlier highs +3.2 1470-a2 at 5:15 am, at the close price of 1.4901, still considering a low risk for forecasting earlier highs. Such trader or user observes super bullish belief entries 1621 at 5:45 am but not adding another lot. The observation of super bullish belief contra+re 2200 allows for the trader or user to close out his/her entire position of 5 lots at 1.4918. The duration of the trade was 2 hours and 15 minutes and an approximate of 172 pips potential profit could have been made with the 5 lots within the limits of maximum allowed contracts or maximum allowed open trades without breakeven analysis 3725 from table 4100 (FIG. 23). The following calculations may be considered on the basis of such trader or user's trade:

| Entry at close | Exit at close (all | |
|---|---|---|
| (initially at 3:45am): | positions at 6:00am): | Difference: |
| 1 lot @ 1.4869 | 1 lot @ 1.4918 (T1a) | +49 pips |
| 1 lot @ 1.4870 (due to 1470-a1) | 1 lot @ 1.4918 (T1a) | +47 pips |
| 1 lot @ 1.4890 (due to 1470-a2) | 1 lot @ 1.4918 (T1a) | +28 pips |
| 1 lot @ 1.4894 (due to 1470-a2) | 1 lot @ 1.4918 (T1a) | +24 pips |
| 1 lot @ 1.4894 (due to 1470-a2) | 1 lot @ 1.4918 (T1a) | +24 pips |

Another trade with respect to FIG. 17 can be taken. A trader or user skilled in the art understands that such dynamic hybrid zone levels 1006 were forecasted at 2:45 am on Nov. 27, 2009. A yellow triangle alert for yellow ext bull warning line 1680 is observed at 3:30 am with another green triangle alert 8220 for scalp-swing setup bullish Dk yellow candle—type a ++ (M) 2126 appeared at 3:45 am. A trader or user enters into a trade as a scalper but with the observance of modified bullish time segment 1131 and Bull entry spike 1875, such trader or user stays into a trade. Such trader or user further observes several low risk earlier highs, of which he/she add lots accordingly, knowing the potential targets due to the hybrid dynamic zone levels 1006 forecasted in advance. A trader or user trails his/her stops under Blue Line 2381 and its scheduled events and its formation of Blue Line angle north 2381-an, which as observed on FIG. 17, occurs at 4:45 am and 5:45 am. Further observation of the—formation of the first leg of Bear entry spike 1880 is seen at 6:00 am. After making an entry at 3:45 am with the close price of 1.4869, a trader or user skilled in the art exits the trade at the high of 1.4873 at 4:00 am but instead remains within such trade due to the observance of bull entry spike 1875, modified bullish time segment 1131 and low risk designators. If a trader or user did not add any additional lots and exited at the close of super bullish belief contra+re 2200 at 1.4918 (T1a ), an approximate potential of 49 pips per lot (1.4918−1.4869) is still made over 2.25 hours. In the above example, it is observed that there was a 7 pips draw down possibility, (1.4869−1.4862).

It should be understood, in FIG. 17, that a large red colored alert symbol 8215 represents a Bearish Scalp-Swing setup entry alert whereas a small red colored alert symbol 8216 represents a Bearish Scalp-Swing setup exit. It is understood that a large green colored alert symbol 8220 represents a Scalp-Swing setup entry alert whereas a small green colored alert symbol 8221 represents a Bullish Scalp-Swing setup exit.

A trader or user skilled in the art understands that typically, swing trading approximately takes one to four days to produce such above mentioned results. However, the various components of multidimensional risk analysis systems 100 allows a trader or user to produce superior, faster, accurate, lower risk entries, confidence, risk recognition, use of colored candles, minimal use of traditional technical analysis and minimal drawdowns.

FIG. 20 shows one embodiment of a display, showing an illustrative screenshot view displaying a bullish scalp-swing setup based on an open-ended hybrid zone risk transfer area, as included within certain embodiments of the multidimensional risk analysis systems 100 of FIGS. 1 and 2. It also provides one illustrative display of a scalp-swing setup, purple (C) candle—type d +++ (M) Pd 2131. A trader or user skilled in the art enters into a trade with a long position. A trader or user takes the entry at 11:53 am on Mar. 1, 2010 at the close price of 1.3505, where such scalp-swing setup, purple (C) candle—typed +++ (M) Pd 2131, occurred and a modified bullish time segment 1131 was observed at the entry. It is further observed that at point “A”, at 11:53 am, Orange Oscillator 2377 crossed Health Risk Directional Indicator Bullish 2015, Health Risk Directional Indicator Bearish 2020 and Modified Dynamic Strength Risk Indicator 1287. A trader or user places a stop at 1.3502, which is observed to be the value of zone line 1040; if the trader or user decides not to place any stops, he/she uses trade-repairs. It is further observed by a trader or user the following values:
Zone line 1010 (Target #3/T3): 1.3547; Zone line 1020: 1.3528 (Target #2/T2) prices reached zone line 1020 at 12:47 pm; Zone line 1030: 1.3513 (Target #1/T1) prices reached zone line 1030 at 12:00 pm; Zone line 1040: 1.3502 (Possible stop); Zone line 1050: 1.3492; Zone line 1060: 1.3479; Zone line 1070: 1.3458; Blue Line 2381: 1.3500.
   With respect to FIG. 20, a trader or user skilled in the art exits at the bear entry spike 1880 at 12:11 pm, with the close price of 1.3526 on Mar. 1, 2010. It is observed that the duration of such trade was 18 minutes and an approximate gain of 21 pips per lot, which at 5 lots as with the previous examples, would be an approximate gain of 105 pips. A trader or user skilled in the art understands that scalp-swing is very fast and easy and traditional swing trading may not be needed. There is a variety of embodiments of scalp-swing setups.

### Risk Recognition for Scalp-swing Trading, Trade-Repair and Portfolio Repair

Within this disclosure, “risk recognition” is utilized to describe the unique method of discovering, sequentizing, prioritizing, recognizing and controlling the various risks that are associated in trading. As such, risk recognition illustrates a general shape, pattern, color, or number of a variety of indicator combinations, which is utilized to help an ordinary skilled user or trader without extensive training to understand important events occurring within financial markets such as market trend changes, breakouts, retracements, new highs, new lows, directional forecastings, reversals, pullbacks, and many other such trading clues.

It is understood by a trader or user skilled in the art that in trading, it is typical for traders or users to be constantly anxious about the price of the market vehicle under observation and tend to generally ignore the multiple risks that are associated with such trading and the location of such with respect to the eight dimensional risks or combinations of eight dimensional risks. Within the financial industry, there have been discussions of risks involved, but there have been no tools that can recognize such risk as it occurs and can then tag them, prioritize them, sequence them, all of which controls the outcome of trading by every tick to every time frame or combination of time frames. Multidimensional risk analysis systems 100 discovers the actual number of risks involved in trading. Eight dimensional risks were discovered, sequentized, prioritized and recognized with colors, alphabets, and symbols, and simplified into any user desired time frame and still has the effect of multiple time frames and multi-confirmations of risk recognitions.

A trader or user skilled in the art, with the use the User's Manual, recognizes and visualizes the various types of risks involved in trading within any market vehicle. It is understood by a trader or user that such various risks are visualized by, but not limiting scope to, Trend Health Risk, modified trend health indicator, and magic spectrum of colored candlesticks (also known as multidimensional risk spectrum) . A trader or user skilled in the art further recognizes bullish, bearish, or neutral risk within the User's Manual. Neutral symbols/candles are used for neutral risk, bullish symbols/candles are used for bullish risk and bearish symbols/candles are used for bearish risk. Certain embodiments of the multidimensional risk analysis systems 100, as described with respect to FIGS. 1 and 2, are configured to perform the above and thereupon, user interface 125 (FIG. 2) is able to project such a display of risk recognition. A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. Those skilled in the art will now understand that there are a variety of alternative methods and concepts behind risk recognition.

### Risk Recognition Factors

Certain embodiments of the multidimensional risk analysis systems 100, as described with respect to FIGS. 1 and 2, are configured, with the user interface 125, to portray the various types of risk recognition factors within the market, which are classified into one of three categories: favorable bullish risk recognition factors, favorable bearish risk recognition factors, and favorable neutral risk recognition factors. A trader or user skilled in the art understands that when a trader or user has taken a trade in the bullish direction, bullish symbols/candles within the Users Manual are used to recognize bullish risk within, but not limiting scope to, trade repair, portfolio repair, or scalp-swing trading. Bullish symbols/candles within the Users Manual, serve as an indication of bullishness and are referred to as favorable bullish risk recognition factors, which are indicated by symbols or colors.

A trader or user skilled in the art understands that when a trader or user has taken a trade in the bearish direction, bearish symbols/candles within the User's Manual are used to recognize bearish risk within, but not limiting scope to, trade repair, portfolio repair, or scalp-swing trading. Bearish symbols/candles within the User's Manual, serve as an indication of bearishness and are referred to as favorable bearish risk recognition factors, which are indicated by symbols or colors. A trader or user skilled in the art understands that when a trader or user is within a neutral area, after taking either bullish or bearish trade, neutral symbols/candles within the User's Manual serve as an indication of neutrality and are referred to as favorable neutral risk recognition factors, which are indicated by symbols or colors. A trader or user may be alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading

### Breakeven Analysis or Replacement of Original Values

FIG. 23 shows one embodiment of a display, showing an illustrative risk control table displaying account, capital preservation, trade repair and scalp-swing trading information, as included within certain embodiments of the multidimensional risk analysis systems 100 of FIGS. 1 and 2. A trader or user understands that the replacement of original values, results are exponential in nature for the original values, due to possible parabolic characteristics are referred to as breakeven analysis within trading. It is further understood that trading parameters 3700 are adjusted in values, with respect to tables 4100 (FIGS. 23) and 4200 (FIG. 24), in order to conserve capital, by reducing factors such as, but not limiting scope to, current equity falling limit 3740, maximum margin available 3560, and maximum allowed contracts or open trades limit at any given time with breakeven analysis 3720. Capital Preservation Trading Parameters, with respect to table 4100 (FIG. 23), makes evident the following: with respect to what a trader can afford to lose per day 3605, if a trader or user states that he/she can afford to lose $15, it requires $15.08 to replace that $15.00, which is a 0.533% increase;

with respect to what a trader can afford to lose per week 3610, if a trader or user states that he/she can afford to lose $105, it requires $108.81 to replace $105.00, which is a 3.628% increase; with respect to how much a trader can afford to lose of liquid assets 3630, if a trader or user states that he/she can afford to lose $1000, it requires $1250 to replace $1000, which is a 25% increase. It is concluded from such that as the amount of dollars lost increases, the amount required to replace such original amount increases exponentially, instead of proportionately, and produces a parabolic effect. A trader or user skilled in the art understands that it becomes more difficult to replace the original amount as the trading percentage loss increases. It is further understood that a 10% loss will require 11.11% to replace the loss, while a 50% loss requires 100% to replace the loss, and a 95% loss in equity requires 1900%, as seen with respect to table 4005 (FIG. 22). The same is applicable on drawdowns.

### EMC Errors Elimination TechniqueiIn Capital Preservation

FIGS. 23 and 24 represent certain embodiments of the multidimensional risk analysis systems 100 with respect to FIGS. 1 and 2. A trader or user skilled in the art understands that upon application of breakeven analysis in trading, it reveals “equity errors” (also known as equity error without breakeven analysis) 3760, “used margin errors” (also known as used margin error without breakeven) 3765, and “maximum allowed contract errors” (also known as maximum allowed contract error without breakeven) 3770, all of which contributes to the loss of capital before trades are done due to the lack of adjustments for such errors. It is understood by a trader or user skilled in the art that such errors must be taken into consideration during repairs, trading, or before trading, and controls the risk before a trader or user is exposed to these unknowingly hidden additional risks. It is further understood that the technique to eliminate errors such as equity error without breakeven analysis 3760, used margin error without breakeven 3765, and maximum allowed contract error without breakeven 3770, in trading, on the basis upon such method of breakeven analysis and its applications to equity, margin and maximum allowed of lots, as such are based upon reduced margin trader satisfied percentage 3620, which is identified as EMC errors elimination technique in capital preservation 3285. It is further understood that such technique is also developed with respect to, but not limiting scope to, account size at broker for a trader 3505, contract size 3540, asset tolerance check 3660, how much a trader can afford to lose of liquid assets 3630, weeks to break 3640, etc. A trader or user is alerted by all important events as illustrated by a yellow triangle or any trader or user desired colors or shapes. All important events selected by a trader or user can have alerts may be sent via electronic mail, PDA's, or by audio/visual alert on chart during trading. The development of such reduces the additional risks that are associated with trading before a trader or user makes a trade. A trader or user skilled in the art further understands that as such aforementioned allows for the control of losses before such losses occurs and helps a trader or user conserve capital upfront rather than within the market. Those skilled in the art will now appreciate the variety of techniques associated with EMC errors elimination in capital preservation.

### Trade Repair and Portfolio Repair

Within this disclosure, “trade repair” and “portfolio repair” is utilized to describe the unique methods, using various components of the multidimensional risk analysis systems 100, in which a trader or user skilled in the art repairs a trade for a given market vehicle or may repair a portfolio, containing various amounts of Market Vehicles, in order to reduce losses, lead to breakeven, or in some instances possible gains, although it should be considered that not all trades are 100% repairable.

With traditional methods in normal trading, traders most likely incur losses when they use stop losses, taking losses when such losses cannot be tolerated, and being forced to exit or liquidate due to margin calls. It is further understood by a trader or user skilled in the art that the identification of the various risk dimensions, which according to the multidimensional risk analysis systems 100 are eight risk dimensions, serve as an important factor in repairing a particular trade or portfolio along with the use of several proprietary methods. Certain embodiments of the multidimensional risk analysis systems 100, as described with respect to FIGS. 1 and 2, are utilized with risk recognition, risk assessment and multi-confirmation in order to reduce losses in comparison to those losses experienced by traditional methods and for those trades which are beyond normal tolerance limits, in such where accepting partial losses result in a better repair situation.

A trader or user skilled in the art understands that while conducting trade repairs or portfolio repairs with respect to either bullish, bearish or controversial trades, such trader or user uses, including but not limiting scope to, components from the User's Manual, Trend Health Risk, modified trend health, spectrum of colored candlesticks, and various methods and its applications within trading. Those skilled in the art will now appreciate that there are a variety of techniques and methods associated with trade repair and portfolio repair.

### Bearish Trade Repair and Risk Recognition

A reasonable trader or user understands that bearish trade repairs occurs when a trader or user has a bearish position (short position) within a market vehicle and the market travels in the opposite direction, thereupon causing such trader or user the desire to preserve capital and control/reduce trading losses and breakeven or gain from such trade with the use of the Users Manual. There are various favorable bearish risk recognition factors that are considered in bearish trade repairs, such as, but not limiting scope to: the dynamic zone line curling or shifting of levels, in which the upper most zone line remains steady and the lower most zone line and/or other zone lines are shifting up from the bottom; super bullish belief contra+re1 (Mc) 2160 (FIGS. 13 and 14) setup possibly occurs in the 1 minute, 15 minutes or 60 minutes time frames; golden bearish candle 1420 (FIG. 6) or golden bearish candle +; completed or half of bear entry spike 1880 (FIGS. 3, 4, 7, 11, 15, 17, etc.); at least one or preferably two pink (C) bearish candles 1445 (FIG. 9); super bullish belief contra+re 2200 (FIGs.9, 14, 17 and 18), super bullish belief contra+re1 2205 (FIGS. 13), or super bullish belief contra+re2, occurring in the 1 minute, 15 minutes or 60 minutes time frames; black neutral candle 1460 (FIGS. 6, 9, 10, and 12) or modified neutral time segment 1151 (FIGS. 4, 6, 10, and 17) occurring in the 1 minute, 15 minutes or 60 minutes time frames; stable hybrid dynamic horizontal zone lines 1006; Hybrid Parallelism; values of upper most Boundary Lines 1230 (FIG. 5) within modified magic health indicator 1216 (FIG. 5) around +6 or more; continuation Spikes; directional line-bear 2060 (FIGS. 5, 7, and 9); bear spot risk line 1695 (FIGS. 11 and 18); and/or, magic: out 2330 (FIG. 6).

One embodiment of bearish trade repair and risk recognition is referred to as bearish trade repair procedure. It is understood by a trader or user skilled in the art that during the reduction of market vehicle prices, bearish trade repairs requires a trader or user to recognize any of the bearish risk recognition factors and utilize them according to their strength. A trader or user skilled in the art further utilizes the vertical distance between the nearest zone lines 1015 (FIGS. 3, 14, and 16), and uses Sudden Market Spot Change Risk (also known as internal market moving risk) 215 (FIG. 2) such as, but not limiting scope to, golden bearish candle 1420 (FIG. 6), golden bearish candle +, etc., and adds additional amounts of the same market vehicle according to tables 4100 (FIGS. 23) and 4200 (FIG. 24). A trader or user fills out all required information or user feed information 3501 and such information from the multidimensional risk analysis systems 100 for the required high daily zone levels 3580. It is assumed by a trader or user that the values displayed within table 4100 (FIG. 23) are the trader or users information and have been provided for example purposes.

With respect to FIGS. 23 and 24, one embodiment of bearish trade repair and risk recognition is referred to as bearish trade repair checklist and repair steps, and is understood with the following example:
(a) A trader or user has a $5.00 loss within a particular trade and he/she would like to repair it. Such trader or user checks the per trade capital loss allowed 3675 within table 4200 (FIG. 24), which allows a maximum value of $45.00 per day, in which produces acceptable results, of which trader or user has programmed to be checked automatically;
(b) A trader or user should check as to whether the differential between the current market vehicle prices are the upper most zone line within 15 minute time frame is not more than 63.89 pips, as per the maximum allowable pip movements or price change 3715 within table 4200 (FIG. 24). If such differential is discovered to be more than 63.89 pips, it becomes difficult for the trader or
   user to repair such trade within a short period of time. A solution for such problem would be for the trader or user to control the amount of lots and at the Hybrid Dynamic Zone Lines on the 1 minute, add additional lots. It is preferable to skip and await stronger favorable bearish risk recognition factors, such as, but not limiting scope to, directional line-bear and for modified dynamic strength risk indicator to be around +6;
(c) A trader to user observes that the average open price to current security price differential limit 3710 within table 4200 (FIG. 24) is 12 pips, which produces unacceptable results. Such trader or user should try to bring the differential close to 6.35 as shown in table 4200 (FIG. 24). Another solution is that the trader or user can add additional lots near upper zone levels in the 1 minute charts, in conjunction with additional favorable bearish risk recognition factors;
(d) A trader or user checks the account opening balance at a broker before trade repairs 3703, which in such example provided, is $2800.00. A possible goal is to increase such value to more than and preferably above $2805.00 with the use of trade-repair techniques;
(e) As assumed in such example, a trader or user has a total of 10 open contracts at the time of repair. When taking such amount, and comparing it to maximum allowed contracts or open
   trades limit at any given time with breakeven analysis 3720, within table 4200 (FIG. 24), it provides the trader or user as to whether he/she is within the maximum amount of allowed contracts. Such trader or has a used margin of $145.80 according to the current margin used from broker 3550 and allowed to add a maximum of 59 lots according to number of lots take out or in 3785. Such trader or user is considered to have safe trading parameters 3700. He/she is also well within the limits of maximum
   allowed contracts or open trades limit at any given time with breakeven analysis 3720 as such trader or user has only 10 contracts when the maximum is 71;
(f) It is observed by a trader or user that the total maximum allowed “used margin” limits are $1078.80, with breakeven, and that current used margin from broker 3550 is $145.80, which is concluded as $145.80 being less than $1078.80, thereupon able to add additional lots; and
(g) A trader or user compares the account opening balance at a broker before trade repairs 3703 to the current equity falling limit 3740, which is $2800.00 and $2594.50, respectively. Thereupon, it appears that there is an additional equity of $205.50

With further respect to FIGS. 23 and 24, a trader or user skilled in the art understands that the observance of turquoise PH lines serves as an indication to not add additional lots at the upper most zone line until the possible appearance of a third pink ext bear warning line, until the upper most zone line becomes parallel to the other zone lines, until the appearance of earlier highs +3.5/earlier highs +3.6, or the appearance of directional line-bear. It is further understood that the concepts of, including but not limiting scope to, Hybrid Parallelism, Halved Hybrid Nozzlelism, and confluence in Hybrid Dynamic Zone Lines and Halved Hybrid Nozzlelism are applied to bearish trade repairs and bearish portfolio repairs. A trader or user is alerted by all important events as illustrated by a yellow triangle or any trader or user desired colors or shapes. All important events have alerts that are selected by a trader or user can have alerts that are sent via electronic mail, PDA's, or by audio/visual alert on chart during trading. There are a variety of bearish trade repairs and risk recognition methods, examples and concepts.

### Bullish Trade Repair and Risk Recognition

Certain bullish trade repairs occurs when a trader or user has taken a bullish position (long position) within a market vehicle and the market travels in the opposite direction, thereupon causing such trader or user the desire to preserve capital and control/reduce trading losses and breakeven or gain from such trade with the use of the Users Manual. There are various favorable bullish risk recognition factors that are considered in bullish trade repairs, such as: the dynamic zone line curling or shifting of levels, in which the lower most zone line remains steady and the upper most zone line or other zone lines are dropping from the top; super bearish belief contra -re-, super bearish belief contra—re-1, or super bearish belief contra—re-2; turquoise bullish candle, turquoise bullish candle +, or turquoise bullish candle ++; completed or half of bull entry spike ; at least one or preferably two yellow bull warning candle; magic: in super bearish belief contra—re-2(Me) setup occurs in the 1 minute, 15 minutes or 60 minutes time frames; black neutral candle or modified neutral time segment occurring in the 1 minute, 15 minutes or 60 minutes time frames; stable horizontal zone lines; Hybrid Parallelism; values of lower most Boundary Lines within modified magic health indicator around −6 or more; continuation Spikes; bull spot risk line; directional line-bull; and/or gray (C) bullish candle.

A trader or user skilled in the art understands that all bullish symbols within the Users Manual is used to recognize bullishness and to either do a trade repair with low risk entries for scalp-swing. Bearish trade repair procedures and bearish trade repair checklist and repair steps are used for the bullish trade repair and bullish trade repair checklist and repair steps by applying opposite parameters within tables 4100 (FIGS. 23) and 4200 (FIG. 24). A trader or user skilled in the art is aware that tables 4100 (FIGS. 23) and 4200 (FIG. 24) are used to properly conduct trade-repair, portfolio repair or perform conservative trading for capital preservation with the multidimensional risk analysis systems 100 based upon EMC error elimination techniques in capital preservation. Hybrid Parallelism, Halved Hybrid Nozzlelism, and confluence in Hybrid Dynamic Zone Lines and Halved Hybrid Nozzlelism concepts are applied to bullish trade repairs and bullish portfolio repairs. There are a variety of methods, examples and concepts behind bullish trade repairs and risk recognition.

### Account, Capital Preservation, Trade Repair and Scalp-Swing Trading Risk Control Table 4100 (FIG. 23) and Quick Repair Parameters, Scalp-Swing Trading and Broker Platform Control Table 4200 (FIG. 24)

A trader or user skilled in the art understands that three major types of trade repair or portfolio repairs or scalp-swing parameters 3400 are used for, including but not limiting scope to, trade-repairs, portfolio repairs, or scalp-swing trading. Certain of the three major types of trade repair or portfolio repairs or scalp-swing parameters 3400 include account information 3500, capital preservation 3600; and trading parameters 3700.

Account information 3500, which is a trader or users provided information and some calculated values, and as such comprises of several components (of which is demonstrated with the examples set forth within tables 4100 (FIGS. 23) and 4200 (FIG. 24)), which is understood by a trader or user skilled in the art when considering the following:
(a) A trader or user uses user feed information 3501, in which such trader or user inputs information into tables 4100 (FIGS. 23) and 4200 (FIG. 24), provided on a spreadsheet program such as Microsoft Excel®. Data to be inputted by a trader or user is visualized as green;
(b) A trader or user observes that the information from magic trader software 3502 is displayed as bright green;
(c) It is understood that the maximum account size allowed 3503 is calculated by taking the differential between liquid assets in all accounts 3625 and total cash account balance at all brokers 3635;
(d) It is understood by a trader or user skilled in the art that Account Size Adequacy 3504 is automatically checked and deemed either “Adequate”, when account size at broker for a trader 3505 is less than maximum account size allowed 3503 and “Inadequate” when maximum account size allowed 3503 is greater than account size at broker for a trader 3505;
(e) A trader or user understands that account size at broker for a trader 3505 illustrates a trader or user's current account balance;
(f) With given respect to table 4100 (FIG. 23) and for example purposes, account size corrected for breakeven 3506 has a value of $2385.64 and such calculation may be determined regarding table 4005 (FIG. 22);
(g) It is understood that 15m two nearest upper zone lines 3507 should be close to select market vehicle to trade 3510, with respect to bearish trade repair 3310:
(h) A trader or user skilled in the art understands that the pip difference between two nearest zone lines 3508 takes into consideration zone lines and to select market vehicle to trade 3510:
(i) It is understood that the high of pip differential for upper zone lines (bearish repair/scalp-swing) in the pip difference between two nearest zone lines 3508 is based upon the 15m two nearest upper zone lines 3507:
(j) As per the example aforementioned, it is understood that the select market vehicle to trade 3510 is EUR/USD;
(k) It is understood that 15m two nearest lower zone lines 3511 is close to select market vehicle to trade 3510, with respect to bullish trade repair 3305;
(l) The high of pip differential for lower zone lines (bullish repair/scalp-swing) in the pip difference between two nearest zone lines 3508 is based upon the 15m two nearest lower zone lines 3511:
(m) A trader or user skilled in the art understands that the contingency amount for max loss for a particular account 3525, as per the trader's selection, is for example 10% to 30%. Within table 4100 (FIG. 23), for example purposes, it is observed that a value of 17% was provided;
(n) A trader or user understands that the selection of leverage 3530, varies according to current rules and regulations and on the select market vehicle to trade 3510:
(o) It is understood that contract size 3540 is different according to what a trader or user selects from the broker. In such understanding, a value of $1000 was selected for example purposes;
(p) It is further understood that reduced margin factor user selection from what broker offers 3515 is part of capital preservation;
(q) A trader or user skilled in the art understands that margin used per contract 3545 depends on what market vehicle is selected, as such within table 4100 (FIG. 23) is either calculated or provided by a broker;
(r) It is understood by a trader or user that current margin used from broker 3550 depends on a trader or users activity and varies depending upon the amount of lots/contracts use, as such is obtained from a broker platform;
(s) Possible values of maximum margin available 3560 is calculated from account size at broker for a trader 3505 and margin used per contract 3545;
(t) It is understood that equity is the current equity, which includes current profits/losses of any open positions, and is provided on the broker platform. It is further understood that equity 3555 should not fall below equity WIBE limit 3740, with breakeven analysis, stated as such in item “10” in table 4200 (FIG. 24). It is also further understood that equity 3555 should not fall below equity WOBE limit 3745, without breakeven analysis, stated as such in item “11” in table 4200 (FIG. 24);
(u) A trader or user skilled in the art understands that the maximum number of contracts can be traded 3565 are calculated using the quotient of augmentation of account size at broker for a trader 3505 and selection of leverage 3530 and augmentation of select market vehicle to trade 3510 and reduced margin factor user selection from what broker offers 3515 and its relation with contract size 3540. As such is corrected for breakeven analysis with the use of high daily zone levels 3580 or low daily zone levels 3581 and the corrected high daily zone levels 3580 and low daily zone levels 3581 (define) without breakeven analysis. It is further understood that there are various types of maximum number of contracts that are traded 3565, such as, but not limiting scope to, maximum number of contracts based on reduced margin factor 3566, maximum number of contracts based on reduced margin factor and breakeven 3567, maximum number of contracts based on highest zone level with breakeven analysis, maximum number of contracts based on lowest zone level with breakeven analysis 3569, maximum number of contracts based on highest zone level without breakeven analysis and maximum number of contracts based on lowest zone level 1 without breakeven analysis;
(v) It is understood that, with respect to the examples aforementioned, in table 4100 (FIG. 23), the maximum number of contracts based on reduced margin factor 3566 value is 103;
(w) It is understood that, with respect to the examples aforementioned, in table 4100 (FIG. 23), the maximum number of contracts based on reduced margin factor and breakeven 3567 value is 82;
(x) It is understood that, with respect to the examples aforementioned, in table 4100 (FIG. 23), the maximum number of contracts based on highest zone level with breakeven analysis, with the use of the upper most zone line and margin factor in table 4100 (FIG. 23) is 79, which are for the daily evels for bears. A trader or user has the choice to use levels from any user desired time frame;
(y) It is understood that, with respect to the examples aforementioned, in table 4100 (FIG. 23), the maximum number of contracts based on lowest zone level with breakeven analysis, is determined with the use of lowest zone line and margin factor in table 4100 (FIG. 23). A trader or user has the choice to use levels from any user desired time frame;
(z) It is understood that, with respect to the examples aforementioned, in table 4100 (FIG. 23), the maximum number of contracts based on highest zone level without breakeven analysis, with the use of the upper most zone line and margin factor without breakeven analysis in table 4100 (FIG. 23), is 99;
(aa) It is understood that, with respect to the examples aforementioned in table 4100 (FIG. 23), the maximum number of contracts based on lowest zone level without breakeven analysis, are determined with the use of the lowest zone line and margin factor without breakeven analysis;
(bb) It is understood that with respect to the lowest of maximum number of contracts that can be traded, the lowest of maximum number of contracts based on reduced margin factor, maximum number of contracts based on reduced margin factor and breakeven, maximum number of contracts based on highest zone level with breakeven analysis and maximum number of contracts based on highest zone level without breakeven analysis are the maximum number of contracts that can be traded 3565;
(cc) It is understood that, with respect to high daily zone levels 3580 and as stated within the example provided in tables 4100 (FIG. 23) and 4200 (FIG. 24), daily zone lines are used for bearish trade repair. A trader or user skilled in the art utilizes and selects one of the nearest high daily zone levels 3580 for short trade/portfolio repairs and the nearest low daily zone levels or long trade/portfolio repairs, with respect to trade repairs and portfolio repairs and for a trader or user with very tight equity issues. It is understood by a trader or user skilled in the art that a rule should be followed in the sense that a trader or user takes the three nearest minimum nearest zone levels from the current prices, with respect to 1 minute, 15 minutes and 60 minute time frames. A trader or user then takes maximum zone differentials from the selected three timeframe zone levels. A trader or user understands that the maximum zone differential should be less than the maximum allowable pip movements 3715, with respect to table 4100 (FIG. 23). A trader or user skilled in the art assumes that if he/she selects the upper most zone line that there would be an upward price risk if a user or trader is short in a trade whereas in selecting the lower most zone line there may be a downward price risk if a user or trader is long in a trade. High daily zone levels 3580 are used for the uppermost zone level when considering a bearish trade repair, which according to the example within tables 4100 (FIGS. 23) and 4200 (FIG. 24), is 1.5143. With respect to a bullish trade repair, a trader or user may use 1.2463, as such listed within the aforementioned tables;
(dd) A trader or user skilled in the art understands that with respect to table 4100 (FIG. 23), that the zone distance between zone lines, with such aforementioned examples, are 574, 450, 317, 386, and 636;
(ee) It is understood by a trader or user skilled in the art that the corrected results for breakeven analysis for zone levels used 3585, with respect to the examples provided in tables 4100 (FIG. 23), table 4200 (FIG. 24), and table 4005 (FIG. 22) are used as a possible reference in order to calculate values such as $2385.54 and maximum number of contracts can be traded 3565;
(ff) It is understood by a trader or user skilled in the art that with respect to the results with current high zone lines (daily) 3590, values of, but not limiting scope to, account size at broker for a trader 3505, selection of leverage 3530, reduced margin factor user selection from what broker offers 3515, and contract size 3540 remains in the column user feed info in color 3596 and are considered user feed information 3501. Within such example, a trader or user is bearish and the trade went in the bullish direction, of which, the value of the chosen market vehicle, EURUSD, is the highest price of high daily zone levels 3580. A trader or user skilled in the art understands that the value of margin used per contract 3545 is explained as to how it is derived in maximum number of contracts can be traded 3565. It is further understood that margin used per contract 3545 is adjusted according to the selected market vehicle to trade 3510, in this case is EURUSD, for the value of 1.5143;
(gg) It is understood by a trader or user skilled in the art with respect to the results with results with current low zone lines (daily) 3595, the column highest price of high daily zone levels 3580 and possibly insert the lowest price if 1.2463, in that a trader or user skilled in the art went bullish and market vehicle prices keep dropping. A trader or user skilled in the art understands that the value of margin used per contract 3545 may be adjusted for 1.2463; and
(hh) It is understood by a trader or user skilled in the art that factors such as, but not limiting scope to, account size at broker for a trader 3505, maximum account size allowed 3503, contingency amount for max loss for a particular account 3525, and maximum number of contracts can be traded 3565 are adjusted in user feed info in color 3596 by using the breakeven analysis within table 4005 (FIG. 22). It is further understood that the calculation methods of such factors such as, but not limiting scope to, account size at broker for a trader 3505, maximum account size allowed 3503, contingency amount for max loss for a particular account 3525, and maximum number of contracts can be traded 3565 are seen in their respective explanations for account information 3500 “a-ag”.

With respect to FIGS. 23 and 24, capital preservation parameters 3600, which takes a trader or users input and breakeven analysis is used, which incorporates exponential accumulation of losses with the use of EMC error elimination technique in capital preservation, and which reduces the parabolic effect as seen in table 4005 (FIG. 22). Several components, of which are subject to breakeven analysis 3290, and to user feed information 3501, before the commencement of breakeven analysis results, are demonstrated with the examples set forth within tables 4100 (FIGS. 23) and 4200 (FIG. 24), are understood by a trader or user skilled in the art as per and including the following:

(a) A trader or user skilled in the art understands that the capital preservation parameters list 3601, include, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, contingency amount for max loss for a particular account 3665, and percentage tolerance per trade 3670. It also includes the calculated factors such as, but not limiting scope to, asset tolerance ratio 3655, asset tolerance check 3660, per trade capital loss allowed 3675, and weeks to break 3640;

(b) It is understood by a trader or user skilled in the art that the actual value of capital preservation parameters 3602 includes user feed information 3501, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, contingency amount for max loss for a particular account 3665, and percentage tolerance per trade 3670. It also includes the calculated factors such as, but not limiting scope to, asset tolerance ratio 3655, asset tolerance check 3660, per trade capital loss allowed 3675, and weeks to break 3640, of which a trader or user skilled in the art reads upon within the capital preservation parameters 3600 points “a-l”;

(c) A trader or user skilled in the art understands that with respect to percentage equity values of capital preservation parameters 3603, involves comparing the actual account size at broker for a trader 3505 for items such as, but not limiting scope to, what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, asset tolerance check 3660, contingency amount for max loss for a particular account 3665 and weeks to break 3640. It is observed that the value of what trader can afford to lose per day 3605, within column percentage equity values of capital preservation parameters 3603, for example purposes, equal 0.50% ((15/3000)*100);

(d) With continued respect to FIGS. 23 and 24. it is understood by a trader or user skilled in the art that with respect to breakeven values of equity percentage of capital preservation parameters 3604, values of items such as, but not limiting scope to, what trader can afford to lose per day 3605, what trader can afford to lose per week 3610, how many weeks in a row trader can afford to lose 3615, how much a trader can afford to lose of liquid assets 3630, asset tolerance check 3660, contingency amount for max loss for a particular account 3665 and weeks to break 3640, are calculated in the same way as calculated within table 4005 (FIG. 22) and such respective items within column of percentage equity values of capital preservation parameters 3603. Such values within breakeven values of equity percentage of capital preservation parameters 3604 are the basis for breakeven analysis values of actual capital preservation parameters 3695;

(e) A trader or user understood by a trader or user skilled in the art, with respect to breakeven analysis values of actual capital preservation parameters 3695, provides the values of each of the items within the breakeven analysis in table 4100 (FIG. 23), under capital preservation 3600, the use of breakeven values of equity percentage of capital preservation parameters 3604, as a potential basis of calculating items such as what trader can afford to lose per day 3605, what trader can afford to lose per week 3610, how many weeks in a row trader can afford to lose 3615, reduced margin trader satisfied 3620, liquid assets in all accounts 3625, how much a trader can afford to lose of liquid assets 3630, asset tolerance check 3660, contingency amount for max loss for a particular account 3665 and weeks to break 3640. A trader or user skilled in the art calculates the values in the same manner as done in table 4005 (FIG. 22) with respective items within column breakeven values of equity percentage of capital preservation parameters 3604. For instance, a trader or user skilled in the art understands that the weeks to break 3640 within breakeven analysis values of actual capital preservation parameters 3695 are calculated in the following respect: ((5000*25)/100) which is equivalent to $1250. As such, it is observed that $1250 can replace how much a trader can afford to lose of liquid assets 3630 within column actual value of capital preservation parameters 3602, which is observed as $1000. It is further understood by a trader or user skilled in the art that according to the EMC error theory, such calculations are taken into consideration, even before trading. As such, this logic is applied to all items such as, but not limiting scope to, what trader can afford to lose per day 3605, what trader can afford to lose per week 3610, how many weeks in a row a trader can afford to lose 3615, reduced margin trader satisfied 3620, liquid assets in all accounts 3625, how much a trader can afford to lose of liquid assets 3630, asset tolerance check 3660, contingency amount for max loss for a particular account 3665 and weeks to break 3640;

(f) It is understood by a trader or user skilled in the art that what trader can afford to lose per day 3605, is understood by a scenario in which a trader or user starts to drop currency bills into the street with no promise of retrieving any of those dropped bills, starting with $5, $10, $15, etc and should continue to drop such currency bills until the trader or user can no longer tolerate or no longer drop anymore bills. This is done for at least 5 days and thereupon, the average of such last five days are considered what a trader or user can afford to lose per day;

(g) With continued respect to FIGS. 23 and 24, a trader or user skilled in the art understands that what trader can afford to lose per week 3610, is understood by a similar scenario as what trader can afford to lose per day 3605, but only for several weeks. Such average of the amount dropped in all of the weeks is referred to as what a trader or user can afford to lose per week;

(h) It is further understood by a trader or user skilled in the art that how many weeks in a row trader can afford to lose 3615, can be understood with reference to what a trader can afford to lose per week 3610, taking into account a consecutive number of weeks, of which thereupon are referred to as weeks in a row trader or user can afford to lose;

(i) A trader or user skilled in the art understands that the liquid assets in all accounts 3625, only include liquid cash within such trader or users bank accounts and CDs. It is further understood that the value of stock certificates, mutual funds, etc are not included as they are considered to be vehicles that can lose value overnight. The basis of such calculations, as a capital preservation method, include the liquid money within a bank minus at least two months' worth of day to day expenses;

(j) A trader or user skilled in the art understands that how much a trader can afford to lose of liquid assets 3630 can be user provided information 3501. It is further understood that if a trader or user had a previous highest trading loss within a day or a biggest loss of any asset, it can be used as a reference;

(k) It is understood by a trader or user skilled in the art that calculation of contingency amount for max loss for a particular account 3665 is done with the ratio of account size at broker for a trader 3505 and contingency amount for max loss for a particular account 3525. A trader or user skilled in the art understands that he/she should stop trading once such trading losses have reached this calculated limit and continue with paper trading. It is further understood that such value should be less than how much a trader can afford to lose of liquid assets 3630. It is observed by a trader or user skilled in the art that contingency amount for max loss for a particular account 3665 does not include breakeven analysis conducted for actual value of capital preservation parameters 3602. However, it is understood by a trader or user skilled in the art that values in column breakeven analysis values of actual capital preservation parameters 3695 include breakeven analysis adjusted for errors; and

(l) a trader or user skilled in the art understands that with respect to contingency amount for max loss for a particular account 3665 without breakeven analysis, the number of weeks to reach or break or exceed contingency amount for max loss for a particular account 3665 within column actual value of capital preservation parameters 3602 are calculated using the possible ratio of contingency amount for max loss for a particular account 3665 and what trader can afford to lose per week 3610 and such calculated value is approximately equal to how many weeks in a row trader can afford to lose 3615. Should how many weeks in a row trader can afford to lose 3615 exceed weeks to break 3640, the trader or user is considered to be over-aggressive and should consider slowing down with his/her trading. It is further understood that a conservative trader or user uses the values of how many weeks in a row trader can afford to lose 3615 on the basis of breakeven analysis values of actual capital preservation parameters 3695, with breakeven analysis, as illustrated in table 4100 (FIG. 23) under capital preservation parameters 3600. As such displayed within table 4100 (FIG. 23), the value of 3.48 weeks, taking into consideration the adjustment of EMC errors using breakeven analysis, allowed the trader to stop losing money in 3.48 weeks instead of in 4.85 weeks, which the latter would have occurred with the user of traditional methods without breakeven analysis and its adjustments and even his own test of 4 weeks as illustrated within the column actual value of capital preservation parameters 3602.

With respect to FIGS. 23 and 24, it is understood by a trader or user skilled in the art that there are certain capital preservation parameters that do not go under breakeven analysis, but can however be applied to the following:
i. The percentage tolerance per trade 3670 is understood by a trader or user skilled in the art to be as, the decision as to how much percentage of losses of the account size, such trader or user is willing to take per trade. Typically, such value may be 1.5% maximum, although it may vary;
ii. It is understood by a trader or user skilled in the art that with respect to reduced margin the trader is satisfied with 3620, with further respect to capital preservation, a trader or user should not use the maximum percentage of margin offered by a broker. As illustrated within table 4005 (FIG. 22), it is observed that when 50% margin is used, with respect to account percent equity loss or percent margin used 4011, the amount of required replacement would be 100%, due to the parabolic curve effect due to exponential replacement values percentage equity required 4014. It is further evident, as stated within replacement/breakeven percent required 4012, that the replacement amounts can be extraordinary; and
iii. A trader or user skilled in the art understands that the total cash account balance at all brokers 3635, can be the sum of broker one account balance 3636, broker two account balance 3637, and broker three account balance 3638, which are cash balances at such brokers, except for the current broker account size 3505. It should be considered that the total cash account balance at all brokers 3635, as previously mentioned, can include additional brokers. A trader or user skilled in the art should avoid using the values of stocks, ETFs, options within the calculations and as a measure of capital preservation.

With respect to FIGS. 23 and 24, it is further understood by a trader or user skilled in the art that there are certain capital preservation checklists that are calculated separately:
i. A trader or user skilled in the art understands that the calculation of asset tolerance ratio 3655 is derived using the ratio of how much a trader can afford to lose of liquid assets 3630 and liquid assets in all accounts 3625 and such calculated value should not be more than 25% or any other value of a trader or users choice;
ii. A trader or user skilled in the art understands that the calculation of asset tolerance check 3660 is derived using account size at broker for a trader 3505 and current equity falling limit (equity WIBE limit) 3740. Such differential should not be more than how much a trader can afford to lose of liquid assets 3630, which is subject to breakeven analysis as illustrated within the column breakeven analysis values of actual capital preservation parameters 3695; and
iii. It is understood by a trader or user skilled in the art that the calculation of per trade capital loss allowed 3675 is derived from the possible multiplication of account size at broker for a trader 3505 and percentage tolerance per trade 3670.

A trader or user skilled in the art understands that it is possible to use capital preservation parameters without breakeven analysis, but should be aware that doing so may result in higher risks in trading as well as the production of inferior trade repairs or portfolio repairs. Trading parameters 3700, which include the risk control table and broker platform, and as such comprises of several components (of which is demonstrated with the examples set forth within tables 4100 (FIGS. 23) and 4200 (FIG. 24)), which is understood by a trader or user skilled in the art as per and including the following:
(1) A trader or user understands that there are a few items that are included within the trading parameters 3701: maximum allowed contracts or open trades limit at any given time with breakeven analysis 3720; maximum allowed contracts or maximum allowed open trades without breakeven analysis 3725; total maximum allowed “used margin” limit with breakeven analysis 3730; total maximum allowed “used margin” limit without breakeven analysis 3735; current equity falling limit (equity WIBE limit) 3740; current equity falling limit (equity WOBE limit) 3745; number of lots take out or in 3785; average open price to current security price differential limit 3710; maximum allowable pip movements or price change 3715; average open price 3705; current equity loss on current trade 3706; how many contracts open currently 3707; and account opening balance at a broker before trade repairs;
(2) A trader or user understands that those parameters aforementioned have numerical values, which are referred to as trading parameter values 3702. It is further understood that there are 13 parameters that are applicable to, but not limiting scope to, trade repair, portfolio repair or scalp-swing;
(3) With respect to table 4200 (FIG. 24), the account opening balance at a broker before trade repair 3703 is observed in item 5 of such table;
(4) With respect to table 4200 (FIG. 24), the average open price 3705 is obtained from the broker platform and depends on a trader or users activity, and is observed in item 4 of such table;
(5) A trader or user understands that the current equity loss on the current trade 3706 is found within the broker platform and such user information 3501 is needed;
(6) A trader or user understands that how many contracts open currently 3707 is found in the broker platform and such user information 3501 is needed;
(7) With respect to table 4200 (FIG. 24), a trader or user understands that the average open price to current security price differential limit 3710 varies for all traders or users, as such is seen in item 2 within this table. Such information is calculated based upon the possible ratio of per trade capital loss allowed 3675 and maximum allowed contracts or open trades limit at any given time with breakeven analysis 3720 along with the use of a multiplier of a trader or user's choice;
(8) It is further understood with respect to table 4200 (FIG. 24) that the maximum allowable pip movements or price change 3715 is the differential of account size at broker for a trader 3505 and equity falling limit (equity WIBE limit) 3740 along with the ratio of average open price to current security price differential limit 3710;
(9) A trader or user understands that the value of the maximum allowed contracts or maximum allowed open trades limit with breakeven analysis 3720 is the limit that the open trades 3271 should not exceed, as illustrated with respect to item 6 within table 4200 (FIG. 24). The maximum allowed contracts or maximum allowed open trades limit with breakeven analysis 3720 are calculated by taking a minimum for the maximum number of contracts can be traded 3565 and consider a factor of safety, such as for example 20;
(10) A trader or user understands that the value of the maximum allowed contracts or maximum allowed open trades limit without breakeven analysis 3725 is the limit that the open trades 3271 should not exceed, as illustrated with respect to item 7 within table 4200 (FIG. 24). The maximum allowed contracts or maximum allowed open trades limit without breakeven analysis 3725 are calculated by taking a possible minimum for the maximum number of contracts can be traded 3565 without breakeven analysis and consider a factor of safety, such as for example 20. A trader or user skilled in the art does calculations similar to the maximum number of contracts can be traded 3565 but needs to still consider contingency amount for max loss for a particular account 3525 into the calculation;
(11) With respect to item 8 in table 4200 (FIG. 24), a trader or user understands that the total maximum allowed “used margin” limit with breakeven analysis 3730 is calculated with the possible augmentation of margin used per contract 3545 and the maximum allowed contracts or maximum allowed open trades limit with breakeven analysis 3270;
(12) With respect to item 9 in table 4200 (FIG. 24), a trader or user understands that the total maximum allowed “used margin” limit without breakeven analysis 3735 is calculated with the augmentation of margin used per contract 3545 and the maximum allowed contracts or maximum allowed open trades limit without breakeven analysis 3275;
(13) With respect to item 10 in table 4200 (FIG. 24), the current equity falling limit (also known as equity WIBE limit” 3740, it is understood by a trader or user skilled in the art that equity (also referred to as current equity) 3555 should not fall below a certain limit in order to conserve capital, based upon breakeven analysis, as such thereupon is calculated by a rectified adjusted account size for contingency for maximum loss percentage 3755 adjoining equity error without breakeven analysis 3760 or using corrected account size for breakeven analysis 3750 and equity error without breakeven analysis 3760. Typically, it is understood by a trader or user skilled in the art that, current equity falling limit (equity WOBE limit) 3745 is lower than current equity falling limit (equity WIBE limit) 3740, which serves as an indication to a trader or user that such trader or user should stop trading before the loss of more money, which is illustrated using, current equity falling limit (equity WOBE limit) 3745. This helps to preserve more capital and can be done earlier in comparison to traditional methods;
(14) With respect to item 11 in table 4200 (FIG. 24), the current equity falling limit (also known as equity WIBE limit” 3740, is understood by a trader or user skilled in the art as such that equity (also referred to as current equity) 3555 should not fall below a certain limit in order to conserve capital, without breakeven analysis, as such thereupon is calculated by a rectified adjusted account size for contingency for maximum loss percentage 3755 without adjoining equity error without breakeven analysis 3760 or using corrected account size for breakeven analysis 3750 and equity error without breakeven analysis 3760;
(15) It is understood by a trader or user skilled in the art that used margin error without breakeven 3765 is the difference between total maximum allowed “used margin” limit without breakeven analysis 3735 and total maximum allowed “used margin” limit with breakeven analysis 3730;
(16) It is understood by a trader or user skilled in the art that the maximum allowed contract error without breakeven 3770 is the difference between that maximum allowed contracts or maximum allowed open trades without breakeven analysis 3725 and maximum allowed contracts or open trades limit at any given time with breakeven analysis 3720;
(17) A trader or user skilled in the art understands that notes for trading parameters and EMC errors 3775 provide the names of the EMC errors, such as three main errors, maximum allowed contract error without breakeven 3770, used margin error without breakeven 3765, and equity error without breakeven analysis 3760. As such, it is further understood that notes with a red color are for maximum allowed contracts or open trades limit at any given time with breakeven analysis 3720, total maximum allowed “used margin” limit with breakeven analysis 3730 and current equity falling limit (equity WIBE limit) 3740;
(18) It is understood by a trader or user skilled in the art that the values of EMC errors and misc. 3780 provide the values such as maximum allowed contract error without breakeven 3770, used margin error without breakeven 3765, and equity error without breakeven analysis 3760 for maximum allowed contracts or maximum allowed open trades without breakeven analysis 3725, total maximum allowed “used margin” limit without breakeven analysis 3735, and current equity falling limit (equity WOBE limit) 3745 respectively within the column values of EMC errors and misc. should be 37. A trader or user skilled in the art is aware that the less than (“<”) symbol can be used for maximum allowed contracts or open trades limit at any given time with breakeven analysis 3720 and total maximum allowed “used margin” limit with breakeven analysis 3730, whereas the greater than (“>”) symbol can be used for current equity falling limit (equity WIBE Limit) 3740. This serves as an indication that the actual value of the equity 3555 is greater than the values of current equity falling limit (equity WIBE Limit) 3740 as illustrated in trading parameter values 3702 for trade repair, portfolio repair or scalp-swing. As such is applicable to maximum allowed contracts or open trades limit at any given time with breakeven analysis 3720 and total maximum allowed “used margin” limit with breakeven analysis 3730 for lesser values using possible EMC error values; and
(19) A trader or user skilled in the art understands that the number or lots to take out or in 3785 is calculated based upon the current margin used from broker 3550, the total maximum allowed “used margin” limit with breakeven analysis 3730 on a differential basis and divide the previous calculation with margin used per contract 3545 making adjustments for the daily highest zone line or daily lowest zone line. The concluded value serves as an indication as to how many contracts that are required to close a position (red values) or how many lots need to be added for trade repair, portfolio repair or scalp-swing. As such, this is programmed by a trader or user skilled in the art for any market vehicle such as stocks, commodities, ETFs, etc.

FIG. 24 shows one embodiment of an illustrative control table view that is operationally associated with the table illustrated in FIG. 23, showing an illustrative tabular view displaying quick repair parameters, scalp-swing trading, and broker platform control, as included within certain embodiments of the multidimensional risk analysis systems 100 of FIGS. 1 and 2. A trader or user skilled in the art further understands the following factors with respect to tables 4100 (FIGS. 23) and 4200 (FIG. 24).

(1) For example purposes, within such tables 4100 (FIG. 23), 4200 (FIGS. 24) and 4005 (FIG. 22), a broker platform 4211 is used, although a trader or user skilled in the art uses any broker platform of their choice. A trader or user uses the trading parameters 3700 and compares such parameters to his/her broker trading platform;

(2) Table 4200 (FIG. 24) notes 4212 which contains the notes for trading parameters 3700 and notes from the broker platform 4211 applications;

(3) The repair/scalp-swing checklist details and applications 4215 is strictly followed either before taking a position or before attempting to repair a trade and as a part of capital conservation. The use of breakeven analysis and parameters of those stated within item 4213 are evaluated properly and a proper conclusion is made. A trader or user skilled in the art checks for a total of ten items with respect to doing repairs or scalp-swing, such are items 1, 2, 3, 4, 5, 6, 8, 10, 12 and 13 under the column 4213 for table 4200 (FIG. 24) and such respective values under column repair/scalp-swing checklist details and applications 4215;

(4) The average open 3705 is understood with the example provided in item 4 of column 4213 of table 4200 (FIG. 24). As thus illustrated, item 4 is observed to have within trading parameter values 3702 of $1.4568. It is further observed that within column, repair/scalp-swing checklist details and applications 4215 (item 2 within table 4200 (FIG. 24)) has a value of 12 pips, which is more than the average open price to current security price differential limit 3710 of 6.35. This serves as an indication to “do a repair”, which is programmed by a trader or user skilled in the art. If, for example, the values of average open price to current security price differential limit 3710 were less than the values of trading parameter values 3702, it serves as an indication of “no repairs”, which are programmed by a trader or user skilled in the art. A trader or user skilled in the art first makes this observation before attempting to do a repair;

(5) The average open price to current security price differential limit 3710 is considered the second most important item within the repair/scalp-swing checklist details and applications 4215. As such, this value should be less than the values within column trading parameter values 3702. It is further understood that if the values in the repair/scalp-swing checklist details and applications 4215 exceeds trading parameter values 3702, for item 2, a trader or user skilled in the art considers to repair such trade and reduces the value closer to the values in trading parameter values 3702;

(6) The current equity loss on current trade 3706, with respect to item 12 within table 4200 (FIG. 24), has a value of $5 within trading parameter values 3702, and is considered to be the third most important item within repair/scalp-swing checklist details and applications 4215. It is observed that such $5 is within the per trade capital loss allowed 3675 limit, which is observed as $45.00. As such, it is programmed to provide a response such as “within per trade limit” as illustrated within item 12 and the column repair/scalp-swing checklist details and applications 4215. It is further understood that current equity loss on current trade 3706 exceed per trade capital loss allowed 3675 limit, it is programmed to provide a response such as “exceeded per trade limit” within the column repair/scalp-swing checklist details and applications 4215. A trader or user skilled in the art concludes that if he/she is within the per trade limit, they can consider doing a repair, whereas if he/she is not within the per trade limit, such trader or user considers the removal of some positions/lots to reduce exposure;

(7) With respect to item 1 within table 4200 (FIG. 24), it is understood by a trader or user skilled in the art that if the value of current equity loss on current trade 3706 is less than the per trade capital loss allowed 3675, it is referred to as “loss under control” where the opposite is referred to as “loss out of control”;

(8) A trader or user skilled in the art, with respect to the maximum allowable pip movements or price change 3715, observes that the limits within trading parameter values 3702 are 63.89 and less than the values in high of pip differential for upper zone lines (bearish repair/scalp-swing) in pip difference between two nearest zone lines 3509, which are deemed as unacceptable. A trader or user skilled in the art understands that he/she takes precaution when adding additional lots within a repair until the current prices are between the first and second zone line on 15 minutes, or any other user desired time frame. It is further understood that a trader or user may not be able to repair a trade 100%;

(9) With respect to the account opening balance before repair 3703, a trader or user skilled in the art understands that the values in trading parameter values 3702 are more than the values within item 11 of column 4213 of table 4200 (FIG. 24), in order to consider such as acceptable. If the opposite were true, it is deemed unacceptable, in which the trader should consider paper trading. A possible alternative is that if such trade is repairable, the trader or user skilled in the art should consider a repair, otherwise should consider returning the account opening balance at a broker before trade repairs 3703 to “acceptable”;

(10) With respect to how many contracts currently open 3707, a trader or user skilled in the art should review items 1, 2, 3, 4, 5 and 12 in within column 4213 of table 4200 (FIG. 24) when deciding to make a trade and then evaluate how many contracts are currently open 3707. It is observed that if the values in trading parameter values 3702 for how many contracts currently open 3707 is less than the values of maximum allowed contracts or open trades limit at any given time with breakeven analysis 3720 in trading parameter values 3702, it is programmed by a trader or user skilled in the art to prompt “add lots”, in which a trader or user adds lots to reduce the average open price to current security price differential limit 3710 in repair/scalp-swing checklist details and applications 4215 closer to the values in trading parameter values 3702;

(11) With respect to the max allowed contracts or open trades limit at any given time with breakeven analysis 3720, a trader or user skilled in the art notes that the values within trading parameter values 3702 for how many contracts open currently 3707, is lower than the values of maximum allowed contracts or open trades limit at any given time with breakeven analysis 3720 in trading parameter values 3702, it is programmed by a trader or user skilled in the art to produce “limits not reached”. It is further understood that if the values of how many contracts open currently 3707 is higher than max allowed contracts or open trades limit at any given time with breakeven analysis 3720, it is programmed by a trader or user skilled in the art to produce “limits reached”. It is further understood that if the limits are reached, additional lots are not added or trades are not repaired. A solution is that if a trader or user skilled in the art is bullish, at the next higher zone level, such trader or user should reduce some lots to return to “limits not reached” whereas if it was a bearish position, the next lower zone level 1005 is used;

(12) With respect to the max allowed used margin limit at any given time with breakeven analysis 3730, the values in user feed info in color 3596 for current margin used from broker 3550 is lower than the values of the total maximum allowed “used margin” limit with breakeven analysis 3730 in trading parameter values 3702. It is programmed by a trader or user to produce “limits not reached”. It is further understood that if the values of user feed info in color 3596 is higher than the total maximum allowed “used margin” limit with breakeven analysis 3730, it is programmed by a trader or user skilled in the art to produce “limits reached”. It is further understood that if the limits are reached, additional lots are not added or trades are not repaired. A solution is that if a trader or user skilled in the art is bullish, at the next higher zone level, such trader or user wants to reduce some lots to return to “limits not reached” whereas if it was a bearish position, the next lower zone level is used;

(13) With respect to the WIBE limit at any given time with breakeven analysis 3740, it is understood that the values in trading parameter values 3702 for account opening balance at a broker before trade repairs 3703 is higher than the values of current equity falling limit (equity WIBE limit) 3740 in trading parameter values 3702, it is programmed to produce “limits not reached” by a trader or user skilled in the art. It is further understood that if the values of trading parameter values 3702 is lower than the values of current equity falling limit (equity WIBE limit) 3740, it is programmed by a trader or user skilled in the art to produce “limits reached”. It is further understood that if the limits are reached, additional lots are not added or trades are not repaired. A solution is that if a trader or user skilled in the art is bullish, at the next higher zone level, such trader or user should reduce some lots to return to “limits not reached” whereas if it was a bearish position, the next lower zone level 1005 is used;

(14) With respect to the max allowed contracts or open trades limit at any given time without breakeven analysis 3725, it is understood that if the value of how many contracts open currently 3707 is prodigious than the values of the max allowed contracts or open trades limit at any given time without breakeven analysis 3725, it is programmed by a trader or user skilled in the art to produce “limits not reached”. It is further understood that if the value of how many contracts open currently 3707 is not prodigious than the values of the max allowed contracts or open trades limit at any given time without breakeven analysis 3725, it is programmed to produce “limits not reached”. It is further understood that once a trader or user reaches “limits reached”. Such broker should not add any additional lots or conduct any scalp-swing trades and consider the control of total maximum allowed “used margin” limit with breakeven analysis 3730 and current equity falling limit (equity WIBE limit) 3740. If considering repairs, he/she considers the reduction of how many contracts open currently until the total maximum allowed “used margin” limit with breakeven analysis 3730 and current equity falling limit (equity WIBE limit) 3740 are possibly under control;

(15) With respect to the max total maximum allowed “used margin” limit without breakeven analysis 3735, it is understood by a trader or user that if the value of current margin used from broker 3550 is prodigious than the values of the total maximum allowed “used margin” limit without breakeven analysis 3735, it is programmed by a trader or user skilled in the art to produce “limits not reached”. It is further understood that if the value of current margin used from broker 3550 is not prodigious than the values of the total maximum allowed “used margin” limit without breakeven analysis 3735, it is programmed by a trader or user skilled in the art to produce “limits reached”. It is further understood that once a trader or user reaches “limits reached”, such trader should not use more maximum allowed “used margin” limit without breakeven analysis 3735 and should consider control current equity falling limit (equity WIBE limit) 3740 and maximum allowed contracts or open trades limit at any given time with breakeven analysis 3720 for possible scalp-swing and trade repairs; and

(16) With respect to the WOBE limit at any given time without breakeven analysis 3745, it is understood by a trader or user skilled the art that if the value of current equity falling limit (equity WOBE limit) 3745 is prodigious than the values of account opening balance at a broker before trade repairs 3703, it is programmed by a trader or user skilled in the art to produce “limits not reached”. If the value of current equity falling limit (equity WOBE limit) 3745 is not prodigious than the values of account opening balance at a broker before trade repairs 3703, it is programmed by a trader or user skilled in the art to produce “limits reached”. It is further understood that if the limits are reached, additional lots should not use any more of current equity falling limit (equity WOBE limit) 3745 and consider to control or adjust the total maximum allowed “used margin” limit with breakeven analysis 3730 and maximum allowed contracts or open trades limit at any given time with breakeven analysis 3720 for scalp-swing and trade-repairs.

A trader or user skilled in the art understands that he/she refers to, but not limiting scope to, the risk transition due to unscheduled and scheduled events, risk transition lines, and hybrid zone risk transfer area for additional risk recognition. It is further understood that a trader or user skilled in the art refers to the User's Manual, and scalp-swing section for the following, but not limiting scope to, risk assessments and risk recognition: forecasting earlier highs with risk assessments; forecasting earlier highs with risk assessment for Halved Hybrid Nozzlelism; forecasting earlier lows with risk assessments; forecasting earlier lows with risk assessments for Halved Hybrid Nozzlelism; super belief bull pin point entries w/risk assessments; super belief bull pin point entries w/risk assessments for Halved Hybrid Nozzlelism; super belief bear pin point entries w/risk assessments; super belief bear pin point entries w/risk assessments for Halved Hybrid Nozzlelism; earlier lows −4.6(Mc)++; earlier lows −4.6(Mc)+; earlier lows −4.6(Mc) and, earlier lows −4.1 Tan(Me)−Oex. There are a variety of embodiments of components, parameters, calculations, and examples for risk, account, capital preservation, trade repair and scalp-swing trading control table 4100 (FIG. 23) and quick repair parameters and scalp-swing trading broker platform friendly control table 4200 (FIG. 24). A trader or user may be alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading. A trader or user skilled in the art uses an explorer or system tester to explore the various parts or components of the multidimensional risk analysis systems 100. A trader or user refers to the Users Manual within Appendix A of the U.S. Provisional Filing Ser. No. 61/343,120, filed Apr. 23, 2010, entitled “Multidimensional Risk Analysis Systems” for a complete list of symbols, indicators, experts, etc. All Figures within this specification represent, in general, a portion of the multidimensional risk analysis systems 100, however a trader or user utilizes a single or multiple portions of the multidimensional risk analysis systems 100 with trading in financial markets.

### Computer Flow Diagram Description

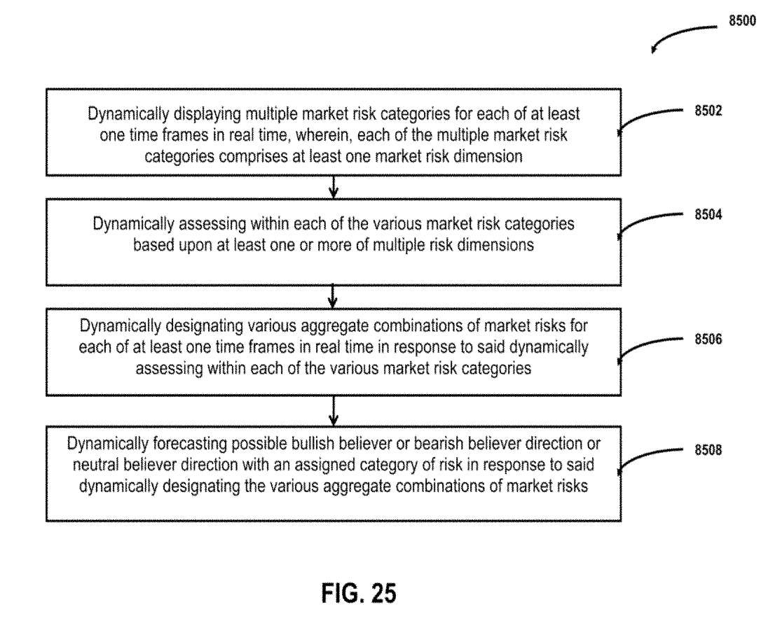

FIGS. 25 to 29 show a number of embodiments of illustrative flow diagrams that are performed on a number of embodiments of the multidimensional risk analysis systems 100 and thereupon displayed upon a number of displays including: the risk assessment, recognition, confirmation, designation, forecasting or identification display 310; the user display 124; or the peripheral user display 124a. Each of these different flow diagrams are now described in order with respect to FIGS. 25 to 29. It is expected, therefore, that such embodiments of the multidimensional risk analysis systems and methods are performed utilizing specific purpose computers.

FIG. 25 shows one embodiment showing an illustrative flow diagram displaying one embodiment of a multidimensional risk analysis method 8500 with forecasting capabilities, as performed by certain embodiments of the multidimensional risk analysis systems 100 of FIGS. 1 and 2. It is expected, therefore, that certain embodiments of the multidimensional risk analysis method 8500 are performed on relatively complex specific purpose computers.

The FIG. 25 embodiment of the multidimensional risk analysis method 8500 performs a dynamically displaying multiple market risk categories for each of at least one time frames step 8502 in real time, wherein each of the multiple market risk categories comprise at least one market risk dimension. For example, as illustrated relative to FIG. 7, certain embodiments of the risk processor 200, the risk assessor 140 and the risk analyzer 150 of FIGS. 1 and 2 can dynamically display multiple risk categories such as by analyzing data, information, symbols, etc. such as can be further displayed on a risk assessment, recognition, confirmation, designation, forecasting or identification display 310; the user display 124; or the peripheral user display 124a.

The FIG. 25 embodiment of the multidimensional risk analysis method 8500 continues with dynamically assessing within each of the multiple market risk categories based upon at least one or more of multiple risk dimensions step 8504 in real time. For example, as illustrated relative to FIG. 7, certain embodiments of the risk processor 200, the risk assessor 140 and the risk analyzer 150 of FIGS. 1 and 2 dynamically assess within each of the multiple market risk categories to assess data, information, symbols, etc. such as can be displayed on a risk assessment, recognition, confirmation, designation, forecasting or identification display 310; the user display 124; or the peripheral user display 124a.

The FIG. 25 embodiment of a multidimensional risk analysis method 8500 performs a dynamically designating various aggregate combinations of market risks for each of at least one time frames in real time in response to said dynamically assessing within each of the various market risk categories step 8506 in real time. For example, as illustrated relative to FIG. 7, certain embodiments of the risk processor 200, the risk assessor 140 and the risk analyzer 150 of FIGS. 1 and 2 designate various aggregate combinations of market risks for each of at least one time frame in real time, etc. such as can be displayed on a risk assessment, recognition, confirmation, designation, forecasting or identification display 310; the user display 124; or the peripheral user display 124a.

FIG. 25 shows one embodiment of a dynamically forecasting Bullish Believer or Bearish Believer direction or Neutral Believer direction with an assigned category of risk in response to said dynamically designating the various aggregate combinations of market risks step 8508 in real time. For example, as illustrated relative to FIG. 7, certain embodiments of the risk processor 200, the risk assessor 140 and the risk analyzer 150 of FIGS. 1 and 2 dynamically forecast Bullish Believer or Bearish Believer direction or Neutral Believer direction with an assigned category of risk such as can be displayed on a risk assessment, recognition, confirmation, designation, forecasting or identification display 310; the user display 124; or the peripheral user display 124a.

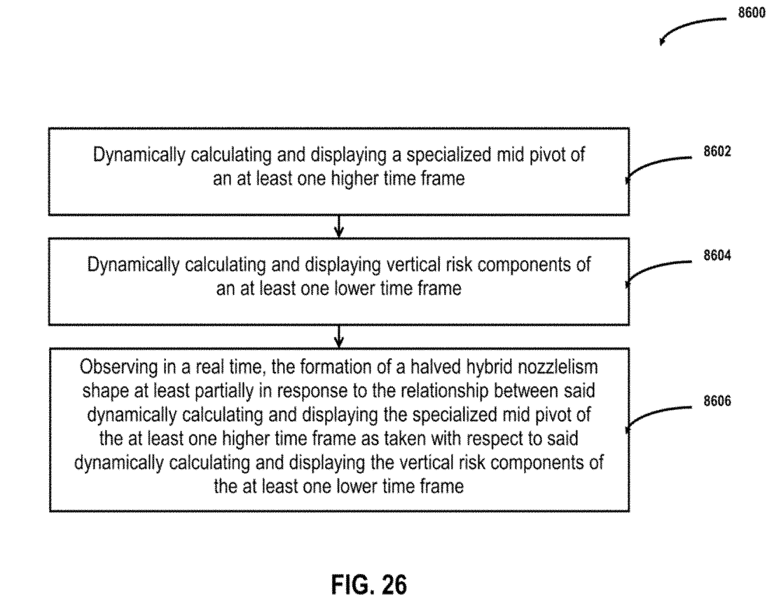

FIG. 26 shows one embodiment showing an illustrative flow diagram displaying a Halved Hybrid Nozzlelism method 8600 with inherent forecasting capabilities, as included within certain embodiments of the multidimensional risk analysis systems 100 of FIGS. 1 and 2. It is expected, therefore, that certain embodiments of the multidimensional risk analysis method 8600 perform Halved Hybrid Nozzlelism method 8600 with inherent forecasting capabilities on relatively complex specific purpose computers.

The Halved Hybrid Nozzlelism method 8600 with inherent forecasting capabilities of FIG. 26 is performed using certain embodiments of the multidimensional risk analysis systems 100 of FIGS. 1 and 2. For example, as illustrated relative to the illustrative display shown in FIG. 9, certain embodiments of the risk processor 200, the risk assessor 140, and the risk analyzer 150 of FIGS. 1 and 2 at least partially perform the Halved Hybrid Nozzlelism method 8600 comprising dynamically calculating and displaying a specialized mid pivot of an at least one higher time frame step 8602 in real time. FIGS. 1 and 2 dynamically calculates and display a specialized mid pivot of an at least one higher time frame such as by analyzing data, information, symbols, etc. which is further displayed on a risk assessment, recognition, confirmation, designation, forecasting or identification display 310; the user display 124; or the peripheral user display 124a.

The Halved Hybrid Nozzlelism method 8600 with inherent forecasting capabilities of FIG. 26 is performed using certain embodiments of the multidimensional risk analysis systems 100 of FIGS. 1 and 2. For example, as illustrated relative to the illustrative display shown in FIG. 9, certain embodiments of the risk processor 200, the risk assessor 140, and the risk analyzer 150 of FIGS. 1 and 2 at least partially perform the Halved Hybrid Nozzlelism method 8600 comprising dynamically calculating and displaying vertical risk components of an at least one lower time frame step 8604 in real time. FIGS. 1 and 2 dynamically calculates and display vertical risk components of an at least one lower time frame such as by analyzing data, information, symbols, etc. which is further displayed on a risk assessment, recognition, confirmation, designation, forecasting or identification display 310; the user display 124; or the peripheral user display 124a.

The Halved Hybrid Nozzlelism method 8600 with inherent forecasting capabilities of FIG. 26 is performed using certain embodiments of the multidimensional risk analysis systems 100 of FIGS. 1 and 2. For example, as illustrated relative to the illustrative display shown in FIG. 9, certain embodiments of the risk processor 200, the risk assessor 140, and the risk analyzer 150 of FIGS. 1 and 2 at least partially perform the Halved Hybrid Nozzlelism method 8600 comprising an observing in a real time, the formation of a Halved Hybrid Nozzlelism shape step 8606 in real time at least partially in response to the relationship between said steps 8602 and 8604 in real time as described in the above two paragraphs. FIGS. 1 and 2 observe in a real time, the formation of a Halved Hybrid Nozzlelism shape at least partially in response to the relationship between said dynamically calculating and displaying the specialized mid pivot of the at least one higher time frame as taken with respect to said dynamically calculating and displaying the vertical risk components of the at least one lower time frame, such as by analyzing data, information, symbols, etc. such as can be displayed on a risk assessment, recognition, confirmation, designation, forecasting or identification display 310; the user display 124; or the peripheral user display 124a.

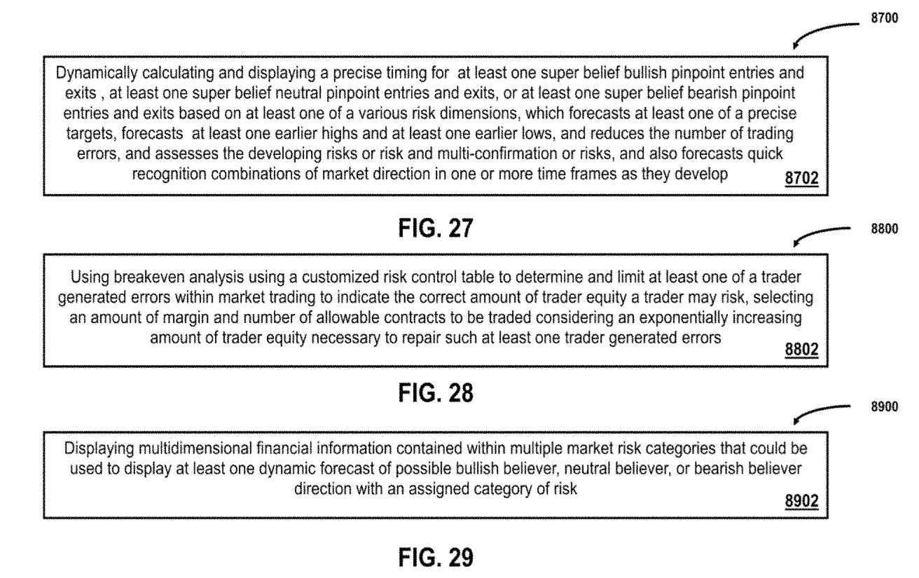

FIG. 27 shows one embodiment of a display, showing an illustrative flow diagram displaying one embodiment of a scalp-swing or mega scalp-swing method 8700 with forecasting capabilities, as included within certain embodiments of the multidimensional risk analysis systems 100 of FIGS. 1 and 2. It is expected, therefore, that certain embodiments of the multidimensional risk analysis method 8700 is performed on relatively complex specific purpose computers.

The FIG. 27 embodiment of the multidimensional risk analysis method 8700 performs a dynamically calculating and displaying a precise timing for at least one super belief bullish pinpoint entries and exits, at least one super belief neutral pinpoint entries and exits, or at least one super belief bearish pinpoint entries and exits based on at least one of a various risk dimensions, which forecasts at least one of a precise targets step 8702 in real time. Certain embodiments of the step 8702 in real time further is used to forecast at least one earlier highs and at least one earlier lows, and reduces the number of trading errors, and assess the developing risks or risk and multi-confirmation or risks, and forecasts quick recognition combinations of market direction in one or more time frames as they develop. For example, as illustrated relative to FIGS. 4, 7, 10, 12, 13, 16, and 21 certain embodiments of the risk processor 200, the risk assessor 140 and the risk analyzer 150 of FIGS. 1 and 2 dynamically calculates and display a precise timing for at least one super belief bullish pinpoint entries and exits , at least one super belief neutral pinpoint entries and exits, or at least one super belief bearish pinpoint entries and exits based on at least one of a various risk dimensions, which forecasts at least one of a precise targets. This is performed such as by analyzing data, information, symbols, etc. which is further displayed on a risk assessment, recognition, confirmation, designation, forecasting or identification display 310; the user display 124; or the peripheral user display 124a.

FIG. 28 shows one embodiment of a display, showing an illustrative flow diagram displaying one embodiment of a method for using customizable risk control tables 8800, as included within certain embodiments of the multidimensional risk analysis systems 100 of FIGS. 1 and 2. It is expected, therefore, that certain embodiments of the multidimensional risk analysis method 8800 areperformed on relatively complex specific purpose computers.

The FIG. 28 embodiment of the multidimensional risk analysis method 8800 performs a breakeven analysis using a customized risk control table to determine and limit at least one of a trader generated errors within market trading to indicate the correct amount of trader equity a trader may risk step 8802 in real time. Certain embodiments of the step 8802 in real time continue by selecting an amount of margin and number of allowable contracts to be traded considering an exponentially increasing amount of trader equity necessary to repair such at least one trader generated errors. For example, as illustrated relative to FIGS. 22, 23, and 24, certain embodiments of the risk processor 200, the risk assessor 140 and the risk analyzer 150 of FIGS. 1 and 2 performs a breakeven analysis using a customized risk control table to determine and limit at least one of a trader generated errors within market trading to indicate the correct amount of trader equity a trader may risk such as by analyzing data, information, symbols, etc. which is further displayed on a risk assessment, recognition, confirmation, designation, forecasting or identification display 310; the user display 124; or the peripheral user display 124a.

FIG. 29 shows one embodiment showing an illustrative flow diagram displaying one embodiment of a multidimensional risk analysis method 8900 that is performed using one embodiment of the multidimensional risk analysis systems 100 of FIGS. 1 and 2. It would be expected, therefore, that certain embodiments of the multidimensional risk analysis method 8900 can be performed on relatively complex specific purpose computers.

The FIG. 29 embodiment of the multidimensional risk analysis method 8900 performs the display of multidimensional financial information contained within multiple market risk categories that are used to display at least one dynamic forecast of possible Bullish Believer, Neutral Believer, or

Bearish Believer direction with an assigned category of risk step 8902 in real time. For example, as illustrated relative to FIGS. 7, 14, and 16, certain embodiments of the risk processor 200, the risk assessor 140 and the risk analyzer 150 of FIGS. 1 and 2 performs the display of multidimensional financial information contained within multiple market risk categories that are used to display at least one dynamic forecast of possible Bullish Believer, Neutral Believer, or Bearish Believer direction with an assigned category of risk step 8902 in real time, such as by analyzing data, information, symbols, etc. such as can be further displayed on a risk assessment, recognition, confirmation, designation, forecasting or identification display 310; the user display 124; or the peripheral user display 124a.

### Sequencing of Risks

A trader or user skilled in the art understands that “sequencing of risks” in multidimensional risk analysis systems is that in which there is a development of multidimensional risks and its subcategories of risks at the same time, either in favor of Bullish Believers, Bearish Believers, or Neutral Believers or at the same time during the transition or exchange between Bullish Believers and Bearish Believers and is referred to as “sequentizing” or “Sequentized”. Importance should be given to prioritizing and selection of risks and its subcategories of risks and its combinations, in order to create a sequence, which produces nearly optimal performance in trading. A trader or user skilled in the art creates a sequence, which provides optimal performance, with the use of software such as Thomson-Reuters Metastock® Pro software, E-Signal®, TradeStation®, or similar financial software. Such financial software provides system tests and/or experts that allow for such sequences. Trial and error testing allows a trader or user skilled in the art to establish a sequence of his/her choice. Various components of the multidimensional risk analysis systems, in part or full, are combined to create several results as per a trader or users choice. For illustrative purposes, the following sequence is used by a trader or user skilled in the art:
1) Earlier Highs with Nozzlelism; 2) Earlier Lows with Nozzlelism; 3) Earlier Highs; Earlier Lows; 4) Super Belief Bull Pin Point Entries; 5) Super Belief Bull Pin Point Entries; 6) Super Bullish Belief Contra; 7) Super Bearish Belief Contra; 8) Top Bear; Bottom Bull; 9) Tan Bearish Candle; 10) Black Neutral Candle; 11) Yellow Candle; 12) Bullish DK Yellow Candle type a; 13) Bullish Bright Green Candle type b; 14) Bullish Green Candle type c; 15) Purple Candle typed; 16) Bearish Brown Candle type e; 17) Bearish Red Candle type f; 18) Gray Bullish Candle; 19) Pink Bearish Candle; 20) Turquoise Bullish Candle; 21) Golden Bearish Candle; 22) Bull Warnings; 23) Bear Warnings; 24) Bull Reversal; 25) Bear Reversal; 26) Magic In; and 27) Magic Out.

A trader or user skilled in the art understands that the risk designators on a scale of +1 to +6, −1 to −6, +1 to +7, or −1 to −7 or of any user desired choice, are used in conjunction with Super Belief Bull/Bear Pin Point Entries and Earlier Highs/Lows with or without utilizing Halved Hybrid Nozzlelism.

Upon reading the teachings of this specification, those skilled in the art will now appreciate that,under appropriate circumstances, the concept of sequencing, may suffice.

### Definition of Terms

Below are definitions of certain terms used herein.

“Bearish Believeness” is a state of mind with input as provided by certain embodiments of the multidimensional risk analysis systems, which certain Bearish Believers are more likely to exhibit. Such believers are less likely to make poor decisions based on the provided information. With multidimensional risk analysis systems, those financial Market Vehicles that show true promise will likely thereby be supported by increasing purchases and trades, and those that do not will not be as strongly supported. As such, the widespread use of certain embodiments of the multidimensional risk analysis systems will help promote Bearish Believers to stay away from those financial vehicles that traders or users would be least benefitted by Bearish Believeness.

“Bearish Believer Condition” is a condition that develops in trading when the various components of Trend Health Risk, such as, but not limiting scope to, internal health risk indicator and modified positive/negative indicator, are aligned below zero Boundary Lines with modified bearish time segment and price perception risk, which are preferably for sections “d”, “e” or “f”. This is for trading a market vehicle in any time frame that comprises of tick to yearly or any combination of time frames.

“Bearish Vertical Lines” is defined as a situation that serves as an indication of bearishness within a market vehicle and is indicated with bearish spot risk lines, warning lines, directional lines, possibly lows, or transition lines. Bearish Vertical Lines comprise of, but not limiting scope to, bear spot risk lines, pink ext bear warning lines, bear directional line, and gold PL line.

“Believeness” is defined as a situation in which a majority of traders or users trading a particular market vehicle believe that they should either be going in the long (bullish), short (bearish) or are neutral about the market vehicle and as such is classified as “Bullish Believeness”, “Bearish Believeness” or “Neutral Believeness”, respectively.

“Believers” is defined as a situation when a majority of the traders or users trading a particular market vehicle have the “Believeness” to go trade in either the bullish, bearish, or are neutral about the market vehicle and as such is classified as “Bullish Believers”, “Bearish Believers”, or “Neutral Believers”, respectively.

“Big Scale Buy Candles” is defined as a situation that occurs typically after the formation of bullish trend change warning candles. It is observed by traders or users that a trend change and/or order flows commences. It is a low risk bullish entry as bullish belief can be converting to bullish direction. It is understood that in a bearish trend, the formation of Big Scale Buy Candles would not last as long but within a bullish trend, it continues the bullish trend. Big Scale Buy Candles comprises of gray (C) bullish candle.

“Big Scale Sell Candles” is defined as a situation that occurs typically after the formation of bearish trend change warning candle. It is observed by traders or users that a trend change and/or order flows commences. It is a low risk bearish entry as bearish belief can be converting to bearish direction. It is understood that in a bullish trend, the formation of Big Scale Sell Candles would not last as long but within a bearish trend, it continues the bearish trend. Big Scale Sell Candles comprises of pink (C) bearish candle.

“Black Candle” is defined as a situation that occurs when there is a high concentration of Neutral

Believers for a particular time frame.

“Blue Line Angle North” is defined as the movement of the Blue Line in an upward direction at an angle, facing north, prior to the time of a scheduled event, on a scale of vertical risk dimensions versus horizontal risk dimensions.

“Blue Line Angle South” is defined as the movement of the Blue Line in a downward direction at an angle, facing south, prior to the time of a scheduled event, on a scale of vertical risk dimensions versus horizontal risk dimensions.

“Blue Line (FXTA Mid Pivot)” is defined by product named “FXTA” or “Forex Traders Advantage”. The Blue Line refers to the mid pivot level and may be shown with different colors and the values is different with different time frames, such as daily, weekly, 60 minutes, etc.

“Bottom Bull” is defined as the opposite of “Top Bear”. “Bottom Bull” comprises of the variations of trough bars and stochastic values of relative strength index is approximately near one hundred between to three to five periods.

“Boundary Lines” is defined as the horizontal lines which are a component of the health indicator, which is a part of the multidimensional risk analysis systems. They are the lines in which the market vehicle will travel between.

“Bullish Believeness” is defined as the state of mind with input as provided by certain embodiments of the multidimensional risk analysis systems. Bullish Believers are more likely to make better and smarter decisions based on the provided information. With multidimensional risk analysis systems, those financial Market Vehicles that show true promise will likely thereby be supported by increasing purchases and trades, and those that do not will not be as strongly supported. As such, the widespread use of certain embodiments of the multidimensional risk analysis systems will help promote Bullish Believers to promote those financial vehicles that traders or users would be most benefitted by Bullish Believeness.

“Bullish Believer Condition” is defined as a situation that develops in trading when the various components of Trend Health Risk, such as but not limiting scope to, internal health risk indicator, and modified positive/negative indicator which is aligned above zero Boundary Lines with modified bullish time segment and price perception risk, which are preferably for sections “a”, “b” or “c”. This is for trading a market vehicle in any time frame that comprises of tick to yearly or any combination of time frames.

“Bullish Vertical Lines” is defined as a situation that indicates bullishness within a market vehicle and is indicated with bullish spot risk lines, warning lines, directional lines, possible highs or transition lines. Bullish Vertical Lines may comprise of, but not limiting scope to, bull spot risk line, yellow ext bull warning line, bull directional line and turquoise PH lines.

“Candlestick Spectrum” is defined as band of colors, symbols, numbers, indicators, and alpha-numeric characters that are produced by multi-dimensional risk and are seen in a candlestick chart or other types of financial charts.

“Components of Halved Hybrid Nozzlelism” are defined as the various types of Halved Hybrid Nozzlelism shapes which are formed with zone line (mid zone line or user selected zone line), and Blue Line (mid pivot or any user desired pivot).

“Dual Spikes” are defined as two or more spikes that indicate bullishness or bearishness within a market vehicle and also indicates a continuation of the trend of the market vehicle. Dual Spikes comprises of blue continuation Spikes.

“Dynamic Sectional Price Risk” is also known as price perception risk. It is defined as one of the eight dimensional risks in the multidimensional risk analysis systems. It is categorized into Sections a , b , c , ‘d’, ‘e’, and ‘f’ ; “a”, “b”, and “c” are used to define price perception risk for Bullish Believers; “d” is used to define profit taking for Bullish Believers; “e” and “f” are used to define price perception risk for Bearish Believers.

“Dynamic Zone Lines” is defined as the horizontal lines which show the vertical risk in the multidimensional risk analysis systems. Dynamic Zone Lines are considered to be adaptive, horizontal, flexible lines that dynamically travel, dynamically travels independently of one another and has forecasting capabilities, allowing the indication of a change within the near future.

“Expansion of Zone Lines” is defined as the increase in distance between the upper most and lower most zone lines. After the Squeezing of Zone Lines, at one point or another the unscheduled intersection of zone line occurs, due to the increased volatility and creates a shifting point either in the upward or downward direction, provided that one of the zone levels, either the upper most zone line or the lower most zone line remain stable, which creates the Expansion of Zone Lines in either the upward or downward direction. When the Squeezing of Zone Lines occurs, the unscheduled intersection of zone lines creates a downward movement for all the zone lines, with the exception of the upper most zone line and Halved Hybrid Nozzlelism Shifting End SpikeNertical Line (Bear To Bull) allowed for stabilization. The first expansion confirmation point and subsequent expansion points of zone lines are spotted by using, but not limiting scope to, Warning Spot For First Gold PL Line (Bull To Bear), gold PL line, and Shifting Point of Zone Lines for any bearish outlook and any warning sign for the first turquoise PH line, Shifting Point of Zone Lines and subsequent black transition spike.

“Family and Characteristics Risk” is defined as one of the eight dimensional risks in the multidimensional risk analysis systems and is formulated separately for subject market vehicle and compared with its peers or within its own family or type.

“Fundamental Risk” is also known as economic events risk and is one of the eight dimensional risks in the multidimensional risk analysis systems.

“FXTA Mid Pivot (Blue Line)” is defined by a product named “FXTA” or “Forex Traders Advantage.” The FXTA mid pivot refers to the mid pivot level and may be shown with different colors and the values can be different with different time frames, such as daily, weekly, 60 minutes, etc.

“Hybrid Dynamic Risk Zones” are defined as the vertical distance between any two zone lines that comprises at least one risk zone wherein the one risk zone comprises one Blue Line.

“Halved Hybrid Nozzlelism” is defined as the phenomenon of the formation of the Halved Hybrid Nozzle shape. Halved Hybrid Nozzlelism is utilized not to describe a physical nozzle, but as when the mid zone line 1040 and blue line 2381 combine. Visually this is seen in the shape of a nozzle that is cut in half and zone line 1040 is seen in the shape of “stairs” in which those stairs (zone line 1040) are moving upwards or downwards toward blue line 2381 or moving upwards or downwards away from blue line 2381. This visual pattern helps indicate trading clues such as training to understand important events occurring within financial markets such as market trend changes, breakouts, retracements, new highs, new lows, directional forecastings, reversals, pullbacks, and many other such trading clues. Also, the various types and shapes of Halved Hybrid Nozzlelism tend to indicate and show the accumulation of Bullish Believers or Bearish Believers or the exchange between Bullish Believers and Bearish Believers. Due to increasing demand of Bullish Believers conditions, Neutral believers conditions, and Bearish Believers conditions, the prices of any market vehicle, at one point, may break either upper zone level or lower zone level in any time frames, which may constitute either new highs, new lows for either intraday or on daily basis or for a particular time frame on zone levels basis. In such cases, the rest of zone levels follow either upper zone level or lower zone level. When comparing the relative positions of mid zone level with respect to a mid pivot or custom pivots, an area having a similar appearance as halved the nozzle shape, is formed either above or below the mid pivot or custom pivots, or on left or right side of the end of the tip of the halved nozzle shape. These areas in trading are referred to in this disclosure as “Halved Hybrid Nozzlelism”, which tends to follow a repeating pattern in trading and provides many trading clues. One can reference FIG. 8 in which the individual visualizes the shaded area between zone line 1040 and blue line 2381 as the Halved Hybrid Nozzle. “Nozzle” by definition is a short tube with a taper or constriction used (as on a hose) to speed up or direct flow of a fluid. “Ism” by definition is a distinctive doctrine, cause, or theory. Doctrine is defined as a body or system of teachings related to a particular subject. Indicators, Alerts and explorers are designed for all parts of this concept by these independently repeating patterns, in part or full.

“Halved Hybrid Nozzlelism shape” is defined as a two-dimensional line diagram that combines two indicators/elements, zone line 1040 and interjected specialized mid pivot blue line 2381. This shape is formed with the mid zone line 1040, components of the Hybrid Dynamic zone lines of a Lower time frame combined with an Interjected Specialized mid pivot of a Higher time frame (blue line 2381).

“Halved Hybrid Nozzlelism Annularization” is defined as an intermediary portion of the Halved Hybrid Nozzlelism formation, which occurs between Halved Hybrid Nozzlelism parallelism and Halved Hybrid Nozzle Tipping area and halved convergence or halved divergence area.

“Halved Hybrid Nozzlelism Convergence” is defined as part of the upper or lower left side of halved Hybrid Nozzlelism, in which where the prices flow into this area first and then travel towards Halved Hybrid Nozzle Annularization or Halved Hybrid Nozzle Tipping area, which is for either Bullish or Bearish Believers.

“Halved Hybrid Nozzlelism Convergence Separation Point” is defined as a point where Halved Hybrid Nozzlelism Convergence starts for either the upper or lower halved. Separation is either due to Hybrid Parallelism or from hybrid zone risk transfer area. For upper left Halved Hybrid Nozzlelism Convergence from this point, market prices get rejected from the Blue Line towards the lower most zone line and eventually put pressure on it to possibly form Halved Hybrid Nozzlelism Convergence for upper right Halved Hybrid Nozzlelism. Typically, the direction is opposite the previous direction of the left side of the separation point area.

“Halved Hybrid Nozzlelism Divergence” is defined as part of the upper or lower left side of Halved Hybrid Nozzlelism, in which where the prices flow into this area last and it travels from Halved Hybrid Nozzle Annularization/Halved Hybrid Nozzle Hybrid Parallelism area, which is for either for a bullish or Bearish Believers.

“Halved Hybrid Nozzlelism Divergence Separation Point” is defined as a point where Halved Hybrid Nozzlelism Divergence starts for either the upper or lower halved. Separations are either due to Hybrid Parallelism or from hybrid zone risk transfer area. For lower right Halved Hybrid Nozzlelism Divergence from this point, market pricesget rejected from the mid zone line towards lowest zone line and eventually put pressure on it. Typically, the direction is opposite to the previous direction on the left side of this separation point area. If Hybrid Parallelism forms from this point, there is a sideways movement until a scheduled intersection of Blue Line or pivot lines.

“Halved Hybrid Nozzlelism Shifting End Spike/Vertical Line (Bear To Bull)” is defined as a configuration that occurs when all zone lines stop shifting to the downside and remain horizontal for Halved Hybrid Nozzlelism.

“Halved Hybrid Nozzlelism Shifting End Spike/Vertical Line (Bull To Bear)” is defined as a configuration that occurs when all zone lines stop shifting to the upside and remain horizontal for Halved Hybrid Nozzlelism.

“Halved Hybrid Nozzle Tipping” is defined as a front Hybrid Parallelism portion, which is in variable length on a Horizontal Time Risk from one to several number of the same time frame and connects at least two Components of Halved Hybrid Nozzlelism, which is referred to as nozzle tipping area.

“Horizontal Time Risk” is also known as time duration risk and is one of the eight dimensional risks in the multidimensional risk analysis systems.

“Hybrid Dynamic Zone Lines” are defined as Dynamic Zone Lines with the combination of a Blue

Line or pivot line. Dynamic Zone Lines are the horizontal lines which show the vertical risk in the multidimensional risk analysis systems. Dynamic Zone Lines are considered to be adaptive, horizontal, flexible lines that may dynamically travel, dynamically travel independently of one another and can have forecasting capabilities, allowing the possible indication of a possible change within the near future.

“Hybrid” is defined as a thing made by combining two different elements (element is defined as a component or constituent of a whole or one of the parts into which a whole may be resolved by analysis).

“Hybrid Parallelism” is defined as a general shape or pattern of a variety of indicator combinations, which are utilized to help an ordinary skilled trader to understand important events such as market trend change, breakouts, retracements, new highs, new lows, directional prediction, reversals, pullbacks, and many other trading clues. Also, the various types and shapes of Hybrid Parallelism tends to indicate and show the accumulation of Bullish Believers or Bearish Believers or the exchange of Bullish Believers and Bearish Believers. The phenomenon of the formation of Hybrid Parallelism shape into the theory of “Halved Hybrid Nozzlelism” is referred to as “Hybrid Parallelism”. Visually, Hybrid Parallelism is seen when zone line 1040 fails to intersect blue line 2381 and travels horizontally instead “Inner Market Family Risk Composite Index” is defined as an index that is similar in nature to Inner Market Family Index with the exception that the algorithm is modified for the exclusion of any component within Trend Health Risk.

“Inner Market Family Risk Index” is defined as a measure to find the closest family members in behavior, out of all of the family members, and to find the common factors, indexes they follow, and compare them to others.

“Interjected Specialized Mid Pivot of a Higher Time Frame” is defined as inserting one specially designed dynamically changing mid pivot, also known as Blue Line 2381, into the Hybrid Dynamic Zone Lines. The zone lines are based on a lower time frame, such as 5 minutes, and the mid pivot/blue line is of a higher time frame, such as 60 minutes.

“Magic In” is comprised of the intersection of the tertiary sum of utmost, minor and ceased prices of the market vehicle over a user desired time period and the advance modal of the tertiary sum of utmost, minor and ceased prices of the market vehicle over a user desired time period. “Magic in” is considered a bull entry special market condition.

“Magic Out” is comprised of the advance modal of the tertiary sum of utmost, minor and ceased prices of the market vehicle over a user desired time period and the intersection of the tertiary sum of utmost, minor and ceased prices of the market vehicle over a user desired time period.

“Market Vehicles” are defined as trading instruments such as stocks, commodities, bonds, interests rates, ETFs, ETNs, ETCs, foreign currencies, etc.

“Multidimensional Bear” is an indicator that occurs when at least four of the eight risk dimensions, preferably at least five, Vertical Risk Dimension (hybrid zone range risk), Horizontal Time Risk (time duration risk), Trend Health Risk, Dynamic Sectional Price Risk (price perception risk), Sudden Market Spot Change Risk (internal market moving risk), Special Conditional Risk (multiple conditions risk), Fundamental Risk (economic event risk) and/or family and characteristic risk possibly occur at the same time.

“Multidimensional Bull” is an indicator that occurs when at least four of the eight risk dimensions, preferably at least five, Vertical Risk Dimension (hybrid zone range risk), Horizontal Time Risk (time duration risk), Trend Health Risk, Dynamic Sectional Price Risk (price perception risk), Sudden Market Spot Change Risk (internal market moving risk), Special Conditional Risk (multiple conditions risk), Fundamental Risk (economic event risk) and/or family and characteristic risk possibly occur at the same time.

“Neutral Believeness” is defined as a state of mind with input as provided by certain embodiments of the multidimensional risk analysis systems, certain Neutral Believers are more likely to exhibit “Neutral Believeness”, and thereupon are less likely to make poor decisions based on the provided information. With multidimensional risk analysis systems, those financial Market Vehicles that show true promise will likely thereby be supported by increasing purchases and trades, and those that do not will not be as strongly supported. As such, the widespread use of certain embodiments of the multidimensional risk analysis systems will help promote Neutral Believers to display neutral behavior relative to those financial vehicles that traders or users would be mutually benefitted by both bearish and Bullish Believeness.

“Neutral Believer Condition” is defined as a state of mind that may develop in trading when the various components of Trend Health Risk, such as, but not limiting scope to, internal health risk indicator and modified positive/negative indicator can be both aligned at the zero Boundary Lines at the same time or either one of them with modified neutral time segment and price perception risk, which are preferably for section “d”, As such may be for trading a market vehicle in any time frame that may comprise of tick to yearly or any combination of time frames.

“Neutral Spikes” are defined as Spikes that do not indicate either bullishness or bearishness within a market vehicle but rather a transition within a trend of a market vehicle. Neutral Spikes comprises of black transition Spikes.

“Nozzlelism to Hybrid Parallelism Transformation Point” is a configuration that occurs after the formation of halved hybrid nozzle, the mid zone line fails to intersect Blue Line or pivot lines, which causes it to form Hybrid Parallelism. If Hybrid Parallelism forms after this point, it becomes an attraction to those levels for the mid zone line as well as Blue Line or pivot line, and within the Hybrid Parallelism phase, this is likely. Such configuration serves as a forecasting tool and causes a breakout from this point. This provides the first evidence of pinpointing the area before the breakouts within the financial market for any market vehicle.

“Double Open-Ended Hybrid Zone Risk Transfer Area” is defined as the distance between zone line 1040 and the Blue Line 2381. It is an area where there can be an exchange between Bullish Believers and Bearish Believers“. The formation of the Double Open-Ended Hybrid Zone Risk Transfer Area occurs by: the Risk Transition Time Area for at least one Scheduled Event for a Specialized mid pivot on the left of Single Double Open-Ended Hybrid Zone and one on the right of an open area for Risk transition or Risk transfer; the Single Double Open-Ended Hybrid Zone Scheduled Risk Transfer Area between one angular Specialized mid pivot line either north or south, one mid Zone line and at least one Horizontal Specialized mid pivot line, for Risk Transfer from Bearish Believers to Bullish Believers or vice versa; at least one completed Single Double Open-Ended Hybrid Scheduled Risk Transfer Area; and at least one completed Single Double Open-Ended Hybrid Scheduled Risk Transfer Area, further comprising the formation of a Single Double Open-Ended Hybrid Scheduled Risk Transfer Area Risk Transfer from Bullish Believers to Bearish Believers and Bearish Believers to Bullish Believers with Risk assessment, Risk recognition, Risk confirmation, Risk designation, forecast and identifications, Multiple Ribbons, symbols and alerts, partially or in full during formation and/or at completion.

“Orange Oscillator” is an indicator that is used in conjunction with the trend health. The Orange Oscillator is based on the quotient of the aggregation of the current and historical strength or the weakness of a market based on either the open, high, low or close prices of the diminution of the nether value of the current and historical strength or weakness of a market based on either open, high, low or close prices to the aggregation of the immense value of the current and historical strength or weakness of a market based upon either the open, high, low, or close prices of the diminution of the nether value of the current and historical strength or weakness of a market based upon either the open, high, low, or close prices for the user selected time period. The Orange Oscillator is plotted onto its owns scale but also can be overlaid without a scale or is merged with a scale on either the right or left. When such indicator possibly crosses, Modified dynamic strength risk indicator, the bullish health risk directional indicator or bearish health risk directional indicator around the values of −4 to −6, a possibly new bullish trend can establish. A trader or user is aware of bullish directional line, scalp-swing trade setups or bullish recognition factors for entries. When the Orange Oscillator crosses modified dynamic strength risk indicator, the bullish health risk directional indicator or bearish health risk directional indicator around +4 to +6, a new bearish trend is established and look for bearish directional line, scalp-swing trade setups, or bearish recognition factors for entries.

“Reversals for Bears” is defined as a reversal signal in which a bullish trend becomes a bearish trend due to the alignment of multiple risk changes and confirmations. Reversal of such trends does not occur even with the appearance of such and other factors are taken into consideration, such as, for example, the dynamic hybrid zone lines. There are certain types of Reversals for Bears, which include, but not limiting scope to, bear reversal, Top Bear small or big, bull top, and excess bull to bear belief.

“Reversals for Bulls” is defined as a reversal signal in which a bearish trend become a bullish trend due to the alignment of multiple risk changes and confirmations. Reversal of such trends does not occur even with the appearance of such and other factors should be taken into consideration, such as, for example, the dynamic hybrid zone lines. There are certain types of Reversals for Bears, which include, but not limiting scope to, bull reversal, Bottom Bull small or big, bear bottom, and excess bear to bull belief.

“Scheduled Event of Blue Line” is defined as an event that occurs when a selected pivot type (for example, 60 minutes, daily, weekly, etc) either moves up or down on a vertical price scale or remains the same at the end of the selected time period for the selected pivot.

“Scheduled Event of Zone Line” is defined as an event that occurs when the scheduled Blue Line event intersects (or remains within the zone) with a zone line.

“Sections a, b, c, d, e, and ‘f” are defined as the various types of price perception risk. Sections “a”, “b”, and “c” are used to define price perception risk for Bullish Believers; Section “d” is used to define profit taking for Bullish Believers; Sections “e” and “f” are used to define price perception risk for Bearish Believers.

“Sections of Halved Hybrid Nozzlelism” are defined as sections that include, but are not limited to, Annularization section, halved convergence section, Halved hybrid nozzlelism parallelism section, Halved Hybrid Nozzlelism tipping section, post Halved Hybrid Nozzlelism confluence section, depending upon the types of Halved Hybrid Nozzlelism.

“Sequentized” is defined as a status of risks that have undergone the process of sequentizing. When applied to multidimensional risk analysis, it is considered that the multidimensional risks and subcategories of risk have been Sequentized.

“Sequentizing (Sequencing of Risks)” is defined as a process of sequencing multidimensional risks, in multidimensional risk analysis systems.

“Shape” is defined as an arrangement that is formed by joining lines together in a particular way.

“Shifting Point of Zone Lines” is defined as a point from which zone lines start to shift upwards or downwards, due to dynamic, adaptive changes within the market, as a result of changing in vertical market risk.

“Special Buy” is defined as a signal which occurs when all of the components or a portion of the major components of the modified health indicator align properly and are considered a bull entry special market condition.

“Special Bearish Market Conditions Risks” is defined as a special condition where the Bearish Believers take control from the Bullish Believers. It is further identified by observing a tan bearish candle, tan bearish candle + or tan bearish candle ++ in the observed timeframe and having a “wick formation” effect on higher time frame for the market vehicle under assessment. Tan bearish candle is an earlier entry indication for Bearish Believers at a reduced risk.

“Special Bullish Market Conditions Risks” is defined as special condition where the Bullish Believers take control from the Bearish Believers. It is further identified by observing a powder blue bearish candle, powder blue bearish candle + or powder blue bullish candle ++ in the observed timeframe and having a “wick formation” effect on higher time frame for the market vehicle under assessment. Powder blue bullish candle is an earlier entry indication for Bullish Believers at a reduced risk.

“Special Conditional Risk” is also known as “multiple conditions risk” and is defined as one of the eight dimensional risks in the multidimensional risk analysis systems. This conditional risk is based upon many special dynamic conditions that occurs within a market vehicle.

“Special Market Conditions for Bull and Bear Entries” are defined as conditions for bull entries and bear entries, in which multidimensional, multi-confirmation risk assessment is taken into consideration. There are certain types of bull entries for special market conditions, which include, but not limiting scope to, Special Buy, Magic In and Multidimensional Bull. There are certain types of bear entries for special market conditions, which include, but not limiting scope to, special sell, Magic Out and Multidimensional Bear.

“Spikes” are defined as either a dotted or solid triangle shaped object, of user choice, which are externally injected. It is observed in segments or in full and develop and show the dynamic changes within the market vehicle. It is also used as entries, exits or events, to obtain the trader or users attention.

“Squeezing of Zone Lines” is defined as the decrease in distance between the upper most and lower most zone lines. Over a period of time, when the market has very low volatility, the distance between all zone lines start to get smaller and smaller, thus creating a situation where modified health risk indicator cannot reach the Boundary Lines. The reduced distance between all zone lines are referred to as squeezing and it creates breakouts or breakdowns.

“Super Bearish Believer Entry” is defined as a condition which develops in trading when the various components of Trend Health Risk such as internal health risk indicator and modified positive/negative indicator have aligned below the zero Boundary Lines with modified bearish time segment and price perception risk, which are preferably for Sections “d”, “e”, or “f”, but only as such when both modified positive/negative indicator and Boundary Lines remain horizontal.

“Super Belief Neutral Pinpoint Entries (For Bearish Believers)” is defined as a condition which develops in trading when the various components of Trend Health Risk such as internal health risk indicator and modified positive/negative indicator are approaching the zero Boundary Lines from more positive to less positive within a short period of time, achieve a value of zero at the same time or within a very short period of time, and then become more negative. Such events are within either a modified neutral time segment or by two time segments side by side, such as modified bullish time segment next to modified bearish time segment. For example, a black neutral candle (overlaid by a tan colored candle for illustrative purposes), is observed during such events and price perception risk which are preferably for sections “e”, or “f” are at the zero boundary line. Such Super Belief Neutral Pinpoint Entries (For Bearish Believers) are observed with, for example, a tan bearish entry-(Me), wherein “f” is the price perception risk defined within the tan bearish candle and “−oex” serves as an indication that there is an extended previous bullish condition with a tan colored candle to indicate an exchange from Bullish Believers to Bearish Believers within the specified candle/bar under observation, hereby referred to as point “L”, and thereupon is considered a Super Belief Neutral Pinpoint Entries (For Bearish Believers).

“Super Belief Neutral Pinpoint Entries (For Bullish Believers)” is defined as a condition which develops in trading when the various components of Trend Health Risk such as internal health risk indicator and modified positive/negative indicator are approaching the zero Boundary Lines from more negative to less negative within a short period of time, achieve a value of zero at the same time or within a very short period of time, and then become more positive. Such events are within either a modified neutral time segment or by two time segments side by side, such as modified bearish time segment next to modified bullish time segment. For example, a black neutral candle or subsequent black candles/bars over a period of time, is observed during such events and price perception risk which are preferably for sections “a”, “b”, or “c” are at the zero boundary line. Such Super Belief Neutral Pinpoint Entries (For Bullish Believers) are observed with, for example, bullish DK yellow candle type a(M), wherein “a” is the price perception risk defined with a black colored candle to indicate an exchange from Bearish Believers to Bullish Believers within the specified candle/bar under observation, hereby referred to as point “N”, and thereupon is considered a Super Belief Neutral Pinpoint Entries (For Bullish Believers).

“Sudden Market Bearish Spot Risks” are defined as indicators that occur when a trend changes suddenly from bullish to bearish. Such candles either show the changes within a market as they occur or provide advanced warning. Such candles are used as a forecasting tool for future decision making. There are certain types of sudden market bearish spot risk candles, which include, but not limiting scope to, golden bearish candle and golden bearish candle+.

“Sudden Market Bullish Spot Risk” are defined as indicators that occur when a trend changes suddenly from bearish to bullish. Such candles either show the changes within a market as they occur or provide advanced warning. Such candles are used as a forecasting tool for possible future decision making. There are certain types of Sudden Market Bullish Spot Risk candles, which include, but not limiting scope to, turquoise bullish candle, turquoise bullish candle+, turquoise bullish candle++, and catalyst turquoise bullish candle.

“Sudden Market Spot Change Risk” is also known as internal market moving risk and is defined as one of the eight dimensional risks in the multidimensional risk analysis systems. It indicates sudden dynamic changes within a market vehicle, in a candle or bar observation for a particular selected time period.

“Super Bullish Believer Entry” is defined as a condition which develops in trading when the various components of Trend Health Risk such as internal health risk indicator and modified positive/negative indicator have aligned above the zero boundary line with modified bullish time segment and price perception risk, which are preferably for sections “a”, “b”, or “c”, but only as such when both modified positive/negative indicator and boundary line remain horizontal.

“Super Neutral Believer Entries” is defined as a condition which develops in trading when the various components of Trend Health Risk such as internal health risk indicator and modified positive/negative indicator have aligned at the zero boundary line with modified neutral time segment and price perception risk, which are preferably for neutral candles, but only as such when both modified positive/negative indicator and boundary line remain at zero for a time period under observation.

“Top Bear” is defined as the opposite of “Bottom Bull”. “Top Bear” comprises of the variations of trough bars and stochastic values of relative strength index is approximately near zero between to three to five periods.

“Trend Development and Recognition with Hybrid Zone Lines” is applicable to Hybrid Dynamic Zone Lines, Hybrid Parallelism, hybrid zone risk transfer areas, hybrid confluence, and Halved Hybrid Nozzlelism. Many scalp-swing trade setups, favorable bullish recognition factors and/or bearish recognition factors which are used for the enhancement of scalp-swing trading opportunities to conduct mega-scalp swing using trend development.

“Trend Health Risk” is defined as one of the eight dimensional risks in the multidimensional risk analysis systems and comprises of internal health risk indicator and modified positive/negative indicator

“Two-dimensional” is defined as an object that consists of more than one line that exist on a plane. They have measurable dimensions when placed on an x-y axis.

“Unscheduled Event of Zone Line” is defined as an event when a selected zone line either moves above or below a Blue Line (pivot line) on a vertical price scale. The zone line movement in this case does not wait for the end of the selected time period of the Blue Line (pivot line).

“Vertical Risk Dimension” is also known as the zone range risk or hybrid zone range risk and is defined as one of the eight dimensional risks in the multidimensional risk analysis systems.

“Warning Spot For First Turquoise PH Line (Bear To Bull)” is defined as a configuration which occurs where the post, where Halved Hybrid Nozzlelism Convergence ends and where halved Annularization starts. This is referred to as a “break out” or the making of new highs for lower left Halved Hybrid Nozzlelism Convergence and upper right Halved Hybrid Nozzlelism Divergence. “PH” indicates higher prices of a market vehicle.

“Warning Spot For First Gold PL Line (Bull To Bear)” is defined as a configuration which occurs where the post, where Halved Hybrid Nozzlelism Divergence ends and where halved Annularization starts. This is referred to as a “breakdown” or the making of new lows for upper left Halved Hybrid Nozzlelism Convergence and lower right Halved Hybrid Nozzlelism Divergence. “PL” indicates lower prices of a market vehicle.

Symbology

A trader or user understands the following designations, which are further referenced with the Users

Manual:

“Bear Bottom”: Shown by a blue colored diamond, indicating that bottoming is approaching but with a different type of risk analysis, comprising of different indicators.

“Bear Entry Spike”: Shown by a red dotted spike in the multicolored Candlestick Spectrum, indicating a directional bearish pinpoint entries.

“Bear Reversal”: Shown by a pink colored “R” and a pink colored arrow underneath such “R”, indicating a reversal from bullish to Bearish Believer Condition.

“Bear Spot Risk Line” : Shown by a vertical red line in the multicolored Candlestick Spectrum, indicating a bearish spot risk.

“Bear Warning:Shown by either an indigo colored candle and/or with a brown colored arrow with

“Bew” symbol.

“Big Scale Bearish Candle”: Shown by a pink colored candle and/or a pink colored arrow with a “Mpb” symbol.

“Big Scale Bullish Candle”: Shown by a gray colored candle and/or a gray colored arrow with “Mgb” symbol.

“Blue Continuation Spikes”: Shown by a blue dotted spike in the trend health window, indicating a continuation of the current trend, either in the bullish or bearish direction.

“Bottom Bull Small or Big”: Shown by a dark yellow northeast arrow with a “Bu” symbol underneath such arrow, indicating that bottoming is reaching within a market vehicle and a reversal of the previous bearish trend.

“Bull Entry Spike”: Shown by a green dotted spike in the multicolored Candlestick Spectrum, indicating directional bullish pinpoint entries.

“Bull Reversal”: Shown by a blue colored “R” and a blue colored arrow on top of such “R”, indicating a reversal from bearish to Bullish Believer Condition.

“Bull Spot Risk Line”: Shown by a vertical green line in the multicolored Candlestick Spectrum, indicating a bullish spot risk.

“Bull Top”: Shown by a red colored diamond, indicating that topping out is approaching but with a different type of risk analysis, comprising of different indicators.

“Bull Warning”: Shown by either a yellow colored candle and/or a with blue colored arrow with “Bw” symbol.

“Core Boundary Lines”: Shown by horizontal dashed gray lines in the trend health window.

“Directional Line Bear”: Shown by a thick vertical red line in the trend health window, indicating a strong Bearish Believers trend direction.

“Directional Line Bull”: Shown by a thick vertical green line in the trend health window, indicating a strong Bullish Believers trend direction.

“Economic Event Spikes”: Shown by a blue lined spike in the multicolored Candlestick Spectrum, indicating an economic event, either single or multiple, has taken place during the time of trading. Multiple economic events are seen with a thicker blue lined spike.

“Excess Bear to Bull Belief”: Shown by a purple colored thumbs up on top of a “Be-b” symbol, indicating bottoming is becoming established and bullish direction or retracement takes place.

“Excess Bull to Bear Belief”: Shown by a dark green colored thumbs down underneath a “B-be” symbol, indicating topping out is becoming established and bearish direction or retracement takes place.

“f”: Dynamic Sectional Price Risk type “f”; no additional catalysts; bearish direction shown by an arrow with red color.

“Gb”: Golden colored candle; bearish direction shown by a golden colored arrow.

“Gold PL Line”: Shown by a goldish colored vertical line in the trend health window, indicating a low (forecasting lower levels of a market vehicle in the next time period).

“Health Risk Directional Indicator-Bearish”: Shown by a red colored line in the trend health window.

“Health Risk Directional Indicator-Bullish”: Shown by a green colored line in the trend health window. “Internal Health Risk Indicator”: Shown by a blue colored line in the trend health window.

“Inner Market Family Risk Composite Index”: Shown by a red colored line in the family and characteristics risk window.

“Inner Market Family Risk Index”: Shown by a blue colored line in the family and characteristic risk window.

“Lower Most Boundary Lines”: Shown by horizontal dashed gray lines in the trend health window.

“Magic In”: Shown by a blue colored thumbs up on top of a blue colored “Mgi” symbol, indicating a bull entry based on special market conditions risk.

“Magic Out”: Shown by a reddish-brown colored thumbs down underneath a reddish-brown colored “Mgo” symbol, indicating a bear entry based on special market conditions risk.

“Magic Wave”: Shown by a thick dark gray colored line in the multicolored Candlestick Spectrum.

“Modified Dynamic Strength Risk Indicator”: Shown by a dotted black colored line in the trend health window.

“Modified Positive/Negative Indicator”: Shown by a purple colored line in the trend health window.

“Multi Dimensional Bear” Shown by a black colored number “2” on top of a thick, large red colored arrow, indicating an alignment of at least four of the eight risk dimensions occurring at the same time.

“Multi Dimensional Bull” Shown by a black colored number “1” underneath a thick, large blue colored arrow on top, indicating an alignment of at least four of the eight risk dimensions occurring at the same time.

“Neutral Candle”: Shown with a black color.

“Orange Oscillator”: Shown by an orange colored line in the trend health window.

“Pa”: Dynamic Sectional Price Risk type “a”; “p” for the inventors signature; bullish direction shown by an arrow with dark yellow color.

“Pb++”: Dynamic Sectional Price Risk type “b”; “++” represent additional two catalysts; “p” for the inventors signature; bullish direction shown by an arrow with bright green color (Note: Three plus signs shows three additional catalysts).

“Pc”: Dynamic Sectional Price Risk type “c”; “p” for the inventors signature; no additional catalysts; bullish direction shown by an arrow with dark green color.

“Pd++with purple thumbs up”: Dynamic Sectional Price Risk type “d”; “p” for inventors signature; purple thumbs up shows possible upward direction; “++” shows two additional catalysts (NOTE: Bigger the thumb, the more possible catalysts involved, indicating possibly more bullish believers entering into trades. Thumbs down represents possibly more Bearish Believers entering trades).

“Pe+”: Dynamic Sectional Price Risk type “e”; “p” for the inventors signature; “+” for one additional catalyst; bearish direction shown by an arrow with brown color.

“Powder Blue (C) Bullish Candle” (Special Bullish Market Condition Risk Earlier Entries): Shown by a powder blue colored candle and/or a blue colored arrow with “oex” which serves as an indication that there is an extended previous bearish condition; no additional catalysts.

“Risk Transition Lines”: Shown by a purple-blue vertical line in the trend health window, indicating scheduled and unscheduled events of the Blue Line, indicating risk in transition.

“Special Buy”: Shown by a dark yellow colored arrow with a “Sb” symbol underneath such arrow, indicating a pinpoint bull entry based on special market conditions risk.

“Special Sell”: Shown by a pink colored arrow with a “SS” symbol on top of such arrow, indicating a pinpoint bear entry based on special market conditions risk.

“Super Bearish Belief Contra-Re-” (Super Belief Pin Point Reversals for Bears to Bulls): Shown by a circled orange colored number “2” symbol with “re-” noted below such orange circle, which indicates pinpoint reversals of Bearish Believers to take some profits and turns into retracements; −re1 indicates an additional strong reversal risk involved; −re2 indicates at least two additional reversal risks involved in analysis.

“Super Bullish Belief Contra +Re” (Super Belief Pin Point Reversals for Bulls to Bears): Shown by a circled green colored number “1” symbol with “re” noted above such green circle, which indicates pin point reversals of Bullish Believers to take some profits and turns into retracements; +re1 indicates an additional strong reversal risk involved; +re2 indicates at least two additional reversal risks involved in analysis.

“Tan Bearish Candle ++” (Special Bearish Market Condition Risk Earlier Entries): Shown by a tan colored candle and/or a light brown colored arrow with an “−oex” which serves as an indication that there is an extended previous bullish condition with two additional catalysts.

“Tb+”: Turquoise colored candle with one additional catalyst; bullish direction shown by a bluish colored arrow.

“Top Bear Small or Big”: Shown by an orange southeast arrow with a “Be” symbol on top of such arrow, indicating that topping out is reaching within a market vehicle and a reversal of the previous bullish trend.

“Transition Bull”: Shown by a bull symbol.

“Transition Spikes”: Shown by a black dotted spike in the trend health window, indicating a transition between Bullish Believer direction to Bearish Believer direction or vice versa.

“Turquoise PH Line”: Shown by a turquoise colored vertical line in the trend health window, indicating a high (forecasting higher levels of a market vehicle in the next time period).

“Upper Most Boundary Lines”: Shown by horizontal dashed gray lines in the trend health window.

“Yellow Ext Bull Warning Line”: Shown by a thick vertical yellow line in the multicolored candlestick spectrum, indicating a warning from extended Bearish Believers to convert into Bullish Believers and may have a retracement or change in direction.

“Yellow Ext Bear Warning Line”: Shown by a thick vertical pink line in the multicolored candlestick spectrum, indicating a warning from extended Bullish Believers to convert into bearish believers and have a retracement or change in direction.

A trader or user is alerted by all important events as illustrated by a yellow triangle or any trader or user desired colors or shapes. All important events have alerts that are selected by a trader or user can have alerts may be and are sent via electronic mail, PDA's, or by audio/visual alert on chart during trading.

Any components or combination of components of multidimensional risk systems are automated by a trader or user through the use of robots, or any other automation methods and apparatus.

A trader or user uses historical data and end of the day data with the multidimensional risk analysis systems, however the results are subject to variation in comparison with using real time data.

A trader or user understands that the learning of the multidimensional risk analysis systems and methods is best learned by use of colored drawings within this disclosure.

A trader or user skilled in the art creates their own market data software that would enable one skilled in the art to accomplish the invention.

Although applicant has described applicants preferred embodiments of this invention, it will be understood that the broadest scope of this invention includes modifications such as diverse shapes, sizes, and materials. Such scope is limited only by the below claims as read in connection with the above specification. Further, many other advantages of applicants invention will be apparent to those skilled in the art from the above descriptions and the below claims.

What is claimed is:

1. A computer method, relating to real-time market analysis through multi dimensional, multi-confirmation risk assessment, risk recognition, risk allocation, and risk transfer system, comprising the steps of:
a) dynamically calculating and displaying, by such at least one specific purpose-computer, a specialized mid pivot of an at least one higher time frame;
b) processing, by at least one specific purpose computer, equipped with a Risk analyzer, a Risk processor, a Risk assessor, a Risk Designator, which further comprises processors including an internal market moving risk, economic event risk, a multiple conditions risk, price perception risk, time duration risk, trend risk, zone range risk, family and characteristic risk; multiple displays and multiple memories, and servers; capable of analyzing data, creating, displaying, and changing shapes, multiple ribbons, patterns, multiple symbols, Risk Dimensions with numbering, multiple colors, alerts, exploration, with at least one real-time market feed with real-time market data; and
c) dynamically calculating and displaying, by such at least one specific purpose computer, vertical risk components of at least one lower time frame; and observing in real time, the formation of a Halved Hybrid Nozzlelism shape at least partially in response to the relationship (relative price positions) between said dynamically calculating and displaying specialized interjected mid pivot of the at least one higher time frame as taken with respect to said dynamically calculating and displaying vertical risk components of at least one lower time frame comprising:
c.1). real-time analyzing and dynamically calculating, by such at least one specific purpose computer, current values of at least one combination of one interjected Specialized pivot and seven Zone lines creating eight Hybrid Dynamic Zone lines and at least one Hybrid Dynamic Risk Zones, with relative price position with each other, including angular movement of Interjected Hybrid mid pivot, on a vertical, market vehicle price scale;
c.2). real-time displaying, by such at least one specific purpose computer, mid zone line, a components of Hybrid Dynamic Zone lines of a Lower time frame, combining with an Interjected Specialized mid pivot of a Higher time frame, creating a Hybrid, for the Halved Hybrid Nozzlelism; and
c.3). real-time displaying, by such at least one specific purpose computer, at least one Halved Hybrid Nozzlelism shape partially or in full, with concentration of either Bullish Believers, Bearish Believers, or Neutral Believers along with a Risk assessment, a Risk recognition, a Risk confirmation, a Risk designation, a Risk transfer, a Risk assignment, forecast, identifications, symbols and alerts, during formation and/or at completion of various types and components of Halved Hybrid Nozzlelism, wherein the specific purpose computer is configured to provide for digital information transmissions between the processor which runs one or a number of processes, circuits, and memory to perform the operation of a multidimensional risk analysis system.

2. The method of claim 2, further comprising at least one Scheduled Event of an Interjected Specialized mid pivot comprising the steps of:
a). real-time dynamically calculating and displaying, by such at least one computer, the formation of at least one repeating of a Scheduled Event of a Dynamically moveable Interjected Specialized mid pivot comprising:
1). displaying, bysuch at least one computer, an Interjected Specialized mid pivot in horizontal position, on a vertical price scale, prior to angular movement; and
2). displaying, bysuch at least one computer, on a Pre-selected Scheduled time, an angular movement, of at least one Interjected Specialized mid pivot of a higher time frame, with or without crossing at least one or more of the seven Zone lines of Vertical Risk of a lower time frame, within at least one of the six Hybrid Dynamic Risk Zones, in either an upward direction, at an angle facing north, or in a downward direction at an angle facing south, within the last segment of a lower time frame period of Hybrid Dynamic Zone line; and
b). real-time dynamically calculating and displaying, by such at least one computer, a completed Scheduled Event of an Interjected Specialized mid pivot either angle north or angle south.

3. The method of claim 2, further comprises at least one Unscheduled Event of an Interjected Specialized mid pivot, comprising the steps of:
a). real-time dynamically calculating and displaying, by such at least one computer, the formation of at least one Unscheduled Event of a dynamically moving Hybrid Dynamic Zone line, comprising:
1). real-time dynamically calculating and displaying intersection of at least one selected Hybrid Dynamic Zone line, to the horizontal position of Interjected Specialized mid pivot, in any direction, on a Vertical price scale of a market vehicle on Unscheduled time; and
2). real-time dynamically calculating and displaying, by such at least one computer, Completed Unscheduled Event of at least one Zone line, intersecting with specialized mid pivot causing at least one Risk Transition and creating at least one Risk Transition line which contributes to the formation of at least one Risk Transition Time Area; and
b). real-time dynamically calculating and displaying, by such at least one computer, Unscheduled Event of at least one mid Zone line, without the Scheduled Event of Interjected Specialized mid pivot, during formation of Tipping Area for Halved Hybrid Nozzlelism, Halved Hybrid Confluence, and Halved Hybrid Parallelism.

4. The method of claim 3 , further comprises at least one Risk Transition Time Area for a Scheduled Event of Interjected Specialized mid pivot, comprising the steps of:
I). real-time dynamically calculating and displaying, by such at least one computer, at least one Risk Transition Time Area comprising:
a). real-time dynamically calculating and displaying, by such at least one computer, the formation of at least one repeating Scheduled Event of a Dynamically moveable Specialized mid pivot; and
b). real-time dynamically calculating and displaying, by such at least one computer, at least one completed Scheduled Event of Interjected Specialized mid pivot, participating in forming at least one Risk Transition time area;
II). real-time dynamically calculating and displaying, by such at least one computer, at least one completed Risk Transition Time Area for at least one Scheduled Event of Interjected Specialized mid pivot participating in forming an open or closed Risk transfer area;
III). real-time dynamically calculating and displaying, by such at least one computer Risk Transition Time Area for at least one Scheduled Event of Interjected Specialized mid pivot, participating in forming at least one type of Halved Hybrid Nozzlelism, Hybrid Confluence, or Hybrid Parallelism; and
IV). real-time displaying, by such at least one computer, Risk assessment, Risk recognition, Risk confirmation, Risk designation, forecast and identifications, Multiple Ribbons, symbols and alerts, partially or in full during formation and/or at completion of Risk Transition Time Area for at least one Scheduled Event of Interjected Specialized mid pivot.

5. The method of claim 1, further comprises at least one Risk Transition Time Area for Unscheduled Event of a Zone line, comprising the steps of:
1). real-time displaying, by such at least one computer, at least eight Hybrid Dynamic Zone lines, at least three Lower Hybrid Dynamic Risk Zones, and at least three Upper Hybrid Dynamic Risk Zones with their relative price position with each other on a vertical market vehide price scale;
2). displaying the Unscheduled time, for at least one to three units of lower time frames and displaying an area for Halved Hybrid Parallelism formation at the intersection of selected Hybrid Dynamic Zone line, having Risk transition or transfer from either Bullish to Bearish Believers or Bearish to Bullish Believers, during the formation of different types of Halved Hybrid Nozzlelism;
3) real-time dynamically calculating and displaying, by such at least one computer, at least one Risk Transition Time Area and one Risk transition line for at least one completed Unscheduled Event of selected Zone line, after nozzle tipping formation, Halved Hybrid Confluence formation and Halved Hybrid Parallelism formation, during formation of different types of Halved Hybrid Nozzlelism; and
4). real-time displaying, by such at least one computer, Risk assessment, Risk recognition, Risk confirmation, Risk designation, forecast and identifications, Multiple Ribbons, symbols and alerts, partially or in full during formation and/or at completion of one Risk Transition Time Area for Unscheduled Event of a Zone line.

6. The method of claim 1, further comprising at least one Double Open-Ended Hybrid Zone Scheduled Risk Transfer Area comprising the steps of:
a.1).creating and displaying, by at least one such computer, the Risk Transition Time Area for at least one Scheduled Event for a Specialized mid pivot on the left of Double Open-Ended Hybrid Zone and one on the right of an open area for Risk transition or Risk transfer;
a.2). creating and displaying, by at least one such computer, the Double Open-Ended Hybrid Zone Scheduled Risk Transfer Area between one angular Specialized mid pivot line either north or south, one mid Zone line and at least one Horizontal Specialized mid pivot line, for Risk Transfer from Bearish Believers to Bullish Believers or vice versa;
a.3). real-time displaying, by at least one such computer, at least one completed Double Open-Ended Hybrid Scheduled Risk Transfer Area; and
b). real-time displaying at least one completed Double Open-Ended Hybrid Scheduled Risk Transfer Area, further comprising the formation of a Double Open-Ended Hybrid Scheduled Risk Transfer Area Risk Transfer from Bullish Believers to Bearish Believers and Bearish Believers to Bullish Believers with Risk assessment, Risk recognition, Risk confirmation, Risk designation, forecast and identifications, Multiple Ribbons, symbols and alerts, partially or in full during formation and/or at completion.

7. The method of claim 1, further comprises at least one Double Open-Ended Hybrid Zone Risk Transfer Area, comprising the steps of:
1). real-time forming and displaying, by such at least one computer, at least two consecutive Scheduled Event of an Interjected Specialized mid pivot of a higher time frame, with angular movement;
2). real-time forming and displaying, by such at least one computer, at least one, mid Zone line, of a lower time frame, staying horizontal, parallel, above, or below to Interjected Specialized mid pivot on a vertical Price scale and at least one, Hybrid Dynamic Risk Zone of a selected market vehicle;
3). real-time forming and displaying, by such at least one computer, at least two Halved Hybrid Parallelisms connecting angular movements of Interjected Specialized mid pivot, of a higher time frame and the Risk Transition Time Area for at least two Scheduled Events for a Specialized mid pivot, for Risk Transition or Risk transferring;
4). real-time displaying, by such at least one computer, at least one Double Open-Ended Hybrid Zone Risk Transfer Area between two angular Interjected Specialized mid pivot lines, one mid Zone line and Horizontal Specialized pivot line, connected by Hybrid Parallelism, for Risk Transfer from Bearish Believers to Bullish Believers or vice versa; and
5) real-time displaying, by such at least one computer, at least one completed -Double-Open-Ended Hybrid Zone Risk Transfer Area, for Risk Transfer from Bearish Believers to Bullish Believers or vice versa with Risk assessment, Risk recognition, Risk confirmation, Risk designation, forecast and identifications, Multiple Ribbons, symbols and alerts, partially or in full during formation and/or at completion.

8. The method of claim 1, further comprising at least one -Double Open-Ended Hybrid Zone Risk Transfer Area comprising the steps of:
1). real-time displaying, by such at least one computer, at least eight Hybrid Dynamic Zone lines, at least three Lower and at least three Upper Hybrid Dynamic Risk Zones with their relative price position with each other on a vertical market vehicle's price scale;
2). real-time forming and displaying, by such at least one computer, at least two consecutive Scheduled Event of an Interjected Specialized mid pivot of a higher time frame, with angular movement and at least one, mid Zone line, of a lower time frame, staying horizontal, parallel, above, or below to Interjected Specialized mid pivot, of a selected market vehicle;
3). real-time forming and displaying, by such at least one computer, at least one, Hybrid Dynamic Risk Zone either from Upper or Lower three Hybrid Risk Zone and the Risk Transition Time Area for at least two Scheduled Event for an Interjected Specialized mid pivot, for Risk transition or Risk transferring; and
4). real-time forming and displaying, by such at least one computer, at least one completed—Double Open-Ended Hybrid Zone Risk Transfer Area between two angular Interjected Specialized mid pivot lines, at least one mid Zone line and Horizontal Specialized Interjected mid pivot line, for Risk Transfer from Bullish Believers to Bearish Believers or vice versa; and with Risk assessment, Risk recognition, Risk confirmation, Risk designation, forecast and identifications, Multiple Ribbons, symbols and alerts, partially or in full during formation and/or at completion.

9. The method of claim 1, further comprising a Trend Direction Recognition for Bullish Believers, Bearish Believers, and Neutral Believers comprising the steps of;
1). real-time displaying, by such at least one computer, at least eight Hybrid Dynamic Zone lines, at least three Lower and at least three Upper Hybrid Dynamic Risk Zones with their relative price position with each other on a vertical market vehide price scale and at least one Scheduled Event of Interjected Specialized mid pivot of a higher time frame with angular movement;
2). calculating and displaying, by such at least one computer, a series of at least three or more consecutive Scheduled Events of Interjected Specialized mid pivot, intersecting Hybrid Dynamic Zone lines from Hybrid Dynamic Zones, at the completion of each Scheduled Event of Specialized mid pivot for Bullish Believers for Bullish trend direction and Bearish Believers, for Bearish trend direction;
3). calculating and displaying, by such at least one computer, a series of mixtures of two or less consecutive Scheduled Event of Interjected Specialized mid pivot, at angle, intersecting Hybrid Dynamic Zone lines from Upperto Lower Hybrid Dynamic Zones, then from Lower to Upper Hybrid Dynamic Zones or vice versa, at the completion of each Scheduled Event of Interjected Specialized mid pivot for Neutral Believers, for Neutral trend direction; and
4). displaying, by such at least one computer, at least three steps of consecutive Scheduled Events with angle, a Recognizing Trend Direction Development for Bullish Believers; and for Bearish Believers and a series of mixtures of two or less steps of consecutive Scheduled Event with angle South or north, Recognizing Trend Direction Development for Neutral Believers; and with Risk recognition, Risk confirmation, Risk designation, forecast and identifications, Multiple Ribbons, symbols and alerts, partially or in full during Trend Direction Development.

10. The method of daim 1, further comprises Forecasting of Earlier Highs and Earlier Lows with a Risk Assessment and a Risk Designation, comprising the steps of:
1). real-time displaying, by such at least one computer, at least one shilling of at least one Upper most Hybrid Dynamic Zone line or mid Zone line, in Upward direction for Earlier Highs and at least one Lower most Hybrid Dynamic Zone line or mid Zone line, in Downward direction for Earlier Lows;
2). real-time displaying, by such at least one computer, adaptive sectional price perception Risk dimension indicators;
3). real-time displaying, by such at least one computer, Risk designators based on Risk assessment, lowest number designation with lowest Risk and highest number with highest Risk;
4). real-time displaying, by such at least one computer, forecasting of Possible Earlier high with symbol of circled “3” and forecasting of Possible Earlier High with symbol of circled “4”;
5). real-time displaying, by such at least one computer, adaptive sectional price perception Risk dimension indicators, with Risk designators, upon formation of at least one section of Halved Hybrid Nozzlelism and/or at shilling of Upper most Zone line in north direction for Earlier highs and in south direction for earlier lows; and
6). Displaying and Forecasting, by at least one such computer, assessing Risk with designation numbers for at least one type of section of a Halved Hybrid Nozzlelism or at least one type of a Halved Hybrid Nozzlelism with concentration of Bullish Believers for at least one Earlier High with concentration of Bearish Believers for at least one Earlier lows along with a Risk assessment, a Risk recognition, a Risk confirmation, a Risk designation, forecast and identifications, Multiple Ribbons, symbols and alerts, partially or in full during formation and/or at completion.

11. The method of claim 1, further comprising Forecasting of Possible Highs with Warning Spots For a First Turquoise Line and Possible Lows with Warning Spots For First Gold Line comprising the steps of:
1). real-time displaying, by such at least one computer, at least one Modified Health Indicator;
2). real-time displaying, by such at least one computer, at least one shilling of mid Zone line in Upward direction, prior to first shilling of Uppermost Hybrid Dynamic Zone line in Upward direction forforecasting of possible high and in downward direction, prior to first shilling of Lower most Hybrid Dynamic Zone line in downward direction for forecasting of possible low;
3). real-time displaying, by such at least one computer, at least one adaptive sectional price perception Risk dimension indicators, Risk designators based on Risk assessment, a Lowest number designation with a Lowest Risk and a Highest number with a Highest Risk, for a selected market vehide;
4). real-time displaying, by such at least one computer, upon formation of at least one section of a Halved Hybrid Nozzlelism and then displaying shilling of Uppermost Zone line in Upward direction for forecasting possible high and upon formation of at least one section of Halved Hybrid Nozzlelism and then displaying shifting of an Uppermost Zone line in downward direction; and
5). real-time displaying, by such at least one computer, at least one forecasting a Possible High with a vertical Turquoise Warning Spot line and at least one forecasting a Possible Low with a vertical Gold Warning Spot line, within at least one Modified Health Indicator and at least one Warning Spot for First Turquoise Possible High line, with concentration of Bullish Believers and at least one Warning Spot for First Gold Possible Low line, with concentration of Bearish Believers, showing breakout, for at least one type of section of a Halved Hybrid Nozzlelism along with a Risk assessment, a Risk recognition, a Risk confirmation, a Risk designation, forecast and identifications, Multiple Ribbons, symbols and alerts, partially or in full during formation and/or at completion.

12. The method of claim 1, further comprising at least one Breakout for Bullish Trend Development using Turquoise Possible Highs (PH) Lines and Breakout Bearish Trend Development using Gold Possible Low (PI) Lines comprising the steps of:
1). real-time displaying, by such at least one computer, at least eight Hybrid Dynamic Zone lines, at least one Hybrid Dynamic Risk Zones with their relative price position with each other on a vertical market vehicle price scale ; and at least one adaptive sectional price perception Risk dimension indicators;
2). real-time displaying, by such at least one computer, at least one adaptive sectional price perception Risk dimension indicator, upon formation of at least one section of a Halved Hybrid Nozzlelism and then displaying shilling of an Upper most Zone line Upward for a Bullish Trend and displaying shilling of a lowermost Zone line Downward for Bearish Trend;
3). real-time displaying, by such at least one computer, at least one forecasting of a Possible High with vertical Turquoise Warning Spot line and at least one forecasting of a Possible Low with vertical Gold \Naming Spot line, within at least one Modified Health Indicator;
4) displaying and forecasting, by at least one such computer, at least one Warning Spot for First Turquoise Possible High line, with concentration of Bullish Believers, showing breakout, and at least one Warning Spot for First Gold Possible Low line, with concentration of Bearish Believers, showing breakout, for at least one type of section of a Halved Hybrid Nozzlelism;
5). real-time displaying, by such at least one computer, after formation of at least one Warning Spot for First Turquoise Possible High line, displaying additional Turquoise Possible High line and after formation of at least one Warning Spot for First Gold Possible High line, for normal breakout, medium breakout and for Powerful Bullish Trend development and for Powerful Bearish Trend development respectively; and
6). real-time displaying, by such at least one computer, at least one extended Pink bear warning, for exhaustion of Bullish trend and at least one extended Yellow bull warning, for exhaustion of Bearish trend along with Risk assessment, Risk recognition, Risk confirmation, Risk designation, forecast and identifications, Multiple Ribbons, symbols and alerts, partially or in full during formation and/or at completion.

13. The method of claim 1, further comprising a Halved Hybrid Parallelism, which comprises:
1). dynamically calculating and displaying, at least eight Hybrid Dynamic Zone lines, at least one Hybrid Dynamic Risk Zones with their relative price position with each other and a component of a Vertical Risk dimension, of a Lower time frame, remaining Parallel to and Higher or Lower in price values comparing at least one Interjected Specialized mid pivot of a Higher time frame with a very limited distance on a vertical scale;
2). real-time displaying, by such at least one computer, relative price position of components of mid Zone line for a Lower time frame, with respect to at least one Interjected Specialized mid pivot and with Downward or Upward shilling of at least one mid Zone lines of a Lower time frame, along with any remaining Hybrid Dynamic Zone lines;
3). real-time displaying, by at least one such computer, at least one Unscheduled intersection of mid Zone line or at least one Unscheduled Event of mid Zone line in Risk Transition Time Area for at least one Unscheduled intersection;
4). real-time displaying, by at least one such computer, at least one scheduled intersecting Event of Interjected Specialized Mid pivot with angular movement, of a Higher Time frame, with at least one mid Zone line of a Lower time frame;
5). real-time displaying, by such at least one computer, components of mid Zone lines of a Lower time frame, combining with Interjected Specialized mid pivot of a Higher time frame, creating “Hybrid”, for Halved Hybrid Parallelism and forming the area for Halved Hybrid Parallelism, between one mid Zone line, an Interjected Specialized mid pivot, an angular side of Interjected Specialized mid pivot either north or south, or an intersection of a mid Zone line to a Specialized Interjected mid pivot, using a Hybrid; and
6). real-time displaying, by such at least one computer, formation of at least one type of a Halved Hybrid Parallelism shape, with concentration of at least one Bullish Believer area or at least one Bearish Believers Area and completed at least one type of completed shape of a Halved Hybrid Parallelism with a Risk assessment, a Risk recognition, a Risk confirmation, a Risk designation, forecast and identifications, Multiple Ribbons, symbols and alerts, partially or in full during formation and/or at completion of various types of Hybrid Parallelism.

14. The method of daim 1, further comprising a Halved Hybrid Confluence;
1). dynamically calculating and real-time displaying, by such at least one computer, at least eight Hybrid Dynamic Zone lines, at least one Hybrid Dynamic Risk Zones with their relative price position with each other and selected mid Zone line, a component of Vertical Risk dimension, of a Lower time frame, remaining Parallel to and Higher or Lower in price values comparing at least one Interjected Specialized mid pivot of a Higher time frame with a very dose visible distance or close to zero distance on a vertical market vehicle price scale;
2). real-time displaying, by such at least one computer, relative price position of components of-mid Zone line for a Lower time frame, with respect to at least one Interjected Specialized mid pivot and Downward or Upward shilling of at least one mid Zone lines of a Lower time frame, along with remaining Hybrid Dynamic Zone lines;
3). real-time displaying, by at least one such computer, at least one Unscheduled intersection of mid Zone line or at least one Unscheduled Event of mid Zone line in Risk Transition Time Area for at least one Unscheduled intersection and at least one Scheduled intersecting Event of Interjected Specialized mid pivot with angular movement, of a Higher Time frame, with at least one mid Zone line of a Lower time frame;
4). real-time displaying, by such at least one computer, components of mid Zone lines of a Lower time frame, combining with Interjected Specialized mid pivot of a Higher time frame, creating “Hybrid”, for Halved Hybrid Confluence and creating the area for Halved Hybrid Confluence, between one mid Zone line, an Interjected Specialized pivot, an angular side of Interjected Specialized mid pivot either north or south, or an intersection of mid Zone line to Interjected Specialized mid pivot, using a Hybrid; and
5). real-time displaying, by such at least one computer, formation of at least one type of Halved Hybrid Confluence shape with concentration of at least one Bullish Believers area or at least one Bearish Believers Area and at least one type of completed shape of Halved Hybrid Confluence with a Risk assessment, a Risk recognition, a Risk confirmation, a Risk designation, forecast and identifications, Multiple Ribbons, symbols and alerts, partially or in full during formation and/or at completion of various types of a Hybrid Confluence.

15. The method of claim 1, further comprising a Halved Hybrid Nozzlelism, comprising the steps of:
1). real-time displaying, by such at least one computer, at least eight Hybrid Dynamic Zone lines, at least one Hybrid Dynamic Risk Zones with their relative price position with each other on a vertical price scale of a selected market vehide and a component of Vertical Risk dimension, of a Lower time frame, remaining Higher or Lower in price values comparing at least one Interjected Specialized mid pivot;
2). real-time displaying, by such at least one computer, relative price position of components of a mid Zone line for a Lowertime frame, with respect to an Interjected Specialized mid pivot;
3). real-time displaying, by such at least one computer, Downward or Upward shilling of at least one mid Zone line of a Lowertime frame, along with remaining Hybrid Dynamic Zone lines;
4). real-time displaying, by at least one such computer, at least one Unscheduled intersection of mid Zone line or at least one Unscheduled Event of mid Zone line in Risk Transition Time Area for at least one Unscheduled intersection;
5). real-time displaying, by at least one such computer, at least one Scheduled intersecting Event of Interjected Specialized mid pivot with angular movement, of a Higher Time frame, with at least one mid Zone line of a Lower time frame;
6). real-time displaying, by such at least one computer, components of mid Zone lines of a Lower time frame, combining with Interjected Specialized mid pivot of a Highertime frame, creating “Hybrid”, for Halved Hybrid Nozzlelism resulting in the formation of different sections of Halved Hybrid Nozzlelism shape, using “Hybrid”, with concentration areas of either Bullish Believers, or Bearish Believers or Neutral Believers; and
7). real-time dynamically calculating and displaying, by such at least one computer, at least one completed Halved Hybrid Nozzlelism shape, using sections of Halved Hybrid with Risk assessment, a Risk recognition, a Risk confirmation, a Risk designation, forecast and identifications, Multiple Ribbons, symbols and alerts, partially or in full during formation and/or at completion of various types of Halved Hybrid Nozzlelism.

16. A computer method according to claim 15, further comprises at least one Lower Left Halved Hybrid Nozzlelism, which comprises the steps of:
1). dynamically calculating and displaying, by such at least one computer, at least eight Hybrid Dynamic Zone lines, at least one Hybrid Dynamic Risk Zones with their relative price position with each other on a vertical price scale of a selected market vehide and a component of Vertical Risk dimension, of a lower time frame, remaining lower in price values comparing at least one Interjected Specialized mid pivot;
2). real-time displaying, by such at least one computer, relative price position of components of mid Zone line fora lower time frame, with respect to Interjected Specialized mid pivot and Upward shilling of at least one mid Zone line of a lower time frame, along with remaining Hybrid Dynamic Zone lines;
3). real-time displaying, by such at least one computer, components of mid Zone lines of a lower time frame, combining with an Interjected Specialized mid pivot of a Highertime frame, creating a Hybrid, for a Lower Left Halved Hybrid Nozzlelism and the formation of different sections of a Lower Left Halved Hybrid Nozzlelism shape in sequence, using a Hybrid, for a Lower Left Halved Hybrid Nozzlelism, with concentration areas of Bullish Believers;
4). real-time displaying, by at least one such computer, at least one Unscheduled intersection of mid Zone line or at least one Unscheduled Event of mid Zone line in Risk transition time area for at least one Unscheduled intersection, after formation of a Lower Left Halved Hybrid Nozzlelism tipping section; and
5). real-time dynamically calculating and displaying, by such at least one computer, at least one completed Lower Left Halved Hybrid Nozzlelism shape combing sections of Lower Left Halved Hybrid Nozzlelism and Unscheduled Event of mid Zone line in Risktransition area, with a concentration of at least one Bullish Believers area with a Risk assessment, a Risk recognition, a Risk confirmation, a Risk designation, forecast and identifications, Multiple Ribbons, symbols and alerts, partially or in full during formation and/or at completion of Lower Left Halved Hybrid Nozzlelism.

17. A computer method according to claim 15, further comprises at least one Upper Left Halved Hybrid Nozzlelism, comprising the steps of: 1). dynamically calculating and real-time displaying, by such at least one computer, at least eight Hybrid Dynamic Zone lines, at least one Hybrid Dynamic Risk Zones with their relative price position with each other on a vertical price scale of a selected market vehicle and a component of a Vertical Risk dimension, of a Lower time frame, remaining Higher in price values comparing at least one Interjected Specialized mid pivot;
2). real-time displaying, by such at least one computer, relative price position of components of mid Zone line for a Lower time frame, with respect to Interjected Specialized mid pivot and Downward shilling of at least one mid Zone lines of a Lowertime frame, along with remaining Hybrid Dynamic Zone lines;
3). real-time displaying, by such at least one computer, components of mid Zone lines of a Lower time frame, combining with Interjected Specialized mid pivot of a Higher time frame, creating a Hybrid, for Upper Left Halved Hybrid Nozzlelism and the formation of different sections of Upper Left Halved Hybrid Nozzlelism shape in sequence, using a Hybrid, for an Upper Left Halved Hybrid Nozzlelism, with concentration areas of Bearish Believers;
4). real-time displaying, by at least one such computer, at least one Unscheduled intersection of mid Zone line or at least one Unscheduled Event of mid Zone line in Risk Transition Time Area for at least one Unscheduled intersection, after formation of a Upper Left Halved Hybrid Nozzlelism tipping section; and
5). real-time dynamically calculating and displaying, by such at least one computer, at least one completed Upper Left Halved Hybrid Nozzlelism shape combing sections of Upper Left Halved Hybrid Nozzlelism and Unscheduled Event of mid Zone line in Risktransition area , with a concentration of at least one Bearish Believers area;
with Risk assessment, Risk recognition, Risk confirmation, Risk designation, forecast and identifications, Multiple Ribbons, symbols and alerts, partially or in full during formation and/or at completion of Upper Left Halved Hybrid Nozzlelism.

18. A computer method according to claim 15, further comprises at least one Lower Right Halved Hybrid Nozzlelism, comprising the steps of:
1). dynamically calculating and real-time displaying, by such at least one computer, at least eight Hybrid Dynamic Zone lines, at least one Hybrid Dynamic Risk Zones with their relative price position with each other on a vertical price scale of a selected market vehide and a component of a Vertical Risk dimension, of a Lower time frame, remaining Lower in price values comparing at least one Interjected Specialized mid pivot;
2). real-time displaying, by such at least one computer, relative price position of components of a mid Zone line for a Lowertime frame, with respect to an Interjected Specialized mid pivot;
3). real-time displaying, by at least one such computer, at least one Unscheduled intersection of mid Zone line or at least one Unscheduled Event of mid Zone line in Risk Transition Time Area for at least one Unscheduled intersection, before formation of a Lower Right Halved Hybrid Nozzlelism tipping section and downward shilling of at least one mid Zone lines of a Lower time frame, along with remaining Hybrid Dynamic Zone lines;
4). real-time displaying, by such at least one computer, components of mid Zone lines of a Lower time frame, combining with Interjected Specialized mid pivot of a Highertime frame, creating “Hybrid”, for lower Right Halved Hybrid Nozzlelism and the formation of different sections of Lower Right Halved Hybrid Nozzlelism shape in sequence, using “Hybrid”, for Lower Right Halved Hybrid Nozzlelism, with concentration areas of Bullish Believers; and
5). real-time dynamically calculating and displaying, by such at least one computer, at least one completed Lower Right Halved Hybrid Nozzlelism shape combing sections of a Lower Right Halved Hybrid Nozzlelism and an Unscheduled Event of mid Zone line in Risk transition area , with a Risk assessment, a Risk recognition, a Risk confirmation, a Risk designation, forecast and identifications, Multiple Ribbons, symbols and alerts, partially or in full during formation and/or at completion of a Lower Right Halved Hybrid Nozzlelism.

19. A computer method according to claim 15, further comprises at least one Upper Right Halved Hybrid Nozzlelism, comprising the steps of:
1). dynamically calculating and real-time displaying, by such at least one computer, at least eight Hybrid Dynamic Zone lines, at least one Hybrid Dynamic Risk Zones with their relative price position with each other on a vertical price scale of a selected market vehide and a component of a Vertical Risk dimension, of a Lower time frame, remaining higher in price values comparing at least one Interjected Specialized mid pivot;
2). real-time displaying, by such at least one computer, relative price position of components of mid Zone line fora lower time frame, with respect to the Interjected Specialized mid pivot and at least one Unscheduled intersection of mid Zone line or at least one Unscheduled Event of mid Zone line in Risk Transition Time Area for at least one Unscheduled Intersection, before the formation of Upper Right Halved Hybrid Nozzlelism tipping section, and upward shifting of at least one mid Zone lines of a lowertime frame, along with remaining Hybrid Dynamic Zone lines;
3). real-time displaying, by such at least one computer, components of mid Zone lines of a lower time frame, combining with Interjected Specialized mid pivot of a Highertime frame, creating a Hybrid, for an Upper Right Halved Hybrid Nozzlelism and the formation of different sections of an Upper Right Halved Hybrid Nozzlelism shape in sequence, using a Hybrid, for an Upper Right Halved Hybrid Nozzlelism, with concentration areas of Bullish Believers; and
4). real-time dynamically calculating and displaying, by such at least one computer, at least one completed Upper Right Halved Hybrid Nozzlelism shape, combing sections of an Upper Right Halved Hybrid Nozzlelism and an Unscheduled Event of mid Zone line in Risk Transition Area, with a Risk assessment, a Risk recognition, a Risk confirmation, a Risk designation, forecast and identifications, Multiple Ribbons, symbols and alerts, partially or in full during formation and/or at completion of an Upper Right Halved Hybrid Nozzlelism.

20. A computer method according to claim 15, further comprises at least one Partial Halved Hybrid Nozzlelism, comprising the steps of:
1). dynamically calculating and real-time displaying, by such at least one computer, at least eight Hybrid Dynamic Zone lines, at least one Hybrid Dynamic Risk Zones with their relative price position with each other on a vertical price scale of a selected market vehide and a component of Vertical Risk dimension, of a lower time frame, remaining Higher or Lower in price values comparing at least one Interjected Specialized mid pivot;
2). real-time displaying, by such at least one computer, relative price position of components of mid Zone line fora lower time frame, with respect to Interjected Specialized mid pivot and Downward or Upward shilling of at least one mid Zone lines of a lowertime frame, along with remaining Hybrid Dynamic Zone lines, if any;
3). real-time displaying, by at least one such computer, at least one Unscheduled intersection of mid Zone line or at least one Unscheduled Event of mid Zone line in a Risk Transition Time Area for at least one Unscheduled intersection and at least one Scheduled Intersecting Event of a Specialized mid pivot with angular movement, of a Higher Time frame, with at least one mid Zone line of a lower time frame;
4). real-time displaying, by such at least one computer, components of mid Zone lines of a lower time frame, combining with Interjected Specialized mid pivot of a Higher time frame, creating a Hybrid, for a Partial Halved Hybrid Nozzlelism and the formation of different sections of a Halved Hybrid Nozzlelism shape, at least one incomplete, using components of at least one mid Zone line of a Lower time frame, and at least one Interjected Specialized mid pivot of a Higher time frame; Nozzlelism, using a Hybrid, with concentration areas of either Bullish or Bearish or Neutral Believers; and
5). real-time Dynamically calculating and displaying, by such at least one computer, sections of a Partial Halved Hybrid Nozzlelism and at least one completed Partial Halved Hybrid Nozzlelism shape, using sections with a Risk assessment, a Risk recognition, a Risk confirmation, a Risk designation, forecast and identifications, Multiple Ribbons, symbols and alerts, partially or in full during formation and/or at completion of various types of Partial Halved Hybrid Nozzlelism.

21. A computer method according to claim 15, further comprises at least one Double Upper Halved Hybrid Nozzlelism comprising the steps of:
1). dynamically calculating and real-time displaying, by such at least one computer, at least eight Hybrid Dynamic Zone lines, at least three Lower Hybrid Dynamic Risk Zones and at least three Upper Hybrid Dynamic Risk Zones with their relative price position with each other on a vertical price scale of a selected market vehide and a component of Vertical Risk dimension, of a Lower time frame, remaining Higher in price values comparing at least one Interjected Specialized mid pivot;
2). real-time displaying, by such at least one computer, relative price position of components of mid Zone line for a Lowertime frame, with respect to Interjected Specialized mid pivot and Downward on Left side and Upward on Right an sides shilling of at least one mid Zone lines of a Lower time frame, along with remaining Hybrid Dynamic Zone lines;
3). real-time displaying, by such at least one computer, components of mid Zone lines of a Lower time frame, combining with an Interjected Specialized mid pivot of a Highertime frame, creating a Hybrid, fora Double Upper Halved Hybrid Nozzlelism and the formation of different sections of a Upper Left Halved Hybrid Nozzlelism shape in sequence using a Hybrid, with of at least one concentration areas of Bearish to Bullish believers area;
4). real-time Dynamically calculating and displaying, by such at least one computer, at least one completed Double Upper Halved Hybrid Nozzlelism shape combing five sections of a Double Upper Halved Hybrid Nozzlelism with a concentration areas of Bearish Believers to Bullish Believers; and
5). real-time displaying, by such at least one computer, a Risk assessment, a Risk recognition, a Risk confirmation, a Risk designation, forecast and identifications, Multiple Ribbons, symbols and alerts, partially or in full during formation and/or at completion of a Double Upper Left Halved Hybrid Nozzlelism.

22. A computer method according to claim 15, further comprises at least one Double Lower Halved Hybrid Nozzlelism comprising the steps of: 1). dynamically calculating and real-time displaying, by such at least one computer, at least eight Hybrid Dynamic Zone lines, at least three Lower Hybrid Dynamic Risk Zones and at least three Upper Hybrid Dynamic Risk Zones with their relative price position with each other on a vertical price scale of a selected market vehide and a component of Vertical Risk dimension, of a Lower Time frame, remaining Higher in price values comparing at least one Interjected mid pivot;
2). real-time displaying, by such at least one computer, relative price position of components of-mid Zone line for a Lowertime frame, with respect to an Interjected Specialized mid pivot;
3). real-time displaying, by such at least one computer, Upward on Left side and Downward on Right sides shilling of at least one mid Zone lines of a Lowertime frame, along with remaining Hybrid Dynamic Zone lines, and components of mid Zone lines of a Lowertime frame, combining with an Interjected Specialized mid pivot of a Highertime frame, creating a Hybrid , for a Double Lower Halved Hybrid Nozzlelism and the formation of different sections of a Upper Left Halved Hybrid Nozzlelism shape in sequence, using a Hybrid, with at least one concentration areas of Bullish believers to Bearish believers area; and
4). real-time dynamically calculating and displaying, by such at least one computer, at least one completed Double Lower Halved Hybrid Nozzlelism shape combing five sections of a Double Lower Halved Hybrid Nozzlelism with a concentration areas of Bullish to Bearish Believers with and a Risk assessment, a Risk recognition, a Risk confirmation, a Risk designation, forecast and identifications, Multiple Ribbons, symbols and alerts, partially or in full during formation and at completion of a Double Lower Left Halved Hybrid Nozzlelism.

23. A computer method according to claim 15, further comprises at least one Halved Hybrid Nozzlelism Parallelism area for Bullish Believers comprising the steps of:
1). dynamically calculating and real-time displaying, by such at least one computer, at least eight Hybrid Dynamic Zone lines, at least one Hybrid Dynamic Risk Zones with their relative price position with each other on a vertical market vehide price scale and a component of Vertical Risk dimension, of a Lower time frame, remaining Parallel to and Higher or Lower in price values comparing at least one Interjected Specialized mid pivot of a Higher time frame with a very limited distance on a vertical scale and a relative price position of components of mid Zone line for a Lower time frame, with respect to at least one Interjected Specialized mid pivot;
2). real-time displaying, by such at least one computer, Upward shifting of at least one mid Zone line of a Lower time frame, along with remaining Hybrid Dynamic Zone lines, with at least one Unscheduled intersection of mid Zone line or at least one Unscheduled Event of mid Zone line in a Risk Transition Time Area for at least one Unscheduled intersection and at least one Scheduled Intersecting Event of a Specialized Mid pivot with an angular movement North, of a Higher Time frame, with at least one mid Zone line of a Lower time frame;
3). real-time displaying, by such at least one computer, components of a mid Zone line of a Lower time frame, combining with an Interjected Specialized mid pivot of a Higher time frame, creating a Hybrid, for a Halved Hybrid Parallelism and the formation of the area for a Halved Hybrid Parallelism, between one mid Zone line, an Interjected Specialized mid pivot, using a Hybrid and formation between a Halved Hybrid Nozzlelism Tipping area and a Halved Hybrid Annularization area and or between one mid Zone line and an Interjected Specialized pivot, with concentration of at least one Bearish Believers area; and
4). real-time displaying, by such at least one computer, formation of at least one type of Halved Hybrid Parallelism sections and at least one type of completed section of Halved Hybrid Parallelism with a Risk assessment, a Risk recognition, a Risk confirmation, a Risk designation, forecast and identifications, Multiple Ribbons, symbols and alerts, partially or in full during formation and/or at completion of various types of Halved Hybrid Parallelism with area for Bullish Believers.

24. A computer method according to claim 15, further comprises at least one Halved Hybrid Nozzlelism Parallelism area for Bearish Believers comprising the steps of:
1). dynamically calculating and real-time displaying, by such at least one computer, at least eight Hybrid Dynamic Zone lines, at least one Hybrid Dynamic Risk Zones with their relative price position with each other and a component of a Vertical Risk dimension, of a Lower time frame, remaining Parallel to and Higher or Lower in price values comparing at least one Interjected Specialized mid pivot of a Higher time frame with a very limited distance on a vertical market vehide price scale;
2). real-time displaying, by such at least one computer, a relative price position of components of a Hybrid mid Zone line for a Lower time frame, with respect to at least one Interjected Specialized mid pivot and Downward shifting of at least one mid Zone lines of a Lower time frame, along with remaining Hybrid Dynamic Zone lines;
3). real-time displaying, by at least one such computer, at least one Unscheduled intersection of mid Zone line or at least one Unscheduled Event of mid Zone line in Risk Transition Time area for at least one Unscheduled intersection and at least one scheduled intersecting Event of an Interjected Specialized mid pivot with angular movement, of a Higher Time frame, with at least one mid Zone line of a Lower time frame;
4). real-time displaying, by such at least one computer, components of mid Zone lines of a Lower time frame, combining with Interjected Specialized mid pivot of a Higher time frame, creating a Hybrid, for Halved Hybrid Parallelism and the formation of the area for the Halved Hybrid Parallelism, between one mid Zone line, an Interjected Specialized mid pivot, using a Hybrid and forming a Halved Hybrid Nozzlelism Tipping area, a Halved Hybrid Annularization area and between one mid Zone line and an Interjected Specialized mid pivot with concentration of at least one Bearish Believers Area; and
5). real-time displaying, by such at least one computer, formation of at least one type of Halved Hybrid Parallelism section and formation of at least one type of completed Halved Hybrid Parallelism with a Risk assessment, a Risk recognition, a Risk confirmation, a Risk designation, forecast and identifications, Multiple Ribbons, symbols and alerts, partially or in full during formation and/or at completion of various types of Halved Hybrid Parallelism with area for Bearish Believers.

25. The computer method of claim 1, wherein the specific purpose computer comprises two Risk processors.
